(19) United States
(12) Patent Application Publication
(10) Pub. No.: US 2010/0019621 A1
(43) Pub. Date: Jan. 28, 2010

(54) ULTRASONIC MOTOR AND ULTRASONIC MOTOR APPARATUS RETAINING THE SAME

(75) Inventors: Tomoki FUNAKUBO, Tama-shi (JP); Hiroshi TSURUTA, Sagamihara-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/502,520

(22) Filed: Jul. 14, 2009

(30) Foreign Application Priority Data
Jul. 14, 2008 (JP) 2008-183170
Dec. 3, 2008 (JP) 2008-308738
Jan. 14, 2009 (JP) 2009-005891
Jan. 14, 2009 (JP) 2009-005892
Mar. 17, 2009 (JP) 2009-064875
Mar. 19, 2009 (JP) 2009-068889

(51) Int. Cl. H02N 2/12

(52) U.S. Cl. 310/323.16

(57) ABSTRACT

An ultrasonic motor according to an aspect of the invention includes at least a piezoelectric element that is an oscillator whose section perpendicular to a central axis has a rectangular length ratio, and a rotor that is rotated about the central axis as a rotation axis while being in contact with an elliptic oscillation generating surface of the oscillator. The central axis is orthogonal to the elliptic oscillation generating surface of the oscillator. The elliptic oscillation is formed by combining first longitudinal resonance oscillation in which expansion and contraction are performed in a rotation axis direction of the piezoelectric element and second twisting resonance oscillation in which the rotation axis is a twisting axis.

### CROSS-REFERENCE TO RELATED APPLICATIONS

This application is based upon and claims the benefit of priority from prior Japanese Patent Applications No. 2008-183170, filed Jul. 14, 2008; No. 2008-308738, filed Dec. 3, 2008; No. 2009-005891, filed Jan. 14, 2009; No. 2009-005892, filed Jan. 14, 2009; No. 2009-064875, filed Mar. 17, 2009; and No. 2009-068889 filed Mar. 19, 2009, the entire contents of all of which are incorporated herein by reference.

### BACKGROUND OF THE INVENTION

1. Field of the Invention

The present invention relates to an ultrasonic motor in which ultrasonic oscillation is used as a driving power caused by standing waves source to drive a driven body and an ultrasonic motor apparatus retaining the ultrasonic motor.

2. Description of the Related Art

For example, an inventor of present invention once proposed a rod-like ultrasonic motor using a standing waves in which a longitudinal oscillation and a twisting oscillation of an oscillator are combined to generate an elliptic oscillation and whereby a rotor is rotated in Jpn. Pat. Appln. KOKAI Publication No. 9-117168. In the oscillator illustrated in an exploded perspective view of FIG. 1 of Jpn. Pat. Appln. KOKAI Publication No. 9-117168, plural piezoelectric elements are inserted between elastic bodies that are obliquely cut with respect to an oscillator shaft direction A positive electrode of the piezoelectric element is divided into two, and the two divided positive electrodes are referred to as A phase and B phase.

In-phase alternate voltages are applied to the A phase and the B phase, which allows the longitudinal oscillation to be generated in the rod-like oscillator. Reversed-phase alternate voltages are applied to the A phase and the B phase, which allows the twisting oscillation to be generated in the rod-like oscillator. At this point, the oscillator has a groove portion and an extending body to an end of the bottom side of the oscillator where is other side of the end being arranged the rotor. The position of the groove portion of the oscillator is determined seriously as to adjust such that a resonance frequency of the longitudinal oscillation is substantially matched with a resonance frequency of the twisting oscillation. When alternate voltages whose phases are different from each other by π/2 are applied to the A phase and the B phase, the longitudinal oscillation and the twisting oscillation are simultaneously generated, which allows an elliptic oscillation to be generated in an upper surface of the rod-like elastic body. The rotor is pressed against the upper surface of the rod-like elastic body, which allows the rotor to be rotated clockwise (CW direction) or counterclockwise (CCW direction).

U.S. Pat. No. 4,965,482 discloses an another cylindrical ultrasonic motor elongated shaft body used as an adjusting member to match the resonance frequency of the longitudinal oscillation and the twisting oscillation.

Thus, a conventional ultrasonic motor needs an extra adjusting member which is elongated along the rotation axis of the motor for adjusting the resonance frequencies of different kinds of oscillation to generate an elliptic oscillation.

### BRIEF SUMMARY OF THE INVENTION

Therefore, an object of the present invention is to provide a novel ultrasonic motor which does not need an extra adjusting member and can be reduced in size in the direction along the rotation axis.

An object of the invention is to provide a simply-structured ultrasonic motor formed of a single member, in which a groove portion is eliminated, a longitudinal oscillation and a twisting oscillation can easily be excited, the longitudinal oscillation and the twisting oscillation are combined to form an elliptic oscillation, and the rotor is rotated by the elliptic oscillation.

Another object of the invention is to provide a simply-structured ultrasonic motor, in which a groove portion is eliminated, a hole is not made in a piezoelectric element, the longitudinal oscillation and the twisting oscillation can easily be excited, and the rotor is rotated by the elliptic oscillation generated in the ultrasonic oscillator.

Still another object of the invention is to provide a simply-structured ultrasonic motor, in which the groove portion is eliminated, the hole is not made in the piezoelectric element, the elliptic oscillation can easily be excited, and the rotor is rotated by the elliptic oscillation generated in the ultrasonic oscillator.

Yet another object of the invention is to provide an ultrasonic motor, in which the elliptic oscillation in which longitudinal and twisting oscillation modes are combined is formed only by a single oscillator, the rotor is rotated by the elliptic oscillation, and a torque can be transmitted in an axial direction.

Another object of the present invention is to provide an improved ultrasonic motor which can generate an elliptic oscillation having the same direction in an extended area and which enables selection of an elliptically oscillating position in accordance with the type of rotor and in accordance with the size, shape and material of the rotor.

A further object of the present invention is to provide an ultrasonic motor which is stably supported by means of a supporting member and which is applicable to any type of device that moves violently or at high speed.

Still yet another object of the invention is to provide an ultrasonic motor comprising:

an oscillator whose section perpendicular to a central axis has a rectangular length ratio;

oscillation applying means for applying a first longitudinal resonance oscillation in which oscillation is performed in a direction of a rotation axial direction of the oscillator and a second twisting resonance oscillation in which the oscillation is performed in a direction orthogonal to the rotation axial direction; and

a driven body that is rotated, with a central axis orthogonal to an elliptic oscillation generating surface of the oscillator as a rotation axis, while being in contact with the elliptic oscillation generating surface,

the rectangular length ratio of the oscillator is set such that a resonance frequency of the first resonance oscillation is substantially matched with a resonance frequency of the second resonance oscillation.

Still further object of the invention is to provide an ultrasonic motor comprising:

an oscillator whose section perpendicular to a central axis has a rectangular length ratio;

oscillation applying means for applying a first longitudinal resonance oscillation in which oscillation is performed in a direction of a rotation axial direction of the oscillator and a second twisting resonance oscillation in which the oscillation is performed in a direction orthogonal to the rotation axial direction; and

a driven body that is rotated, with a central axis orthogonal to an elliptic oscillation generating surface of the oscillator as a rotation axis, while being in contact with the elliptic oscillation generating surface,

the rectangular length ratio of the oscillator is set such that a resonance frequency of the first resonance oscillation is substantially matched with a resonance frequency of the second resonance oscillation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A to 1E illustrate an ultrasonic motor according to a first embodiment of the invention, wherein FIG. 1A is an appearance perspective view of the ultrasonic motor, FIG. 1B is a sectional view of the ultrasonic motor, FIG. 1C is an appearance perspective view illustrating an oscillator to which a friction contact member is bonded, FIG. 1D is an appearance perspective view of the oscillator, and FIG. 1E illustrates an arrangement example of an interdigital electrode formed in a surface of the oscillator;

FIGS. 2A to 2E are views for explaining match of an eigenfrequency of a piezoelectric element 11 used in the ultrasonic motor 10 of the first embodiment;

FIG. 3 illustrates a resonance frequency of each mode when a horizontal axis is set to short side length/long side length (a/b) while a side c of the piezoelectric element 11 of FIG. 2 is kept constant;

FIG. 4 illustrates the detailed interdigital electrode provided in a side surface of the piezoelectric element 11 that is the oscillator of the ultrasonic motor 10, and is a plan view illustrating the piezoelectric element 11 as viewed from above;

FIGS. 5A to 5D illustrate the detailed interdigital electrode provided in the side surface of the piezoelectric element 11 that is the oscillator of the ultrasonic motor 10, and illustrates the piezoelectric element 11 of FIG. 4 as viewed from an α direction, a β direction, a γ direction, and a δ direction;

FIGS. 6A to 6D illustrate the detailed interdigital electrode provided in the side surface of the piezoelectric element 11 that is the oscillator of the ultrasonic motor 10, and illustrates the piezoelectric element of FIG. 4 as viewed from the α direction, the β direction, the γ direction, and the δ direction;

FIGS. 7A to 7D illustrate a piezoelectric element 11 according to a first modification of the first embodiment as viewed from the U direction, the D direction, the γ direction, and the δ direction;

FIG. 8 is an appearance perspective view illustrating an ultrasonic motor according to a second modification of the first embodiment;

FIGS. 9A and 9B illustrate an ultrasonic motor according to a third modification of the first embodiment, wherein FIG. 9A illustrates an example in which a piezoelectric element 47 has an elliptic section orthogonal to a shaft, and FIG. 9B illustrates an example in which a piezoelectric element 48 has a rhombic section orthogonal to a shaft;

FIG. 10 is an appearance perspective view illustrating an ultrasonic motor according to a second embodiment of the invention;

FIGS. 11A and 11B illustrate an oscillator to which a friction contact member of the ultrasonic motor of the second embodiment is bonded, wherein FIG. 11A is an appearance perspective view of the oscillator, and FIG. 11B is a plan view of the oscillator;

FIG. 12 illustrates the ultrasonic motor of the second embodiment, and is a plan view illustrating a piezoelectric element 51 as viewed from above;

FIGS. 13A and 13B illustrate the ultrasonic motor of the second embodiment, and illustrates the piezoelectric element 51 of FIG. 11 as viewed from the α direction and the β direction;

FIGS. 14A and 14B illustrate the ultrasonic motor of the second embodiment, and illustrates the piezoelectric element 51 of FIG. 11 as viewed from the α direction and the β direction;

FIG. 15 is an appearance perspective view illustrating an ultrasonic motor according to a third embodiment of the invention;

FIGS. 16A and 16B illustrate an oscillator to which a friction contact member of the ultrasonic motor of the third embodiment is bonded, wherein FIG. 16A is an appearance perspective view of the oscillator, and FIG. 16B is a plan view of the oscillator;

FIG. 17 illustrates the ultrasonic motor of the third embodiment, and is a plan view illustrating a piezoelectric element 61 as viewed from above;

FIGS. 18A and 18B illustrate the ultrasonic motor of the third embodiment, and illustrates the piezoelectric element 61 of FIG. 17 as viewed from the α direction and the β direction;

FIG. 19 is an appearance perspective view illustrating an ultrasonic motor according to a fourth embodiment of the invention;

FIGS. 20A and 20B illustrate a laminated piezoelectric element to which a friction contact member is bonded in the ultrasonic motor 80 of FIG. 19, wherein FIG. 20A is an appearance perspective view of the laminated piezoelectric element, and FIG. 20B is a plan view of the laminated piezoelectric element;

FIGS. 21A to 21I illustrate a configuration of the laminated piezoelectric element 81, wherein FIG. 21A is a plan view of the laminated piezoelectric element as viewed from above, FIG. 21B is an exploded perspective view of the laminated piezoelectric element, FIG. 21C is a perspective view of the laminated piezoelectric element as viewed from the α direction of FIG. 21A,

FIG. 21D illustrates the laminated piezoelectric element as viewed from the γ direction of FIG. 21A, FIG. 21E illustrates the laminated piezoelectric element as viewed from the δ direction of FIG. 21A, FIG. 21F illustrates a state in which an external electrode is attached to the laminated piezoelectric element of FIG. 21D, FIG. 21G illustrates a state in which an external electrode is attached to the laminated piezoelectric element of FIG. 21E, FIG. 21H illustrates another example in which an external electrode is attached to the laminated piezoelectric element of FIG. 21D, and FIG. 21I illustrates another example in which an external electrode is attached to the laminated piezoelectric element of FIG. 21E;

FIG. 22 illustrates an arrangement example of an interdigital electrode formed in a surface of the laminated piezoelectric element;

FIG. 23 is a sectional view which includes a polarization direction illustrated along a line B-B′ of FIG. 21B and is perpendicular to a side face;

FIGS. 24A to 24C illustrate a configuration of a laminated piezoelectric element 81 according to a first modification of the fourth embodiment, wherein FIG. 24A is an exploded perspective view of the laminated piezoelectric element, FIG. 24B illustrates the laminated piezoelectric element 81 of FIG. 24A as viewed from the left, and FIG. 24C illustrates the laminated piezoelectric element 81 of FIG. 24A as viewed from the right;

FIGS. 25A and 25B illustrate a configuration of a laminated piezoelectric element 81 according to a second modification of the fourth embodiment, wherein FIG. 25A is an exploded perspective view of the laminated piezoelectric element, and FIG. 25B illustrates the laminated piezoelectric element 81 of FIG. 25A as viewed from a bottom side;

FIG. 26 is an exploded perspective view illustrating a configuration of the laminated piezoelectric element of an ultrasonic motor according to a fifth embodiment of the invention;

FIG. 27 illustrates a section including a laminated direction and a direction orthogonal to a digital direction of an interdigital electrode in order to illustrate a polarization state in the laminated piezoelectric element of the fifth embodiment;

FIG. 28 is an appearance perspective view illustrating an ultrasonic motor according to a sixth embodiment of the invention;

FIG. 29 is an appearance perspective view illustrating an oscillator to which a friction contact member is bonded in the ultrasonic motor of FIG. 28;

FIGS. 30A to 30D illustrate a configuration of a laminated piezoelectric element 111 of the sixth embodiment, wherein FIG. 30A is a plan view illustrating the laminated piezoelectric element as viewed from above, FIG. 30B is an exploded perspective view of the laminated piezoelectric element, FIG. 30C illustrates the laminated piezoelectric element 111 as viewed from the γ direction of FIG. 30A, and FIG. 30D illustrates the laminated piezoelectric element 111 as viewed from the δ direction of FIG. 30A;

FIGS. 31A to 31D illustrate a configuration of a laminated piezoelectric element 131 according to a first modification of the sixth embodiment, wherein FIG. 31A is a plan view illustrating the laminated piezoelectric element as viewed from above, FIG. 31B is an exploded perspective view of the laminated piezoelectric element, FIG. 31C illustrates the laminated piezoelectric element 131 as viewed from the γ direction of FIG. 31A, and FIG. 31D illustrates the laminated piezoelectric element as viewed from the δ direction of FIG. 31A;

FIG. 32 is an appearance perspective view illustrating an ultrasonic motor according to a seventh embodiment of the invention;

FIGS. 33A and 33B illustrate the laminated piezoelectric element of FIG. 32, wherein FIG. 33A is an exploded perspective view of the laminated piezoelectric element, and FIG. 33B is a perspective view of the laminated piezoelectric element;

FIGS. 34A to 34C illustrate a configuration of the laminated piezoelectric element of the seventh embodiment, FIG. 34A illustrates examples of a piezoelectric sheet and an internal electrode pattern, wherein FIG. 34B illustrates an arrangement example of an interdigital electrode formed in a surface of an oscillator, and FIG. 34C illustrates an external electrode after the laminated piezoelectric element of FIG. 34B is laminated;

FIGS. 35A to 35C illustrate a configuration of a laminated piezoelectric element according to a first modification of the seventh embodiment, wherein FIG. 35A is an exploded perspective view of the laminated piezoelectric element, FIG. 35B illustrates the laminated piezoelectric element of FIG. 35A as viewed from the left, and FIG. 35C illustrates the laminated piezoelectric element of FIG. 35A as viewed from the right;

FIGS. 36A and 36B illustrate a configuration of a laminated piezoelectric element according to a second modification of the seventh embodiment, wherein FIG. 36A is an exploded perspective view of the laminated piezoelectric element, and FIG. 36B illustrates an external electrode of the laminated piezoelectric element of FIG. 36A;

FIGS. 37A and 37B illustrate a configuration of a laminated piezoelectric element according to a third modification of the seventh embodiment, wherein FIG. 37A is an exploded perspective view of the laminated piezoelectric element, and FIG. 37B illustrates an external electrode of the laminated piezoelectric element of FIG. 37A;

FIGS. 38A to 38D illustrate a configuration of a laminated piezoelectric element according to a fourth modification of the seventh embodiment, wherein FIG. 38A illustrates examples of a piezoelectric sheet and an internal electrode pattern, FIG. 38B is a perspective view of the laminated piezoelectric element as viewed from a direction of the piezoelectric sheet (3)155c of FIG. 38A, FIG. 38C illustrates the laminated piezoelectric element as viewed from a direction of a right side surface, and FIG. 38D illustrates the laminated piezoelectric element as viewed from a direction of a left side surface;

FIGS. 39A to 39C illustrate a configuration of an oscillator according to a fifth modification of the seventh embodiment, wherein FIG. 39A is an exploded perspective view of the oscillator, FIG. 39B illustrates an electrode pattern of a first piezoelectric element of FIG. 39A, and FIG. 39C illustrates an electrode pattern of a second piezoelectric element of FIG. 39A;

FIGS. 40A to 40C illustrate a configuration of an oscillator in an ultrasonic motor according to an eighth embodiment of the invention, wherein FIG. 40A is an exploded perspective view of the oscillator, FIG. 40B is a perspective view illustrating a state in which the oscillator of FIG. 40A is assembled, and FIG. 40C illustrates the oscillator of FIG. 40A as viewed from above;

FIGS. 41A and 41B illustrate a configuration of an oscillator in an ultrasonic motor according to a first modification of the eighth embodiment, wherein FIG. 41A is an exploded perspective view of the oscillator, and FIG. 41B is a perspective view illustrating a state in which the oscillator of FIG. 41A is assembled;

FIG. 42 is an appearance perspective view illustrating an ultrasonic motor according to a ninth embodiment of the invention;

FIGS. 43A to 43C illustrate an oscillator of FIG. 42, wherein FIG. 43A is an exploded perspective view of the oscillator, FIG. 43B is an appearance perspective view of the oscillator, and FIG. 43C is a top view of the oscillator;

FIGS. 44A to 44C illustrate a configuration of a laminated piezoelectric element according to a ninth embodiment, wherein FIG. 44A illustrates examples of a piezoelectric sheet and an internal electrode pattern, FIG. 44B illustrates an arrangement example of an interdigital electrode formed in a surface of the oscillator, and FIG. 44C illustrates an external electrode after the laminated piezoelectric element of FIG. 44A is laminated;

FIG. 45 is an exploded perspective view illustrating a configuration of an oscillator according to a first modification of the ninth embodiment;

FIGS. 46A and 46B illustrate a configuration of a laminated piezoelectric element according to a third modification of the ninth embodiment, wherein FIG. 46A is an exploded perspective view of the laminated piezoelectric element, and FIG. 46B illustrates an external electrode of the laminated piezoelectric element of FIG. 46A;

FIGS. 47A to 47C illustrate a configuration of an oscillator of an ultrasonic motor according to a tenth embodiment of the invention, wherein FIG. 47A is an exploded perspective view of the oscillator, FIG. 47B is a perspective view illustrating a state in which the oscillator of FIG. 47A is assembled, and FIG. 47C illustrates the oscillator of FIG. 47B as viewed from above;

FIGS. 48A and 48B illustrate a configuration of an oscillator of an ultrasonic motor according to a first modification of the tenth embodiment, wherein FIG. 48A is an exploded perspective view of the oscillator, and FIG. 48B is a perspective view illustrating a state in which the oscillator of FIG. 48A is assembled;

FIG. 49 is an appearance perspective view illustrating an ultrasonic motor according to an eleventh embodiment of the invention;

FIGS. 50A and 50B illustrate the oscillator of FIG. 49, wherein FIG. 50A is an appearance perspective view of the oscillator, and FIG. 50B is an appearance perspective view illustrating the oscillator of FIG. 50A to which a friction contact is bonded;

FIG. 51 is an exploded perspective view illustrating a configuration of a piezoelectric sheet of a laminated piezoelectric element 261;

FIGS. 52A and 52B schematically illustrate an oscillation state of each oscillation mode, wherein FIG. 52A schematically illustrates an oscillation state of a face shear oscillation mode, and FIG. 52B schematically illustrates an oscillation state of a flexural oscillation mode;

FIGS. 53A and 53B illustrate the face shear oscillation mode as viewed from a direction perpendicular to an ef surface of FIG. 50A, and illustrate the oscillation states in which oscillation phases are deviated from each other by π;

FIGS. 54A and 54B illustrate the flexural oscillation mode as viewed from an upper surface, and illustrate the oscillation states in which the oscillation phases are deviated from each other by a;

FIGS. 55A and 55B illustrate a central sectional portion 277 of FIG. 52B;

FIG. 56 is a view in which a g/e value and a resonance frequency of each mode when g is changed are plotted while a side of the oscillator is kept e=f (constant);

FIGS. 57A and 57B illustrate a state of a strain (principal strain) of the ef surface when the face shear oscillation is generated;

FIGS. 58A and 58B illustrate a state of a strain (principal strain) of the ef surface when the flexural oscillation is generated;

FIGS. 59A and 59B are views for explaining an internal electrode pattern for generating the face shear oscillation and the flexural oscillation;

FIG. 60 is a view for explaining that each oscillation mode can be excited from an alternate force F40;

FIG. 61 is an exploded perspective view illustrating a configuration of a piezoelectric sheet according to a twelfth embodiment of the invention;

FIG. 62 is an appearance perspective view illustrating a laminated piezoelectric element of the twelfth embodiment;

FIGS. 63A and 63B are views for explaining the flexural oscillation while only the piezoelectric sheet (2) is taken out;

FIGS. 64A and 64B illustrate a configuration of an oscillator according to a thirteenth embodiment of the invention, wherein FIG. 64A is an appearance perspective view of the oscillator as viewed from a surface side, and FIG. 64B is a plan view of the oscillator as viewed from a backside;

FIG. 65 is an exploded perspective view illustrating a configuration of an ultrasonic motor apparatus according to a fourteenth embodiment of the invention;

FIG. 66 is an assembly drawing illustrating the ultrasonic motor apparatus of the fourteenth embodiment;

FIG. 67 is a sectional view illustrating the ultrasonic motor apparatus of the fourteenth embodiment;

FIG. 68 is a perspective view illustrating pins 313a to 313d that support a laminated piezoelectric element 1301 according to a second modification of the fourteenth embodiment;

FIG. 69 is an assembly drawing illustrating an ultrasonic motor apparatus of the second modification of the fourteenth embodiment;

FIG. 70 is a perspective view illustrating the pins 313c and 313d that support a laminated piezoelectric element 301 in another example of the second modification of the fourteenth embodiment;

FIG. 71 is a sectional view illustrating an ultrasonic motor apparatus in another example of the second modification of the fourteenth embodiment, and illustrates a detailed portion in which a laminated piezoelectric element supported only by the pins 313c and 313d is fitted;

FIG. 72 is an exploded perspective view illustrating a configuration of an ultrasonic motor apparatus according to a fifteenth embodiment of the invention;

FIG. 73 is an assembly drawing illustrating the ultrasonic motor apparatus of the fifteenth embodiment;

FIG. 74 is a sectional view illustrating the ultrasonic motor apparatus of the fifteenth embodiment;

FIG. 75 is an exploded perspective view illustrating a configuration of an ultrasonic motor apparatus according to a sixteenth embodiment of the invention;

FIG. 76 is an assembly drawing illustrating the ultrasonic motor apparatus of the sixteenth embodiment;

FIG. 77 is a sectional view illustrating the ultrasonic motor apparatus of the sixteenth embodiment;

FIG. 78 is an appearance perspective view illustrating a configuration of a rotating contact member of an ultrasonic motor apparatus according to a first modification of the sixteenth embodiment;

FIG. 79 is an assembly drawing illustrating the ultrasonic motor apparatus of the first modification of the sixteenth embodiment;

FIG. 80 is a sectional view illustrating the ultrasonic motor apparatus of the first modification of the sixteenth embodiment;

FIGS. 81A and 81B illustrate a configuration of an ultrasonic motor apparatus according to a seventeenth embodiment of the invention, wherein FIG. 81A is an exploded perspective view of the ultrasonic motor apparatus, and FIG. 81B is an enlarged perspective view illustrating a shaft-integrated rotor of FIG. 81A;

FIG. 82 is an assembly drawing illustrating an ultrasonic motor apparatus of the seventeenth embodiment;

FIG. 83 is a sectional view illustrating the ultrasonic motor apparatus of the seventeenth embodiment;

FIG. 84 is an exploded perspective view illustrating a configuration of an ultrasonic motor apparatus according to an eighteenth embodiment of the invention;

FIG. 85 is an assembly drawing illustrating the ultrasonic motor apparatus of the eighteenth embodiment;

FIG. 86 is a sectional view illustrating the ultrasonic motor apparatus of the eighteenth embodiment;

FIG. 87 is an exploded perspective view illustrating an ultrasonic motor apparatus according to a nineteenth embodiment of the invention;

FIG. 88 is an assembly drawing illustrating the ultrasonic motor apparatus of the nineteenth embodiment;

FIG. 89 is a sectional view illustrating the ultrasonic motor apparatus of the nineteenth embodiment;

FIG. 90 is an exploded perspective view illustrating an ultrasonic motor apparatus according to a twentieth embodiment of the invention;

FIG. 91 is an assembly drawing illustrating the ultrasonic motor apparatus of the twentieth embodiment;

FIG. 92 is a sectional view illustrating the ultrasonic motor apparatus of the twentieth embodiment;

FIG. 93 is an exploded perspective view illustrating an ultrasonic motor apparatus according to a first modification of the twentieth embodiment;

FIG. 94 is an appearance perspective view illustrating a configuration of a cover in a case of FIG. 93;

FIG. 95 is an assembly drawing illustrating the ultrasonic motor apparatus of the first modification of the twentieth embodiment;

FIG. 96 is a sectional view illustrating the ultrasonic motor apparatus of the first modification of the twentieth embodiment;

FIG. 97 is an exploded perspective view illustrating a configuration of an ultrasonic motor apparatus according to a twenty-first embodiment of the invention;

FIG. 98 is an assembly drawing illustrating the ultrasonic motor apparatus of the twenty-first embodiment; and

FIG. 99 is a sectional view illustrating the ultrasonic motor apparatus of the twenty-first embodiment.

### DETAILED DESCRIPTION OF THE INVENTION

Embodiments of the invention will be described below with reference to the drawings.

### First Embodiment

An ultrasonic motor according to a first embodiment of the invention will be described.

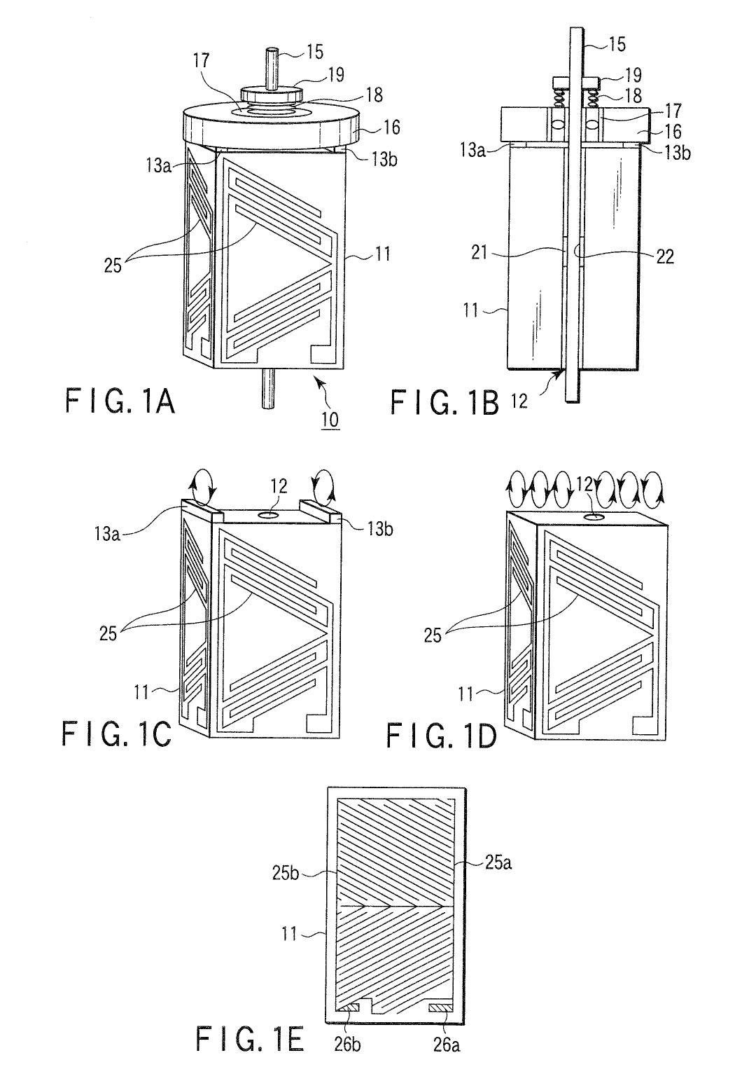

FIGS. 1A to 1E illustrate an ultrasonic motor according to the first embodiment of the invention, wherein FIG. 1A is an appearance perspective view of the ultrasonic motor, FIG. 1B is a sectional view of the ultrasonic motor, FIG. 1C is an appearance perspective view illustrating an oscillator to which a friction contact member is bonded, FIG. 1D is an appearance perspective view of the oscillator, and FIG. 1E illustrates an arrangement example of an interdigital electrode formed in a surface of the oscillator.

Referring to FIGS. 1A and 1B, an ultrasonic motor 10 includes a piezoelectric element 11, friction contact members 13a and 13b that are bonded to a surface orthogonal to a longitudinal direction of the piezoelectric element 11, a shaft 15 that is inserted in a throughhole 12 made in the longitudinal direction of the piezoelectric element 11, a rotor 16 that is driven while being in contact with the friction contact members 13a and 13b, a bearing 17, a spring 18, and a spring retaining ring 19.

In the first to third embodiments, the oscillator includes the single piezoelectric element.

Referring to FIGS. 1C and 1D, the piezoelectric element 11 is formed into a substantially rectangular solid, and is made of hard Piezoelectric Zirconate Titanate (hereinafter referred to as PZT), Potassium Niobate whose Q value is 1000 or more. Interdigital electrodes 25 are provided in four side surfaces of the piezoelectric element 11.

As used herein, the interdigital electrode shall mean an electrode in which, for example, a positive-phase electrode 25a and a negative-phase electrode 25b are alternately disposed as illustrated in FIG. 1E. For the sake of convenience, the interdigital electrode 25 is omitted in the drawings except FIG. 1E, although actually the interdigital electrode 25 is formed over each of the side surfaces as illustrated in FIG. 1E so as to be increased in the side surface as much as possible. Electrode lead-out portions 26a and 26b are formed at leading ends of the positive-phase electrode 25a and the negative-phase electrode 25b, respectively. The detailed interdigital electrode 25 will be described later.

The throughhole 12 is made in a central portion in the longitudinal direction (vertical direction of FIG. 1) of the piezoelectric element 11 in order to insert the shaft 15 therein. Referring to FIG. 1B, the shaft 15 has a substantially cylindrical shape, and is fixed in a substantially central portion 21 of the throughhole 12 of the piezoelectric element (oscillator) 11 using a bonding agent 22. A diameter of the throughhole 12 is slight larger than the shaft 15 to prevent from contact each other. A diameter of the shaft 15 in the central portion 21 is slightly larger than that in other portions. Herein, a diameter of the throughhole 12 may be slight smaller than that in other portions, instead of changing a diameter of the shaft 15. The shaft 15 is in contact with and fixed to the piezoelectric element 11 only in the central portion of the throughhole 12 in the piezoelectric element 11, and other portions of the shaft 15 are not in contact with an inner wall surface of the throughhole 12 during driving the piezoelectric element 11.

The friction contact members 13a and 13b are bonded to one of end faces (end face in which the rotor 16 is disposed) of the piezoelectric element 11. Each of the friction contact members 13a and 13b is formed into the rectangular solid. The friction contact members 13a and 13b are bonded to one of the end faces of the piezoelectric element 11, and are bonded to two points where an elliptic oscillation is generated. The friction contact members 13a and 13b are made of engineering plastics such as PPS.

The rotor 16 is made of alumina ceramics, and the bearing 17 is fitted in a central portion of the rotor 16. Accordingly, the rotor 16 is placed on the friction contact members 13a and 13b of the oscillator while a pressing force is applied to the friction contact members 13a and 13b. The spring 18 is compressed by rotating the spring retaining ring 19, thereby properly applying a pressing force between the rotor 16 and the friction contact members 13a and 13b of the piezoelectric element 11. The spring 18 comes into contact only with the inside of the bearing 17.

Although not illustrated, a screw is formed in part of the shaft 15, and the shaft 15 is screwed in the spring retaining ring 19 in which a screw is also formed.

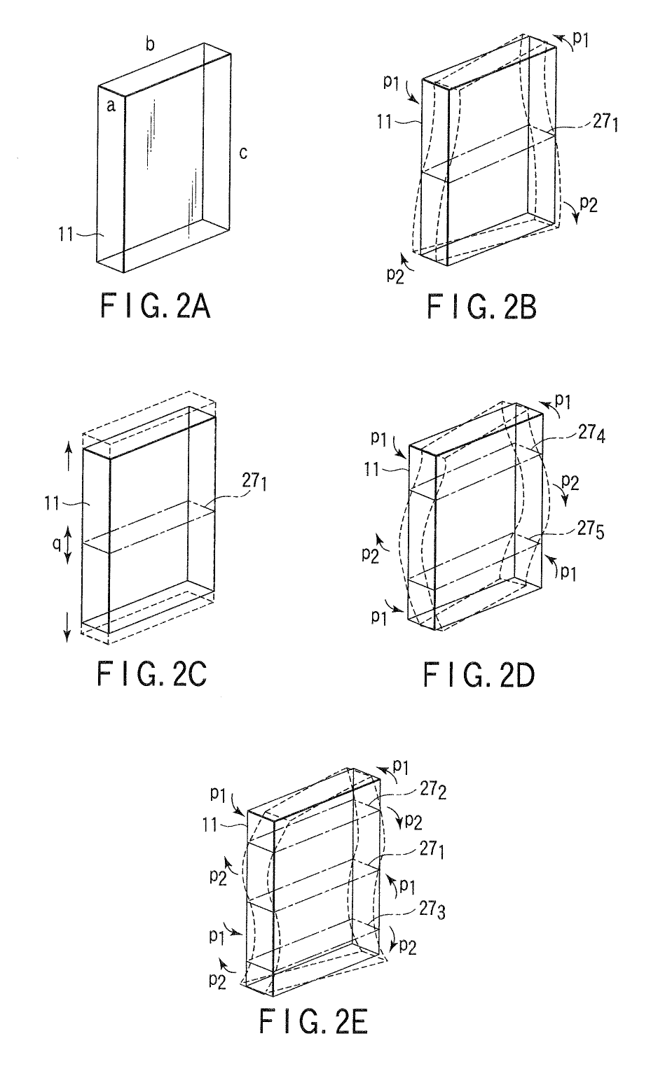

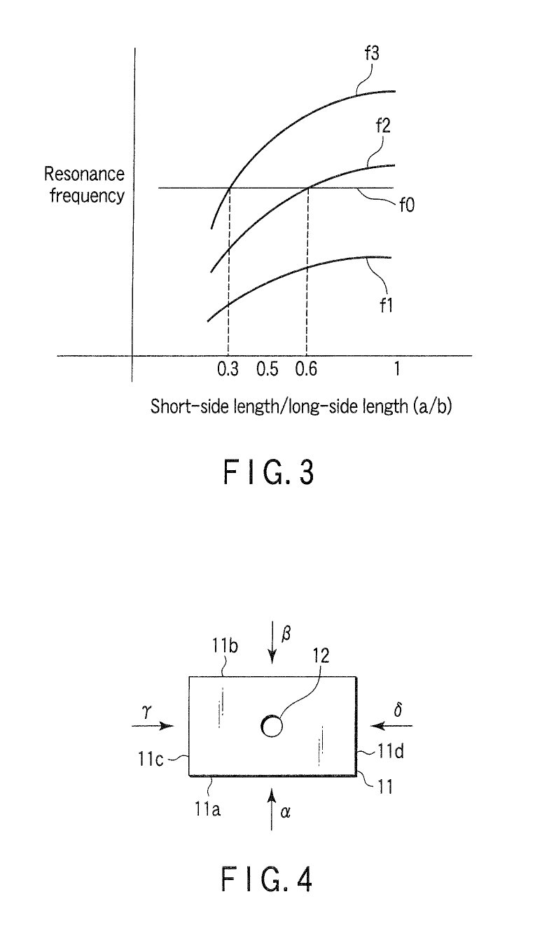

The match of an eigenfrequency of the piezoelectric element 11 used in the ultrasonic motor 10 of the first embodiment will be described with reference to FIGS. 2A to 2E and 3.

Referring to FIG. 2A, the piezoelectric element 11 is formed into the rectangular slid, and sizes of sides a, b, and c are set to proper values, whereby a resonance frequency in a first longitudinal oscillation mode is matched with a resonance frequency in a second twisting oscillation mode or a third twisting oscillation mode.

FIG. 2B schematically illustrates a transformation of a body of the piezoelectric element 11 as the vibrator in an oscillation state of a first twisting oscillation mode, FIG. 2C schematically illustrates an oscillation state of a first longitudinal oscillation mode, FIG. 2D schematically illustrates an oscillation state of a second twisting oscillation mode, and FIG. 2E schematically illustrates an oscillation state of a third twisting oscillation mode. In FIGS. 2B to 2E, the numerals p1 and p2 designate a direction of the twisting oscillation, and the numeral q designates a direction of the longitudinal oscillation. A solid line indicates the shape of the piezoelectric element 11 before the oscillation, and a broken line indicates the shape of the piezoelectric element 11 after the oscillation. In FIGS. 2B to 2E, the numerals 27₁, 27₂, 27₃, 27₄, and 27₅ designate a position corresponding to a node of the oscillation of the piezoelectric element (oscillator) 11, and the numerals 27₄ and 27₅ designate an upper node position of the second twisting oscillation and a lower node position of the second twisting oscillation.

It is defined that a, b, and c are sides of the rectangular solid. It is assumed that a direction of the side c is an oscillation direction in the first longitudinal oscillation mode and a twist axial direction of the twisting oscillation. It is assumed that directions of the sides a and b are orthogonal to the side c. It is assumed that a<b<c is a length ratio of rectangular each section perpendicular to an axis line parallel to the side c. The side a is referred to as short side, and the side b is referred to as long side.

FIG. 3 illustrates a resonance frequency of each mode when a horizontal axis is set to various rectangular ratio of short side length/long side length (a/b) while the side c is kept constant. As can be seen from FIG. 3, when the value a/b is changed, a resonance frequency f0 in the first longitudinal oscillation mode is independent of the value a/b, and the value a/b is substantially kept constant. However, the resonance frequency of the twisting oscillation is monotonously increased as the value reaches 1. A resonance frequency f1 in the first twisting oscillation mode is not matched with the resonance frequency f0 in the first longitudinal oscillation mode even if the value a/b is changed.

On the other hand, it is clear that a resonance frequency f2 in the second twisting oscillation mode is matched with the resonance frequency f0 in the first longitudinal oscillation mode when the value a/b is close to 0.6. It is also clear that a resonance frequency f3 in the third twisting oscillation mode is matched with the resonance frequency f0 in the first longitudinal oscillation mode when the value a/b is close to 0.3. Accordingly, in the first embodiment, dimensions of the piezoelectric element 11 are set such that the value a/b ranges from 0.5 to 0.7, more preferably the value a/b becomes about 0.6. Herein, the value c which is length the oscillator along the central axis, can be optional so that obtains a desired power or size according with a device to be applied.

The interdigital electrode provided in the side surface of the piezoelectric element 11 that is the oscillator of the ultrasonic motor 10 will be described in detail with reference to FIGS. 4 to 6.

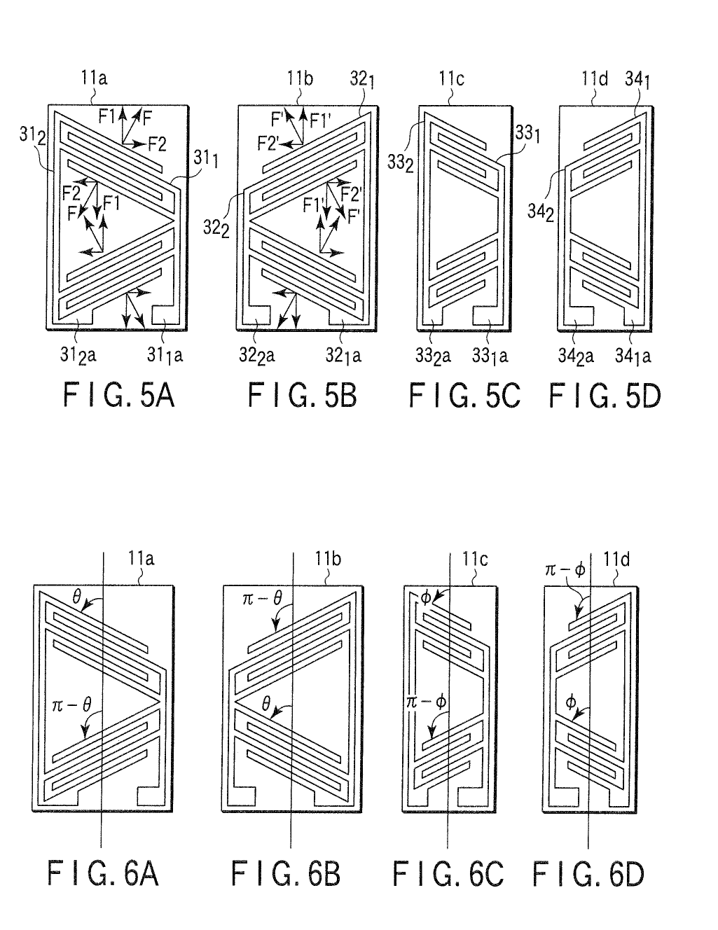

The interdigital electrodes are provided in the four side surfaces parallel to the side c of the rectangular-solid piezoelectric element 11. FIG. 4 is a plan view illustrating the piezoelectric element 11 as viewed from above, FIGS. 5A to 5D and FIGS. 6A to 6D illustrate the piezoelectric element 11 of FIG. 4 as viewed from an α direction, a β direction, a γ direction, and a δ direction.

Driving interdigital electrodes 31₁ and 31₂ are provided in a surface 11a in the α direction, driving interdigital electrodes 32₁ and 32₂ are provided in a surface 11b in the β direction, oscillation detecting interdigital electrodes 33₁ and 33₂ are provided in a surface 11c in the γ direction, and oscillation detecting interdigital electrodes 34₁ and 34₂ are provided in a surface 11d in the δ direction.

As illustrated in FIG. 5A, the interdigital electrodes 31₁ and 31₂ are provided at two points in the surface 11a, and are electrically connected in parallel. As illustrated in FIG. 2D, the interdigital electrodes are located near nodes 27₄ and 27₅ of the second twisting oscillation. It is defined that a gradient of the interdigital electrode is a direction in which the interdigital electrodes intersect each other. As illustrated in FIG. 6A, the interdigital electrode has the gradient of an angle θ (0<θ<π/2), and the lower interdigital electrode has the gradient of an angle π−θ. This is because, in the neighborhood of the lower node, the twist is generated in the opposite direction to the direction of the twist in the neighborhood of the upper node.

The interdigital electrode is produced such that a silver electrode having a thickness of several micrometers is printed and burned in the surface of the piezoelectric element 11. Then polarization processing is performed by applying a high voltage to piezoelectrically activate the piezoelectric element 11. Electrode lead-out portions 31₁a and 31₂a are provided below the interdigital electrodes 31₁ and 31₂. The electrode lead-out portions 31₁a and 31₂a are used as electrode lead-out portions for an A-positive phase and an A-negative phase, respectively.

In the examples of FIGS. 5A to 5D and 6A to 6D, two pairs of interdigital electrodes are provided in one surface. Alternatively, the number of pairs may appropriately be increased by narrowing a width of the interdigital electrode as illustrated in FIG. 1E.

Referring to FIG. 5B, similarly interdigital electrodes 32₁ and 32₂ and electrode lead-out portions 32₁a and 32₂a for a B-positive phase and a B-negative phase are provided at similar positions in the surface 11b located opposite the surface 11a. Referring to FIG. 6B, for the same reason described above, the upper interdigital electrode is formed so as to have the gradient of π−θ, and the lower interdigital electrode is formed so as to have the gradient of θ.

Configurations of oscillation detecting interdigital electrodes provided in other two side surfaces will be described.

Referring to FIG. 5C, interdigital electrodes 33₁ and 33₂ are provided at two points, and are electrically connected in parallel. Electrode lead-out portions 33₁a and 33₂a are provided below the interdigital electrodes 33₁ and 33₂ for a C-positive phase and a C-negative phase, respectively. As illustrated in FIG. 2D, the interdigital electrode 33₁ and 33₂ are located in the neighborhood of nodes 27₄ and 27₅ of the second twisting oscillation.

Referring to FIG. 6C, the upper interdigital electrode has a gradient of an angle φ (0<φ<π/2), and the lower interdigital electrode has a gradient of an angle π−φ. That is, as can be seen from FIG. 2D, in the neighborhood of the lower node, the twist is generated in the opposite direction to the direction of the twist in the neighborhood of the upper node.

Referring to FIG. 5D, for the same reason described above, interdigital electrodes 34₁ and 34₂ and electrode lead-out portions 34₁a and 34₂a for a D-positive phase and a D-negative phase are provided in the surface 11d located opposite the surface 11c. In such cases, the upper interdigital electrode is formed so as to have the gradient of π−φ, and the lower interdigital electrode is formed so as to have the gradient of φ.

An operation of the piezoelectric element 11 will be described.

First the operation of the piezoelectric element in which the driving interdigital electrode is used will be described.

As illustrated in FIG. 5A, it is assumed that an alternate voltage corresponding to the resonance frequency of the first longitudinal oscillation or second twisting oscillation is applied to the electrode lead-out portions 31₁a and 31₂a for the A phase (A-positive phase and A-negative phase). FIG. 5A illustrates a force, which is generated in the upper interdigital electrode at that time by an inverse piezoelectric effect, in terms of vector. The force F of FIG. 5A is an alternate force, and forces F1 and F2 are obtained by vector decomposition of the force F. As is clear from FIG. 5A, the force F1 can excite the longitudinal oscillation. As is clear from FIG. 5A, the force F2 can generate the second twisting oscillation.

Then it is also assumed that the alternate voltage having the same frequency is applied to the electrode lead-out portions 32₁a and 32₂a for a B phase (B-positive phase and B-negative phase) of FIG. 5B. FIG. 5B illustrates a force generated in the upper interdigital electrode at that time in terms of vector. The force F′ of FIG. 5B is an alternate force, and forces F1′ and F2′ are obtained by vector decomposition of the force F1′. As is clear from FIG. 5B, the force F1′ can excite the longitudinal oscillation. As is clear from FIG. 5B, the force F2′ can generate the second twisting oscillation.

Then it is also assumed that the alternate voltages having the in-phase frequencies are simultaneously applied to the A phase and the B phase. Assuming that only the forces are generated in the upper portions of the surface 11a and surface 11b by the interdigital electrodes, as can be seen from FIGS. 5A to 5D and 6A to 6D, the force F2 and force F2′ cancel each other, the second twisting oscillation is not generated, and only the first longitudinal oscillation is generated.

Then it is also assumed that the alternate voltages having the antiphase frequencies (phase difference of π) are simultaneously applied to the A phase and the B phase. Similarly, assuming that only the forces are generated in the upper portions of the surface 11a and surface 11b by the interdigital electrodes, as can be seen from FIGS. 5A and 5B, the force F1 and force F1′ cancel each other, the first longitudinal oscillation is not generated, and only the second twisting oscillation is generated.

Then it is also assumed that the alternate voltages having the frequencies (phase difference between 0 and π) are simultaneously applied to the A phase and the B phase. In such cases, the first longitudinal oscillation and the second twisting oscillation are simultaneously generated to form the combined oscillation. As illustrated in FIG. 1C, the clockwise (CW direction) or counterclockwise (CCW direction) elliptic oscillation is formed at the position in which the friction contact members 13a and 13b of the oscillator are bonded such that the rotor 16 is rotated.

Because the same holds true for the remaining pair of driving interdigital electrodes (the lower interdigital electrode of the surface 11a and the lower interdigital electrode of the surface 11b), the description is omitted. When the elliptic oscillation is generated at the position of the friction contact member of the oscillator, the pressed rotor is rotated clockwise (CW direction) or counterclockwise (CCW direction) according to the direction of the rotation of the elliptic oscillation.

An operation of the oscillation detecting interdigital electrode will be described.

Interdigital electrodes 33₁, 33₂, 34₁, and 34₂ similar to those of the surfaces 11a and 11b are provided in the surface 11c in the γ direction of FIG. 4 and the surface 11d in the δ direction.

When the first longitudinal oscillation or second twisting oscillation is generated, a charge is generated in the interdigital electrode surface by a piezoelectric effect. The charge is observed as a voltage at the C phase (between C-positive phase and C-negative phase) or a voltage at the D phase (between D-positive phase and D-negative phase).

As described above, although the force is generated by the inverse piezoelectric effect in the operation of the driving interdigital electrode, the charge or voltage is generated by a mechanical strain in the operation of the lower oscillation detecting interdigital electrode. In cases where only the first longitudinal oscillation is generated, parallel forward connection is established between the C phase and D phase (the C-positive-phase electrode lead-out portion 33₁a and the D-positive-phase electrode lead-out portion 34₁a are connected, and the C-negative-phase electrode lead-out portion 33₂a and the D-negative-phase electrode lead-out portion 34₂a are connected: it is defined as parallel forward connection phase), and the voltage generated between the C phase and D phase is obtained as a signal that is in proportion to magnitude and phase of the first longitudinal oscillation.

On the other hand, in cases where parallel inverse connection is established between the C phase and the D phase (the C-positive-phase electrode lead-out portion 33₁a and the D-negative-phase electrode lead-out portion 34₂a are connected, and the C-negative-phase electrode lead-out portion 33₂a and the D-positive-phase electrode lead-out portion 34₁a are connected: it is defined as parallel inverse connection phase), the signal is not supplied. In cases where only the second twisting oscillation is generated, the parallel inverse connection is established between the C phase and the D phase, and the voltage generated between the C phase and D phase is obtained as the signal that is in proportion to the magnitude and phase of the second twisting oscillation. In cases where the parallel forward connection is established between the C phase and D phase, the signal is not supplied.

Therefore, the first longitudinal oscillation or the second twisting oscillation can independently be detected by selecting the connection between the C phase and D phase.

A method of driving a motor using the oscillation detecting phase (C phase and D phase) will be described.

It is known that a phase difference between the signal phase of the A phase or B phase that is the driving phase and the oscillation detecting phase (for example, the parallel inverse connection between the C phase and the D phase) has a predetermined value Ω during a resonance frequency operation of the second twisting oscillation. Accordingly, when the frequency is adjusted to drive the motor such that the phase difference between the driving phase and the oscillation detecting phase always becomes the value Ω, the oscillator can always be driven near the second twisting resonance frequency even if temperature rise is generated by heat generation of the motor, or a change in resonance frequency is generated by a change in ambient temperature or a change in load, that is, the motor can efficiently be driven at an optimum frequency. The motor can be driven in a similar way near a first longitudinal resonance frequency.

In the first embodiment, the oscillator includes single piezoelectric element, and the motor has the simple shape of the rectangular solid. In the conventional longitudinal twisting motor, the groove portion is required to adjust the frequency of the twisting oscillation. On the contrary, the groove portion is eliminated in the first embodiment. Further, since the oscillation detecting electrode is provided, the motor can efficiently be driven at the optimum frequency.

(First Modification of First Embodiment)

An ultrasonic motor according to a first modification of the first embodiment will be described below.

In the following embodiments and modifications, in order to avoid repetition of the description, the same component as the first embodiment is designated by the same reference numeral, and the illustration and description are omitted.

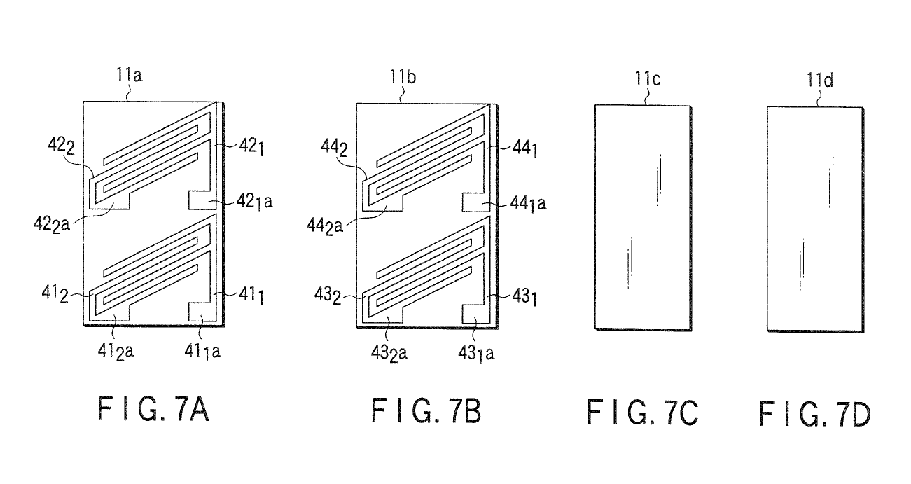

FIGS. 7A to 7D illustrate a piezoelectric element 11 according to the first modification of the first embodiment as viewed from the α direction, the β direction, the γ direction, and the δ direction.

In the first modification of the first embodiment, an A phase (A-positive-phase interdigital electrode 41₁a and A-negative-phase interdigital electrode 41₂a) for the driving phase and a B phase (B-positive-phase interdigital electrode 42₁a and B-negative-phase interdigital electrode 42₂a) for the driving phase are provided in the surface 11a, and a C phase (C-positive-phase interdigital electrode 43₁a and C-negative-phase interdigital electrode 43₂a) for the oscillation detecting phase and a D phase (D-positive-phase interdigital electrode 44₁a and D-negative-phase interdigital electrode 44₂a) for the oscillation detecting phase are provided in the surface 11b. At this point, the interdigital electrode is not provided in the surfaces 11c and 11d. Because the other configurations and operations are similar to those of the first embodiment, the description is omitted.

In the first modification of the first embodiment, because the electrode is not provided in the surfaces 11c and 11d, advantageously the configuration becomes simplified. Alternatively, the A phase for the driving phase and the C phase for the oscillation detecting phase may be provided in the surface 11a while the B phase for the driving phase and the D phase for the oscillation detecting phase are provided in the surface 11b.

(Second Modification of First Embodiment)

An ultrasonic motor according to a second modification of the first embodiment will be described below.

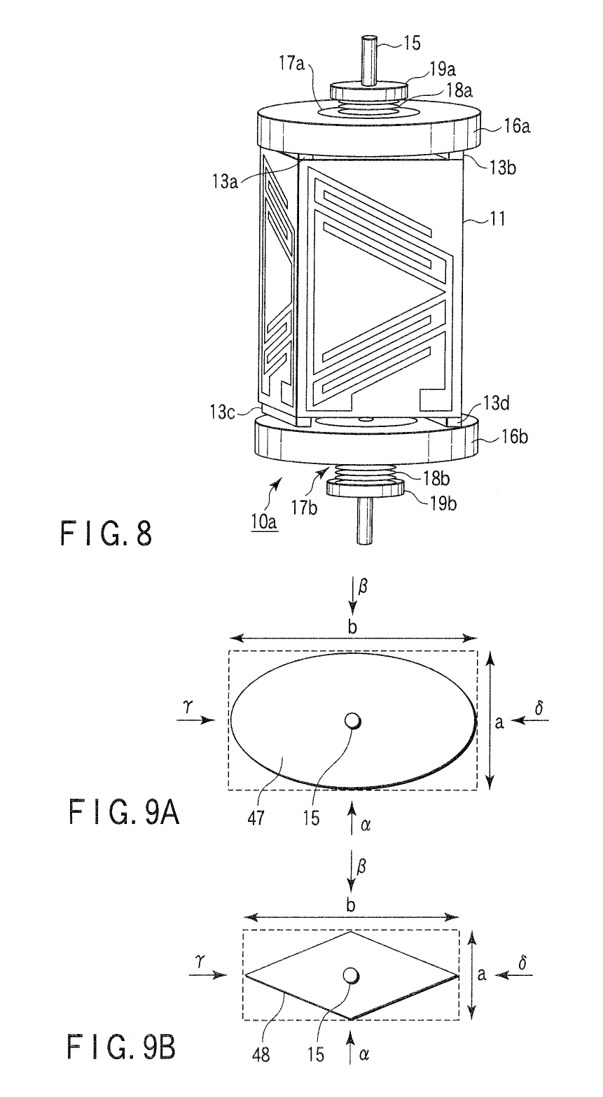

FIG. 8 is an appearance perspective view illustrating the ultrasonic motor of the second modification of the first embodiment.

In the second modification of the first embodiment, a rotor is further provided on a bottom surface side in the ultrasonic motor of the first embodiment. Because the configurations and driving methods of the friction contact members 13a, 13b, 13c, and 13d, first and second rotors 16a and 16b, bearings 17a and 17b, springs 18a and 18b, and spring retaining rings 19a and 19b are similar to those of the first embodiment, the description thereof is omitted.

In the second modification of the first embodiment, advantageously the rotation of the rotor is taken out from two points.

In the second modification of the first embodiment, in cases where sectional areas of the piezoelectric element orthogonal to the axis of the shaft are not identical to each other, for example, in cases where a first rotor 16a differs from a second rotor 16b in the sectional areas of the piezoelectric element while the first rotor 16a is equal to the second rotor 16b in the value a/b of the rectangular-solid piezoelectric element, two different outputs can be taken out from the first rotor 16a and the second rotor 16b.

(Third Modification of First Embodiment)

An ultrasonic motor according to a third modification of the first embodiment will be described below.

In the first embodiment, the piezoelectric element (oscillator) is formed into the rectangular-solid shape. However, the piezoelectric element is not limited to the rectangular solid. For example, as illustrated in FIGS. 9A and 9B, the effect of the first embodiment is also obtained in an oscillator in which a section perpendicular to a central axis has a rectangular length ratio.

FIGS. 9A and 9B illustrate an ultrasonic motor of the third modification of the first embodiment, wherein FIG. 9A illustrates an example in which a piezoelectric element 47 has an elliptic section orthogonal to a shaft, and FIG. 9B illustrates an example in which a piezoelectric element 48 has a rhombic section orthogonal to the shaft. In FIGS. 9A and 9B, a virtual rectangle tangent to an outer diameter of the rhombic section is indicated by an broken line, and dimensions of the virtual rectangle are expressed by the letters a and b.

The first longitudinal oscillation resonance frequency is substantially matched with the second twisting oscillation resonance frequency by appropriately adjusting the dimensions a and b, so that the ultrasonic motor can be driven by the configuration and driving method similar to those of the first embodiment.

In the first embodiment, the oscillator has the structure of the single piezoelectric element. Alternatively, a laminated piezoelectric element may be formed by alternately laminating a first layer in which one of the interdigital electrodes is formed and a second layer in which the other interdigital electrode is formed. Therefore, the ultrasonic motor is operated by the similar driving principle. The elastic body and the piezoelectric element may be bonded, or the elastic body and the laminated piezoelectric element may be bonded. Therefore, the ultrasonic motor is operated when the interdigital electrode is formed similar to that of the first embodiment.

### Second Embodiment

An ultrasonic motor according to a second embodiment of the invention will be described below.

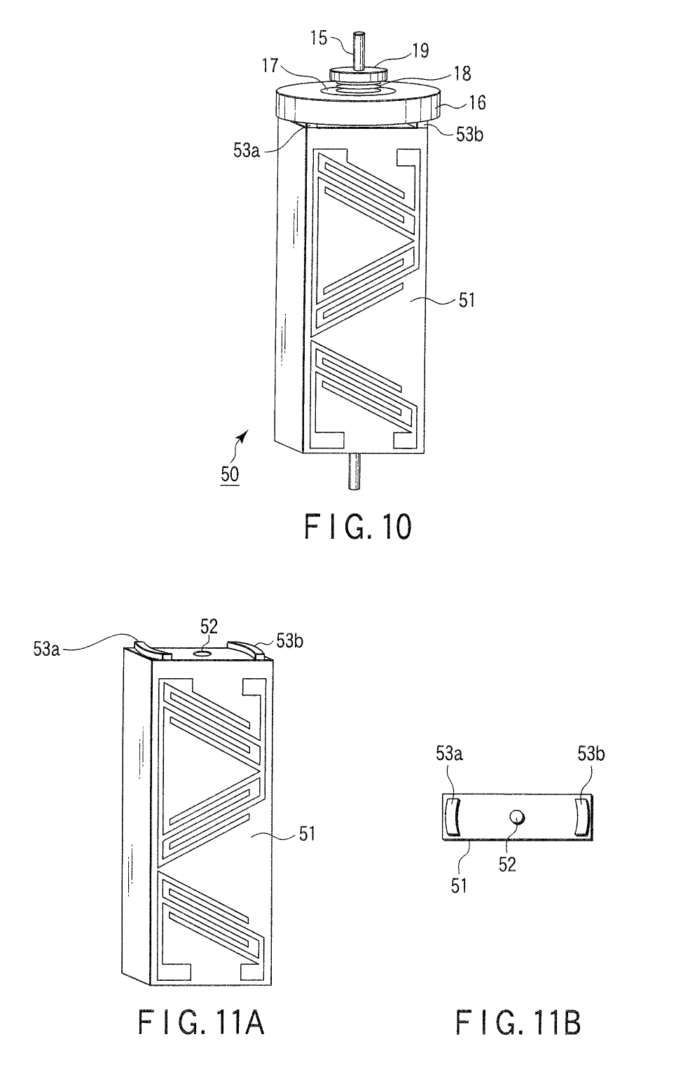

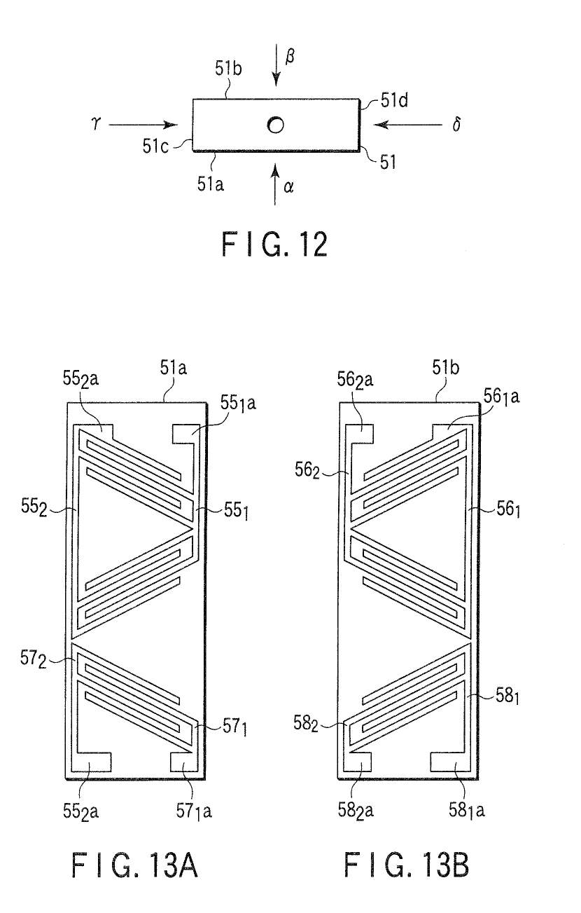

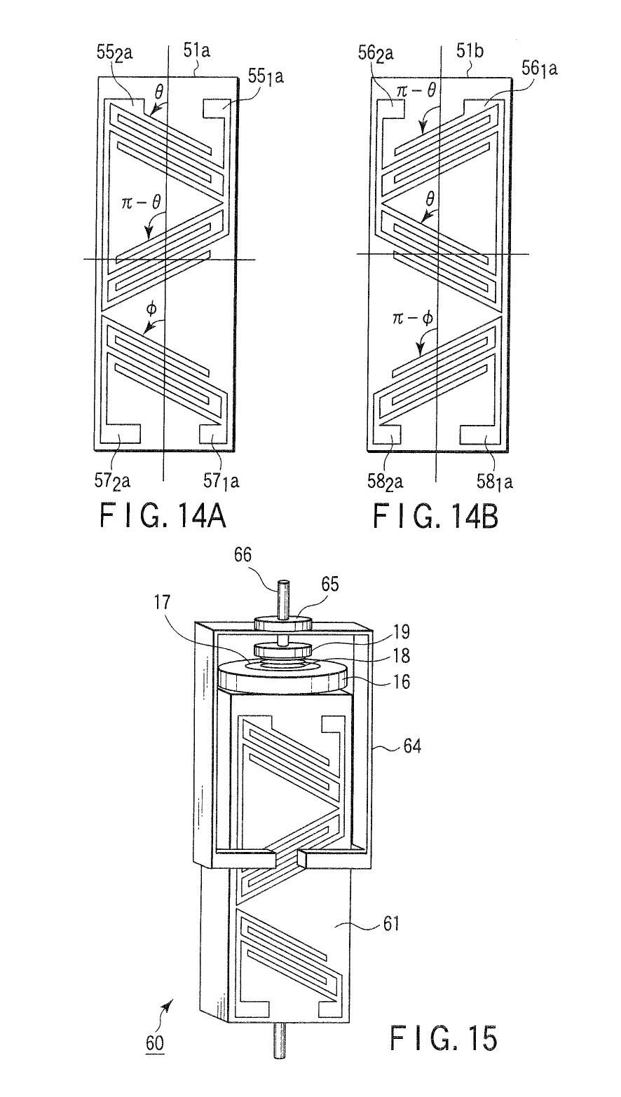

FIG. 10 is an appearance perspective view illustrating the ultrasonic motor of the second embodiment. FIGS. 11A and 11B illustrate an oscillator to which a friction contact member is bonded, wherein FIG. 11A is an appearance perspective view of the oscillator, and FIG. 11B is a plan view of the oscillator. FIG. 12 is a plan view illustrating a piezoelectric element 51 as viewed from above, and FIGS. 13A, 13B, 14A, and 14B illustrate the ultrasonic motor 51 of FIG. 11 as viewed from the α direction and the β direction.

An ultrasonic motor 50 of the second embodiment is formed into a rectangular-solid shape like the first embodiment, and the value a/b of the ultrasonic motor 50 ranges from 0.2 to 0.4, more preferably the value a/b becomes about 0.3. When the value a/b of the ultrasonic motor 50 ranges from 0.2 to 0.4, the resonance frequency f0 of the first longitudinal oscillation is substantially matched with the resonance frequency f3 of the third twisting oscillation as illustrated in FIG. 3.

The ultrasonic motor 50 includes a piezoelectric element 51, friction contact members 53a and 53b, the shaft 15, the rotor 16, the bearing 17, the spring 18, and the spring retaining ring 19. The oscillator includes the single piezoelectric element 51, and a throughhole 52 is made in the piezoelectric element 51. The friction contact members 53a and 53b made of a PPS material are formed in an arc shape having the same curvature as the rotor 16, and are located inside of an outer circumference of the rotor 16.

In the second embodiment, the interdigital electrodes are provided in surfaces 51a and 51b of the piezoelectric element 51. The surface 51a is located in the α direction of FIG. 12, and the surface 51b is located in the β direction. The interdigital electrode is not provided in surfaces 51c and 51d. The surface 51c is located in the γ direction of FIG. 12, and the surface 51d is located in the δ direction.

The interdigital electrode in the surface 51a will be described with reference to FIG. 13A.

Referring to FIG. 2E, the third twisting oscillation has the center, upper, and lower nodes (27₁, 27₂, and 27₃). The central node 27₁ is matched with a geometric center of the piezoelectric element 51. Referring to FIG. 2C, the node 27₁ of the first longitudinal oscillation is located in the center. Therefore, the node position of the first longitudinal oscillation is geometrically matched with the central node position of the third twisting oscillation.

The upper interdigital electrode in the surface 51a and the central interdigital electrode (interdigital electrodes 55₁, and 55₂) are electrically connected in parallel, and act as the A phase (A-positive phase and A-negative phase) for the driving phase. The lower interdigital electrode (interdigital electrodes 57₁, and 57₂) acts as the C phase (C-positive phase and C-negative phase) for the oscillation detecting phase.

As illustrated in FIG. 14A, assuming that θ (0<φ<π/2) is the angle of the upper interdigital electrode, the angle of the central interdigital electrode is set to π−θ, and the angle of the lower interdigital electrode is set to φ (0<φ<π/2). The value of φ may be identical to or different from the value of θ.

The interdigital electrode in the surface 51b will be described with reference to FIG. 13B.

Similarly the upper, central, and lower interdigital electrodes are provided. The upper and central interdigital electrodes are electrically connected in parallel, and the upper and central interdigital electrodes act as the B phase (B-positive phase and B-negative phase) for the driving phase. The lower interdigital electrode acts as the D phase (D-positive phase and D-negative phase) for the oscillation detecting phase.

As illustrated in FIG. 14B, the angle of the upper interdigital electrode is set to π−θ, the angle of the central interdigital electrode is set to θ, and the angle of the lower interdigital electrode is set to (π−φ).

In FIGS. 13 and 14, the numerals 55₁a, 55₂a, 56₁a, and 56₂a designate electrode lead-out portions of the A-positive phase, A-negative phase, B-positive phase, and B-negative phase, and the numerals 57₁a, 57₂a, 58₁a, and 58₂a designate electrode lead-out portions of the C-positive phase, C-negative phase, D-positive phase, and D-negative phase.

FIG. 10 illustrates the motor in which the oscillator of the second embodiment is used. Because the configuration of the ultrasonic motor 50 is similar to that of the first embodiment, the description is omitted.

The operation of the ultrasonic motor of the second embodiment will be described.

Because the oscillator, the method of driving the motor in the driving phase, and the method of detecting the oscillation in the oscillation detecting phase to drive the motor at the optimum driving frequency are similar to those of the first embodiment, the description is omitted.

In the second embodiment, the oscillator can be thinned in addition to the effect similar to that of the first embodiment.

Modifications similar to the first to third modifications of the first embodiment can be made in the second embodiment.

The oscillation detecting interdigital electrode is not provided in the same surface as the driving interdigital electrode, but may be provided in the surfaces sic and 51d.

### Third Embodiment

An ultrasonic motor according to a third embodiment of the invention will be described below.

In the first and second embodiments, the throughhole is made in the piezoelectric element, and the shaft is inserted in the throughhole. In the third embodiment, the throughhole is not made in the piezoelectric element.

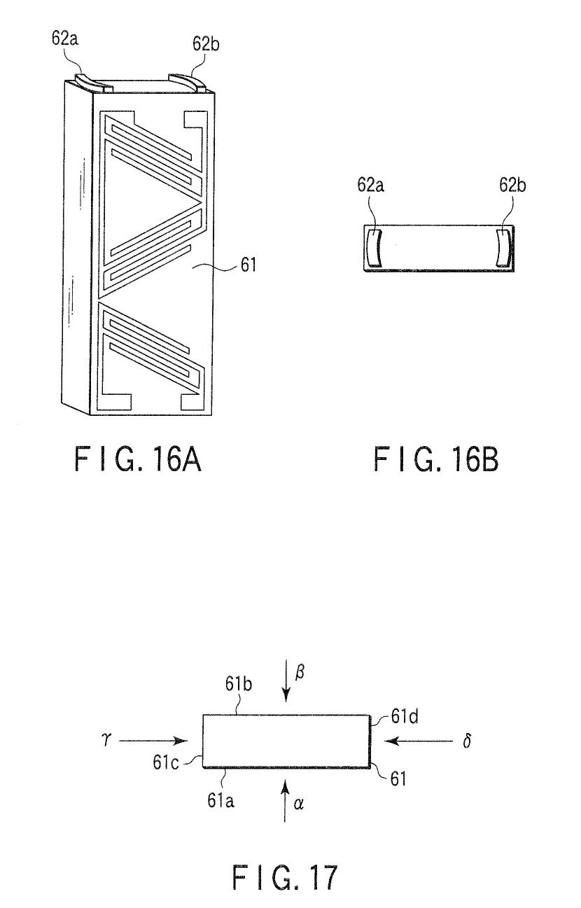

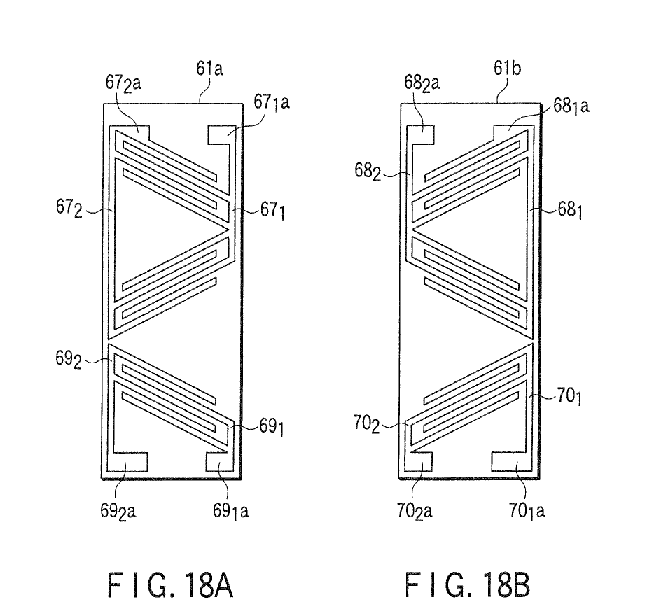

FIG. 15 is an appearance perspective view illustrating the ultrasonic motor of the third embodiment. FIGS. 16A and 16B illustrate an oscillator to which a friction contact member is bonded, FIG. 16A is an appearance perspective view of the oscillator, and FIG. 16B is a plan view of the oscillator. FIG. 17 is a plan view illustrating a piezoelectric element 61 as viewed from above, and FIGS. 18A and 18B illustrate the piezoelectric element 61 of FIG. 17 as viewed from the α direction and the β direction.

In an ultrasonic motor 60 of the third embodiment, the piezoelectric element 61 is formed into a rectangular-solid shape like the second embodiment, and the value a/b of the piezoelectric element 61 ranges from 0.2 to 0.4, more preferably the value a/b becomes about 0.3. When the value a/b of the piezoelectric element 61 ranges from 0.2 to 0.4, the resonance frequency f0 of the first longitudinal oscillation is substantially matched with the resonance frequency f3 of the third twisting oscillation as illustrated in FIG. 3.

The ultrasonic motor 60 includes a piezoelectric element 61, friction contact members 62a and 62b, the rotor 16, the bearing 17, the spring 18, the spring retaining ring 19, an oscillator holder 64, a shaft fixing ring 65, and a shaft 66. The oscillator includes the single piezoelectric element 61.

The oscillator holder 64 is bonded to a substantially central portion of the piezoelectric element (oscillator) 61. The central portion is geometrically substantially matched with a node portion of the first longitudinal oscillation of the piezoelectric element 61 and a central node portion of the third twisting oscillation. The oscillator holder 64 is made of an aluminum material to which an alumite treatment is performed or a metallic material to which insulating treatment is performed. The oscillator holder 64 is integral with the oscillator. A lower portion of the oscillator holder 64 is formed into a U-shape so as to sandwich the piezoelectric element 61 from the side surface side of the piezoelectric element 61. An upper surface of the oscillator holder 64 is formed into a flat-plate shape while a throughhole is made therein. The shaft 66 partially having a screw thread is inserted in the throughhole.

The shaft 66 is fixed to the upper surface of the oscillator holder 64 by the shaft fixing ring 65. As described above, the shaft 66 is inserted in the bearing 17, the spring retaining ring 19, and the shaft fixing ring 65. The rotor 16 is rotatably fixed to the outer circumference of the bearing 17. The spring 18 is inserted between the spring retaining ring 19 and the bearing 17, and the spring retaining ring 19 is rotated and adjusted such that the pressing force is properly applied between the rotor 16 and the piezoelectric element 61. After the adjustment, the spring retaining ring 19 is fixed to the shaft 66 using a bonding agent.

Interdigital electrodes 671, 672, 691, and 692 and electrode lead-out portions 67₁a, 67₂a, 69₁a, and 69₂a for the A-positive phase, A-negative phase, C-positive phase, and C-negative phase are provided in a surface 61a of the piezoelectric element 61. Interdigital electrodes 681, 682, 701, and 702 and electrode lead-out portions 68₁a, 68₂a, 70₁a, and 70₂a for the B-positive phase, B-negative phase, D-positive phase, and D-negative phase are provided in a surface 61b.

The operation of the ultrasonic motor 60 of the third embodiment will be described.

In the third embodiment, because the oscillator, the method of driving the motor in the driving phase, and the method of detecting the oscillation in the oscillation detecting phase to drive the motor at the optimum driving frequency are similar to those of the first and second embodiments, the description is omitted.

In the third embodiment, in addition to the effect similar to that of the second embodiment, the following effect is further obtained. The node portion of the first longitudinal oscillation is geometrically substantially matched with the central node portion of the third twisting oscillation. Therefore, even if the oscillator is held near the common node portion by the oscillator holder 64, the oscillation of the oscillator is hardly prevented, and the oscillation of the oscillator is hardly transmitted to the oscillator holder 64.

Accordingly, the shaft, the rotor, or the spring can be provided utilizing the upper surface of the oscillator holder 64, and the process for making the throughhole in the center of the longitudinal direction of the piezoelectric element or the process for fixing the shaft in the throughhole is eliminated, so that the process is simplified.

Modifications similar to the modifications of the first embodiment can be made in the third embodiment.

In the third embodiment, the piezoelectric element 61 is sandwiched by the oscillator holder 64 in the position where the node portion of the first longitudinal oscillation is geometrically substantially matched with the central node portion of the third twisting oscillation. Although some losses are generated, the value a/b of the rectangular-solid piezoelectric element is set to the range of 0.5 to 0.7, more preferably to about 0.6, and the oscillator of the first embodiment is used, the piezoelectric element is sandwiched by the oscillator holder 64 in the node portion position of the second twisting oscillation or the node portion position of the first longitudinal oscillation of the piezoelectric element 11 of the first embodiment.

In the third embodiment, the electrode provided in the side surface of the piezoelectric element is used as the interdigital electrode. However, the invention is not limited to the third embodiment.

### Fourth Embodiment

An ultrasonic motor according to a fourth embodiment of the invention will be described below.

The ultrasonic motor of the fourth embodiment will be described with reference to FIGS. 19, 20A, 20B, 21A to 21I, 22, 23, 2A to 2E, and 3.

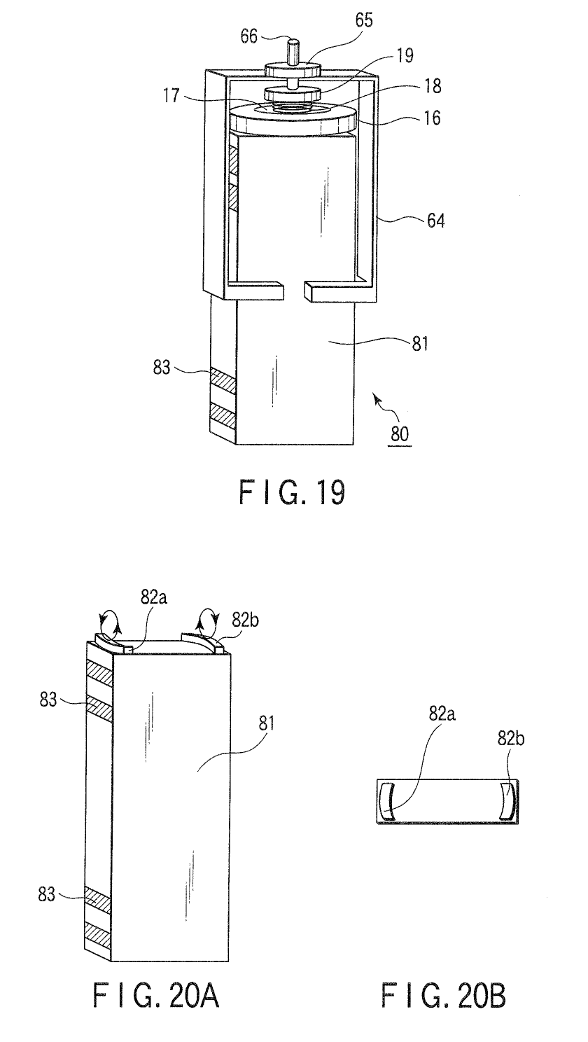

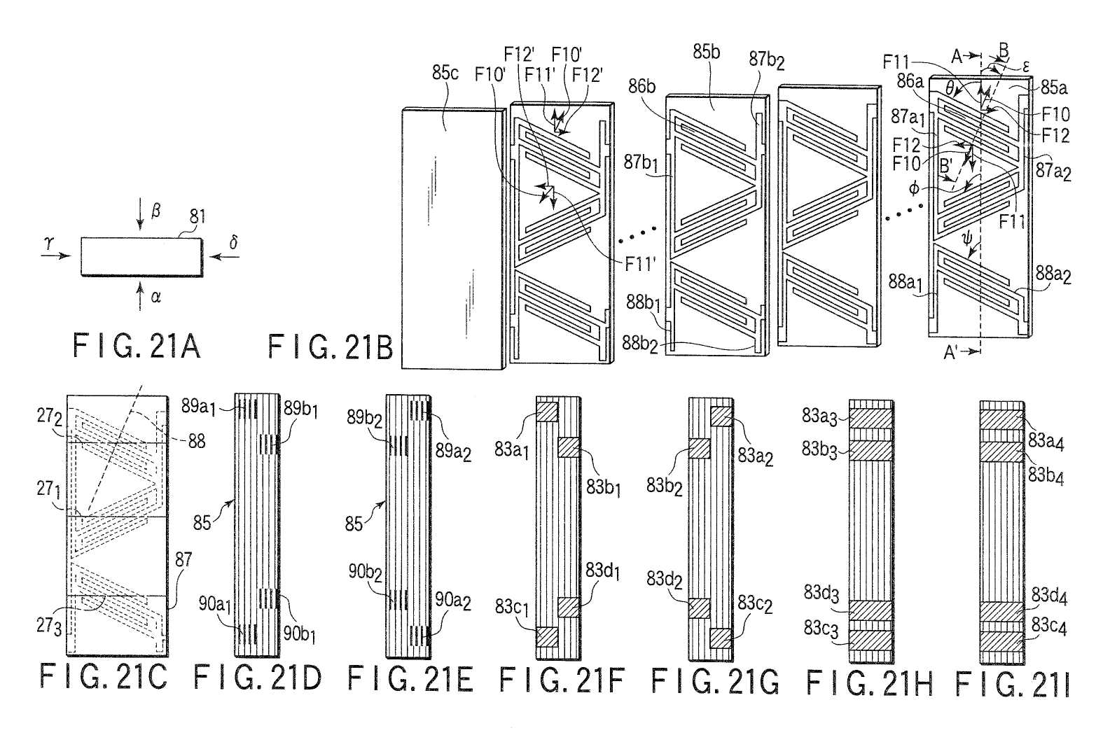

FIG. 19 is an appearance perspective view illustrating the ultrasonic motor of the fourth embodiment. FIGS. 20A and 20B illustrates a laminated piezoelectric element to which a friction contact member is bonded, wherein FIG. 20A is an appearance perspective view of the laminated piezoelectric element, and FIG. 20B is a plan view of the laminated piezoelectric element. FIGS. 21A to 21I illustrate a configuration of a laminated piezoelectric element 81, wherein FIG. 21A is a plan view of the laminated piezoelectric element as viewed from above, FIG. 21B is an exploded perspective view of the laminated piezoelectric element 81, FIG. 21C is a perspective view of the laminated piezoelectric element 81 as viewed from the α direction of FIG. 21A, FIG. 21D illustrates the laminated piezoelectric element 81 as viewed from the 7 direction of FIG. 21A, FIG. 21E illustrates the laminated piezoelectric element 81 as viewed from the δ direction of FIG. 21A, FIG. 21F illustrates a state in which an external electrode is attached to the laminated piezoelectric element 81 of FIG. 21D, FIG. 21G illustrates a state in which the external electrode is attached to the laminated piezoelectric element 81 of FIG. 21E, FIG. 21H illustrates another example in which the external electrode is attached to the laminated piezoelectric element 81 of FIG. 21D, and FIG. 21I illustrates another example in which an external electrode is attached to the laminated piezoelectric element 81 of FIG. 21E.

An ultrasonic motor 80 includes a laminated piezoelectric element (oscillator) 81, friction contact members 82a and 82b, an external electrode 83, the rotor 16, the bearing 17, the spring 18, the spring retaining ring 19, the oscillator holder 64, the shaft fixing ring 65, and the shaft 66.

In the following embodiments including the fourth embodiment, the oscillator is formed by laminating the plural piezoelectric elements.

The friction contact members 82a and 82b are bonded to the surface orthogonal to the longitudinal direction of the laminated piezoelectric element 81, and are in contact with the rotor 16. However, it is not always necessary to provide the friction contact members 82a and 82b. The external electrodes 83 are provided at four points in the left side surface of FIGS. 19 and 20A, and are also provided at four points in the right side surface (not illustrated).

The rotor 16 is rotated while pressed against a top surface of the laminated piezoelectric element 81 having the prismatic shape. The bearing 17 includes a bearing inner ring to which the shaft 66 is fixed and a bearing outer ring fixed to an inner circumference of the rotor 16. The spring 18 is an elastic member that applies the pressing force to the bearing inner ring. The spring retaining ring 19 is used to control a contracting amount of the spring 18.

The oscillator holder 64 is fixed to a substantially central portion of the laminated piezoelectric element 81 to hold the shaft 66. The central portion is geometrically substantially matched with the node portion of the first longitudinal oscillation of the laminated piezoelectric element 81 and the central node portion of the third twisting oscillation.

A configuration of an internal electrode of the laminated piezoelectric element 81 in the ultrasonic motor 80 of the fourth embodiment will be described.

The laminated piezoelectric element 81 is formed by laminating the thin piezoelectric sheets made of PZT. A predetermined internal electrode pattern is formed in the piezoelectric sheet.

FIG. 21A illustrates the laminated piezoelectric element 81 as viewed from above, and the four side surfaces are designated by arrows α, β, γ, and δ. FIG. 21B illustrates examples of the piezoelectric sheet and internal electrode pattern.

The piezoelectric sheet is made of the PZT material having the thickness of about 10 μm to about 100 μm. An internal electrode pattern 1 (hereinafter referred to as internal electrode pattern (1)) 86a is printed in a piezoelectric sheet 1 (hereinafter referred to as piezoelectric sheet (1)) 85a. An internal electrode pattern 2 (hereinafter referred to as internal electrode pattern (2)) 86b is printed in a piezoelectric sheet 2 (hereinafter referred to as piezoelectric sheet (2)) 85b. As illustrated in FIG. 21, the interdigital internal electrodes are printed as the internal electrode pattern (1)86a at three points in the piezoelectric sheet (1)85a.

The interdigital internal electrode is made of, for example, a silver-palladium alloy. A width of the interdigital internal electrode is set in the range of about 0.1 mm to about 1 mm, and an insulating width between the interdigital internal electrodes is set in a range of about 0.1 mm to about 1 mm. For example, a thickness of the interdigital internal electrode ranges from 2 to 3 μm.

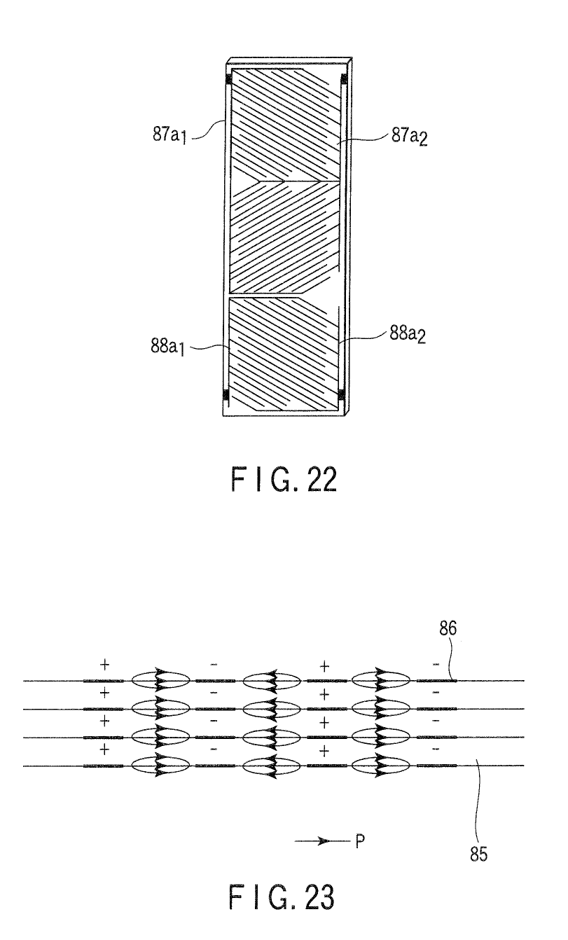

As described above, the interdigital electrode shall mean an electrode in which the positive-phase electrode and the negative-phase electrode are alternately disposed. For the sake of convenience, the two pairs of interdigital electrodes are illustrated in FIG. 21B. However, in order that the interdigital electrode occupies as large an area as possible in the side surface, actually the number of pairs of interdigital electrodes may be increased such that the interdigital electrode is formed over the side surface as illustrated in FIG. 22. In the following embodiments, because the interdigital electrode is provided in the laminated piezoelectric element, the interdigital electrode is also referred to as interdigital internal electrode.

Referring to FIG. 21B, an angle θ formed between the height direction (indicated by the broken line) of the interdigital electrode and the digital direction of the interdigital internal electrode is set to a range of 0<θ<π/2 in the upper interdigital electrode (first interdigital electrode). As indicated by the broken line of FIG. 21B, because a polarization direction ε is orthogonal to the digital direction of the interdigital electrode, the polarization direction ε is expressed as follows:

0<|ε|<π/2

An angle φ formed between the height direction of the interdigital electrode and the digital direction of the second interdigital internal electrode (second interdigital electrode) is set as follows:

π/2<φ<π

The second interdigital electrode and the first interdigital electrode are electrically connected in parallel, and the second interdigital electrode is partially extended to an end portion of the piezoelectric sheet. The first and second interdigital electrodes act as the driving interdigital electrode. The angles θ and φ may be set to the inverse ranges.

An angle ψ is formed between the height direction of the interdigital electrode and the digital direction of the third interdigital internal electrode (third interdigital electrode), and the angle Ψ is set to values except for 0, π/2, and π. In the fourth embodiment, the angle ψ is set as follows:

0<ψ<π/2

The third interdigital electrode acts as the oscillation detecting electrode.

The n piezoelectric sheets (1)85a in which the internal electrode patterns (2)86a are printed are laminated, and then the n piezoelectric sheets (2)85b in which the internal electrode patterns (2)86b are printed are similarly laminated. As illustrated in FIG. 21B, the piezoelectric sheet (2)85b differs from the piezoelectric sheet (1)85a in the position of the electrode extended to the end portion. The piezoelectric sheet (2)85b is identical to the piezoelectric sheet (1)85a in the configuration and position of the interdigital electrode. Finally a piezoelectric sheet 3 (hereinafter referred to as piezoelectric sheet (3)) 85c in which the electrode is not printed is laminated on the piezoelectric sheet (2)85b.

Therefore, the number of sheets becomes 2n+1, that is, the odd number in the whole of the laminated piezoelectric elements 81.

FIG. 21C is a front view illustrating the laminated piezoelectric element 81.

The third twisting oscillation and the first longitudinal oscillation are utilized in the fourth embodiment. The central portion of the upper interdigital electrode is provided near the upper node position 27₂ of the third twisting oscillation, the central portion of the central interdigital electrode is provided near the central node position of the third twisting oscillation and near the node position 27₁ of the first longitudinal oscillation, and the central portion of the lower interdigital electrode is provided near the lower node position 27₃ of the third twisting oscillation

FIGS. 21D and 21F illustrate the laminated piezoelectric element 81 as viewed from the γ direction of FIG. 21A. Referring to FIG. 21B, the upper interdigital electrode and a central interdigital electrode 87a₁ of the internal electrode pattern (1)86a are extended leftward to the end portion to form an internal electrode exposed portion 89a₁. The internal electrode exposed portion 89a₁ is connected to an external electrode A-positive phase 83a₁. Similarly the upper interdigital electrode and a central interdigital electrode 87b₁ of the internal electrode pattern (2)86b are extended leftward to the end portion to form an internal electrode exposed portion 89b₁. The internal electrode exposed portion 89b₁ is connected to an external electrode B-positive phase 83b₁.

A lower interdigital electrode 88a₁ of the internal electrode pattern (1)86a is extended leftward to the end portion to form an internal electrode exposed portion 90a₁. The internal electrode exposed portion 90a₁ is connected to an external electrode C-positive phase 83C₁. A lower interdigital electrode 88b₁ of the internal electrode pattern (2)86b is extended leftward to the end portion to form an internal electrode exposed portion 90b₁. The internal electrode exposed portion 90b₁ is connected to an external electrode D-positive phase 83d₁.

FIGS. 21E and 21G illustrate the laminated piezoelectric element 81 as viewed from the δ direction of FIG. 21A. Referring to FIG. 21B, the upper interdigital electrode and a central interdigital electrode 87a₂ of the internal electrode pattern (1)86a are extended rightward to the end portion to form an internal electrode exposed portion 89a₂. The internal electrode exposed portion 89a₂ is connected to an external electrode A-negative phase 83a₂. Similarly in FIG. 21B, the upper interdigital electrode and a central interdigital electrode 87b₂ of the internal electrode pattern (2)86b are extended rightward to the end portion to form an internal electrode exposed portion 89b₂. The internal electrode exposed portion 89b₂ is connected to an external electrode B-negative phase 83b₂.

A lower interdigital electrode 88a₂ of the internal electrode pattern (1)86a is extended rightward to the end portion to form an internal electrode exposed portion 90a₂. The internal electrode exposed portion 90a₂ is connected to an external electrode C-positive phase 83C₂. A lower interdigital electrode 88b₂ of the internal electrode pattern (2)86b is extended rightward to the end portion to form an internal electrode exposed portion 90b₂. The internal electrode exposed portion 90b₂ is connected to an external electrode D-positive phase 83d₂.

When the electrode pattern provides the equal oscillation characteristics in relation to the section cut by the virtual center line, the oscillation characteristics are not changed even if the external electrode is disposed in the different position as illustrated in FIGS. 21F and 21G, and thus the symmetrical property of the electrode pattern is actually maintained.

A method of producing the laminated piezoelectric element 81 will be described.

The plural piezoelectric sheets (1)85a in which the internal electrode patterns (1)86a are printed and the plural piezoelectric sheets (2)85b in which the internal electrode patterns (2)86b are printed are prepared before the burning. After the n piezoelectric sheets (1)85a are laminated, the n piezoelectric sheets (2)85b are laminated, and the one piezoelectric sheet (3)85c in which the internal electrode is not printed is laminated on the piezoelectric sheets (2)85b. Then the laminated piezoelectric sheets are pressed and cut into a predetermined size, after which the burning is performed at a predetermined temperature. Then external electrodes 83a₁, 83a₂, 83b₁, 83b₂, 83c₁, 83c₂, 83d₁, and 83d₂ are printed and baked in predetermined positions.

The external electrode is not limited to the fourth embodiment. The external electrodes 83a₁, 83a₂, 83b₁, 83b₂, 83c₁, 83c₂, 83d₁, and 83d₂ having substantially the same width as the internal electrode exposed portions 89a₁, 89a₂, 89b₁, 89b₂, 90a₁, 90a₂, 90b₁, and 90b₂ are provided in the fourth embodiment. Alternatively, as illustrated in FIGS. 21H and 21I, the external electrodes may be provided across the short side of the laminated piezoelectric element 81.

FIG. 21H illustrates the laminated piezoelectric element 81 as viewed from the γ direction of FIG. 21A, and FIG. 21I illustrates the laminated piezoelectric element 81 as viewed from the δ direction of FIG. 21A.

External electrodes 83a₃, 83a₄, 83b₃, 83b₄, 83c₃, 83c₄, 83d₃, and 83d₄ and internal electrode exposed portions 89a₁, 89a₂, 89b₁, 89b₂, 90a₁, 90a₂, 90b₁, and 90b₂ are provided such that the external electrodes 83a₃, 83a₄, 83b₃, 83b₄, 83c₃, 83c₄, 83d₃, and 83d₄ are connected to the internal electrode exposed portions 89a₁, 89a₂, 89b₁, 89b₂, 90a₁, 90a₂, 90b₁, and 90b₂.

The polarization will be described with reference to FIG. 23.

FIG. 23 is a sectional view which includes a polarization direction illustrated along a line B-B′ of FIG. 21B and is perpendicular to a side surface.

Referring to FIG. 23, in a polarization vector indicated by an arrow P, the polarization is formed from one pole (+) toward the other pole (−) with some bulge in the central portion. The polarization vector is matched with an electric-field vector. For example, a distance between the adjacent internal electrodes is 300 μm, and a distance (thickness direction of the piezoelectric sheet) between the positive pole and negative pole is 100 μm.

The operation of the laminated piezoelectric element 81 will be described.

As described above, as is clear from FIG. 3, the resonance frequency in the second twisting oscillation mode is matched with the resonance frequency in the first longitudinal oscillation mode when the value a/b is close to 0.6, and the resonance frequency in the third twisting oscillation mode is matched with the resonance frequency in the first longitudinal oscillation mode when the value a/b is close to 0.3. Accordingly, in the fourth embodiment, dimensions of the piezoelectric element 81 are set such that the value a/b becomes about 0.3.

In the fourth embodiment, for example, the dimensions of the sides a×b×c of the laminated piezoelectric element 81 are set to 3×10×20 mm.

The method of driving the laminated piezoelectric element 81 will be described using the first layer that is the outermost layer of the piezoelectric sheet (1) and the outermost layer that is the finally laminated piezoelectric sheet (2) as illustrated in FIG. 21B.

The operation of the piezoelectric element 81 in which the driving interdigital electrode is used will be described.

The alternate voltage corresponding to the resonance frequency of the first longitudinal oscillation or third twisting oscillation is applied to the A phase (A-positive phase and A-negative phase). In FIG. 21B, the force that is generated near the upper interdigital electrode by the inverse piezoelectric effect is indicated in terms of vector.

A force F10 illustrated in FIG. 21B is an alternate force, and forces F11 and F12 are obtained by vector decomposition of the force F10. As is clear from FIG. 21B, the force F11 excites the longitudinal oscillation. As is clear from FIG. 21B, the force F12 generates the third twisting oscillation.

The alternate voltage having the same frequency as the A phase is applied to the B phase (B-positive phase and B-negative phase). In FIG. 21B, the force that is generated near the upper interdigital electrode of the piezoelectric sheet (2)85b located in the outermost side surface is indicated in terms of vector.

A force F10′ illustrated in FIG. 21B is an alternate force, and forces F11′ and F12′ are obtained by vector decomposition of the force F10′. As is clear from FIG. 21B, the force F11′ excites the longitudinal oscillation. As is clear from FIG. 21B, the force F12′ generates the third twisting oscillation.

Then only the force generated in simultaneously applying the alternate voltages having the in-phase frequencies to the A phase and the B phase is considered. As illustrated in FIG. 21B, the force F12 and force F12′ cancel each other, the third twisting oscillation is not generated, and only the first longitudinal oscillation is generated.

When the alternate voltages having the antiphase frequencies (phase difference of π) are simultaneously applied to the A phase and the B phase, the force F11 and force F11′ cancel each other, the first longitudinal oscillation is not generated, and only the third twisting oscillation is generated.

Then it is assumed that the alternate voltages having the frequencies (phase difference between 0 and π) are simultaneously applied to the A phase and the B phase. In such cases, the first longitudinal oscillation and the third twisting oscillation are simultaneously generated to form the combined oscillation. As illustrated in FIG. 20A, the clockwise (CW direction) or counterclockwise (CCW direction) elliptic oscillation is formed at the position where the friction contact members 82a and 82b of the laminated piezoelectric element 81 are bonded such that the rotor 16 is rotated. When the elliptic oscillation is generated in the friction contact members 82a and 82b of the laminated piezoelectric element 81, the pressed rotor 16 is rotated clockwise (CW direction) or counterclockwise (CCW direction) about a rotation axis (or central axis) of the shaft 86 according to the rotation direction of the elliptic oscillation.

Because the twisting direction becomes inverted for the remaining pair of central driving interdigital electrodes, the direction of interdigital electrode is set so as to become an obtuse angle. Because the driving principle is similar to that of FIG. 20A, the description is omitted.

An operation of the lower oscillation detecting interdigital electrode of FIG. 21B will be described.

When the first longitudinal oscillation or third twisting oscillation is generated, the charge is generated in the interdigital electrode surface by the piezoelectric effect. The charge is observed as the voltage at the C phase (between C-positive phase and C-negative phase) or the voltage at the D phase (between D-positive phase and D-negative phase) Although the force is generated by the inverse piezoelectric effect in the operation of the driving interdigital electrode, the charge or voltage is generated by the mechanical strain in the operation of the oscillation detecting interdigital electrode.

In cases where only the first longitudinal oscillation is generated, the parallel forward connection is established between the C phase and D phase (the C-positive phase and the D-positive phase are connected, and the C-negative phase and the D-negative phase are connected: it is defined as the parallel forward connection phase), and the voltage generated between the C phase and D phase is obtained as a signal that is parallel to the magnitude and phase of the first longitudinal oscillation. On the other hand, in cases where the parallel inverse connection is established between the C phase and the D phase (the C-positive phase and the D-negative phase are connected, and the C-negative phase and the D-positive phase are connected: it is defined as the parallel inverse connection phase), the signal is not supplied.

In cases where only the third twisting oscillation is generated, the parallel inverse connection (the C-positive phase and the D-negative phase are connected, and the C-negative phase and the D-positive phase are connected) is established between the C phase and the D phase, and the voltage generated between the C phase and D phase is obtained as the signal that is parallel to the magnitude and phase of the third twisting oscillation. In cases where the parallel forward connection (the C-positive phase and the D-positive phase are connected, and the C-negative phase and the D-negative phase are connected) is established between the C phase and D phase, the signal is not supplied.

Therefore, the first longitudinal oscillation or the third twisting oscillation can independently be detected by selecting the connection between the C phase and D phase.

A method of driving the motor using the oscillation detecting phase (C phase and D phase) will be described.

It is known that the phase difference between the signal phase of the A phase or B phase that is the driving phase and the oscillation detecting phase (for example, the parallel inverse connection between the C phase and the D phase) has a predetermined value Ω during the resonance frequency operation of the third twisting oscillation. Accordingly, when the frequency is adjusted to drive the motor such that the phase difference between the driving phase and the oscillation detecting phase always becomes the value Ω, the oscillator can always be driven near the third twisting resonance frequency, that is, the motor can efficiently be driven at the optimum frequency, even if the temperature rise is generated by the heat generation of the motor or even if the change in resonance frequency is generated by the change in ambient temperature or the change in load. The motor can be driven in a similar way near the first longitudinal resonance frequency.

In the fourth embodiment, the oscillator includes the single laminated piezoelectric element, and the motor has the simple shape of the rectangular solid. Further, the oscillator of the fourth embodiment has the laminated structure, so that the motor can be driven at a low voltage. In the conventional longitudinal twisting motor, the groove portion is required to adjust the frequency of the twisting oscillation. On the contrary, the groove portion is eliminated in the fourth embodiment. Further, since the oscillation detecting electrode is provided, the motor can always be driven at the optimum frequency.

In the oscillator of the fourth embodiment, the section perpendicular to the rotation axis is formed into the rectangular shape having a predetermined ratio, so that the laminated piezoelectric element can easily be produced using a familiar technique of laminating the piezoelectric element.

(First Modification of Fourth Embodiment)

An ultrasonic motor according to a first modification of the fourth embodiment will be described below.

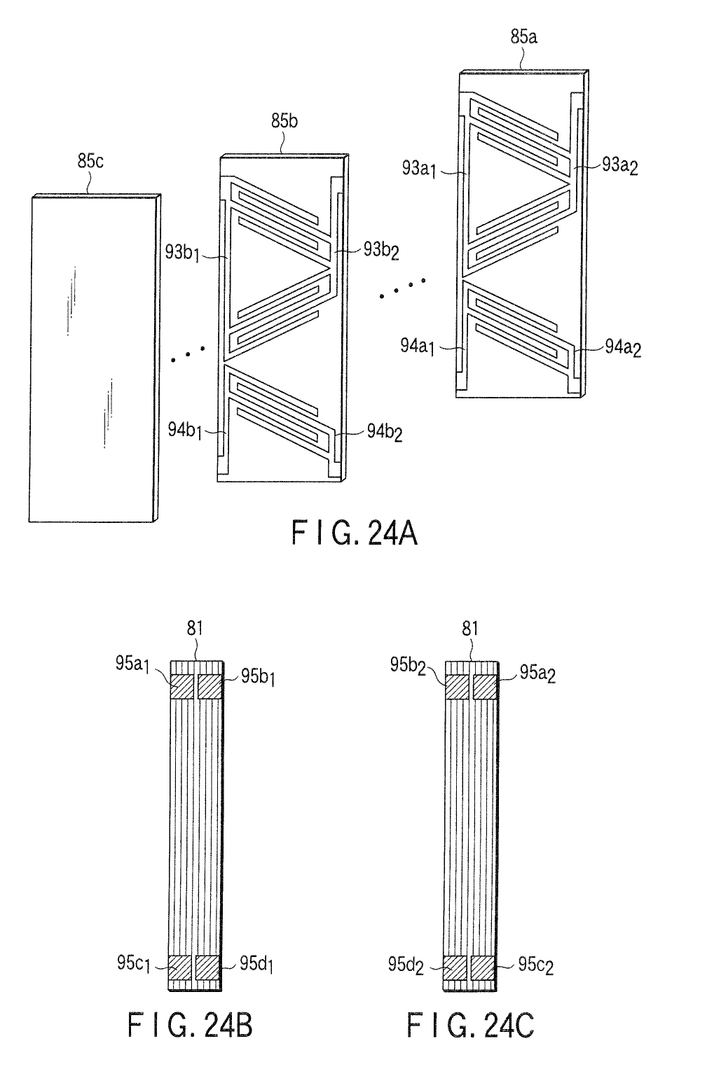

FIGS. 24A to 24C illustrate a configuration of the laminated piezoelectric element 81 of the first modification of the fourth embodiment, wherein FIG. 24A is an exploded perspective view of the laminated piezoelectric element 81, FIG. 24B illustrates the laminated piezoelectric element 81 of FIG. 24A as viewed from the left, and FIG. 24C illustrates the laminated piezoelectric element 81 of FIG. 24A as viewed from the right.

As illustrated in FIG. 24A, the first modification of the fourth embodiment differs from the fourth embodiment in that the upper interdigital electrode and the central interdigital electrodes 93a₁ and 93a₂, the upper interdigital electrode and the central interdigital electrodes 93b₁ and 93b₂, and the lower interdigital electrodes 94a₁ and 94a₂ and the lower interdigital electrodes 94b₁ and 94b₂ are identical to one another in the shapes of the internal electrode pattern (1)86a and internal electrode pattern (2)86b. At this point, as illustrated in FIGS. 24B and 24C, the external electrode is equally divided into two to form external electrodes 95a₁, 95a₂, 95b₁, 95b₂, 95c₁, 95c₂, 95d₁, and 95d₂.

In the first modification of the fourth embodiment, advantageously only one kind of the internal electrode pattern is used to form the internal electrodes.

(Second Modification of Fourth Embodiment)

An ultrasonic motor according to a second modification of the fourth embodiment will be described below.

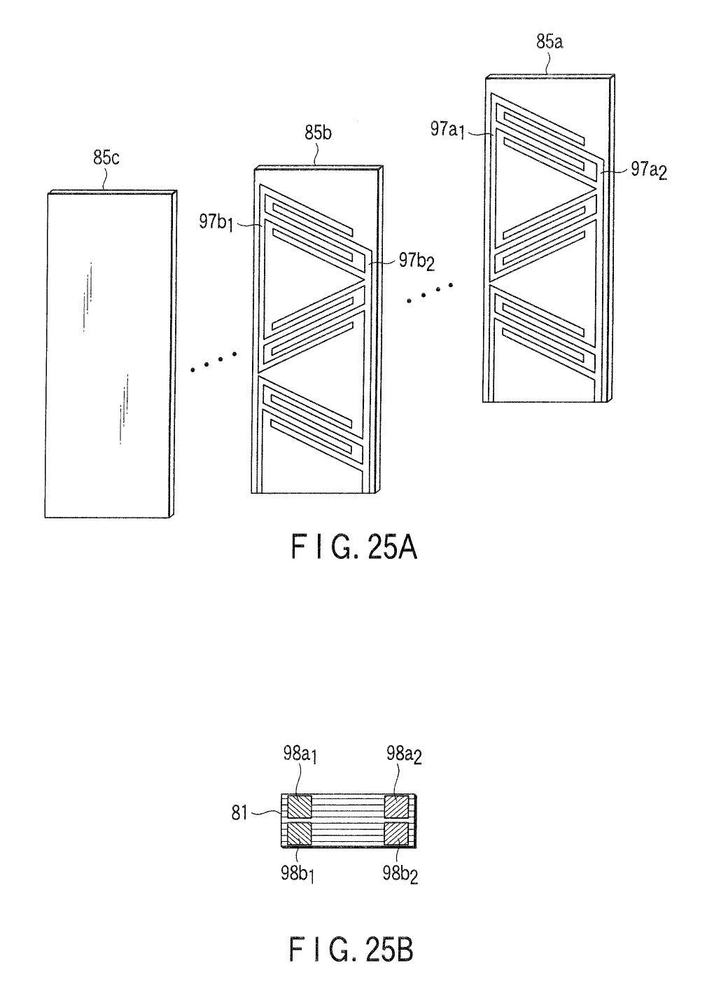

FIGS. 25A and 25B illustrate a configuration of a laminated piezoelectric element 81 of the second modification of the fourth embodiment, wherein FIG. 25A is an exploded perspective view of the laminated piezoelectric element 81, and FIG. 25B illustrates the laminated piezoelectric element 81 of FIG. 25A as viewed from a bottom side.

In the second modification of the fourth embodiment, all the three pairs of interdigital electrodes are used as the driving electrode when attention is focused on one piezoelectric sheet.

The three pairs of interdigital electrodes 97a₁, 97a₂, 97b₁, and 97b₂ are electrically connected in parallel, and angles formed between the three pairs of interdigital electrodes and the longitudinal direction of the upper interdigital electrode are an acute angle, an obtuse angle, and an acute angle in order. This is because, as illustrated in FIGS. 2A to 2E, the twisting directions of the third twisting oscillation become normal (inverse), inverse (normal), and normal (inverse) in the descending order.

Further, in the second modification of the fourth embodiment, because the lead-out position to the end portion of the internal electrode is provided only in the lower portion of FIG. 25A, external electrodes 98a₁, 98a₂, 98b₁, and 98b₂ are provided only in the lower surface of the laminated piezoelectric element 81 as illustrated in FIG. 25B.

Accordingly, in the second modification of the fourth embodiment, all the internal electrodes are used as the driving electrode, so that the large-power motor can be realized. Because the external electrodes are provided only in the bottom surface, only one surface is used when a flexible board (not illustrated) is connected, whereby the structure is advantageously simplified.

### Fifth Embodiment

An ultrasonic motor according to a fifth embodiment of the invention will be described below.

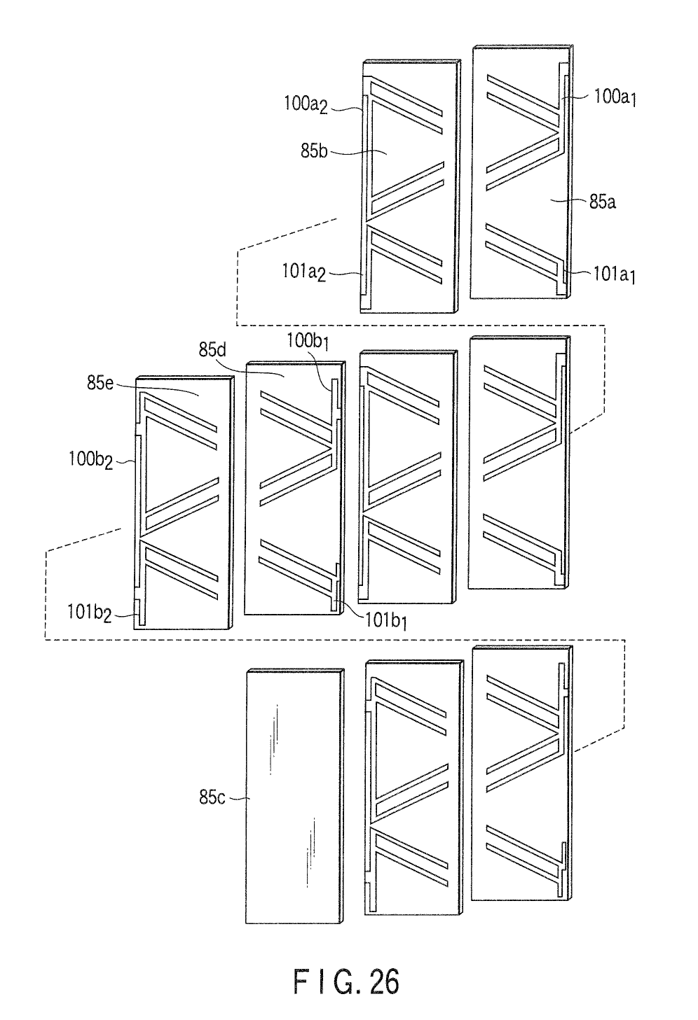

FIG. 26 is an exploded perspective view illustrating a configuration of a laminated piezoelectric element in the ultrasonic motor of the fifth embodiment.

The fifth embodiment differs from the fourth embodiment only in the configuration of the laminated piezoelectric element. Accordingly, only the configuration of the laminated piezoelectric element will be described here.

In the fifth embodiment, the dimensions of the sides a×b×c of the laminated piezoelectric element (oscillator) are set to, for example, 3×10×20 mm.

Referring to FIG. 26, only the right digit of the interdigital electrode is printed in the internal electrode pattern of the piezoelectric sheet (1)85a. This is referred to as interdigital right-digit electrode. As illustrated in FIG. 26, the interdigital right-digit electrode includes an upper interdigital right-digit electrode, a central interdigital right-digit electrode 100a₁, and a lower interdigital right-digit electrode 101a₁ in the descending order. The central positions of these interdigital right-digit electrodes are substantially matched with the node position of the third twisting oscillation (described in detail later). The gradient of the upper interdigital right-digit electrode is similar to that of the fourth embodiment. The gradient of the central interdigital right-digit electrode is similar to that of the fourth embodiment.

The upper interdigital right-digit electrode and the central interdigital right-digit electrode 100a₁ act as the driving internal electrode. As illustrated in FIG. 26, the upper interdigital right-digit electrode and the central interdigital right-digit electrode 100a₁ are connected, and parts of the upper interdigital right-digit electrode and the central interdigital right-digit electrode 100a₁ are led out to the end portion. The lower interdigital right-digit electrode 101a₁ is provided below the central interdigital right-digit electrode 100a₁, and the angle of the lower interdigital right-digit electrode 101a₁ is similar to that of the first embodiment. The lower interdigital right-digit electrode 101a₁ acts as the oscillation detecting electrode, and part of the lower interdigital right-digit electrode 101a₁ is led out to the end portion of the piezoelectric sheet.

On the other hand, only the left digit of the interdigital electrode is printed in the internal electrode pattern of the piezoelectric sheet (2)85b. This is referred to as interdigital left-digit electrode. The interdigital left-digit electrode of the piezoelectric sheet (2)85b is positioned and printed such that the interdigital left-digit electrode of the piezoelectric sheet (2)85b and the interdigital right-digit electrode of the piezoelectric sheet (1)85a form a pair of interdigital electrodes when the laminated piezoelectric element 81 is viewed from the front surface.

As illustrated in FIG. 26, the interdigital left-digit electrode includes an upper interdigital left-digit electrode, a central interdigital left-digit electrode 100a₂, and a lower interdigital left-digit electrode 101a₂ in the descending order. The central positions of these interdigital left-digit electrodes are substantially matched with the node position of the third twisting oscillation.

The upper interdigital left-digit electrode and the central interdigital left-digit electrode 100a₂ act as the driving internal electrode. As illustrated in FIG. 26, the upper interdigital left-digit electrode and the central interdigital left-digit electrode 100a₂ are connected, and parts of the upper interdigital left-digit electrode and the central interdigital left-digit electrode 100a₂ are led out to the end portion. The lower interdigital left-digit electrode 101a₂ is provided below the central interdigital left-digit electrode 100a₂. The lower interdigital left-digit electrode 101a₂ acts as the oscillation detecting electrode, and part of the lower interdigital left-digit electrode 101a₂ is led out to the end portion.

After the n (even number) piezoelectric sheets (1)85a and the n piezoelectric sheets (2)85b are alternately laminated, n piezoelectric sheets 4 (hereinafter referred to as piezoelectric sheet (4)) 85d and n piezoelectric sheets 5 (hereinafter referred to as piezoelectric sheet (5)) 85e are alternately laminated, and finally the piezoelectric sheet (3)85c in which the electrode pattern is not printed is laminated on the top.

The piezoelectric sheet (4)85d differs from the piezoelectric sheet (5)85e only in the lead-out position to the end portion, and the piezoelectric sheet (4)85d is identical to the piezoelectric sheet (5)85e in the electrode pattern.

Then the external electrode is formed. Because the external electrode is similar to that of the fourth embodiment, the description is omitted.

Because the method of producing the laminated piezoelectric element 81 of the fifth embodiment is similar to that of the fourth embodiment, the description is omitted.

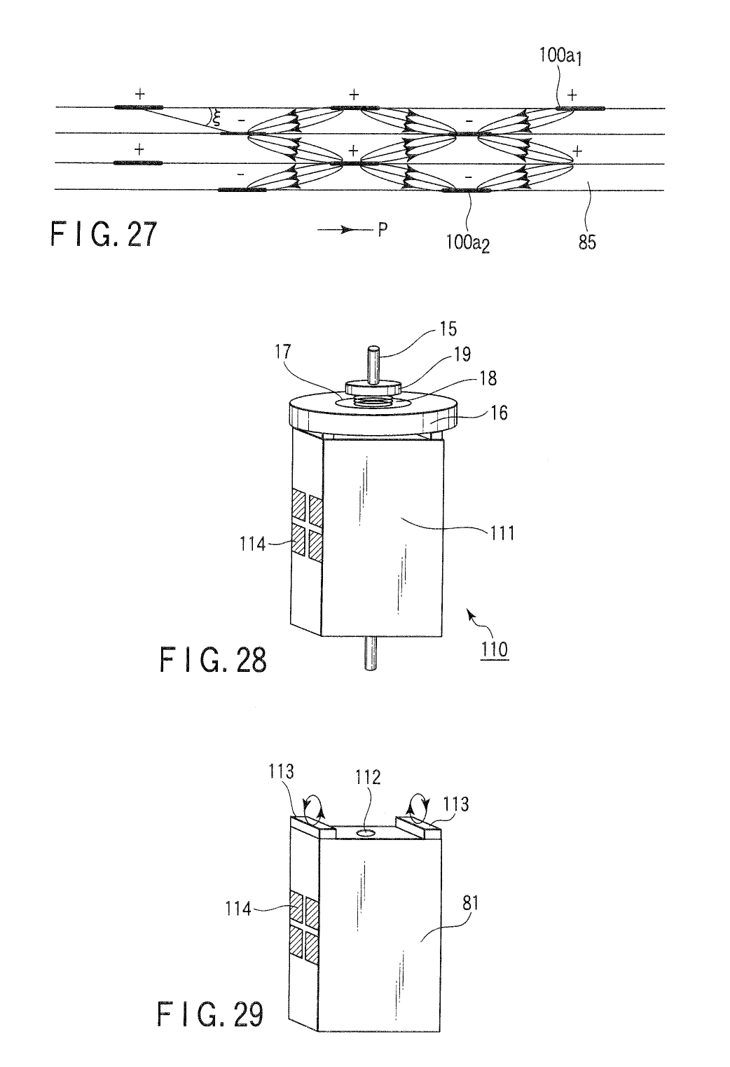

FIG. 27 illustrates a section including a laminated direction and a direction orthogonal to the digital direction of the interdigital electrode in order to illustrate the polarization state in the laminated piezoelectric element of the fifth embodiment.

The polarization is established in a ξ direction from one of the poles. The polarization vector has the slight bulge in the center, and is orientated toward the other pole. The polarization vector is matched with the electric-field vector. When the gradient ξ is decreased, electromechanical conversion efficiency is enhanced in the oscillator.

In the fifth embodiment, because the laminated piezoelectric sheet, the method of driving the motor in the driving phase, and the method of detecting the oscillation in the oscillation detecting phase to drive the motor at the optimum driving frequency are similar to those of the fourth embodiment, the description is omitted.

In the fifth embodiment, the following effect is obtained in addition to the effect similar to that of the fourth embodiment.

In the fourth embodiment, the positive electrode and the negative electrode exist in the same layer. Therefore, when the thickness is increased by the electrode during the lamination, the increased-thickness portion is deformed in the pressing, the electrodes are brought close to each other or the electrodes are short-circuited in the worst case, and possibly a polarization manipulation in which the high voltage is used cannot be performed. On the other hand, in the fifth embodiment, only the electrodes having the same polarity exist in the same layer, so that the trouble in the fourth embodiment can be eliminated.

### Sixth Embodiment

An ultrasonic motor according to a sixth embodiment of the invention will be described below with reference to FIGS. 28, 29, and 30A to 30D.

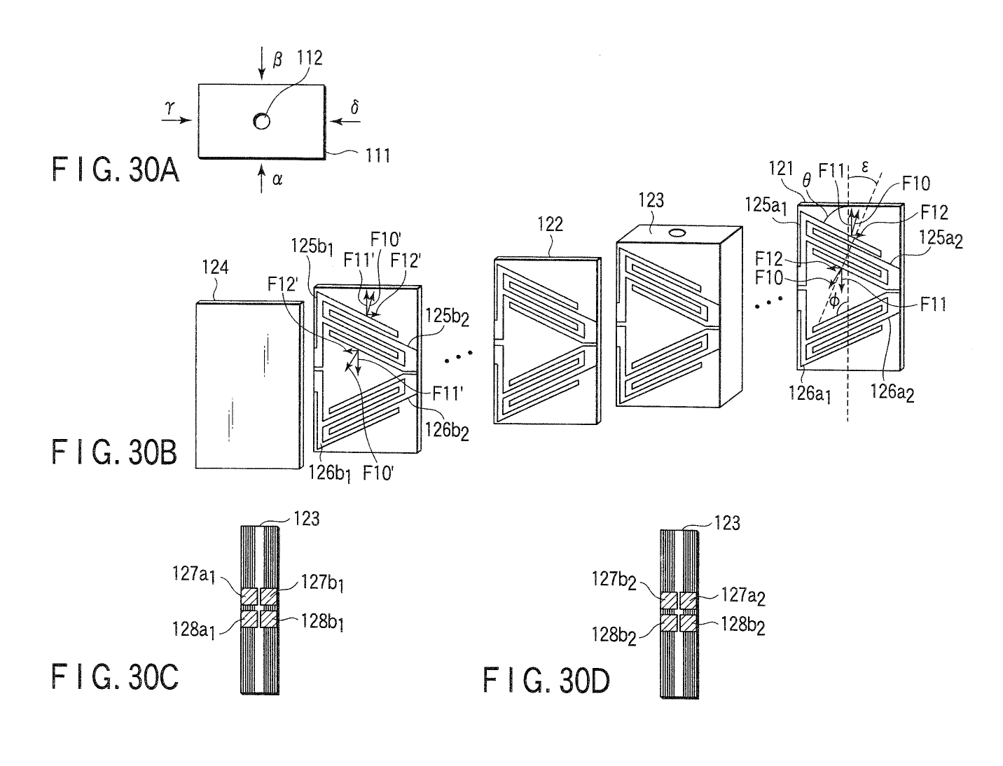

FIG. 28 is an appearance perspective view illustrating the ultrasonic motor of the sixth embodiment. FIG. 29 is an appearance perspective view illustrating an oscillator to which a friction contact member is bonded. FIGS. 30A to 30D illustrate a configuration of a laminated piezoelectric element 111 of the sixth embodiment, FIG. 30A is a plan view illustrating the laminated piezoelectric element 111 as viewed from above, FIG. 30B is an exploded perspective view of the laminated piezoelectric element 111, FIG. 30C illustrates the laminated piezoelectric element 111 as viewed from the γ direction of FIG. 30A, and FIG. 30D illustrates the laminated piezoelectric element 111 as viewed from the δ direction of FIG. 30A.

An ultrasonic motor 110 includes the laminated piezoelectric element (oscillator) 111, friction contact members 113a and 113b, the shaft 15, the rotor 16, the bearing 17, the spring 18, and the spring retaining ring 19. The friction contact members 113a and 113b are bonded to a surface orthogonal to the longitudinal direction of the laminated piezoelectric element 111. The shaft 15 is inserted in a throughhole 112 made in the longitudinal direction of the laminated piezoelectric element 111. The rotor 16 is rotated while being in contact with the friction contact members 113a and 113b.

The throughhole 112 is made in the central portion in the longitudinal direction (vertical direction of the FIGS. 28 to 30) of the laminated piezoelectric element 111 in order to insert the shaft 15 therein. The shaft 15 has the substantially cylindrical shape, and the shaft is fixed to the substantially central portion of the throughhole 112 in the laminated piezoelectric element 111 using the bonding agent (not illustrated). In the shaft 15, only the diameter of the central portion is larger than those of other portions. The shaft 15 is in contact with and fixed to the laminated piezoelectric element 111 only in the central portion of the throughhole 112 in the laminated piezoelectric element 111, and other portions of the shaft 15 are not in contact with the wall surface of the throughhole 112.

The friction contact members 113a and 113b are bonded to one (on the side where the rotor 16 is disposed) of end faces of the laminated piezoelectric element 111. The friction contact members 113a and 113b are formed into the rectangular-solid shape. On one of the end faces of the laminated piezoelectric element 111, the friction contact members 113a and 113b are bonded to two points where the elliptic oscillation is generated, respectively.

The rotor 16 is made of alumina ceramics, and the bearing 17 is fitted in the central portion of the rotor 16. Accordingly, the rotor 16 is placed while the pressing force is applied to the friction contact members 113a and 113b of the laminated piezoelectric element 111. The spring 18 is compressed by rotating the spring retaining ring 19, thereby properly applying the pressing force between the rotor 16 and the friction contact members 113a and 113b of the laminated piezoelectric element 111. The spring 18 is in contact only with the inside of the bearing 17.

Although not illustrated, the screw is formed in part of the shaft 15, and the shaft 15 is screwed in the spring retaining ring 19 in which a tapped hole is made.

As illustrated in FIGS. 28 and 29, external electrodes 114 are provided at four points in a side surface of the laminated piezoelectric element 111. Although not illustrated, the external electrodes are provided at four points in the opposite side surface.

In the sixth embodiment, for example, the dimensions of the sides a×b×c of the laminated piezoelectric element 111 are set to 6×10×20 mm.

A configuration of the laminated piezoelectric element (oscillator) 111 of the sixth embodiment will be described.

FIG. 30A illustrates the laminated piezoelectric element 111 as viewed from above, and the four side surfaces are designated by arrows α, β, γ, and δ. FIG. 30B illustrates examples of the piezoelectric sheet and internal electrode pattern.

In the laminated piezoelectric element 111, n thin piezoelectric sheets 1 (hereinafter referred to as piezoelectric sheet (1)) 121 in which a predetermined internal electrode pattern is formed and (n−1) thin piezoelectric sheets 2 (hereinafter referred to as piezoelectric sheet (2)) 122 having the same configuration as the piezoelectric sheet (1)121 are laminated on both sides of one piezoelectric sheet 3 (hereinafter referred to as piezoelectric sheet (3)) 123 in which the throughhole 112 is made. In the laminated piezoelectric element 111, a thin piezoelectric sheet 4 (hereinafter referred to as piezoelectric sheet (4)) 124 in which the internal electrode pattern is not formed is laminated on the outside of the piezoelectric sheet (2)122.

The point differing from that of the fourth embodiment will be described.

As illustrated in FIG. 30B, the interdigital electrodes are printed as the internal electrode pattern at two points in each of the piezoelectric sheet (1)121 and piezoelectric sheet (2)122. For the sake of convenience, the two pairs of interdigital electrodes are illustrated in FIG. 30B. However, in order that the interdigital electrode occupies as large an area as possible in the side surface, actually the number of pairs of interdigital electrodes may be increased such that the interdigital electrode is formed over the side surface as illustrated in FIG. 22.

The angle θ formed between the height direction (indicated by the broken line) of FIG. 30B and the digital direction of the interdigital electrodes 125a₁, 125a₂, 125b₁, and 125b₂ is set as follows in the upper interdigital electrode:

0<θ<π/2

As indicated by the broken line of FIG. 30B, because the polarization direction ε is orthogonal to the digital direction of the interdigital electrode, the polarization direction ε is expressed as follows:

0<|ε|<π/2

The upper interdigital electrode acts as the driving electrode.

The angle φ formed between the height direction of FIG. 30B and the digital direction of the second interdigital electrodes 126a₁, 126a₂, 126b₁, and 126b₂ is set to values except for 0, π/2, and π. In the sixth embodiment, the angle φ is set as follows:

π/2<φ<3π/2

The second interdigital electrodes 126a₁, 126a₂, 126b₁, and 126b₂ act as the oscillation detecting electrode.

After the n piezoelectric sheets (1)121 are laminated, the piezoelectric sheet (3)123 is laminated on the piezoelectric sheet (1)121. The piezoelectric sheet (3)123 in which the internal electrode is printed is slightly thicker than the piezoelectric sheet (1)121, and the throughhole 112 is made in the center of the piezoelectric sheet (3)123. Then the (n−1) piezoelectric sheets (2)122 are laminated on the piezoelectric sheet (3)123. Finally the piezoelectric sheet (4)124 in which the electrode is not printed is laminated on the piezoelectric sheet (2)122. Therefore, the number of sheets becomes 2n+1, that is, the odd number as a whole.

The reason why the thick piezoelectric sheet (piezoelectric sheet (3)123) is prepared in the central portion is that the throughhole 112 is made in the length direction in the center of the piezoelectric sheet.

In the sixth embodiment, the second twisting oscillation and the first longitudinal oscillation are utilized. The central portion of the upper interdigital electrode is provided near the upper node position of the second twisting oscillation, and the central portion of the lower interdigital electrode is provided near the lower node position of the second twisting oscillation.

FIG. 30C illustrates the laminated piezoelectric element 111 as viewed from the γ direction of FIG. 30A.

A left-digit electrode 125a₁ of the upper interdigital electrode having the internal electrode pattern is connected to an external electrode 127a₁ for the A-positive phase. Similarly a left-digit electrode 125b₁ of the upper interdigital electrode having the internal electrode pattern is connected to an external electrode 127b₁ for the B-positive phase. A left-digit electrode 126a₁ of the lower interdigital electrode having the internal electrode pattern is connected to an external electrode 128a₁ of the C-positive phase. A left-digit electrode 126b₁ of the lower interdigital electrode having the internal electrode pattern is connected to an external electrode 128b₁ of the D-positive phase.

FIG. 30D illustrates the laminated piezoelectric element 111 as viewed from the δ direction of FIG. 30A.

A right-digit electrode 125a₂ of the upper interdigital electrode having the internal electrode pattern is connected to an external electrode 127a₂ of the A-negative phase. Similarly a right-digit electrode 125b₂ of the upper interdigital electrode having the internal electrode pattern is connected to an external electrode 127b₂ of the B-negative phase. A right-digit electrode 126a₂ of the lower interdigital electrode having the internal electrode pattern is connected to an external electrode 128a₂ of the C-negative phase. A right-digit electrode 126b₂ of the lower interdigital electrode having the internal electrode pattern is connected to an external electrode 128b₂ of the D-negative phase.

Because the method of producing the laminated piezoelectric element of the sixth embodiment is similar to that of the fourth embodiment, the description is omitted.

An operation of the laminated piezoelectric element 111 will be described.

The dimensions of the sides a, b, and c of the rectangular solid illustrated in FIG. 2A are set to proper values, thereby utilizing the first longitudinal oscillation mode and second twisting oscillation mode in the sixth embodiment. Accordingly, the value a/b is set to about 0.6, and the dimensions of the sides a×b×c are set to, for example, 6×10×20 mm.

The method of driving the laminated piezoelectric element 111 will be described using the first layer that is the outermost layer of the piezoelectric sheet (1)121 and the outermost layer that is the finally laminated piezoelectric sheet (2)122 as illustrated in FIG. 30B.

The operation of the piezoelectric element 111 in which the driving interdigital electrode is used will be described.

The alternate voltage corresponding to the resonance frequency of the first longitudinal oscillation or second twisting oscillation is applied to the A-phase (A-positive phase and A-negative phase) external electrodes 127a₁ and 127a₂ of FIGS. 30C and 30D. In the piezoelectric sheet (1)121 of FIG. 30B, the force that is generated near the upper interdigital electrode by the inverse piezoelectric effect is indicated in terms of vector

A force F10 illustrated in FIG. 30B is the alternate force, and forces F11 and F12 are obtained by the vector decomposition of the force F10. As is clear from FIG. 30B, the force F11 excites the longitudinal oscillation. As is clear from FIG. 30B, the force F12 generates the second twisting oscillation.

The alternate voltage having the same frequency is also applied to the B-phase (B-positive phase and B-negative phase) external electrodes 127b₁ and 127b₂ of FIGS. 30C and 30D. In the other outermost side surface located in the piezoelectric sheet (2)122 of FIG. 30B, the force that is generated near the upper interdigital electrode is indicated in terms of vector.

The force F10′ of FIG. 30B is the alternate force, and forces F11′ and F12′ are obtained by vector decomposition of the force F10′. As is clear from FIG. 30B, the force F11′ can excite the longitudinal oscillation. As is clear from FIG. 30B, the force F12′ can generate the second twisting oscillation.

Then it is also assumed that the alternate voltages having the in-phase frequencies are simultaneously applied to the A phase and the B phase. As can be seen from FIG. 30B, the force F12 and force F12′ cancel each other, the second twisting oscillation is not generated, and only the first longitudinal oscillation is generated. When the alternate voltages having the antiphase frequencies (phase difference of π) are simultaneously applied to the A phase and the B phase, the force F11 and force F11′ cancel each other, the first longitudinal oscillation is not generated, and only the second twisting oscillation is generated.

Then it is also assumed that the alternate voltages having the frequencies (phase difference between 0 and π) are simultaneously applied to the A phase and the B phase. In such cases, the first longitudinal oscillation and the second twisting oscillation are simultaneously generated to form the combined oscillation. As illustrated in FIG. 29, the clockwise or counterclockwise elliptic oscillation is formed in the position where the friction contact members 113a and 113b of the laminated piezoelectric element 111 are bonded such that the rotor 16 is rotated. When the elliptic oscillation is generated in the position of the friction contact members 113a and 113b of the laminated piezoelectric element 111, the pressed rotor 16 is rotated clockwise or counterclockwise according to the rotation direction of the elliptic oscillation.

The operation of the lower oscillation detecting interdigital electrode of FIG. 30B will be described.

When the first longitudinal oscillation or second twisting oscillation is generated, the charge is generated in the interdigital electrode surface by the piezoelectric effect. The charge is observed as the voltage at the C phase (between C-positive phase and C-negative phase) or the voltage at the D phase (between D-positive phase and D-negative phase). Although the force is generated by the inverse piezoelectric effect in the operation of the driving interdigital electrode, the charge or voltage is generated by the mechanical strain in the operation of the oscillation detecting interdigital electrode. In cases where only the first longitudinal oscillation is generated, the parallel forward connection is established between the C phase and D phase (the C-positive phase and the D-positive phase are connected, and the C-negative phase and the D-negative phase are connected), and the voltage generated between the C phase and D phase is obtained as a signal that is parallel to the magnitude and phase of the first longitudinal oscillation. On the other hand, in cases where the parallel inverse connection is established between the C phase and the D phase (the C-positive phase and the D-negative phase are connected, and the C-negative phase and the D-positive phase are connected), the signal is not supplied.

In cases where only the second twisting oscillation is generated, the parallel inverse connection (the C-positive phase and the D-negative phase are connected, and the C-negative phase and the D-positive phase are connected) is established between the C phase and the D phase, and the voltage generated between the C phase and D phase is obtained as the signal that is parallel to the magnitude and phase of the second twisting oscillation. On the other hand, in cases where the parallel forward connection (the C-positive phase and the D-positive phase are connected, and the C-negative phase and the D-negative phase are connected) is established between the C phase and D phase, the signal is not supplied.

Therefore, the first longitudinal oscillation or the second twisting oscillation can independently be detected by selecting the connection between the C phase and D phase.

A method of driving the motor using the oscillation detecting phase (C phase and D phase) will be described.

It is known that the phase difference between the signal phase of the A phase or B phase that is the driving phase and the oscillation detecting phase (for example, the parallel inverse connection between the C phase and the D phase) has a predetermined value Ω during the resonance frequency operation of the second twisting oscillation. Accordingly, when the frequency is adjusted to drive the motor such that the phase difference between the driving phase and the oscillation detecting phase always becomes the value Ω, the oscillator can always be driven near the second twisting resonance frequency, that is, the motor can efficiently be driven at the optimum frequency, even if the temperature rise is generated by the heat generation of the motor or even if the change in resonance frequency is generated by the change in ambient temperature or the change in load. The motor can be driven in a similar way near the first longitudinal resonance frequency.

Thus, in the sixth embodiment, in addition to the effects of the fourth and fifth embodiments, advantageously the oscillator holder that is required in the fourth and fifth embodiments is eliminated, and a degree of freedom is generated in the space occupied by the oscillator holder while the number of components is decreased.

(First Modification of Sixth Embodiment)

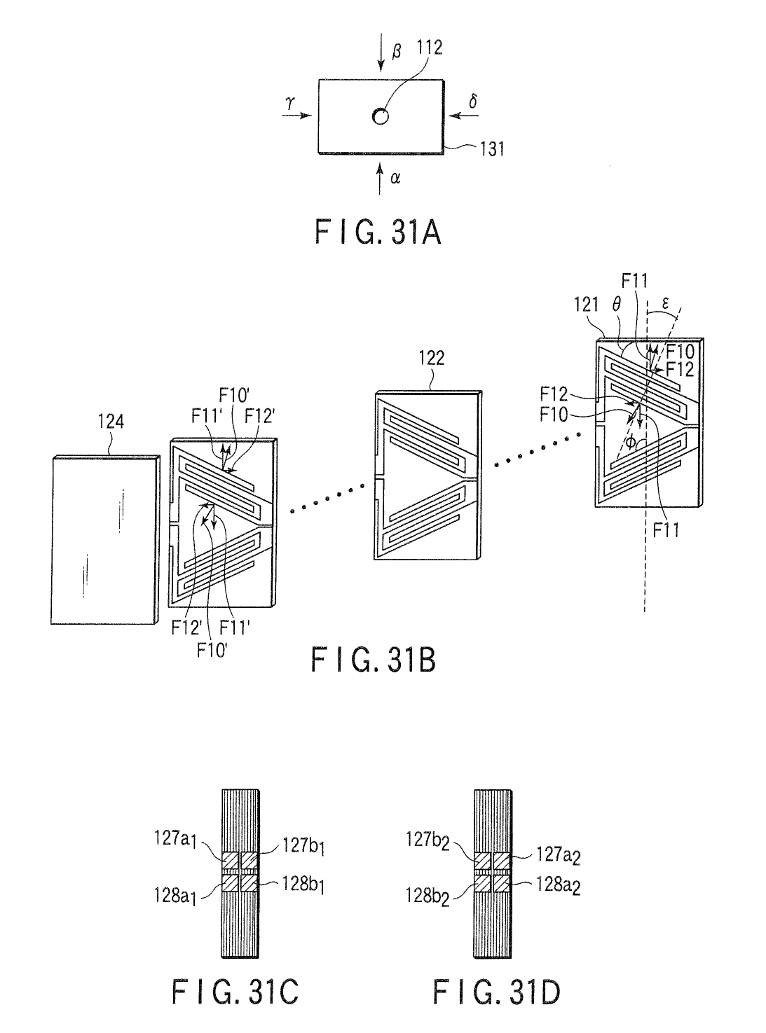

FIGS. 31A to 31D illustrate a configuration of a laminated piezoelectric element 131 according to a first modification of the sixth embodiment, FIG. 31A is a plan view illustrating the laminated piezoelectric element 131 as viewed from above, FIG. 31B is an exploded perspective view of the laminated piezoelectric element 131, FIG. 31C illustrates the laminated piezoelectric element 131 as viewed from the γ direction of FIG. 31A, and FIG. 31D illustrates the laminated piezoelectric element 131 as viewed from the δ direction of FIG. 31A.

In the first modification of the sixth embodiment, the thick piezoelectric sheet (3) is not used unlike the sixth embodiment, but the plural piezoelectric sheets (1)121 and one piezoelectric sheet (4)124 are laminated. After all the piezoelectric sheets are laminated, the throughhole 112 is made in the central portion to insert the shaft 15 therein.

Part of the internal electrode is removed by the throughhole 112 such that the exposed portion of the internal electrode of the piezoelectric sheet is not connected to an external electrode. As illustrated in FIGS. 31C and 31D, the part of the internal electrode of the piezoelectric sheet is removed between an A-positive-phase external electrode 127a₁ and a B-positive-phase external electrode 127b₁, between a C-positive-phase external electrode 128a₁ and a D-positive-phase external electrode 128b₁, between an A-negative-phase external electrode 127a₂ and a B-negative-phase external electrode 127b₂, and between a C-negative-phase external electrode 128a₂ and a D-negative-phase external electrode 128b₂. Therefore gaps are provided.

Thus, in the first modification of the sixth embodiment, as with the fifth embodiment, the interdigital electrode can include the two kinds of the piezoelectric sheets.

(Second Modification of Sixth Embodiment)

In a second modification of the sixth embodiment, although not illustrated, all the interdigital electrodes can be used as the driving interdigital electrode like the second modification of the fourth embodiment.

Therefore, the high-power ultrasonic motor can be realized.

Although the dimensions of the sides a×b×c (length in the center axial direction) are cited only by way of example in the above-described embodiments, the dimensions of the sides a×b×c are appropriately changed according to the application devices and intended end-usage of the ultrasonic motor. For example, as illustrated in FIG. 3, a predetermined ratio (in FIG. 3, a rectangular ratio corresponding to an intersection) at which the resonance frequency of the first longitudinal resonance oscillation is matched with the resonance frequency of the second twisting (or third twisting) resonance oscillation to exert the same value is most suitable to the rectangular ratio a/b of the ultrasonic motor after the production is completed. The range (for example, within ±0.02) close to the predetermined ratio can also be used as the rectangular ratio a/b at which the resonance frequency of the first longitudinal resonance oscillation is substantially matched with the resonance frequency of the second twisting (or third twisting) resonance oscillation. When the rectangular ratio falls within the effective range (for example, within ±0.05), the above described effect of the invention can be obtained.

Any length (side c, for example, 20 mm) in the rotation axial direction may be adopted as long as the electrode can be disposed to generate the oscillation along the longitudinal direction and the twisting direction. It is not necessary that the length of the side c is set to a predetermined ratio of other lengths (side a and side b), and it is not necessary to provide the length of the conventional groove for adjusting the oscillation. Accordingly, advantageously the simple, compact ultrasonic motor in which a degree of freedom of the design is increased can be provided. When the dimensions are enlarged or reduced in a similar manner by various dimensional ratios a/b and a/c (or b/c) in the three directions, the ultrasonic motor having arbitrary dimensions can be provided, whereby the ultrasonic motor can be applied to various targets of varying size.

### Seventh Embodiment

An ultrasonic motor according to a seventh embodiment of the invention will be described below.

The ultrasonic motor of the seventh embodiment will be described below with reference to FIGS. 32, 33, and 34 and FIGS. 2, 3, and 23.

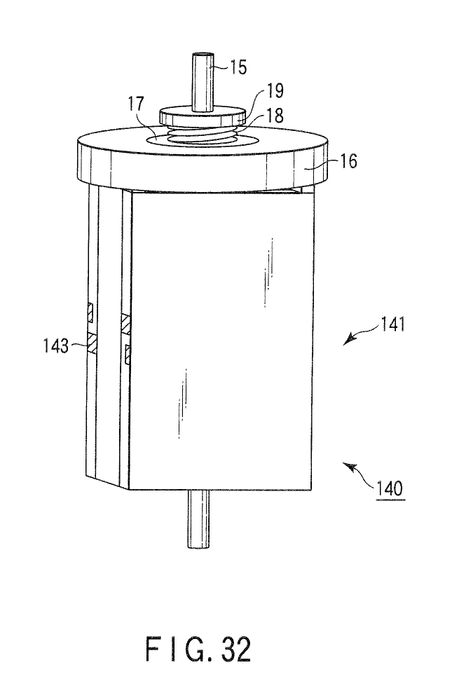

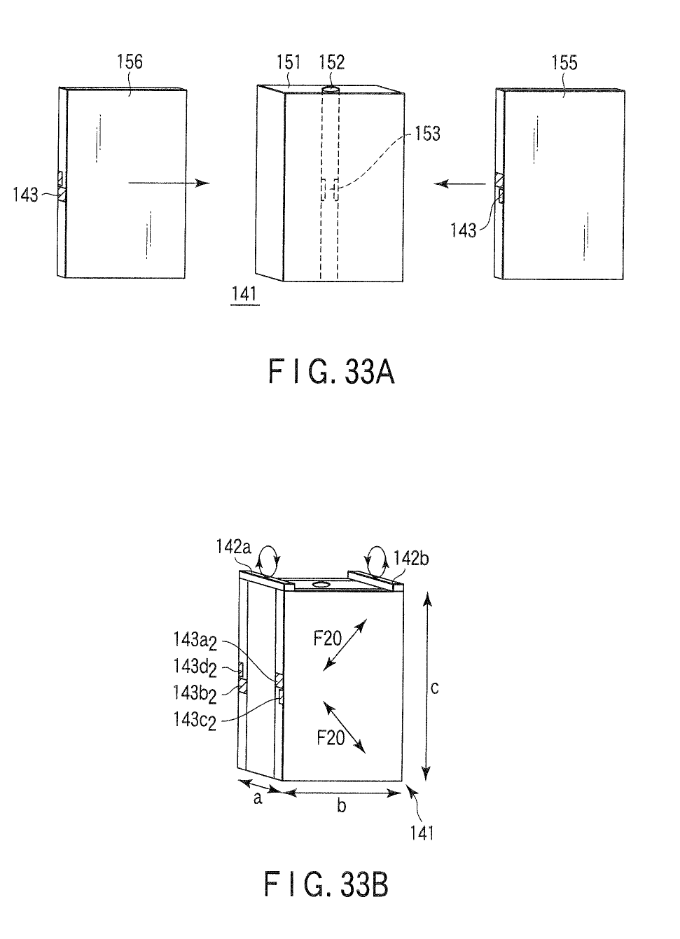

FIG. 32 is an appearance perspective view illustrating the ultrasonic motor of the seventh embodiment. FIGS. 33A and 33B illustrate the laminated piezoelectric element of FIG. 32, wherein FIG. 33A is an exploded perspective view of the laminated piezoelectric element, and FIG. 33B is a perspective view of the laminated piezoelectric element.

An ultrasonic motor 140 includes a laminated piezoelectric element 141 constituting an oscillator, friction contact members 142a and 142b, an external electrode 143, the shaft 15, the rotor 16, the bearing 17, the spring 18, and the spring retaining ring 19.

The friction contact members 142a and 142b are bonded to the surface orthogonal to the longitudinal direction of the laminated piezoelectric element 141 so as to be in contact with the rotor 16. The friction contact members 142a and 142b are made of a ceramic material such as alumina and zirconia or an engineering plastic material such as PPS and PEEK. As illustrated in FIG. 33B, the clockwise (CW direction) or counterclockwise (CCW direction) elliptic oscillation is generated in the positions of the friction contact members 142a and 142b. However, it is not always necessary to provide the friction contact members 142a and 142b. As illustrated in FIGS. 32, 33A, and 33B, external electrodes 143 are provided at four points in a left side surface. Although not illustrated, the external electrodes are provided at four points in the right side surface.

The rotor 16 is rotated while pressed against the top surface of the laminated piezoelectric element 141 having the prismatic shape. The rotor 16 is journaled in the bearing 17 while an outer side surface of the bearing 17 is fixed to the inner side surface of the rotor 16. The bearing 17 includes the bearing inner ring to which the shaft 15 is fixed and the bearing outer ring fixed to an inner circumference of the rotor 16.

The spring 18 is an elastic member that applies the pressing force to the bearing inner ring, and the spring 18 is in contact with the side portion in the bearing 17. The spring retaining ring 19 compresses the spring 18 to control the contracting amount of the spring 18 generating the spring force. As described above, the shaft 15 is fixed in the substantially central portion of the laminated piezoelectric element 141.

The longitudinal direction of the axis of the shaft 15 is defined as a center axial direction.

In the laminated piezoelectric element 141 having the rectangular-solid shape, a rectangular-solid first laminated piezoelectric element 155 and a rectangular-solid second laminated piezoelectric element 156 are bonded to both side surfaces of an elastic body 151 made of a metallic material such as stainless steel and brass using the bonding agent. A throughhole 152 is made in the central portion of the elastic body 151 in order to insert the shaft 15 therein. An internal thread 153 is provided in the central portion in the axial direction of the throughhole 152 in order to retain the shaft 15, and an external thread (not illustrated) in the central portion of the shaft 15 is engaged with and bonded to the internal thread 153. The internal thread 153 is geometrically substantially matched with the node portion of the first longitudinal oscillation and the central node portion of the second twisting oscillation of the laminated piezoelectric element 141.

As illustrated in FIGS. 32 and 33, the external electrodes 143 are provided in the side surfaces of the laminated piezoelectric elements 155 and 156.

In the first laminated piezoelectric element 155, the external electrodes 143 for the A-negative phase and C-negative phase exist in one side surface of FIG. 33. Although not illustrated, the external electrodes 143 for the A-positive phase and C-positive phase exist in the opposite side surface. In the second laminated piezoelectric element 156, the external electrodes for the B-negative phase and D-negative phase exist in one side surface of FIG. 33. Although not illustrated, the external electrodes for the B-positive phase and D-positive phase exist in the opposite side surface.

The dimensions of the laminated piezoelectric element 141 are set to a=6 mm, b=10 mm, and c=20 mm. The thicknesses of the friction contact members 142a and 142b ranges from about 0.1 mm to about 1 mm.

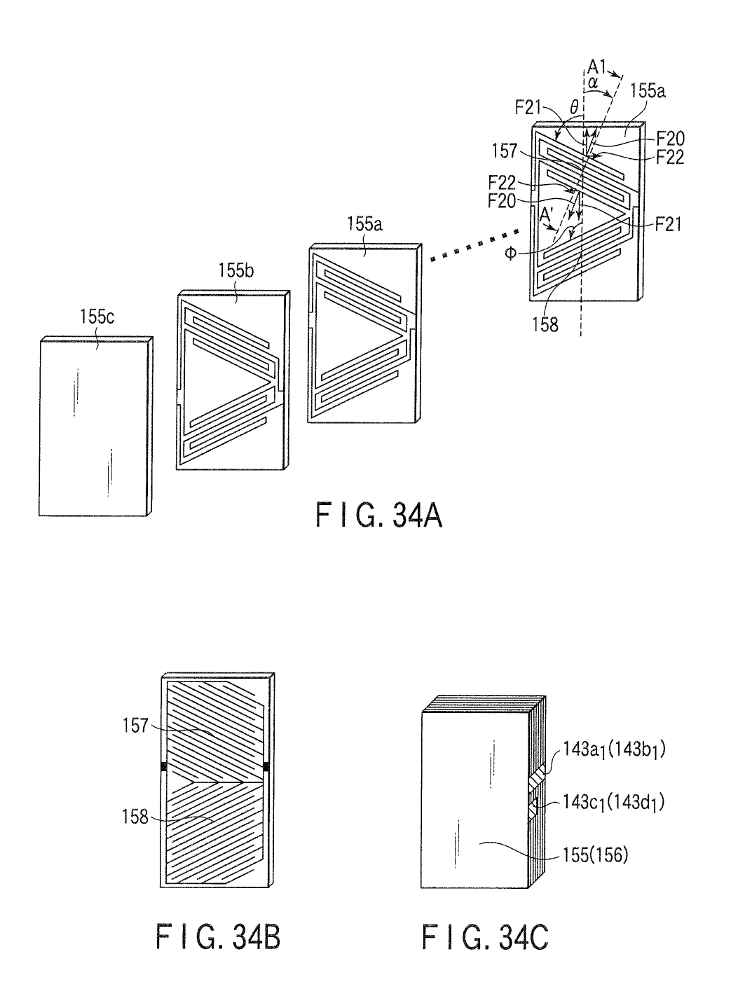

A configuration of the laminated piezoelectric element of the seventh embodiment will be described with reference to FIGS. 34A to 34C.

FIG. 34A illustrates examples of the piezoelectric sheet and internal electrode pattern.

In the laminated piezoelectric element 155, the thin piezoelectric sheets are laminated, and a predetermined internal electrode pattern is formed in the piezoelectric sheet. The piezoelectric sheet is made of a PZT material whose thickness ranges from about 10 μm to about 100 μm, an internal electrode pattern is printed in a piezoelectric sheet 1 (hereinafter referred to as piezoelectric sheet (1)) 155a, and an internal electrode pattern 2 is printed in a piezoelectric sheet 2 (hereinafter referred to as piezoelectric sheet (2)) 155b.

The internal electrode is made of a silver-palladium alloy, and has the thickness of several micrometers. As illustrated in FIG. 34A, interdigital electrodes (upper interdigital electrode (internal electrode) 157 and a lower interdigital electrode (internal electrode) 158) are printed in the piezoelectric sheet (1)155a. A width of the interdigital internal electrode is set in a range of about 0.1 mm to about 1 mm, and an insulating width between the interdigital internal electrodes is set in a range of about 0.1 mm to about 1 mm.

For the sake of convenience, the two pairs of interdigital electrodes are illustrated in FIG. 34A. However, in order that the interdigital electrode occupies as large an area as possible in the side surface, actually the number of pairs of interdigital electrodes may be increased such that the interdigital electrode is formed over the side surface as illustrated in FIG. 34B.

Referring to FIG. 34A, the angle θ formed between the center axial direction (indicated by the broken line) of the interdigital electrode and the digital direction of the interdigital electrode is set in a range of 0<θ<π/2 in the upper interdigital electrode 157. Because the polarization direction α (indicated by the broken line) is orthogonal to the digital direction of the interdigital electrode, the polarization direction α is expressed as follows:

α=π/2−θ

0<α<π/2

The angles α and θ are inversely measured as illustrated in FIG. 34A.

As illustrated in FIG. 34A, the angle φ formed between the center axial direction and the lower interdigital electrode 158 is set as follows:

φ=π−θ

π/2<φ<π

The lower interdigital electrode 158 and the upper interdigital electrode 157 are electrically connected in parallel, and parts of the lower interdigital electrode 158 and the upper interdigital electrode 157 are extended to the end portion of the piezoelectric sheet. The n piezoelectric sheets (a)155a are laminated, and then the piezoelectric sheet (2)155b is laminated. The electrode pattern of the piezoelectric sheet (2)155b is identical to that of the piezoelectric sheet (1)155b, although the electrode pattern of the piezoelectric sheet (2)155b differs from that of the piezoelectric sheet (1)155b in the position of the electrode extended to the end portion. The piezoelectric sheets (2)155b are used to detect the oscillation. Finally the piezoelectric sheet 3 (hereinafter referred to as piezoelectric sheet (3)) 155c in which the electrode is not printed is laminated.

When the laminated piezoelectric element 141 is formed, the second twisting oscillation and first longitudinal oscillation that are generated in the oscillator are utilized in the seventh embodiment. The central portion of the upper interdigital electrode 157 is provided near the upper node position of the second twisting oscillation, and the central portion of the lower interdigital electrode 158 is provided near the lower node position of the second twisting oscillation.

FIG. 34C illustrates an external electrode after the laminated piezoelectric element of FIG. 34B is laminated.

Referring to FIG. 34C, an external electrode 143a₁ (143b₁) for the A-positive (B-positive) phase and an external electrode 143c₁ (143d₁) for the C-positive (D-positive) phase are provided in the right side surface. The external electrode 143a₁ (143b₁) is electrically connected to the internal electrodes of the n piezoelectric sheet (a)155a. The external electrode 143c₁(143d₁) is electrically connected to the internal electrode of the one piezoelectric sheet (2)155b. Although not illustrated, an external electrode 143a₂ (143b₂) for the A-negative (B-negative) phase and an external electrode 143c2 (143d₂) for the C-negative (D-negative) phase are provided in the left side surface.

In boding the laminated piezoelectric element 141 to the elastic body 151 of FIG. 33A, after the first laminated piezoelectric element 155 is bonded to one of the surfaces of the elastic body 151, and the second laminated piezoelectric element 156 is bonded to the other surface of the elastic body 151. At this point, the second laminated piezoelectric element 156 is turned upside down, and the second laminated piezoelectric element 156 is inside out. This is because the polarization is orientated toward the same direction while the side of the piezoelectric sheet (2)155b, in which the oscillation detecting phase exists, is disposed outside the laminated piezoelectric element 141 in relation to the elastic body 151 using the same kind of the laminated piezoelectric elements.

The method of producing the laminated piezoelectric elements 155 and 156 of the seventh embodiment will be described.

The n piezoelectric sheets (1)155a in which the internal electrode patterns are printed and the one piezoelectric sheet (2)155b in which the internal electrode pattern is printed are prepared before the burning. After the n piezoelectric sheets (1)155a are laminated, the one piezoelectric sheet (2)155b is laminated, and the piezoelectric sheet (3)155c in which the internal electrode is not printed is laminated on the piezoelectric sheets (2)155b.

Then the laminated piezoelectric sheets are pressed and cut into a predetermined size, and the burning is performed at a predetermined temperature. Then the external electrodes 143 are printed and baked in predetermined positions. Then the polarization is established to complete the laminated piezoelectric elements 155 and 156.

The section, which includes the polarization direction indicated along a line A1-A1′ of FIG. 34A and is orthogonal to the side surface, is similar to that of FIG. 23. Accordingly, because the internal electrodes 157 and 158 and the piezoelectric sheet 155 can be replaced by the internal electrode 86 and piezoelectric sheet 85 of FIG. 23, the description of the polarization is omitted.

An operation of the laminated piezoelectric element 141 will be described.

As described above, the resonance frequency in the second twisting oscillation mode is matched with the resonance frequency in the first longitudinal oscillation mode when the value a/b is close to 0.6, and the resonance frequency in the third twisting oscillation mode is matched with the resonance frequency in the first longitudinal oscillation mode when the value a/b is close to 0.3. Accordingly, in the seventh embodiment, because the first longitudinal resonance mode and the second twisting resonance mode are used, the dimensions of the laminated piezoelectric element 141 are set such that the value a/b becomes about 0.6.

As can be seen from the resonance oscillation of each mode illustrated in FIGS. 2A to 2E, the node portion of the first longitudinal oscillation mode is located in the substantially central region of the piezoelectric element, and the node portion of the second twisting oscillation mode is located in any region on the central axis (and the upper node position and the lower node position). Accordingly, the common node portion is located in the substantially central region on the central axis of the elastic body 151. When the shaft 15 is retained in the common node portion, the high-efficiency motor is obtained because the oscillation does not leak to the shaft 15.

The operation of the laminated piezoelectric element 141 of the seventh embodiment in which the upper interdigital electrode 157 of FIG. 34A is used will be described.

The operation of the laminated piezoelectric element 141 in which the driving interdigital electrode is used will be described.

The alternate voltage corresponding to the resonance frequency of the first longitudinal oscillation or second twisting oscillation is applied to the A phase (A-positive phase and A-negative phase) and B phase (B-positive phase and B-negative phase) of FIG. 33B.

In FIG. 34A, the force that is generated near the upper interdigital electrode by the inverse piezoelectric effect is indicated by a vector F20. The force F20 of FIG. 34A is an alternate force, and forces F21 and F22 are obtained by vector decomposition of the force F20. As is clear from FIG. 34A, a force F21 becomes an expansion and contraction force that excites the longitudinal oscillation. As is clear from FIG. 34B, a force F22 becomes a twisting force that generates the second twisting oscillation. The same holds true for the laminated piezoelectric elements. The laminated piezoelectric elements 141 are bonded to both the surfaces of the elastic body 151.

The description is made back in FIG. 33B.

When the alternate voltage is applied to the A phase of the first laminated piezoelectric element 155, for the reasons described above, the alternate force having the vector F20 of FIG. 33B is generated in the A phase of the first laminated piezoelectric element 155. Although not illustrated, similarly the alternate force having the vector F20 is generated in the B phase of the second laminated piezoelectric element 156 when the alternate voltage is applied to the B phase of the second laminated piezoelectric element 156 in the backside.

When the in-phase alternate voltages corresponding to the resonance frequency of the first longitudinal oscillation or second twisting oscillation of the laminated piezoelectric element 141 are applied to the A phase and B phase, the alternate forces having the vectors F20 are combined to cancel the twisting forces, and only the first longitudinal resonance oscillation is generated.

When the alternate voltages having the antiphase frequencies (phase difference of α) are simultaneously applied to the A phase and the B phase, the antiphase vectors F20 are generated in the first laminated piezoelectric element 155 and the second laminated piezoelectric element 156. Therefore, the expansion and contraction forces are cancelled, and the twisting forces are applied to generate only the second twisting resonance oscillation.

Then it is also assumed that the alternate voltages having the phase difference except for 0, π, and −π are simultaneously applied to the A phase and the B phase. In such cases, the first longitudinal oscillation and the second twisting oscillation are simultaneously generated to form the combined oscillation. As illustrated in FIG. 33B, the clockwise (CW direction) or counterclockwise (CCW direction) elliptic oscillation is generated in the positions of the friction contact members 142a and 142b of the laminated piezoelectric element 141 such that the rotor 16 is rotated.

When the elliptic oscillation is generated in the positions of the friction contact members 142a and 142b of the laminated piezoelectric element 141, the pressed rotor 16 is rotated clockwise (CW direction) or counterclockwise (CCW direction) according to the rotation direction of the elliptic oscillation.

Because the twisting direction becomes inverted for the remaining pair of lower interdigital electrodes 157, the direction of interdigital electrode is set so as to become an obtuse angle. Because the driving principle is similar to that of upper interdigital electrode 156, the description is omitted.

An oscillation detecting operation performed by the piezoelectric sheet (2)155b of FIG. 34A will be described.

When the first longitudinal oscillation or second twisting oscillation is generated, the charge is generated in the interdigital electrode surface by the piezoelectric effect. In FIG. 33B, the charge is observed as the voltage at the C phase (between C-positive phase and C-negative phase) or the voltage at the D phase (between D-positive phase and D-negative phase). Although the force is generated by the inverse piezoelectric effect in the operation of the driving interdigital electrode, the charge or voltage is generated by the mechanical strain in the operation of the oscillation detecting interdigital electrode.

In cases where only the first longitudinal oscillation is generated, the parallel forward connection is established between the C phase and D phase (the C-positive phase and the D-positive phase are connected, and the C-negative phase and the D-negative phase are connected: it is defined as the parallel forward connection phase), and the voltage generated between the C phase and D phase is obtained as a signal that is parallel to the magnitude and phase of the first longitudinal oscillation. On the other hand, in cases where the parallel inverse connection is established between the C phase and the D phase (the C-positive phase and the D-negative phase are connected, and the C-negative phase and the D-positive phase are connected: it is defined as the parallel inverse connection phase), the signal is not supplied.

In cases where only the second twisting oscillation is generated, the parallel inverse connection (the C-positive phase and the D-negative phase are connected, and the C-negative phase and the D-positive phase are connected) is established between the C phase and the D phase, and the voltage generated between the C phase and D phase is obtained as the signal that is parallel to the magnitude and phase of the second twisting oscillation. On the other hand, in cases where the parallel forward connection (the C-positive phase and the D-positive phase are connected, and the C-negative phase and the D-negative phase are connected) is established between the C phase and D phase, the signal is not supplied.

Therefore, the first longitudinal oscillation or the second twisting oscillation can independently be detected by selecting the connection between the C phase and D phase.

The method of driving the motor using the oscillation detecting phase (C phase and D phase) will be described.

It is known that the phase difference between the signal phase of the A phase or B phase that is the driving phase and the oscillation detecting phase (for example, the parallel inverse connection between the C phase and the D phase) has a predetermined value Q during the resonance frequency operation of the second twisting oscillation. Accordingly, when the frequency is adjusted to drive the motor such that the phase difference between the driving phase and the oscillation detecting phase always becomes the value Q, the oscillator can always be driven near the second twisting resonance frequency, that is, the motor can efficiently be driven at the optimum frequency, even if the temperature rise is generated by the heat generation of the motor or even if the change in resonance frequency is generated by the change in ambient temperature or the change in load. The motor can be driven in the similar way near the first longitudinal resonance frequency.

Thus, in the seventh embodiment, it is not necessary to provide the groove portion in part of the elastic body, and it is not necessary to make the hole in the piezoelectric element. Therefore, the configuration becomes simplified, and not only can the production easily be performed but also stable motor characteristics are obtained.

Further, in the seventh embodiment, the piezoelectric element has the laminated structure, so that the ultrasonic motor can be driven at a low voltage. The oscillation detecting phase is also provided, so that the ultrasonic motor can always be driven at the optimum frequency using the signal of the oscillation detecting phase.

(First Modification of Seventh Embodiment)

An ultrasonic motor according to a first modification of the seventh embodiment will be described below.

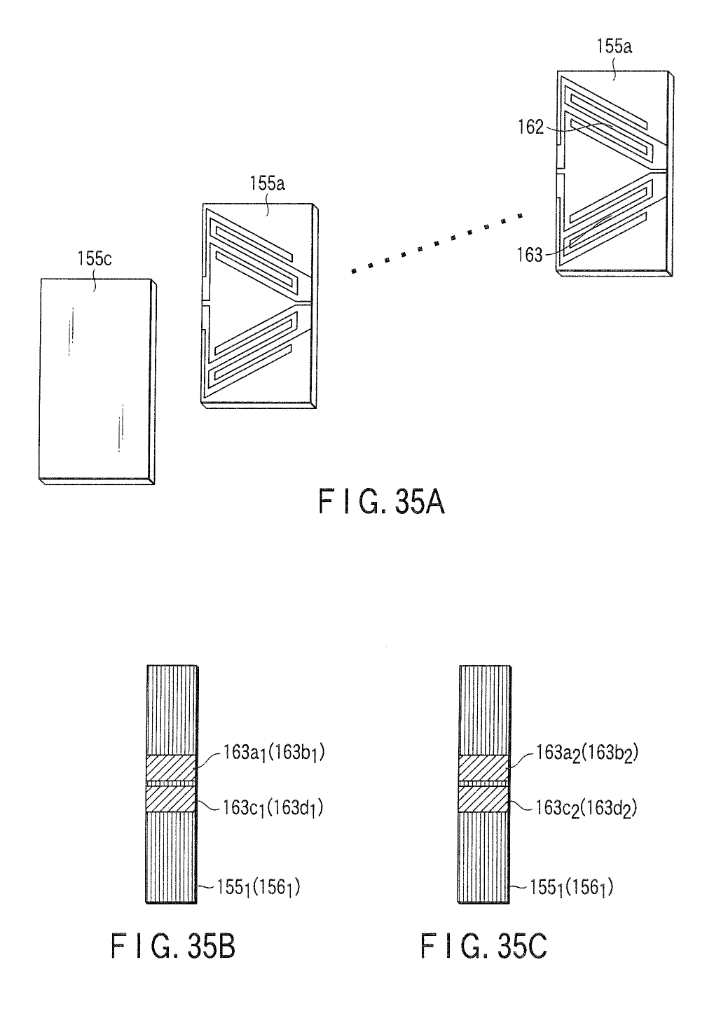

FIGS. 35A to 35C illustrate a configuration of a laminated piezoelectric element of the first modification of the seventh embodiment, wherein FIG. 35A is an exploded perspective view of the laminated piezoelectric element, FIG. 35B illustrates the laminated piezoelectric element of FIG. 35A as viewed from the left, and FIG. 35C illustrates the laminated piezoelectric element of FIG. 35A as viewed from the right.

The following modifications of the seventh embodiment differ from the seventh embodiment only in the configuration of the laminated piezoelectric element. Accordingly, only the configuration of the laminated piezoelectric element will be described below. In the following modifications of the seventh embodiment, because other basic configurations and operations of the ultrasonic motor are similar to those of the seventh embodiment, the same component is designated by the same reference numeral in order to avoid the overlapping description, and the illustration and detailed description are omitted.

Referring to FIG. 35A, the internal electrode of the piezoelectric sheet (1)155a is identical to that of the seventh embodiment. However, the first modification of the seventh embodiment differs from the seventh embodiment in the position where the end portion of the upper interdigital electrode 162 is led out and the position where the end portion of the upper interdigital electrode 163 is led out.

In the first modification of the seventh embodiment, after the n piezoelectric sheets are laminated, the piezoelectric sheet (3)155c in which the internal electrode is not provided is finally laminated to form a laminated piezoelectric element 1551.

Referring to FIG. 35B, in the right side surface of the laminated piezoelectric element 1551, an external electrode 163a₁ (163b₁) for the A-positive (B-positive) phase that is the driving phase is provided in the upper portion, and an external electrode 163c₁ (163d₁) for the C-positive (D-positive) phase that is the oscillation detecting phase is provided in the lower portion. Similarly, as illustrated in FIG. 35C, in the left side surface of the laminated piezoelectric element 1551, an external electrode 163a₂ (163b₂) for the A-negative (B-negative) phase that is the driving phase is provided in the upper portion, and an external electrode 163c₂ (163d₂) for the C-negative (D-negative) phase that is the oscillation detecting phase is provided in the lower portion.

Because the entire configuration and driving method of the laminated piezoelectric element 1551 are similar to those of the seventh embodiment, the description is omitted.

Thus, in the first modification of the seventh embodiment, all the signals of the lower interdigital electrodes are used as the oscillation detecting signal, so that the large oscillation detecting signal can be obtained.

(Second Modification of Seventh Embodiment)

An ultrasonic motor according to a second modification of the seventh embodiment will be described below.

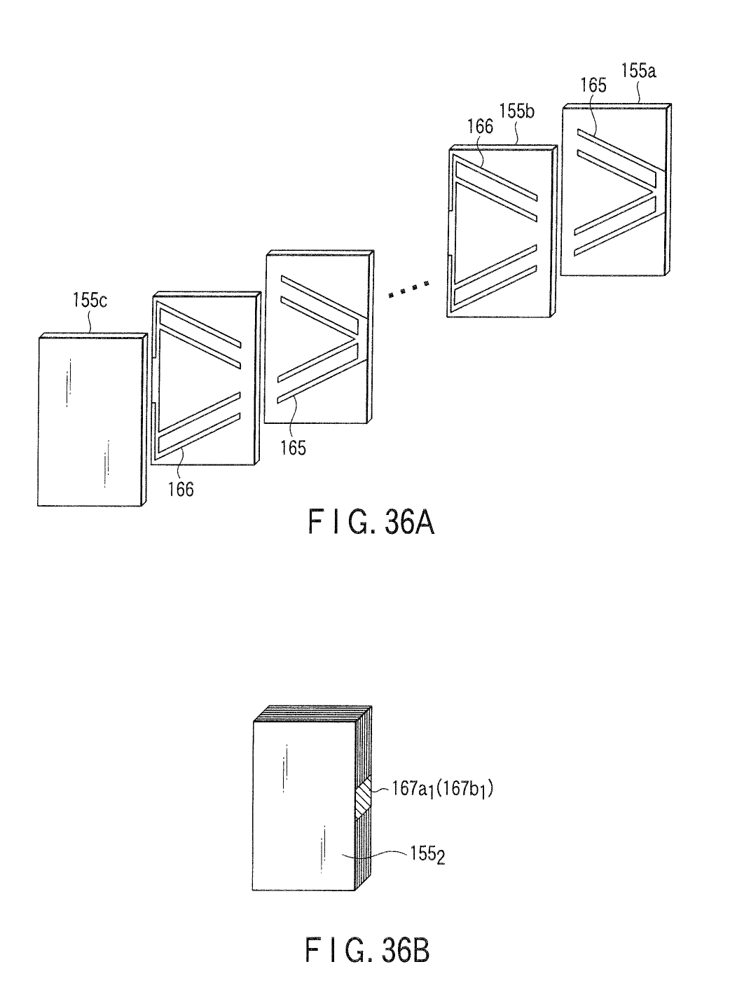

FIGS. 36A and 36B illustrate a configuration of a laminated piezoelectric element of the second modification of the seventh embodiment, wherein FIG. 36A is an exploded perspective view of the laminated piezoelectric element, and FIG. 36B illustrates an external electrode of the laminated piezoelectric element of FIG. 36A.

In the second modification of the seventh embodiment, for example, one side (right-digit interdigital electrode) of an interdigital electrode 165 for the A-positive (B-positive) phase is printed in the piezoelectric sheet (1)155a, and the other side (left-digit interdigital electrode) of an interdigital electrode 166 for the A-negative (B-negative) phase is printed in the piezoelectric sheet (2)155b. The interdigital electrode 166 is disposed while the height direction (c direction of FIG. 33B) is shifted such that the digital portion of the interdigital electrode 166 is located between the digital portions of the interdigital electrode 165.

The piezoelectric sheets (1)155a and the piezoelectric sheets (2)155b are alternately laminated, and the piezoelectric sheet (3)155c in which the electrode is not printed is finally laminated.

As illustrated in FIG. 36B, only the external electrode for the A phase (B phase) that is the driving phase is provided in the second modification of the seventh embodiment. Although only the A-positive phase (B-positive phase) external electrode 157a₁ (157b₁) is illustrated in FIG. 36B, the A-negative phase (B-negative phase) external electrode 157a₂ (157b₂) is also provided.

In the second modification of the seventh embodiment, the polarization state is similar to that of FIG. 27. Accordingly, because the internal electrodes 165 and 166 and the piezoelectric sheet 155 can be replaced by the internal electrodes 100a₁ and 100a₂ and piezoelectric sheet 85 of FIG. 23, the description of the polarization is omitted.

Because the positive internal electrodes (A-positive phase (B-positive phase)) and the negative internal electrodes (A-negative phase (B-negative phase)) are alternately laminated, the polarization direction has a slight angle ξ as illustrated FIG. 27. That is, the pair of piezoelectric sheet (1)155a and piezoelectric sheet (2)155b acts as the interdigital electrode.

In the first embodiment in which the positive electrode and the negative electrode exist in the surface, a discharge phenomenon is possibly generated during the polarization when the electrode is projected. On the other hand, discharge phenomenon can be prevented in the second modification of the seventh embodiment.

(Third Modification of Seventh Embodiment)

An ultrasonic motor according to a third modification of the seventh embodiment will be described below.

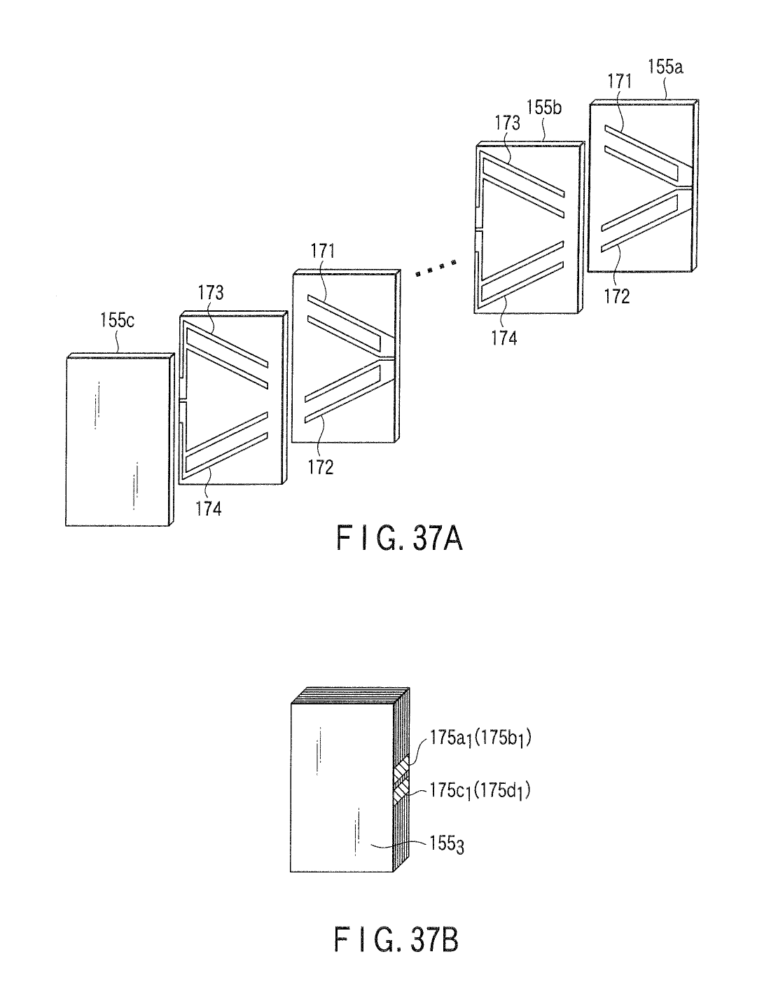

FIGS. 37A and 37B illustrate a configuration of a laminated piezoelectric element of the third modification of the seventh embodiment, wherein FIG. 37A is an exploded perspective view of the laminated piezoelectric element, and FIG. 37B illustrates an external electrode of the laminated piezoelectric element of FIG. 37A.

The third modification of the seventh embodiment differs from the second modification of the seventh embodiment in that upper interdigital electrodes 171 and 173 act as the driving electrode while lower interdigital electrodes 172 and 174 act as the oscillation detecting electrode. The upper interdigital electrodes 171 and 173 include driving external electrodes 175a₁ and 175b₁, and the lower interdigital electrodes 172 and 174 include detecting external electrode 175c1 and 175d₁.

In the third modification of the seventh embodiment, the oscillation detecting phase can be added compared with the second modification of the seventh embodiment.

(Fourth Modification of Seventh Embodiment)

An ultrasonic motor according to a fourth modification of the seventh embodiment will be described below.

In the fourth modification of the seventh embodiment, the first longitudinal oscillation mode and third twisting oscillation mode of the oscillator are simultaneously excited to obtain the elliptic oscillation.

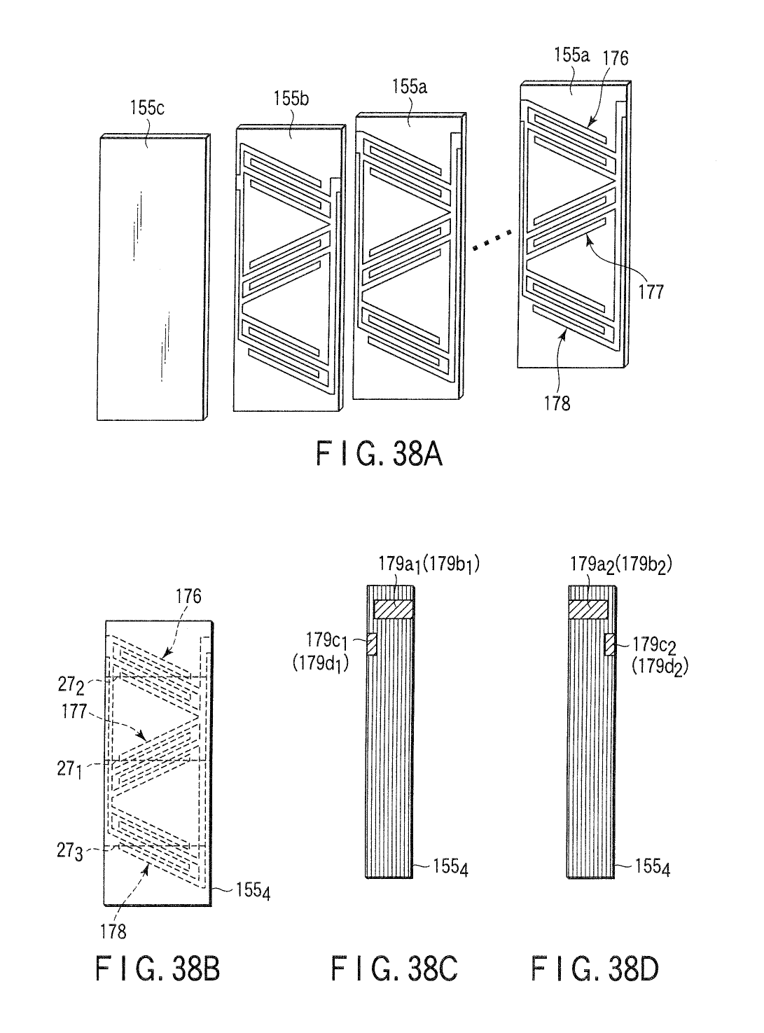

FIGS. 38A to 38D illustrate a configuration of a laminated piezoelectric element of the fourth modification of the seventh embodiment, wherein FIG. 38A illustrate examples of a piezoelectric sheet and an internal electrode pattern, FIG. 38B is a perspective view of the laminated piezoelectric element as viewed from a direction of the piezoelectric sheet of FIG. 38A, FIG. 38C illustrates the laminated piezoelectric element as viewed from a direction of a right side surface, and FIG. 38D illustrates the laminated piezoelectric element as viewed from a direction of a left side surface.

Three interdigital electrodes 176, 177, and 178 are provided in the piezoelectric sheet (1)155a. After n piezoelectric sheets (1)155a are laminated, the one piezoelectric sheet (2)155b is laminated, and the piezoelectric sheet (3)155c is finally laminated to form a laminated piezoelectric element 1554. The piezoelectric sheet (2)155b has the same internal electrode pattern as the piezoelectric sheets (1)155a and the different end-portion leading out position. The internal electrode is not printed in the piezoelectric sheet (3)155c. At this point, the internal electrode pattern of the piezoelectric sheet (1)155a is used as the driving electrode, and the internal electrode pattern of the piezoelectric sheet (2)155b is used as the oscillation detecting electrode.

The three points of the interdigital electrodes 156, 157, and 158 will be described with reference to FIG. 38B.

The upper interdigital electrode 176 is located at the position corresponding to the upper node position 27₂ in the third twisting oscillation mode. The central interdigital electrode 177 is located at the position corresponding to the node position in the first longitudinal oscillation mode and the central node position 27₁ in the third twisting oscillation mode. The lower interdigital electrode 178 is located at the position in the position corresponding to the lower node position 27₃ in the third twisting oscillation mode.

As to the external electrode, an external electrode 179a₁ (179b₁) for the A-positive phase (B-positive phase) and an external electrode 179a₂ (179b₂) for the A-negative phase (B-negative phase) are provided in a portion in which the piezoelectric sheets (1)155a are laminated and at the end-portion leading out position. An external electrode 179c₁ (179d₁) for the C-positive phase (D-positive phase) and an external electrode 179c₂ (179d₂) for the C-negative phase (D-negative phase) are provided at the end-portion leading out position of the piezoelectric sheet (2)155b.

That is, as illustrated in FIGS. 38C and 38D, the detecting external electrodes 179c₁(179d₁) and 179c₂ (179d₂) are provided below the driving external electrodes 179a₁ (179b₁) and 179a₂ (179b₂).

In cases where the oscillator is formed using the laminated piezoelectric element 1554 of the fourth modification of the seventh embodiment, it is necessary that a ratio of the short side a of the laminated piezoelectric element to the long side b be set to about 0.3. Specifically, the dimensions of the oscillator are set to a=3 mm, b=10 mm, c=20 mm.

Thus, in the fourth modification of the seventh embodiment, the common node portion (central portion) in the first longitudinal oscillation mode and the third twisting oscillation mode exists in the oscillator, so that the oscillator can be retained at that position.

(Fifth Modification of Seventh Embodiment)

An ultrasonic motor according to a fifth modification of the seventh embodiment will be described below.

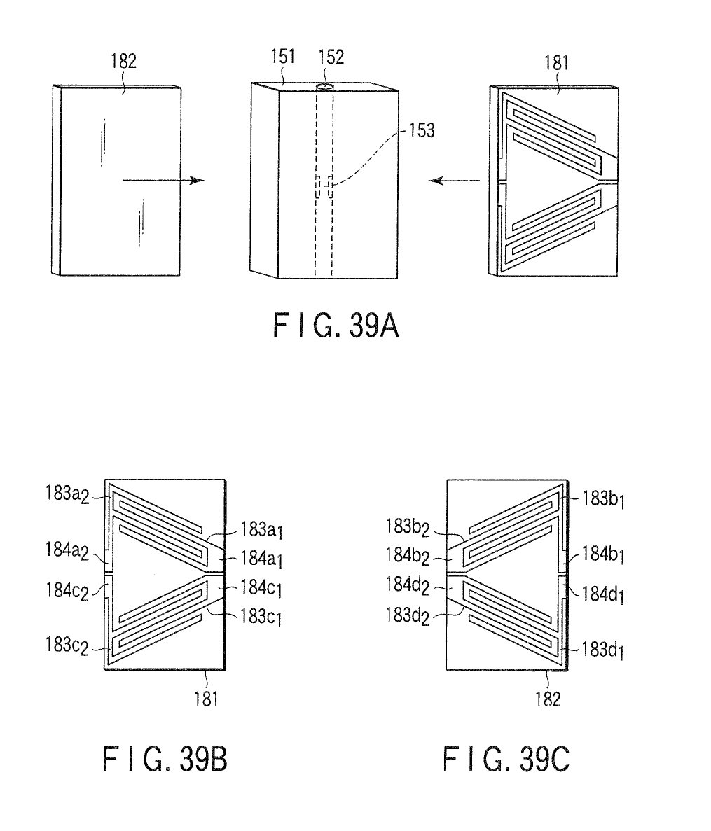

FIGS. 39A to 39C illustrate a configuration of an oscillator of the fifth modification of the seventh embodiment, wherein FIG. 39A is an exploded perspective view of the oscillator, FIG. 39B illustrates an electrode pattern of a first piezoelectric element of FIG. 39A, and illustrates an electrode pattern of a second piezoelectric element of FIG. 39A.

In the seventh embodiment and the first to fourth modifications of the seventh embodiment, the laminated piezoelectric element is used as the piezoelectric element. However, in the fifth modification of the seventh embodiment, a single-plate piezoelectric element is used as the piezoelectric element.

A first piezoelectric element 181 and a second piezoelectric element 182 are bonded and fixed to both side surfaces of the elastic body 151. Electrode patterns of the interdigital electrodes are printed in the first piezoelectric element 181 and the second piezoelectric element 182. An electrode pattern of the piezoelectric element is similar to that of the first modification of the seventh embodiment. An A-positive-phase lead-out portion 184a₁ and an A-negative-phase lead-out portion 184a₂ are provided in interdigital electrodes 183a₁ and 183a₂ on the side of the first piezoelectric element 181. The A-positive-phase lead-out portion 184a₁ and the A-negative-phase lead-out portion 184a₂ are used as the driving electrode. A C-positive-phase lead-out portion 184c₁ and a C-negative-phase lead-out portion 184c₂ are provided in the interdigital electrodes 183a₁ and 183a₂, and the C-positive-phase lead-out portion 184c₁ and the C-negative-phase lead-out portion 184c₂ are used as the detecting electrode. Similarly a B-positive-phase lead-out portion 184b₁ and a B-negative-phase lead-out portion 184b₂ are provided in interdigital electrodes 183b₁ and 183b₂ on the side of the second piezoelectric element 182. The B-positive-phase lead-out portion 184b₁ and the B-negative-phase lead-out portion 184b₂ are used as the driving electrode. A D-positive-phase lead-out portion 184d₁ and a D-negative-phase lead-out portion 184d₂ are provided in the interdigital electrodes 184b₁ and 184b₂, and the D-positive-phase lead-out portion 184d₁ and the D-negative-phase lead-out portion 184d₂ are used as the detecting electrode.

In the fifth modification of the invention, although the driving voltage is not lowered, the motor can include the simple piezoelectric element.

Although not illustrated, all the external electrodes of the laminated piezoelectric element used in the seventh embodiment may be provided in one side surface in another modification. In such cases, external wiring is easily performed using a flexible board.

### Eighth Embodiment

An ultrasonic motor according to an eighth embodiment of the invention will be described below.

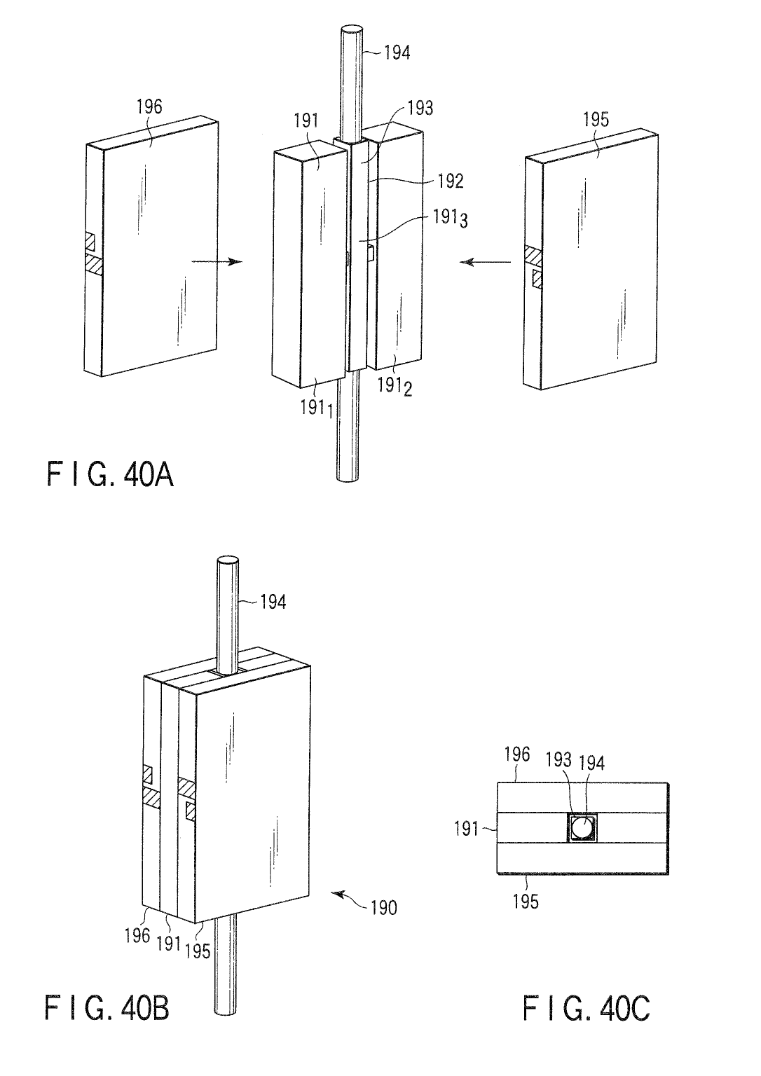

FIGS. 40A to 40C illustrate a configuration of an oscillator in an ultrasonic motor according to the eighth embodiment of the invention, wherein FIG. 40A is an exploded perspective view of the oscillator. FIG. 40B is a perspective view illustrating a state in which the oscillator of FIG. 40A is assembled, and FIG. 40C illustrates the oscillator of FIG. 40A as viewed from above.

The eighth embodiment differs from the seventh embodiment only in the configurations of the elastic body and shaft. Accordingly, only the configurations of the elastic body and shaft will be described below. In the eighth embodiment, because other basic configurations and operations of the ultrasonic motor are similar to those of the seventh embodiment, the same component is designated by the same reference numeral in order to avoid the overlapping description, and the illustration and detailed description are omitted.

As illustrated in FIG. 40, in a rectangular-solid elastic body 191 made of stainless steel or brass, groove portions 192 are vertically provided at two points from the upper and lower surfaces to the neighborhood of the central portion. A first main body 191₁ and a second main body 191₂, which are cut by the groove portions 192, are integral with a junction portion 191₃ of the central portion. A square shaft 193 is integral with the junction portion 191₃, and is extended along the groove portions 192. A round shaft 194 is continuously integral with the square shaft 193 in the axial direction of the square shaft 193. That is, all the first main body 191₁, second main body 191₂, junction portion 191₃, square shaft 193, and round shaft 194 of the elastic body 191 are integrally formed.

As with the seventh embodiment, a first laminated piezoelectric element 195 and a second laminated piezoelectric element 196 are bonded to surfaces of the elastic body 191 using the bonding agent.

In the square shaft 193, surfaces facing the first laminated piezoelectric element 195 and second laminated piezoelectric element 196 have gaps with surfaces of the first laminated piezoelectric element 195 and second laminated piezoelectric element 196. Accordingly, as illustrated in FIG. 40C, the square shaft 193 does not come into contact with the laminated piezoelectric elements 195 and 196.

A thread portion (not illustrated) is provided in part of the round shaft 194.

In the eighth embodiment, the round shaft 194 is integral with the square shaft 193. Alternatively, the round shaft 194 and the square shaft 193 may be coupled with a thread and the like.

In the eighth embodiment, the following effect can be obtained.

In cases where the oscillator is miniaturized, it is difficult that the throughhole is made in the elastic body to provide the internal thread in the central portion unlike the seventh embodiment. In such cases, the shaft is previously integral with the elastic body to solve the trouble like the eighth embodiment. The junction portion is formed as small as possible, which suppresses the vibration of the shaft to the minimum.

(First Modification of Eighth Embodiment)

An ultrasonic motor according to a first modification of the eighth embodiment will be described below.

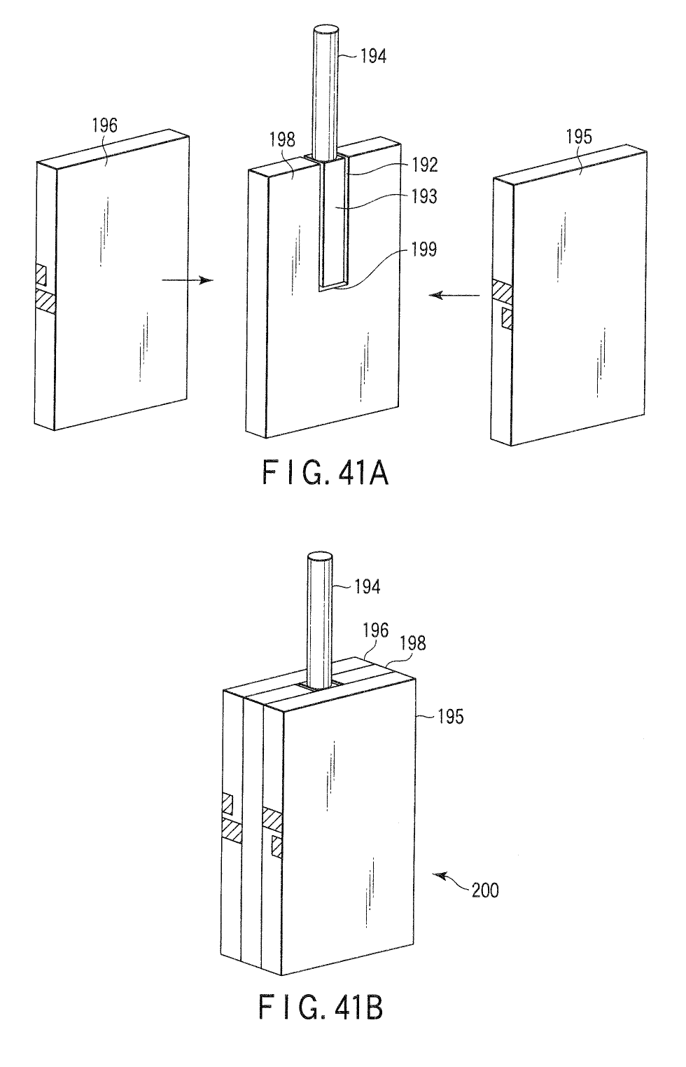

FIGS. 41A and 41B illustrate a configuration of an oscillator in an ultrasonic motor of the first modification of the eighth embodiment, wherein FIG. 41A is an exploded perspective view of the oscillator, and FIG. 41B is a perspective view illustrating a state in which the oscillator of FIG. 41A is assembled.

As illustrated in FIGS. 41A and 41B, the first modification of the eighth embodiment differs from eighth embodiment in the following points. That is, the two groove portions 192 are provided only in an upper half of an elastic body 198, and the continuously-formed round shaft 194 and square shaft 193 are integral with the elastic body 198 in a junction portion 199.

Therefore, compared with the seventh embodiment, an elastic-body machining region can be reduced to obtain the simpler elastic body and oscillator.

In the embodiments, the interdigital electrode is provided in the side surface of the piezoelectric element. The invention is not limited to the embodiments.

In the eighth embodiment, although the dimensions of the sides a×b×c (length in the center axial direction) are cited only by way of example, the dimensions can appropriately be changed according to the application devices and intended end-usage of the ultrasonic motor. For example, as illustrated in FIG. 3, a predetermined ratio (in FIG. 3, a rectangular ratio corresponding to an intersection) at which the resonance frequency of the first longitudinal resonance oscillation is matched with the resonance frequency of the second twisting (or third twisting) resonance oscillation to exert the same value is most suitable to the rectangular ratio a/b of the ultrasonic motor after the production is completed. The range (for example, within ±0.02) close to the predetermined ratio can also be used as the rectangular ratio a/b at which the resonance frequency of the first longitudinal resonance oscillation is substantially matched with the resonance frequency of the second twisting (or third twisting) resonance oscillation. When the rectangular ratio falls within the effective range (for example, within ±0.05), the above described effect of the invention can be obtained. Herein, the value c which is length the oscillator along the central axis, can be optional so that obtains a desired power or size according with a device to be applied.

### Ninth Embodiment

An ultrasonic motor according to a ninth embodiment of the invention will be described below.

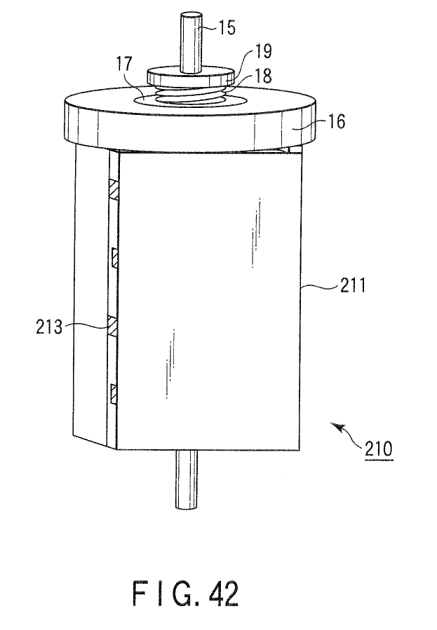

The ultrasonic motor of the ninth embodiment will be described below with reference to FIGS. 42 to 44.

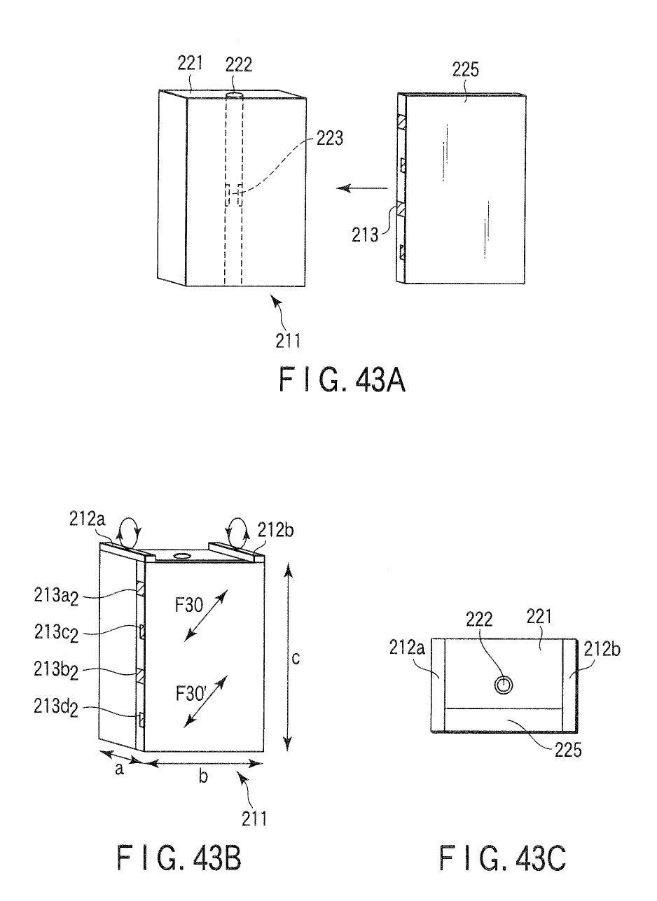

FIG. 42 is an appearance perspective view illustrating the ultrasonic motor of the ninth embodiment. FIGS. 43A to 43C illustrates an oscillator of FIG. 42, wherein FIG. 43A is an exploded perspective view of the oscillator, FIG. 43B is an appearance perspective view of the oscillator, and FIG. 43C is a top view of the oscillator.

An ultrasonic motor 210 includes an oscillator 211, friction contact members 212a and 212b, an external electrode 213, the shaft 15, the rotor 16, the bearing 17, the spring 18, and the spring retaining ring 19.

The friction contact members 212a and 212b are bonded to the surface orthogonal to the longitudinal direction of the oscillator 211 so as to be in contact with the rotor 16. The friction contact members 212a and 212b are made of a ceramic material such as alumina and zirconia or an engineering plastic material such as PPS and PEEK. As illustrated in FIG. 43B, the clockwise (CW direction) or counterclockwise (CCW direction) elliptic oscillation is generated in the positions of the friction contact members 212a and 212b. However, it is not always necessary to provide the friction contact members 212a and 212b.

As to the external electrode 213, an A-negative phase external electrode 213a₂, a C-negative phase external electrode 213c₂, a B-negative phase external electrode 213b₂, and D-negative phase external electrode 213d₂ are provided in a side surface of a laminated piezoelectric element 225 (described in detail later) constituting the oscillator 211. Although not illustrated, A-positive phase, C-positive phase, B-positive phase, and D-positive phase external electrodes are provided in the opposite side surface of the laminated piezoelectric element 225.

The rotor 16 is rotated while pressed against the top surface of the oscillator 211 having the prismatic shape. The longitudinal direction of the axis of the shaft 15 is defined as a center axial direction.

In the oscillator 211 having the rectangular-solid shape, a laminated piezoelectric element 221 is bonded to one of side surfaces of an elastic body 225 made of a metallic material such as stainless steel and brass using the bonding agent. As illustrated in FIG. 43B, in bonding the laminated piezoelectric element 225 to the side surface of the elastic body 221 to form the oscillator 211, a throughhole 222 is made in the central portion of the elastic body 221 in order to insert the shaft 15 therein. That is, the throughhole 222 is made eccentrically to the central portion of the elastic body 221.

An internal thread 223 is provided in the central portion in the axial direction of the throughhole 222 in order to retain the shaft 15, and an external thread (not illustrated) in the central portion of the shaft 15 is engaged with and bonded to the internal thread 223. The internal thread 223 is geometrically substantially matched with the node portion of the first longitudinal oscillation and the node portion of the second twisting oscillation of the oscillator 211.

The dimensions of the laminated piezoelectric element 211 are set to a=6 mm, b=10 mm, and c=20 mm. The thicknesses of the friction contact members 212a and 212b range from about 0.1 mm to about 1 mm.

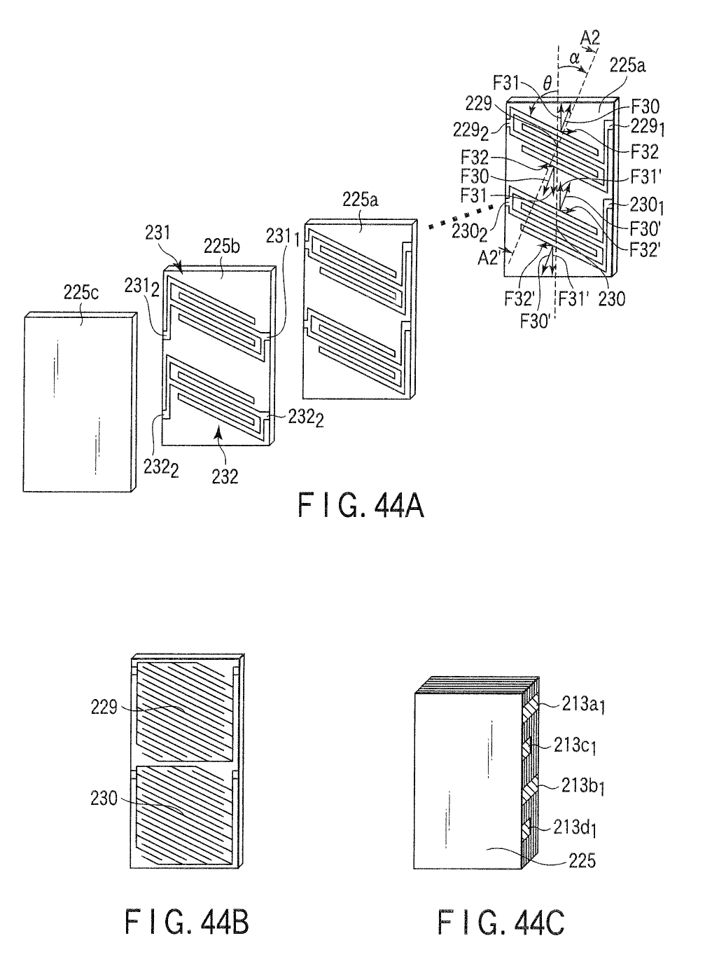

A configuration of the laminated piezoelectric element of the ninth embodiment will be described with reference to FIGS. 44A to 44C.

FIG. 44A illustrates examples of the piezoelectric sheet and internal electrode pattern.

In the laminated piezoelectric element 225, the thin piezoelectric sheets are laminated, and a predetermined internal electrode pattern is formed in the piezoelectric sheet. The piezoelectric sheet is made of a PZT material whose thickness ranges from about 10 μm to about 100 μm, an internal electrode pattern is printed in a piezoelectric sheet 1 (hereinafter referred to as piezoelectric sheet (1)) 225a, and an internal electrode pattern 2 is printed in a piezoelectric sheet 2 (hereinafter referred to as piezoelectric sheet (2)) 225b.

The internal electrode is made of a silver-palladium alloy, and has the thickness of several micrometers. As illustrated in FIG. 44A, interdigital electrodes (first interdigital electrode (internal electrode) 229 and a second interdigital electrode (internal electrode) 230) are printed at two points in the piezoelectric sheet (1)225a. A width of the interdigital internal electrode is set in a range of about 0.1 mm to about 1 mm, and an insulating width between the interdigital internal electrodes is set in a range of about 0.1 mm to about 1 mm. Parts of the first interdigital electrode 229 and second interdigital electrode 230 are led out to the end portion of the piezoelectric sheet in order to electrically connect the first interdigital electrode 229 and second interdigital electrode 230 to the external electrodes 213a₁, 213a₂, 213b₁, and 213b₂, thereby providing electrode lead-out portions 229₁, 229₂, 230₁ and 230₂.

For the sake of convenience, the two pairs of interdigital electrodes are illustrated in FIG. 44A. However, in order that the interdigital electrode occupies as large an area as possible in the side surface, actually the number of pairs of interdigital electrodes may be increased such that the interdigital electrode is formed over the side surface as illustrated in FIG. 44B.

Referring to FIG. 44A, the angle θ formed between the center axial direction (indicated by the broken line) of the interdigital electrode and the digital direction of the interdigital electrode is set in a range of 0<θ<π/2 in the first interdigital electrode 229. Because the polarization direction α (indicated by the broken line) is orthogonal to the digital direction of the interdigital electrode, the polarization direction α is expressed as follows:

α=π/2−θ

0<α<π/2

The angles α and θ are inversely measured as illustrated in FIG. 44A.

As illustrated in FIG. 44A, similarly the angle θ is formed between the center axial direction and the second interdigital electrode 230. The n piezoelectric sheets (1)225a are laminated, and then the piezoelectric sheet (2)225b is laminated. Although the electrode pattern of the piezoelectric sheet (2)225b is basically identical to that of the piezoelectric sheet (1)225b, the electrode pattern of the piezoelectric sheet (2)225b differs from that of the piezoelectric sheet (1)225b in that third and fourth interdigital electrodes 231 and 232 are provided. The third interdigital electrode 231 differs from the fourth interdigital electrode 232 in the position of the electrode extended to the end portion. The third interdigital electrode 231 and the fourth interdigital electrode 232 are used as the oscillation detecting electrode. Parts of the third interdigital electrode 231 and fourth interdigital electrode 232 are led out to the end portion of the piezoelectric sheet in order to electrically connect the third interdigital electrode 231 and fourth interdigital electrode 232 to the external electrodes 213c₁, 213c₂, 213d₁, and 213d₂, thereby providing electrode lead-out portions 231₁, 231₂, 232₁, and 232₂.

Finally the piezoelectric sheet 3 (hereinafter referred to as piezoelectric sheet (3)) 255c in which the electrode is not printed is laminated.

When the oscillator 211 is formed, the second twisting oscillation and first longitudinal oscillation that are generated in the oscillator 211 are utilized in the ninth embodiment. The central portion of the upper first interdigital electrode 229 is provided near the upper node position of the second twisting oscillation, and the central portion of the lower second interdigital electrode 230 is provided near the lower node position of the second twisting oscillation.

FIG. 44C illustrates an external electrode after the laminated piezoelectric element of FIG. 44A is laminated.

Referring to FIG. 44C, the external electrodes 213a₁ and 213b₁ for the A-positive phase and B-positive phase and the external electrodes 213c₁ and 213d₁ for the C-positive phase and D-positive phase are provided in the right side surface. The external electrodes 213a₁ and 213b₁ are electrically connected to the internal electrodes of the n piezoelectric sheets (1)225a. The external electrodes 213c₁ and 213d₁ are electrically connected to the internal electrode of the one piezoelectric sheet (2)225b. Although not illustrated, external electrodes 213a₂ and 213b₂ for the A-negative phase and B-negative phase and external electrodes 213c₂ and 213d₂ for the C-negative phase and D-negative phase are provided in the left side surface.

The laminated piezoelectric element 225 is bonded to the elastic body 221.

The method of producing the laminated piezoelectric element 255 of the ninth embodiment will be described.

The n piezoelectric sheets (1)225a in which the internal electrode patterns are printed and the one piezoelectric sheet (2)225b in which the internal electrode pattern is printed are prepared before the burning. After the n piezoelectric sheets (1)225a are laminated, the one piezoelectric sheet (2)225b is laminated, and the piezoelectric sheet (3)225c in which the internal electrode is not printed is laminated on the piezoelectric sheet (2)225b.

Then the laminated piezoelectric sheets are pressed and cut into a predetermined size, and the burning is performed at a predetermined temperature. Then external electrodes 213 are printed and baked in predetermined positions. Then the polarization is established to complete the laminated piezoelectric element 255.

The section, which includes the polarization direction indicated along a line A2-A2′ of FIG. 44A and is orthogonal to the side surface, is similar to that of FIG. 23. Accordingly, because the internal electrodes 229 and 230 and the piezoelectric sheet 225 can be replaced by the internal electrode 86 and piezoelectric sheet 85 of FIG. 23, the description of the polarization is omitted.

The operation of the oscillator 211 will be described.

As is clear from FIG. 3, the resonance frequency in the second twisting oscillation mode is matched with the resonance frequency in the first longitudinal oscillation mode when the value a/b is close to 0.6, and the resonance frequency in the third twisting oscillation mode is matched with the resonance frequency in the first longitudinal oscillation mode when the value a/b is close to 0.3. Accordingly, in the ninth embodiment, because the first longitudinal resonance mode and the second twisting resonance mode are used, the dimensions of the oscillator 211 are set such that the value a/b becomes about 0.6. Specifically, as described above, the dimensions of the oscillator 211 are set to a=6 mm, b=10 mm, and c=20 mm.

The operation of the oscillator 211 of the ninth embodiment in which the first interdigital electrode 229 of FIG. 44A is used will be described.

The operation of the oscillator 211 in which the driving interdigital electrode (the first interdigital electrode 229 and second interdigital electrode 230 of the piezoelectric sheet (1)225a) is used will be described.

The alternate voltage corresponding to the resonance frequency of the first longitudinal oscillation or second twisting oscillation is applied to the A phase (A-positive phase and A-negative phase) and B phase (B-positive phase and B-negative phase) of FIGS. 43B and 44B.

In FIG. 44A, the forces that are generated near the first interdigital electrode 229 and second interdigital electrode 230 by the inverse piezoelectric effect are indicated by vectors F30 and F30′. The forces F30 and F30′ of FIG. 44A are the alternate force, and forces F31 and F32 and forces F31′ and F32′ are obtained by the vector decomposition of the forces F30 and F30′. As is clear from FIG. 44A, the forces F31 and F31′ become the expansion and contraction forced that excite the first longitudinal oscillation. As is clear from FIG. 44A, the forces F32 and F32′ become twisting forces that generate the second twisting oscillation. The same holds true for the laminated piezoelectric elements. The laminated piezoelectric elements 225 are bonded to one side surface of the elastic body 212.

The description is made back in FIG. 43B.

When the alternate voltage is applied to the A phase of the laminated piezoelectric element 255, for the reasons described above, the alternate force having the vector F30 of FIG. 43B is generated in the A phase of the laminated piezoelectric element 255. Although not illustrated, similarly the alternate force having the vector F30′ is generated in the B phase when the alternate voltage is applied to the B phase.

When the in-phase alternate voltages corresponding to the resonance frequency of the first longitudinal oscillation or second twisting oscillation of the oscillator 211 are applied to the A phase and B phase, the alternate forces having the vectors F30 and F30′ are combined to cancel the twisting forces, and only the first longitudinal resonance oscillation is generated.

When the alternate voltages having the antiphase frequencies (phase difference of π) are simultaneously applied to the A phase and the B phase, because the antiphase vectors F30 and F30′ are generated, the expansion and contraction forces are cancelled, and the second twisting force acts to generate only the second twisting resonance oscillation.

Then it is also assumed that the alternate voltages having the phase difference except for 0 and π are simultaneously applied to the A phase and the B phase. In such cases, the first longitudinal oscillation and the second twisting oscillation are simultaneously generated to form the combined oscillation. As illustrated in FIG. 43B, the clockwise (CW direction) or counterclockwise (CCW direction) elliptic oscillation is generated in the positions of the friction contact members 212a and 212b of the oscillator 211 such that the rotor 16 is rotated.

When the elliptic oscillation is generated in the positions of the friction contact members 212a and 212b of the oscillator 211, the pressed rotor 16 is rotated clockwise (CW direction) or counterclockwise (CCW direction) according to the rotation direction of the elliptic oscillation.

An oscillation detecting operation performed by the third interdigital electrode 231 and fourth interdigital electrode 232 of the piezoelectric sheet (2)255b of FIG. 44A will be described.

When the first longitudinal oscillation or second twisting oscillation is generated, the charge is generated in the interdigital electrode surface by the piezoelectric effect. In FIG. 43B, the charge is observed as the voltage at the C phase (between C-positive phase and C-negative phase) or the voltage at the D phase (between D-positive phase and D-negative phase). Although the force is generated by the inverse piezoelectric effect in the operation of the driving interdigital electrode, the charge or voltage is generated by the mechanical strain in the operation of the oscillation detecting interdigital electrode.

In cases where only the first longitudinal oscillation is generated, the parallel forward connection is established between the C phase and D phase (the C-positive phase and the D-positive phase are connected, and the C-negative phase and the D-negative phase are connected: it is defined as the parallel forward connection phase), and the voltage generated between the C phase and D phase is obtained as a signal that is parallel to the magnitude and phase of the first longitudinal oscillation. On the other hand, in cases where the parallel inverse connection is established between the C phase and the D phase (the C-positive phase and the D-negative phase are connected, and the C-negative phase and the D-positive phase are connected: it is defined as the parallel inverse connection phase), the signal is not supplied.

In cases where only the second twisting oscillation is generated, the parallel inverse connection (the C-positive phase and the D-negative phase are connected, and the C-negative phase and the D-positive phase are connected) is established between the C phase and the D phase, and the voltage generated between the C phase and D phase is obtained as the signal that is parallel to the magnitude and phase of the second twisting oscillation. On the other hand, in cases where the parallel forward connection (the C-positive phase and the D-positive phase are connected, and the C-negative phase and the D-negative phase are connected) is established between the C phase and D phase, the signal is not supplied.

Therefore, the first longitudinal oscillation or the second twisting oscillation can independently be detected by selecting the connection between the C phase and D phase.

The method of driving the motor using the oscillation detecting phase (C phase and D phase) will be described.

It is known that the phase difference between the signal phase of the A phase or B phase that is the driving phase and the oscillation detecting phase (for example, the parallel inverse connection between the C phase and the D phase) has a predetermined value Q during the resonance frequency operation of the second twisting oscillation. Accordingly, when the frequency is adjusted to drive the motor such that the phase difference between the driving phase and the oscillation detecting phase always becomes the value Ω, the oscillator can always be driven near the second twisting resonance frequency, that is, the motor can efficiently be driven at the optimum frequency, even if the temperature rise is generated by the heat generation of the motor or even if the change in resonance frequency is generated by the change in ambient temperature or the change in load. The motor can be driven in the similar way near the first longitudinal resonance frequency.

In the ninth embodiment, it is not necessary to provide the groove portion in part of the elastic body, and it is not necessary to make the hole in the piezoelectric element. Therefore, the configuration becomes simplified, and not only can the production easily be performed but also stable motor characteristics are obtained.

Further, in the ninth embodiment, the piezoelectric element has the laminated structure, so that the ultrasonic motor can be driven at a low voltage. The oscillation detecting phase is also provided, so that the ultrasonic motor can always be driven at the optimum frequency using the signal of the oscillation detecting phase.

(First Modification of Ninth Embodiment)

An ultrasonic motor according to a first modification of the ninth embodiment will be described below.

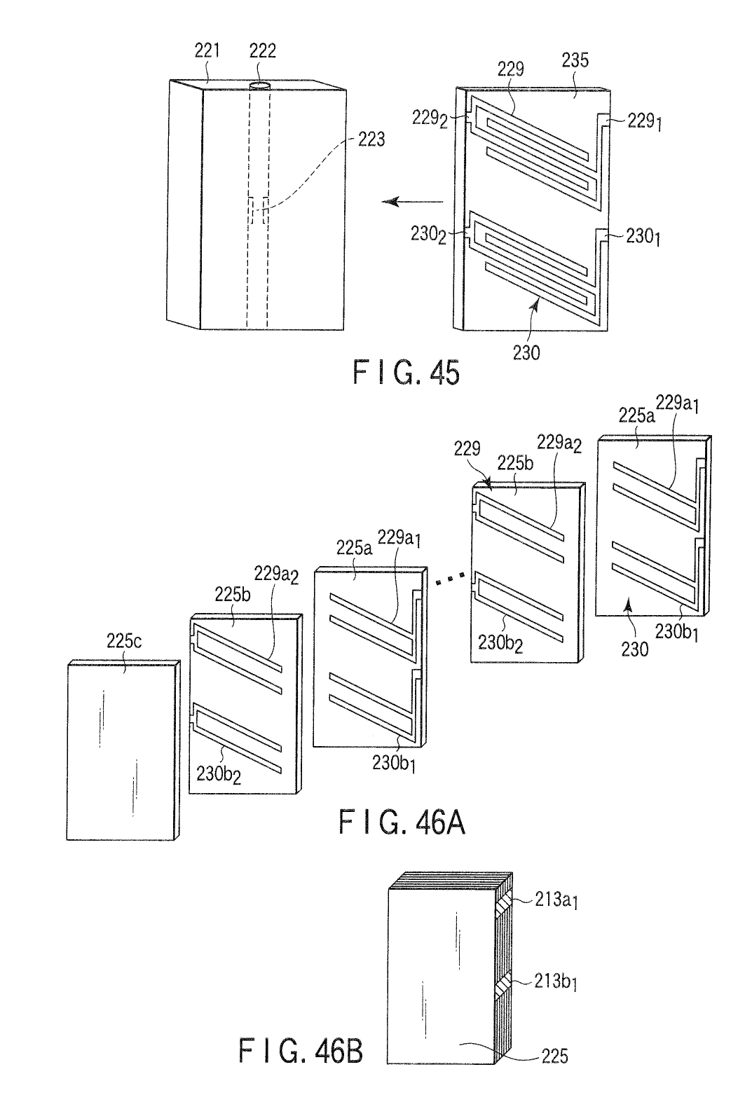

FIG. 45 is an exploded perspective view illustrating a configuration of an oscillator of the first modification of the ninth embodiment.

In the ninth embodiment, the laminated piezoelectric element is used as the piezoelectric element constituting the oscillator. In the first modification of the ninth embodiment, a single-plate piezoelectric element is used as the piezoelectric element.

A single-plate piezoelectric element 235 in which the electrode pattern of the interdigital electrode is printed is bonded and fixed to one of the side surfaces of the elastic body 221. At this point, the surface in which the electrode pattern is printed is disposed opposite the surface facing the elastic body 221. The electrode pattern of the piezoelectric element is similar to that of the ninth embodiment. The upper first interdigital electrode 229 and the lower second interdigital electrode 230 are provided as the interdigital electrode of the single-plate piezoelectric element 235.

Thus, in the first modification of the ninth embodiment, the single plate is used as the piezoelectric element, so that the configuration of the piezoelectric element can be simplified.

(Second Modification of Ninth Embodiment)

An ultrasonic motor according to a second modification of the ninth embodiment will be described below.

In the second modification of the ninth embodiment, although not illustrated, the third twisting resonance oscillation can be utilized instead of the second twisting resonance oscillation. At this point, it is necessary that size ratio of the short-side length/long-side length (a/b) of the oscillator 211 be set to about 0.3 (see FIGS. 2 and 3).

In the second modification of the ninth embodiment, the oscillator can be retained irrespective of the shaft of the ninth embodiment. That is, as is clear from FIGS. 2A to 2E, the common node of the first longitudinal resonance oscillation and third twisting resonance oscillation is located in the central portion of the outer side surface of the oscillator, so that the rotor and the like can be attached using the common node as the oscillator retaining portion.

(Third Modification of Ninth Embodiment)

An ultrasonic motor according to a third modification of the ninth embodiment will be described below.

FIGS. 46A and 46B illustrate a configuration of a laminated piezoelectric element of the third modification of the ninth embodiment, wherein FIG. 46A is an exploded perspective view of the laminated piezoelectric element, and FIG. 46B illustrates an external electrode of the laminated piezoelectric element of FIG. 46A.

In the third modification of the ninth embodiment, for example, one side (right-digit interdigital electrode) of each of an first interdigital electrode 229a₁ for the A-positive phase and a second interdigital electrode 230b₁ for the B-positive phase is printed in the piezoelectric sheet (1)225a, and the other side (left-digit interdigital electrode) of a first interdigital electrode 229a₂ for the A-negative phase and a second interdigital electrode 230b₂ for the B-negative phase is printed in the piezoelectric sheet (2)255b. The first interdigital electrodes 229a₁ and 229a₂ are disposed while the height directions (c direction of FIG. 43B) of the first interdigital electrodes 229a₁ and 229a₂ are shifted such that the digital portions of the first interdigital electrodes 229a₁ and 229a₂ are located between the digital portions of the interdigital electrode 229. Similarly the second interdigital electrodes 230b₁ and 230b₂ are disposed while the height directions of the second interdigital electrodes 230b₁ and 230b₂ are shifted such that the digital portions of the second interdigital electrodes 230b₁ and 230b₂ are located between the digital portions of the interdigital electrode 230.

The piezoelectric sheets (1)225a and the piezoelectric sheets (2)225b are alternately laminated, and the piezoelectric sheet (3)225c in which the electrode is not printed is finally laminated.

As illustrated in FIG. 46B, only the external electrodes for the A phase and B phase that are the driving phase are provided in the third modification of the ninth embodiment. Although the A-positive phase external electrode 213a₁ and the B-positive phase external electrode 213b₁ are illustrated in FIG. 46B, the A-negative phase external electrode 213a₂ and the B-negative phase external electrode 213b₂ are also provided.

In the third modification of the ninth embodiment, the polarization state is similar to that of FIG. 23. Accordingly, because the internal electrodes 229 and 230 and the piezoelectric sheet 225 can be replaced by the internal electrode 86 and piezoelectric sheet 85 of FIG. 23, the description of the polarization is omitted.

Because the positive internal electrodes (A-positive phase (B-positive phase)) and the negative internal electrodes (A-negative phase (B-negative phase)) are alternately laminated, the polarization direction is established with a slight angle ξ as illustrated FIG. 23. That is, the pair of piezoelectric sheet (1)225a and piezoelectric sheet (2)225b acts as the interdigital electrode.

In the ninth embodiment in which the positive electrode and the negative electrode exist in the surface, a discharge phenomenon is possibly generated during the polarization when the electrode is projected. On the other hand, the discharge phenomenon can be prevented in the third modification of the ninth embodiment.

### Tenth Embodiment

An ultrasonic motor according to a tenth embodiment of the invention will be described below.

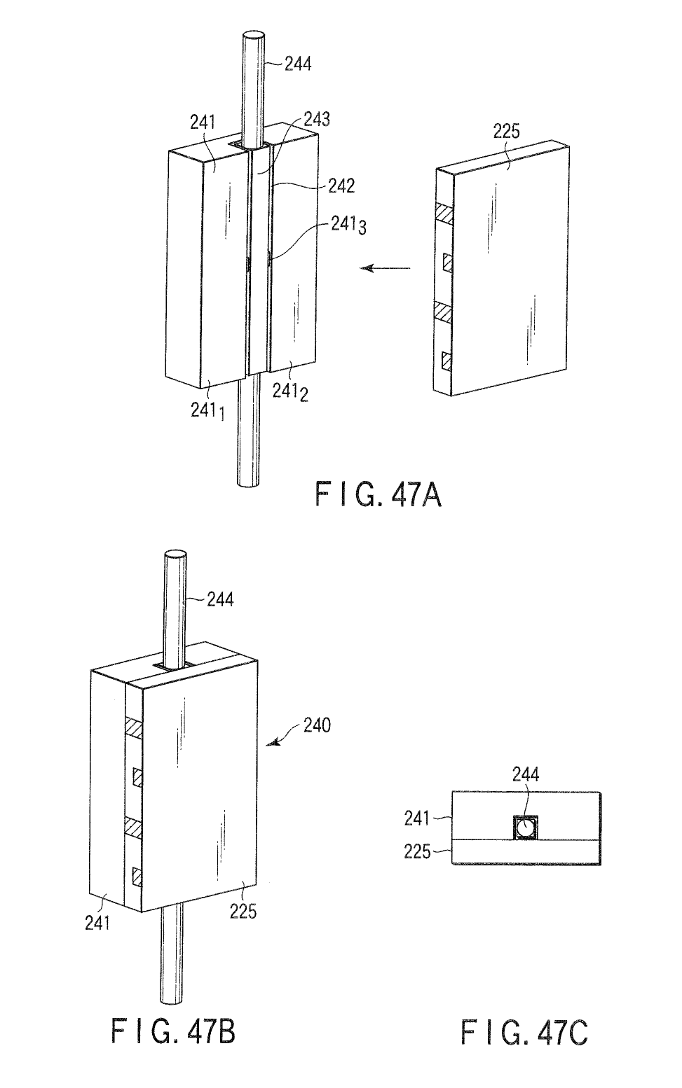

FIGS. 47A to 47C illustrate a configuration of an oscillator in the ultrasonic motor of the tenth embodiment, wherein FIG. 47A is an exploded perspective view of the oscillator, FIG. 47B is a perspective view illustrating a state in which the oscillator of FIG. 47A is assembled, and FIG. 47C illustrates the oscillator of FIG. 47B as viewed from above.

The tenth embodiment differs from the ninth embodiment only in the configurations of the elastic body and shaft.

As illustrated in FIG. 47, in a rectangular-solid elastic body 241 made of stainless steel or brass, groove portions 242 are vertically provided at two points from the upper and lower surfaces to the neighborhood of the central portion. A first main body 241₁ and a second main body 241₂, which are cut by the groove portions 242, are integral with a junction portion 241₃ of the central portion. A square shaft 243 is integral with the junction portion 241₃, and the square shaft 243 is extended along the groove portions 242. A round shaft 244 is continuously integral with the square shaft 243 in the axial direction of the square shaft 243. That is, all of the first main body 241₁, second main body 241₂, junction portion 241₃, square shaft 243, and round shaft 244 of the elastic body 241 are integrally formed.

As with the ninth embodiment, a first laminated piezoelectric element 225 is bonded to side surfaces of the elastic body 241 using the bonding agent.

In the square shaft 243, surfaces facing the first laminated piezoelectric element 225 have gaps with surfaces of the first laminated piezoelectric element 225. Accordingly, as illustrated in FIG. 47C, the square shaft 243 does not come into contact with the laminated piezoelectric element 225.

A thread portion (not illustrated) is provided in part of the round shaft 244.

In the tenth embodiment, the round shaft 244 is integral with the square shaft 243. Alternatively, the round shaft 244 and the square shaft 243 may be coupled with a thread and the like.

In the tenth embodiment, the following effect can be obtained.

In cases where the oscillator is miniaturized, it is difficult that the throughhole is made in the elastic body to provide the internal thread in the central portion unlike the ninth embodiment. In such cases, the shaft is previously integral with the elastic body to solve the trouble like the tenth embodiment. The junction portion is formed as small as possible, which suppresses the vibration of the shaft to the minimum.

(First Modification of Tenth Embodiment)

An ultrasonic motor according to a first modification of the tenth embodiment will be described below.

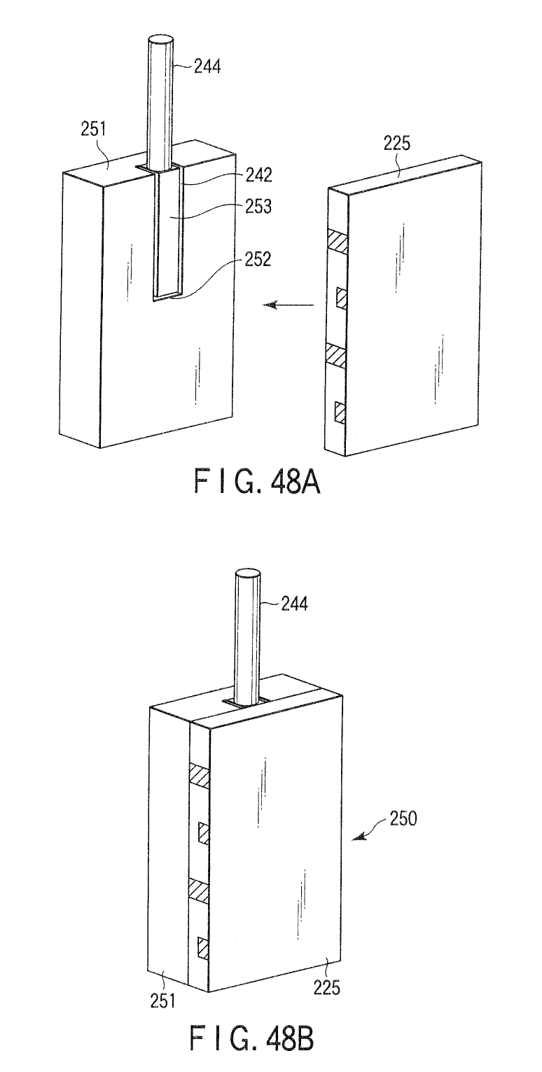

FIGS. 48A and 48B illustrate a configuration of an oscillator of an ultrasonic motor of the first modification of the tenth embodiment, wherein FIG. 48A is an exploded perspective view of the oscillator, and FIG. 48B is a perspective view illustrating a state in which the oscillator of FIG. 48A is assembled.

The first modification of the tenth embodiment differs from the tenth embodiment only in the configuration of the oscillator.

As illustrated in FIGS. 48A and 48B, the first modification of the tenth embodiment differs from eighth embodiment in the following points. That is, the two groove portions 242 are provided only in an upper half of an elastic body 251, and the continuously-formed round shaft 244 and square shaft 243 are integral with the elastic body 251 in a junction portion 252.

Therefore, compared with the tenth embodiment, an elastic-body machining region can be reduced to obtain the simpler elastic body and oscillator.

In the embodiments, the interdigital electrode is provided in the side surface of the piezoelectric element. The invention is not limited to the embodiments.

### Eleventh Embodiment

An ultrasonic motor according to an eleventh embodiment of the invention will be described below.

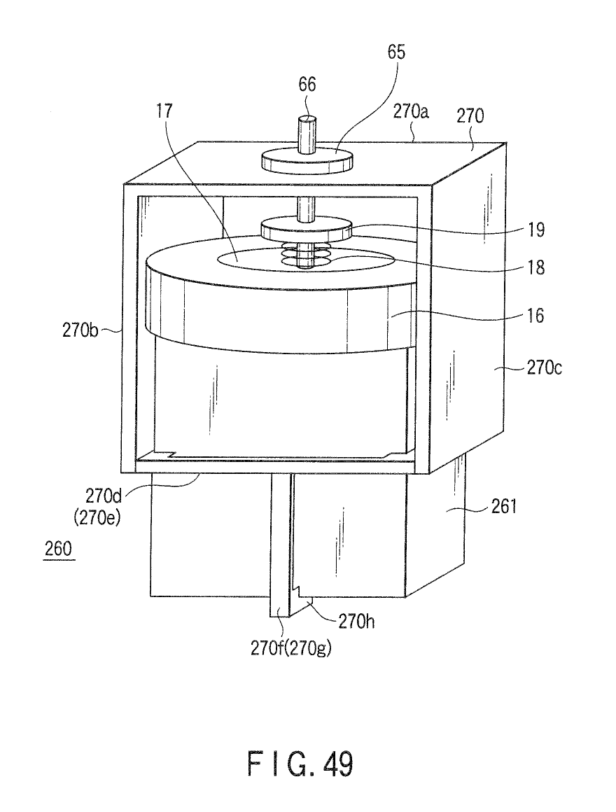

The eleventh embodiment will be described with reference to FIGS. 49 to 60.

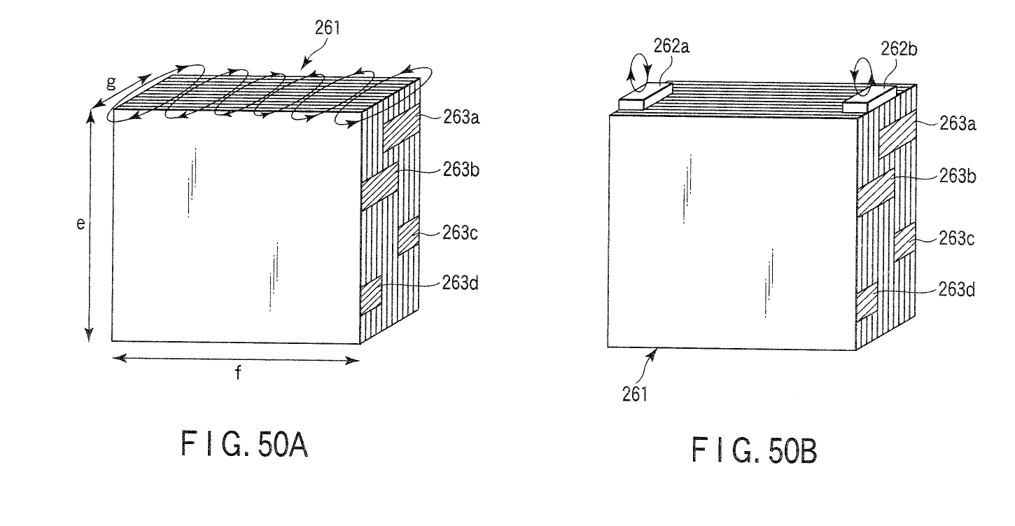

FIG. 49 is an appearance perspective view illustrating the ultrasonic motor of the eleventh embodiment. FIGS. 50A and 50B illustrate the oscillator of FIG. 49, wherein FIG. 50A is an appearance perspective view of the oscillator, and FIG. 50B is an appearance perspective view illustrating the oscillator of FIG. 50A to which a friction contact is bonded.

An ultrasonic motor 260 includes a laminated piezoelectric element (oscillator) 261 constituting the oscillator, friction contacts 262a and 262b, an external electrode 263 (263a to 263d), the rotor 16, the bearing 17, the spring 18, the spring retaining ring 19, the shaft fixing ring 65, the shaft 66, and an oscillator holder 270.

In the eleventh embodiment, the oscillator 261 is used as the laminated piezoelectric element in which plural piezoelectric elements are laminated.

The friction contacts 262a and 262b are bonded to the surface orthogonal to the longitudinal direction of the laminated piezoelectric element 261 to come into contact with the rotor 16 that is the driven body. However, it is not always necessary to provide the friction contacts 262a and 262b. In the right side surface of FIGS. 50A and 50B, the external electrodes 263 (263a to 263d) are provided at four points in each phase. Although not illustrated, the external electrodes are provided also at four points in the left side surface.

As illustrated in FIG. 49, the laminated piezoelectric element 261 is retained in the substantially central portion of three side surfaces (in this case, lower side surface, right side surface, and left side surface) by an oscillator holder 270. The shaft 66 whose outer circumference is threaded is extended from the top surface portion of the oscillator holder 270 toward the central portion of the top surface of the laminated piezoelectric element 261, and the shaft 66 is fixed to the inner side surface of the bearing. The outer side surface of the bearing 17 is fixed to the inner side surface of the rotor 16, and the spring 18 is in contact with the inside portion of the bearing. When the spring retaining ring 19 is rotated, the spring 18 is compressed to press the inner side surface of the bearing 17, and finally a predetermined pressing force acts between the rotor 16 and the laminated piezoelectric element 261.

The oscillator holder 270 is a retaining member that is fixed to the substantially central portion of the laminated piezoelectric element 261 to retain the shaft 66 and the laminated piezoelectric element 261. The oscillator holder 270 is made of an aluminum material to which an alumite treatment is performed or a metallic material to which an insulating treatment is performed. The oscillator holder 270 is integral with the laminated piezoelectric element 261. The oscillator holder 270 includes a top surface portion 270a, side surface portions 270b and 270c, guide portions 270d and 270e (guide portion 270e is not illustrated), guide portions 270f and 270g (guide portion 270g is not illustrated), and a bottom surface portion 270h. The shaft 66 is pierced through the top surface portion 270a. The side surface portions 270b and 270c are disposed opposite such that the side surfaces of the laminated piezoelectric element 261 are covered therewith. The guide portions 270d and 270e connect the lower end portions of the side surface portions 270b and 270c. The guide portions 270f and 270g are extended from the intermediate portion of the guide portions 270d and 270e toward the direction orthogonal to the guide portions 270d and 270e. The bottom surface portion 270h connects the guide portion 270f and the guide portion 270g.

The lower end portions of the side surface portions 270b and 270c and the bottom surface portion 270h are geometrically substantially matched with the node portion in the face shear oscillation mode and the node portion in the flexural oscillation mode. The laminated piezoelectric element 261 is supported only by a connection point between the side surface portion 270b and the guide portion 270d, a connection point between the side surface portion 270b and the guide portion 270e, a connection point between the side surface portion 270c and the guide portion 270d, a connection point between the side surface portion 270c and the guide portion 270e, a connection point between the guide portion 270f and the bottom surface portion 270h, and a connection point between the guide portion 270g and the bottom surface portion 270h.

The shaft fixing ring 65 fixes the oscillator holder 270 and the shaft 66. The longitudinal direction of the shaft 66 is defined as a center axial direction.

The laminated piezoelectric element 261 will be described in detail.

As illustrated in FIG. 50A, the rectangular-solid laminated piezoelectric element 261 has side lengths e, f, and g, and has a laminated structure of the piezoelectric ceramic and the internal electrode.

Referring to FIG. 50A, an external electrode (A-positive phase) 263a, an external electrode (B-positive phase) 263b, an external electrode (C-positive phase) 263c, and an external electrode (D-positive phase) 263d are provided in the right side surface. Although not illustrated, similarly an external electrode (A-negative phase), an external electrode (B-negative phase), an external electrode (C-negative phase), and an external electrode (D-negative phase) are provided at similar positions in the left side surface opposite the right side surface.

A surface formed by the side e and the side f of FIG. 50A is defined as an ef surface. A backside opposite the ef surface is defined as an ef backside.

FIG. 50B illustrates the state in which the friction contacts 262a and 262b are bonded to the region where the elliptic oscillation is generated in the upper surface of the laminated piezoelectric element 261. The friction contact members 262a and 262b are made of a ceramic material such as alumina and zirconia or an engineering plastic material such as PPS and PEEK. Though described in detail later, as illustrated in FIG. 50B, the clockwise (CW direction) or counterclockwise (CCW direction) elliptic oscillation is generated in the positions of the friction contact members 262a and 262b such that the rotor 16 is rotated.

The dimensions of the oscillator are set to e=10 mm, f=10 mm, and g=4.5 mm. The thickness of the friction contact ranges from about 0.1 mm to about 1 mm.

As shown in FIGS. 1D and 50A, in the entire upper surface of the oscillator (which is an elliptic oscillations generating surface), standing waves which is formed as elliptic oscillations of different rotating directions are generated steadily and sequentially (continually) along the long-side direction, with the central axis (i.e., a node) as a boundary. Herein, a distribution of the standing waves has a microscopic gradation that is increased in proportion with a distance from the central axis of the oscillator as shown in FIG. 50A. In the case where the upper surface of the oscillator is flat, a rotor (which is a body to be rotated) is rotated even if the rotor and a pair of friction contact members 13a and 13b (262a and 262b) are arranged at positions that are away from the rotation axis by arbitrary distances. Therefore, the positions of the friction contact members can be adjusted in accordance with the radius of the rotor. In addition, a plurality of pairs of friction contact members can be arranged symmetrically with respect to the rotation axis so as to reduce the load which may be caused by friction.

The upper and the bottom surfaces (which are elliptic oscillation generating surfaces) of the oscillator do not have to be flat. The upper and bottom surfaces may have desirable shapes in accordance with the type and shape of body to be rotated. For example, in case of applying prevent invention to a spherical vibration type actuator such as disclosed in U.S. Pat. No. 6,404,104 which is related to an ultrasonic motor using a flexucial (bending) traveling waves, where a partially-spherical depression or a cylindrical projection is formed in the upper surface of the oscillator in such a manner as to contain the central axis of the oscillator, a spherical body (i.e., a rotor) is rotated in a direction orthogonal to an elliptical oscillation by competing two directional elliptic oscillations which is symmetric to the central axis. Where a partially-spherical depression or a cylindrical projection is formed in the upper surface corresponding to the long side in such a manner as not to contain the central axis of the oscillator, the spherical body (i.e., the rotor) is rotated in the same direction of an elliptical oscillation. This spherical body rotation mechanism can be suitably applied to a robotic articulation capable of performing a motion of a multi-degree of freedom. According to the present invention, the spherical body can be rotated at any position on the upper surface of a rectangular solid shape.

In actuality, an elliptic oscillation having the same torque as that in the upper surface and rotating in the opposite direction is generated in the bottom surface of the oscillator. As shown in FIG. 8, another rotor may be arranged on the bottom surface in the reverse state to that of the upper surface. By so doing, rotations in the same direction can be obtained at two positions.

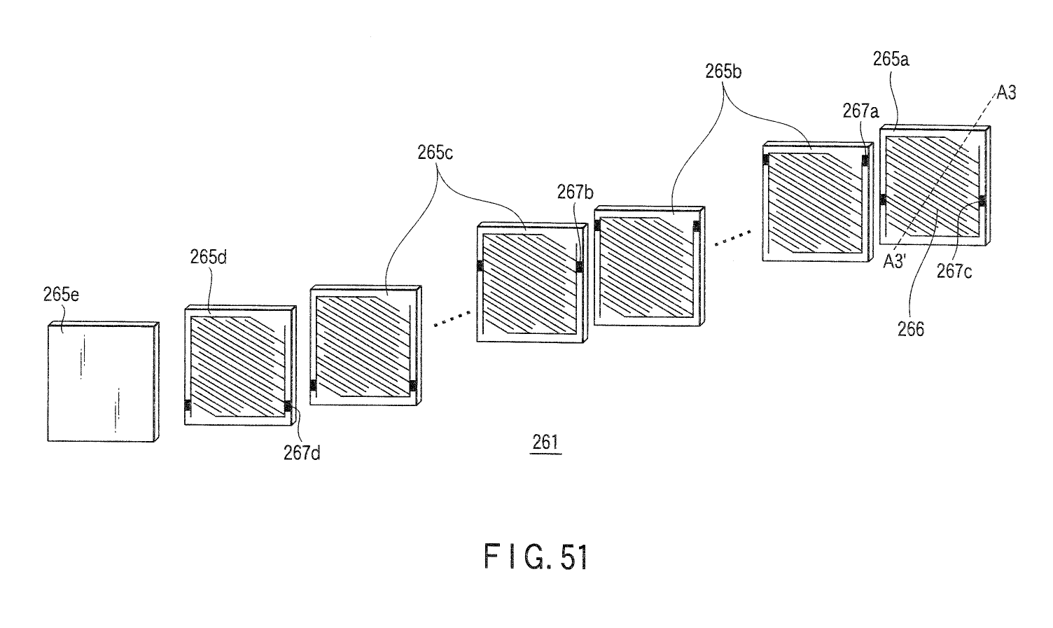

FIG. 51 is an exploded perspective view illustrating a configuration of a piezoelectric sheet of the laminated piezoelectric element 261.

In the laminated piezoelectric element 261, the thin piezoelectric sheets such as PZT are laminated, and a predetermined internal electrode pattern is formed in the piezoelectric sheet. The piezoelectric sheet 265 is made of a PZT material whose thickness ranges from about 10 μm to about 100 μm. The laminated piezoelectric element 261 includes a piezoelectric sheet 1 (hereinafter referred to as piezoelectric sheet (1)) 265a, a piezoelectric sheet 2 (hereinafter referred to as piezoelectric sheet (2)) 265b, a piezoelectric sheet 3 (hereinafter referred to as piezoelectric sheet (3)) 265c, a piezoelectric sheet 4 (hereinafter referred to as piezoelectric sheet (4)) 265d, and a piezoelectric sheet 5 (hereinafter referred to as piezoelectric sheet (5)) 265e. The similar patterns of the internal electrode 266 are printed in one of surfaces of each of the piezoelectric sheet (1)265a, piezoelectric sheet (2)265b, piezoelectric sheet (3)265c, and piezoelectric sheet (4)265d. However, the piezoelectric sheet (1)265a, the piezoelectric sheet (2)265b, the piezoelectric sheet (3)265c, and the piezoelectric sheet (4)265d differ from one another in the position where the electrode is extended to the side surface. In the piezoelectric sheet (5)265e, the internal electrode is not printed.

In the eleventh embodiment, the one piezoelectric sheet (1)265a is disposed in the outermost portion, the plural (n) piezoelectric sheets (2)265b and the plural (n) piezoelectric sheets (3)265c are laminated on the side where the internal electrode 266 of the piezoelectric sheet (1)265a is provided, the one piezoelectric sheet (4)265d is laminated on the piezoelectric sheets (3)265c, and finally the one piezoelectric sheet (5)265e is provided on the piezoelectric sheet (4)265d. The extended electrode 267c is provided in the piezoelectric sheet (1)265a in order to be connected to the external electrode 263c. Similarly the extended electrode 267a is provided in the piezoelectric sheet (2)265b in order to be connected to the external electrode 263a, the extended electrode 267b is provided in the piezoelectric sheet (3)265c in order to be connected to the external electrode 263b, and the extended electrode 267d is provided in the piezoelectric sheet (4)265d in order to be connected to the external electrode 263d.

The internal electrode 266 is made of a silver-palladium alloy, and has the thickness of several micrometers. As illustrated in FIG. 51, the internal electrode 266 has the interdigital electrode structure. At this point, the interdigital electrode shall mean an electrode in which the positive phase electrodes and the negative phase electrodes are alternately disposed. The interdigital electrode is formed in one of the side surfaces so as to occupy as large an area as possible in the side surface.

A width of the interdigital internal electrode is set in a range of about 0.1 mm to about 1 mm, and an insulating width between the interdigital internal electrodes is set in a range of about 0.1 mm to about 1 mm. As described in detail later, the interdigital electrode is provided in substantially the entire surface of the piezoelectric sheet 265 while inclined by about 45 degrees. The one piezoelectric sheet (1)265a is laminated. The piezoelectric sheet (1)265a acts as the oscillation detecting electrode. Then the n piezoelectric sheets (2)265b are laminated (although the specific number of n is 21 in the eleventh embodiment, hereinafter the number of piezoelectric sheets is referred to as n). The piezoelectric sheets (2)265b act as the driving electrode. Then the n piezoelectric sheets (3)265c are laminated. The piezoelectric sheets (3)265c also act as the driving electrode. Then the one piezoelectric sheet (4)265d is laminated. The piezoelectric sheet (4)265d acts as the oscillation detecting electrode.

The method of producing the laminated piezoelectric element 261 will be described.

The one piezoelectric sheet (1)265a in which the internal electrode pattern is printed, the n piezoelectric sheets (2)265b in which the internal electrode patterns are printed, the n piezoelectric sheets (3)265c in which the internal electrode patterns are printed, the one piezoelectric sheet (4)265d in which the internal electrode pattern is printed, and finally the one piezoelectric sheet (5)265e in which the internal electrode is not printed are prepared before the burning. After the piezoelectric sheets (1)265a to (5)265e are laminated, the laminated piezoelectric sheets are pressed and cut into a predetermined size, and the burning is performed at a predetermined temperature. Then external electrodes are printed and baked in predetermined positions. Then the polarization is performed to complete the laminated piezoelectric element 261.

The section in the laminated direction, which includes the polarization direction indicated along a line A3-A3′ of FIG. 51, is similar to that of FIG. 23. Accordingly, because the internal electrode 266 and the piezoelectric sheet 265 can be replaced by the internal electrode 86 and piezoelectric sheet 85 of FIG. 23, the description of the polarization is omitted.

The operation of the laminated piezoelectric element 261 will be described.

As to the dimensions of the sides e, f, and g of the rectangular-solid laminated piezoelectric element 261 illustrated in FIG. 50A, the side e is equal to the side f while the side g is set to a proper value, thereby matching the resonance frequency of the face shear oscillation with the resonance frequency of the flexural oscillation.

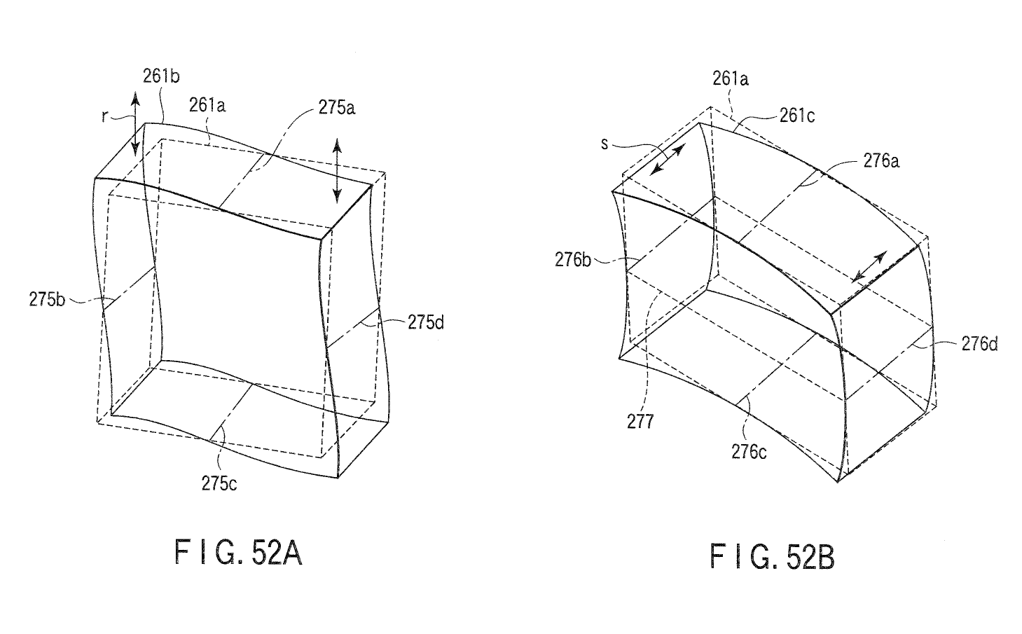

FIGS. 52A and 52B schematically illustrate a transformation of a body of the vibrator in an oscillation state of each oscillation mode, wherein FIG. 52A schematically illustrates the oscillation state of the face shear oscillation mode, and FIG. 52B schematically illustrates the oscillation state of the flexural oscillation mode. In FIGS. 52A and 52B, a shape of a static state 261a is illustrated by the broken line, and shapes of oscillation states 261b and 261c in the oscillation mode are illustrated by the solid line.

In the face shear oscillation of FIG. 52A, when attention is paid to the upper surface, the end portion of the upper surface has a vertically-oscillating component. Although actually the end portion of the upper surface is oscillated in an oblique direction, the end portion of the upper surface has the vertically-oscillating component indicated by an arrow r as a vector component. However, as is clear from FIG. 52A, the vertically-oscillating phases in the end portions of the upper surface are deviated from each other by π. Node lines 275a, 275b, 275c, and 275d exist in substantially central portions of the four side surfaces. The oscillation displacement is eliminated or slightly generated in the node lines 275a, 275b, 275c, and 275d.

In the flexural oscillation of FIG. 52B, when attention is paid to the upper surface, the end portion of the upper surface has a horizontally-oscillating component as shown by an arrow s direction. However, as is clear from FIG. 52B, the horizontally-oscillating phases in the end portions of the upper surface are identical to each other. Node lines 276a, 276b, 276c, and 276d exist in substantially central portions of the four side surfaces. The oscillation displacement is eliminated or slightly generated in the node lines 276a, 276b, 276c, and 276d.

The two oscillations are combined to generate the elliptic oscillation in the end portion of the upper surface. The node line in each oscillation mode exists in the common region, and the common region can be retained when the laminated piezoelectric element 261 is retained.

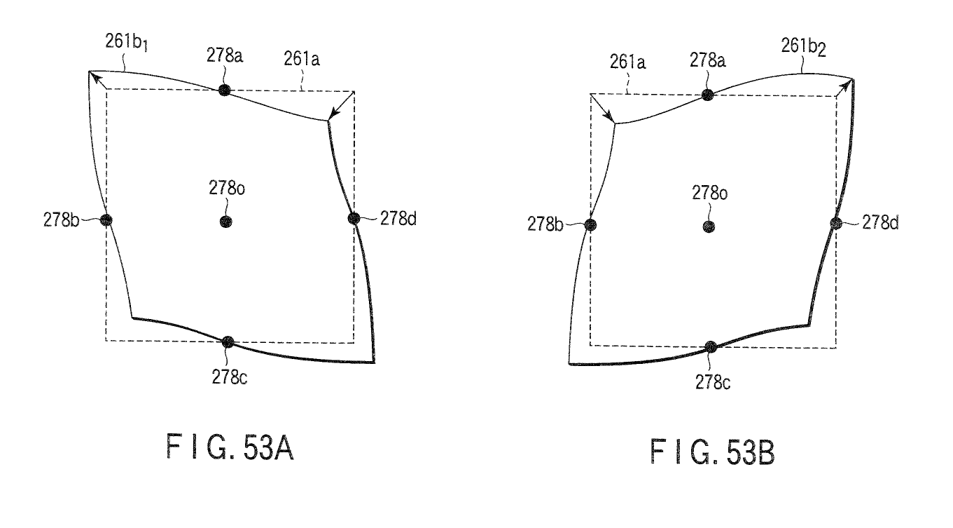

Each oscillation mode will be described in detail with reference to FIGS. 53A, 53B, 54A, 54B, 55A, and 55B.

FIGS. 53A and 53B illustrate the face shear oscillation mode as viewed from a direction perpendicular to an ef surface of FIG. 50A, and illustrate the oscillation states in which oscillation phases are deviated from each other by π. That is, FIGS. 53A and 53B illustrate the state in which oscillation states 261b₁ and 261b₂ of the solid line are deviated from each other by the phase π. Positions of black circles 278a, 278b, 278c, and 278d of FIGS. 53A and 53B substantially correspond to the node lines of the oscillation.

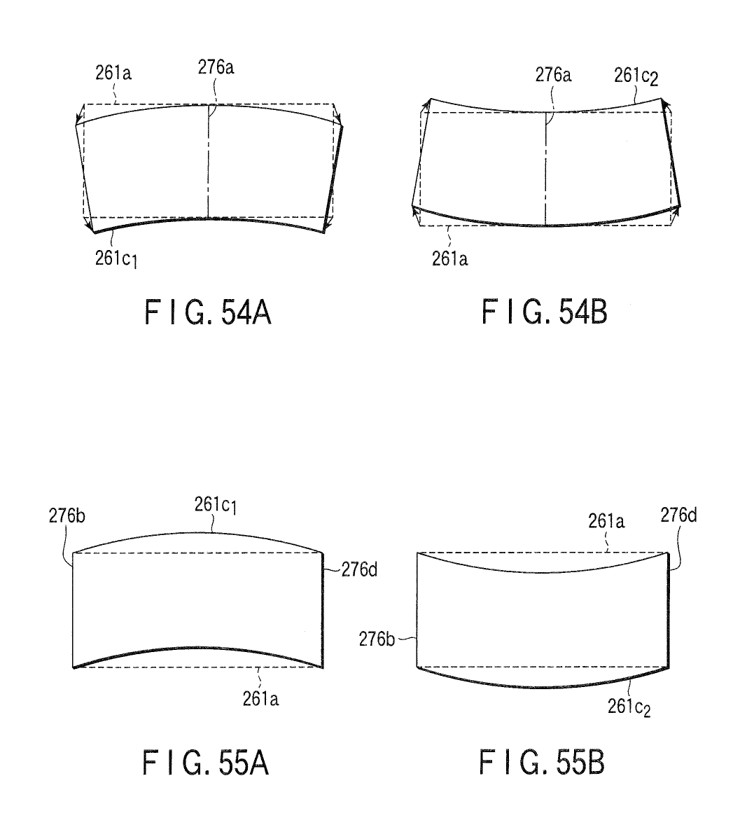

FIGS. 54A and 54B illustrate the flexural oscillation mode as viewed from an upper surface, and illustrate the oscillation states in which the oscillation phases are deviated from each other by π. That is, FIGS. 54A and 54B illustrate the state in which oscillation states 261c₁ and 261c₂ of the solid line are deviated from each other by the phase π. Arrows of FIGS. 54A and 54B indicate the oscillation displacement of each vertex.

FIGS. 55A and 55B illustrate a central sectional portion 277 of FIG. 52B. As illustrated in FIGS. 55A and 55B, in the section, the end portions just correspond to the position of the node lines 276b and 276d, the central portion has the oscillation displacement (bulge). At this point, FIGS. 55A and 55B illustrate the state in which the oscillation phases are deviated from each other by n. The oscillation of FIGS. 55A and 55B is referred to as flexural oscillation mode.

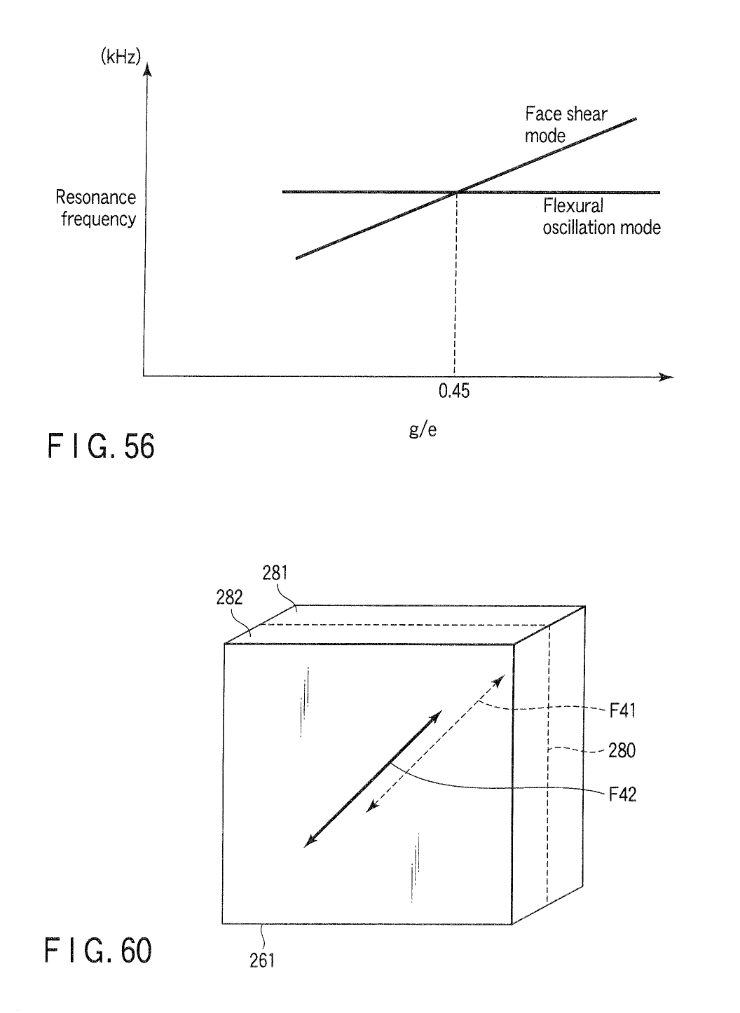

FIG. 56 is a view in which the value g/e and the resonance frequency in each mode are plotted when the side g of the oscillator is changed while the side e is equal to the side f (constant). As can be seen from FIG. 56, the resonance frequency of the face shear oscillation is substantially kept constant irrespective of the value g/e. However, the resonance frequency of the flexural oscillation is monotonously increased with increase in the value g/e. Accordingly, the resonance frequency of the face shear oscillation is matched with the resonance frequency of the flexural oscillation when the value g/e is about 0.45.

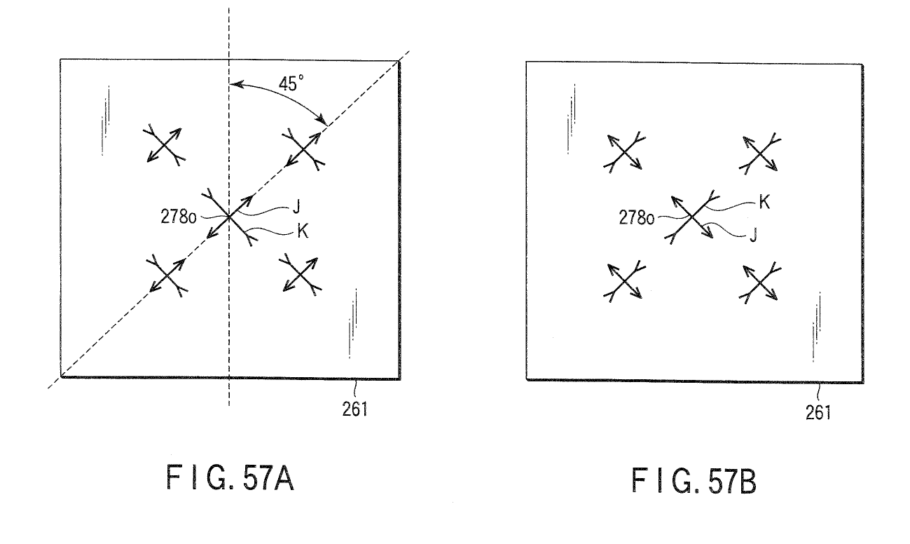

FIGS. 57A and 57B illustrate a state of a strain (principal strain) of the ef surface when the face shear oscillation is generated. In the face shear oscillation, a strain is generated as illustrated in FIG. 57A at a certain moment in sites of FIG. 57A. That is, in FIG. 57A, an expansion strain (indicated by the letter J) is generated in the 45-degree direction, and a contraction strain (indicated by the letter K) is generated in the direction orthogonal to the 45-degree direction. FIG. 57B illustrates the strain in the state in which the oscillation phase is deviated from that of FIG. 57A by π. At this point, the contraction strain K is generated in the 45-degree direction, and the expansion strain J is generated in the direction orthogonal to the 45-degree direction. The numeral 278o designates the center of the ef surface.

As is clear from FIG. 52A, the strains in the ef backside are similar to those in the ef surface. The expansion strain is defined as positive, and the contraction strain is defined as negative.

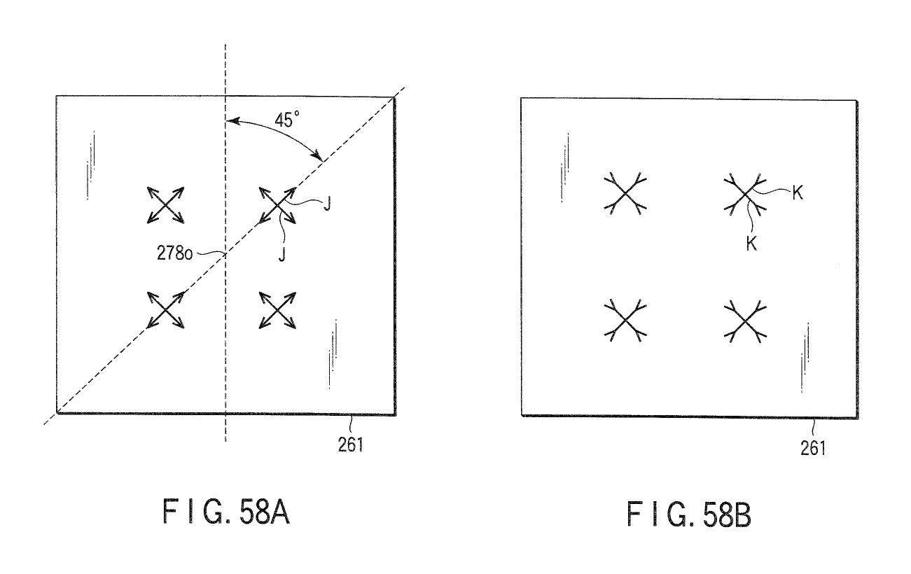

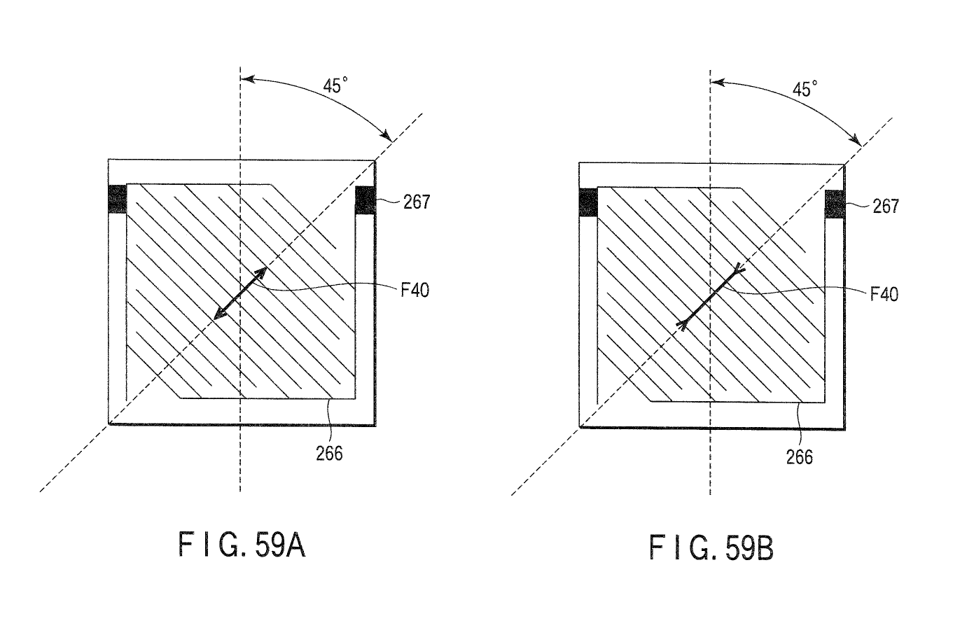

FIGS. 58A and 58B illustrate a state of the strain (principal strain) of the ef surface when the flexural oscillation is generated. In the flexural oscillation, at a certain moment in sites of FIG. 58A, the expansion strain J is generated in the 45-degree direction as illustrated in FIG. 58A, and the expansion strain J is also generated in the direction orthogonal to the 45-degree direction. FIG. 58B illustrates the strain in the state in which the oscillation phase is deviated from that of FIG. 58A by π. At this point, the contraction strain K is generated in the 45-degree direction, and the contraction strain K is also generated in the direction orthogonal to the 45-degree direction.

As is clear from FIG. 52B, it is noted that the strain in the ef backside has the sign opposite the sign of the strain of the ef surface.

The internal electrode pattern for generating the face shear oscillation and flexural oscillation will be described with reference to FIGS. 59A and 59B.

When the interdigital electrode is formed with the internal electrode pattern 266 inclined by about 45 degrees, the substantially-in-plane polarization is generated between the positive and negative interdigital electrodes as illustrated in FIG. 23. When the alternate voltage corresponding to the resonance frequency is applied to the interdigital electrode during the oscillation, a tensile force F40 acts in the 45-degree direction at a certain moment as illustrated in FIG. 59A. The tensile force F40 is generated by a piezoelectric longitudinal effect because the electric flux line acts along the direction of the polarization vector. The tensile force F40 is proportional to a piezoelectric constant e33.

Actually the piezoelectric transverse effect is simultaneously generated when the alternate voltage is applied. Although not illustrated, the force is generated in the direction orthogonal to the force F40 by the piezoelectric transverse effect. The force generated by the piezoelectric transverse effect is proportional to a piezoelectric constant e31. However, in normally-used piezoelectric ceramics such as PZT, because usually an absolute value of the piezoelectric constant e31 is much smaller than an absolute value of the piezoelectric constant e33, the piezoelectric transverse effect is not considered in the eleventh embodiment.

FIG. 59B illustrates the force at the time the phase of the alternate voltage is deviated from the state of FIG. 59A by π. In such cases, a compressive force acts in the same direction as the tensile force F40 of FIG. 59A. The alternate stress inclined by 45 degrees can be generated with the interdigital electrode inclined by 45 degrees as the internal electrode.

That the alternate force F40 can excite each oscillation mode will be described with reference to FIG. 60.

As illustrated in FIG. 51, the laminated piezoelectric element 261 of the eleventh embodiment has the structure in which the piezoelectric sheets are laminated, and the interdigital electrode is printed in the piezoelectric sheet while inclined by 45 degrees. In consideration of only the driving piezoelectric sheet, with a boundary of a central surface 280 of FIG. 60, the n piezoelectric sheets (2) are laminated in a deep-side half region 281 while the n piezoelectric sheets (3) are laminated in a near-side half region 282, and the n piezoelectric sheets (2) and the n piezoelectric sheets (3) are electrically coupled to the A phase and B phase of the external electrodes, respectively. A force F41 indicated by a broken-line arrow may act on the deep-side half region 281 of FIG. 60 by the alternate voltage applied to the A phase. A force F42 indicated by a solid-line arrow may act on the near-side half region 282 by the alternate voltage applied to the B phase.

When the in-phase alternate voltages having the resonance frequencies in each mode are applied to the A phase and the B phase, in-phase forces are generated in the deep-side half region 281 and the near-side half region 282. As can be seen from FIGS. 57 and 58B, the flexural oscillation is not generated, but only the face shear oscillation is generated. On the other hand, when the antiphase alternate voltages having the resonance frequencies in each mode are applied to the A phase and the B phase, antiphase forces are generated in the deep-side half region 281 and the near-side half region 282. As can be seen from FIGS. 57 and 58, the face shear oscillation is not generated, but only the flexural oscillation is generated.

The operation of the ultrasonic motor 260 having the configuration of FIG. 49 will be described.

As described above, only the face shear oscillation is generated when the in-phase alternate voltages are applied to the A phase (A-positive phase 263a) and B phase (B-positive phase 263b) of FIGS. 50A and 50B, and only the flexural oscillation is generated when the antiphase alternate voltages are applied to the A phase 263a and B phase 263b. When the alternate voltages having a certain phase difference are applied to the A phase 263a and B phase 263b, the face shear oscillation and the flexural oscillation are simultaneously excited. Because the face shear oscillation and the flexural oscillation are simultaneously excited with a predetermined phase difference, the elliptic oscillation is generated in the end portion of the upper surface of the laminated piezoelectric element 261 as illustrated in FIG. 50B.

As illustrated in FIGS. 52A and 52B, when the attention is paid to the end portions of the upper surface, the end portions of the upper surface are oscillated antiphase in the face shear oscillation, and are oscillated in-phase in the flexural oscillation. Accordingly, when the elliptic oscillation is generated, the rotation of the elliptic oscillation in the left end portion is opposite to the rotation of the elliptic oscillation in the right end portion, and the phase of the elliptic oscillation in the left end portion is deviated from the phase of the elliptic oscillation in the right end portion by π.

In the ultrasonic motor 260 having the configuration of FIG. 49, as described above, the friction contacts 262a and 262b in the elliptic oscillation state are brought into contact with the rotor 16 to impart the force to the rotor 16. The elliptic oscillations of the friction contacts 262a and 262b are opposite to each other, so that the torque can be imparted to the rotor 16 to rotate the rotor 16. When the phase difference between the A phase 263a and the B phase 263b is inverted, the rotor 16 can be rotated in the opposite direction.

The oscillation detecting operation performed by the piezoelectric sheet (1)265a and piezoelectric sheet (4)265d of FIG. 51 will be described.

The piezoelectric sheet (1)265a and the piezoelectric sheet (4)265d are symmetrically disposed in relation to the central surface 280 of FIG. 60. The driving piezoelectric sheet (2)265b and the piezoelectric sheet (3)265c are also symmetrically disposed in relation to the central surface 280. It can be thought that the principle of the oscillation detecting operation is opposite to the above-described principle of the driving operation.

As illustrated in FIGS. 57A and 57B, in cases where only the face shear oscillation is excited, because the strains having the same sign are generated in the deep-side half region 281 and near-side half region 282 of the central surface 280 of FIG. 60, the same in-phase voltages are generated in the piezoelectric sheet (1)265a and piezoelectric sheet (4)265d by the piezoelectric effect. Accordingly, the signal proportional to the magnitude and phase of the face shear oscillation is supplied between the terminal at which the C-positive phase and the D-positive phase are connected and the terminal at which the C-negative phase and the D-negative phase are connected (defined as the parallel forward connection).

On the other hand, as illustrated in FIGS. 58A and 58B, in cases where only the flexural oscillation is excited, because the strains having the different signs are generated in the deep-side half region 281 and near-side half region 282 of the central surface 280 of FIG. 60, the same antiphase voltages are generated in the piezoelectric sheet (1)265a and piezoelectric sheet (4)265d by the piezoelectric effect. Accordingly, the signal proportional to the magnitude and phase of the flexural oscillation is supplied between the terminal at which the C-positive phase and the D-negative phase are connected and the terminal at which the C-negative phase and the D-positive phase are connected (defined as the parallel inverse connection). Therefore, the face shear oscillation or flexural oscillation can independently be detected by selecting the connection between the C phase and D phase (parallel forward connection or parallel inverse connection).

The method of driving the motor using the oscillation detecting phase (C phase and D phase) will be described.

It is known that the phase difference between the signal phase of the A phase or B phase that is the driving phase and the oscillation detecting phase (for example, the parallel inverse connection between the C phase and the D phase) has a predetermined value Q during the resonance frequency operation of the flexural oscillation. Accordingly, when the frequency is adjusted to drive the motor such that the phase difference between the driving phase and the oscillation detecting phase always becomes the value Ω, the oscillator can always be driven near the flexural oscillation resonance frequency, that is, the motor can efficiently be driven at the optimum frequency, even if the temperature rise is generated by the heat generation of the motor or even if the change in resonance frequency is generated by the change in ambient temperature or the change in load. The motor can be driven in a similar way near the face shear oscillation resonance frequency.

Although the dimensions of the sides e×f×g are cited only by way of example in the above-described embodiments, the dimensions of the sides e×f×g are appropriately changed according to the application devices and intended end-usage of the ultrasonic motor. For example, as illustrated in FIG. 56, a predetermined ratio at which the resonance frequency of the flexural oscillation mode is matched with the resonance frequency of the face shear mode to exert the same value is most suitable to the rectangular ratio g/e of the ultrasonic motor after the production is completed. The range (for example, within ±0.02) close to the predetermined ratio can also be used as the rectangular ratio a/b at which the resonance frequency of the first longitudinal resonance oscillation is substantially matched with the resonance frequency of the second twisting (or third twisting) resonance oscillation. When the rectangular ratio falls within the effective range (for example, within ±0.05), the above described effect of the invention can be obtained.

In the eleventh embodiment, it is not necessary to provide the groove portion in part of the elastic body, and it is not necessary to make the hole in the piezoelectric element. Therefore, the configuration becomes simplified, and not only can the production easily be performed but also stable motor characteristics are obtained. Further, in the eleventh embodiment, the piezoelectric element has the laminated structure, so that the ultrasonic motor can be driven at a low voltage. The oscillation detecting phase is also provided, so that the ultrasonic motor can always be driven at the optimum frequency using the signal of the oscillation detecting phase.

In the oscillator of the eleventh embodiment, because the common node between the two oscillation modes exists in the central portion of each of the four side surfaces, the common node can be retained. In such cases, not only can the oscillator firmly be fixed, but also the leakage of the oscillation through the retaining member can be suppressed to a minimum level, and therefore the high-efficiency motor can be realized.

In the eleventh embodiment, the gradient of the interdigital electrode is set to 45 degrees. Alternatively, the gradient of the interdigital electrode may be set to any angle near the 45 degrees in the range where the two modes can be excited, that is, the range where the two modes can be excited in the principle of the eleventh embodiment. As to the dimensions of the oscillator, the side ratio e:f:g is set to 1:1:0.45 in the eleventh embodiment. However, sometimes the resonance frequency is deviated due to the coupling of the oscillator holder or the pressing of the rotor. In such cases, it is necessary to slightly change the side ratio e:f:g within the range where the principle of the eleventh embodiment holds.

In the eleventh embodiment, the two piezoelectric sheets are used to detect the oscillation. Alternatively, even-numbered piezoelectric sheets such as four piezoelectric sheets and eight piezoelectric sheets may be used to detect the oscillation.

In the ultrasonic motor of the eleventh embodiment, the outer circumference of the rotor is formed into a concavo-convex shape, and the motor output may be taken out in a gear engagement manner, or the motor output may be taken out from the outer circumference of the rotor through a belt.

In the oscillator of the eleventh embodiment, the oscillation detecting piezoelectric sheets are disposed so as to sandwich the driving piezoelectric sheet therebetween. Alternatively, the driving piezoelectric sheets may be disposed so as to sandwich the oscillation detecting piezoelectric sheet. The oscillator of the eleventh embodiment has the structure in which the driving piezoelectric sheets and the oscillation detecting piezoelectric sheets are laminated. Alternatively, the oscillator may include only the driving piezoelectric sheets.

### Twelfth Embodiment

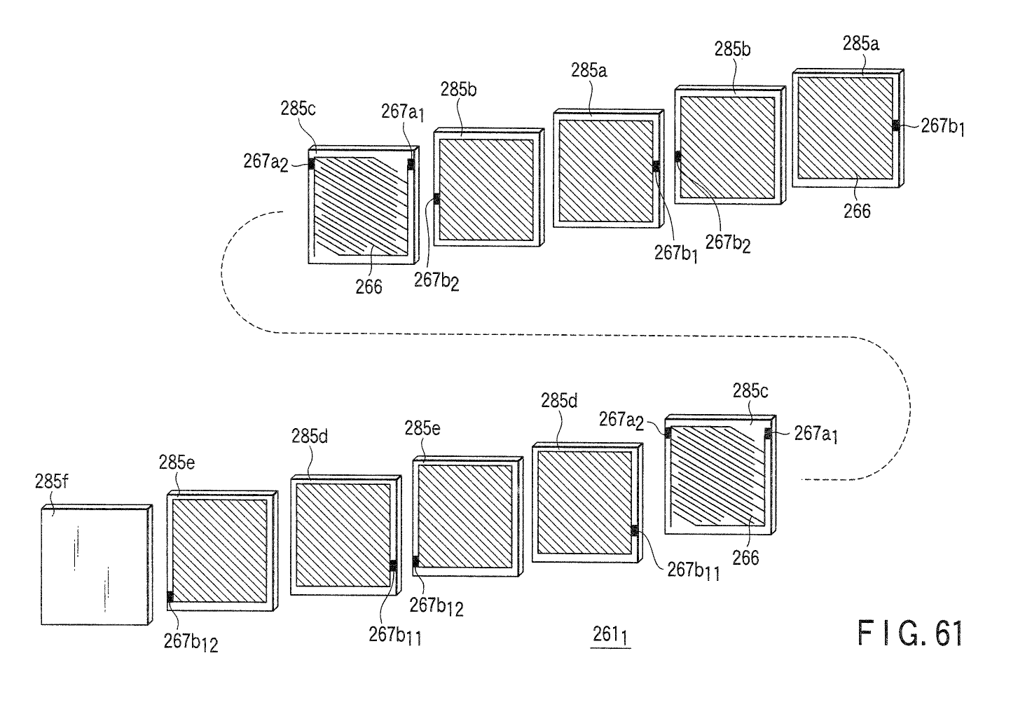

An ultrasonic motor according to a twelfth embodiment of the invention will be described below with reference to FIGS. 61, 62, 63A, and 63B.

The twelfth embodiment differs from the eleventh embodiment only in the configuration of the laminated piezoelectric element. In the twelfth embodiment, the outer dimensions (e:f:g) of the laminated piezoelectric element constituting the oscillator are similar to those of the eleventh embodiment.

FIG. 61 is an exploded perspective view illustrating a configuration of a piezoelectric sheet of the twelfth embodiment.

A laminated piezoelectric element 2611 of the twelfth embodiment includes two piezoelectric sheets (1)285a, two piezoelectric sheets (2)285b, 2n piezoelectric sheets (3)285c, two piezoelectric sheets (4)285d, two piezoelectric sheets (5)285e, and one piezoelectric sheet 6 (hereinafter referred to as piezoelectric sheet (6)) 285f. In the piezoelectric sheet (1)285a, the piezoelectric sheet (2)285b, the piezoelectric sheet (4)285d, and the piezoelectric sheet (5)285e, the electrode is formed in substantially the entire surface while an insulating portion of 0.2 to 1 mm remains in the edge portion. However, the piezoelectric sheet (1)285a, the piezoelectric sheet (2)285b, the piezoelectric sheet (4)285d, and the piezoelectric sheet (5)285e differ from one another only in the positions of extended electrodes 267b₁, 267b₂, 267b₁₁, and 267b₁₂ provided therein.

The interdigital electrode 266 similar to that of the eleventh embodiment is printed in the piezoelectric sheet (3)285c, and the even-numbered interdigital electrodes 266 are prepared (2n interdigital electrodes 266: n=18, that is, 36 in the twelfth embodiment). Extended electrodes 267a₁ and 267a₂ are provided in each of the piezoelectric sheets (3). The internal electrode is not printed in the piezoelectric sheet (6)285f.

The piezoelectric sheets will be described in the laminated order.

Two each of the piezoelectric sheets (1)285a, piezoelectric sheets (2)285b, piezoelectric sheets (1)285a, and piezoelectric sheets (2)285b are laminated in this order. Then the 2n piezoelectric sheets (3)285c are laminated. Then two each of the piezoelectric sheets (4)285d, piezoelectric sheets (5)285e, piezoelectric sheets (4)285d, and piezoelectric sheets (5)285e are laminated in this order. Finally the piezoelectric sheet (6)285f in which the interdigital electrode is not printed is laminated.

Because the method of producing the laminated piezoelectric element (oscillator) 2611 of the twelfth embodiment is similar to that of the eleventh embodiment, the description is omitted.

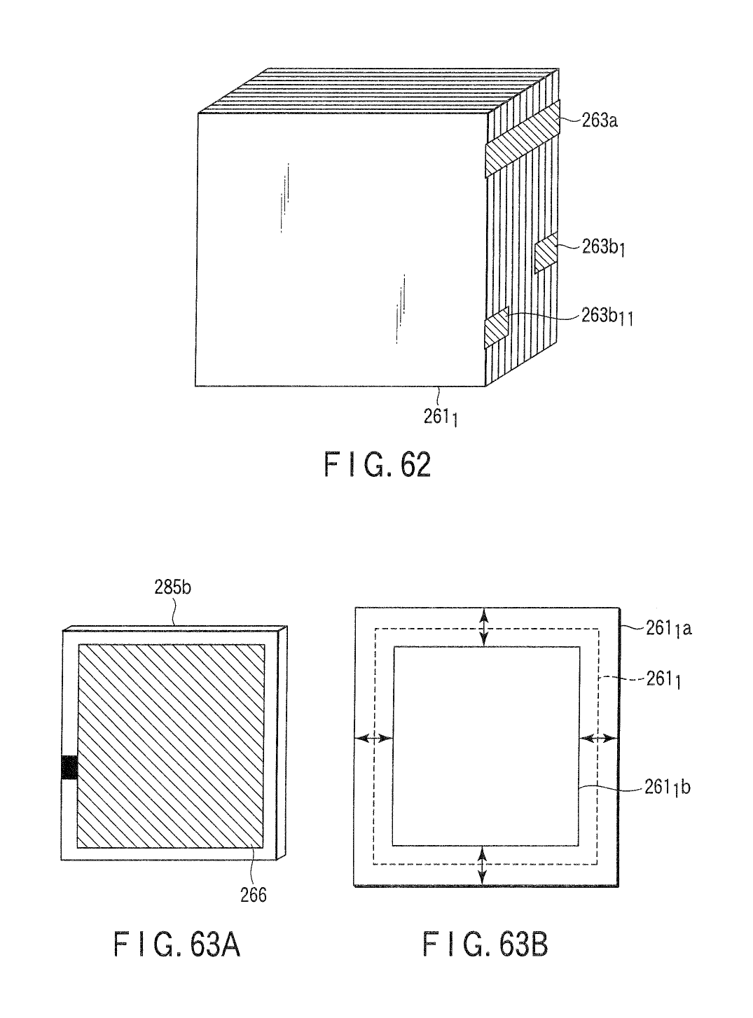

An appearance of the oscillator of the twelfth embodiment will be described with reference to FIG. 62.

Referring to FIG. 62, the external electrode is formed in the right side surface. The A-positive phase external electrode 263a is provided in the topmost position corresponding to the position of the extended electrode 267a₁ of the piezoelectric sheet (3)285c, the B1-positive phase external electrode 263b₁ is provided in the position corresponding to the piezoelectric sheet (1)285a, and the B2-positive phase external electrode 263b₁₁ is provided in the position corresponding to the piezoelectric sheet (4)285d. Although not illustrated in FIG. 62, in the left side surface, similarly the A-negative phase external electrode 263a is provided in the topmost position corresponding to the position of the extended electrode 267a₂ of the piezoelectric sheet (3)285c, the B1-negative phase external electrode is provided in the position corresponding to the piezoelectric sheet (2)285b, and the B2-negative phase external electrode is provided in the position corresponding to the piezoelectric sheet (5)285e.

Because the configuration of the ultrasonic motor in which the laminated piezoelectric element 2611 is used is similar to that of the eleventh embodiment, the description is omitted.

The operation of the laminated piezoelectric element 2611 will be described.

Referring to FIG. 60, the piezoelectric sheets (3)285c of the twelfth embodiment are symmetrically disposed in relation to the central surface 280 of the laminated piezoelectric element, and all the piezoelectric sheets (3) belong to the A phase. When the alternate voltage corresponding to the resonance frequency is applied to the A phase, only the face shear oscillation is excited.

Before the description of the flexural oscillation, the operation of the piezoelectric sheet (2) will be described with reference to FIGS. 63A and 63B.

FIG. 63A illustrates the piezoelectric sheet (2)285b, and the internal electrode 266 is provided in substantially the entire surface of the piezoelectric sheet (2)285b. The similar electrode (to which the piezoelectric sheet (1)285a contributes) is also provided in the backside. When the alternate voltage is applied after the polarization, the oscillation of alternate voltage is generated by the piezoelectric transverse effect such that the piezoelectric sheet (1)285a is expanded or contracted in whole as shown in FIG. 63B.

Referring to FIGS. 61 and 62, when the alternate voltage having the resonance frequency is applied between the B1-positive phase and B1-negative phase of the laminated piezoelectric element, the piezoelectric sheet group including the piezoelectric sheets (1)285a and piezoelectric sheets (2)285b is oscillated as illustrated in FIG. 63B. That is, compared with the static state 2611, the displacement is generated between a maximum displacement state 261₁a and a minimum displacement state 261₁b. However, because the displacement is not generated in the piezoelectric sheet (3)285c that is integral with the piezoelectric sheet group including the piezoelectric sheets (1)285a and piezoelectric sheets (2)285b, the flexural oscillation of FIG. 52B is generated on the whole in the laminated piezoelectric element.

Similarly, when the alternate voltage having the resonance frequency is applied between the B2-positive phase and B2-negative phase of the oscillator, the piezoelectric sheet group including the piezoelectric sheets (4)285d and piezoelectric sheets (5)285e is oscillated as illustrated in FIG. 63B. However, because the displacement is not generated in the piezoelectric sheet (3)285c that is integral with the piezoelectric sheet group including the piezoelectric sheets (4)285d and piezoelectric sheets (5)285e, the flexural oscillation of FIG. 52B is generated on the whole in the oscillator.

The B1 phase and B2 phase are driven antiphase in the actual driving method. The reason why the B1 phase and the B2 phase are used as the B phase is that a symmetric property is improved in the whole of the oscillator. Hereinafter the B1 phase and B2 phase that are driven antiphase are referred to as B phase.

When the A phase and B phase are driven with the predetermined phase difference, the elliptic oscillation can be excited in the upper surface of the oscillator.

Because the method of driving the ultrasonic motor in which the laminated piezoelectric element 2611 is used is similar to that of the eleventh embodiment, the description is omitted.

Thus, in the twelfth embodiment, the following effect can be obtained in addition to the effect of the eleventh embodiment.

Because the face shear oscillation and the flexural oscillation are independently excited, the magnitude and phase of each of the face shear oscillation and flexural oscillation can freely be changed, and therefore the elliptic oscillation can be generated with a high degree of freedom.

Although the oscillation detecting element is not provided in the twelfth embodiment, the oscillation detecting element may be formed in the manner similar to that of the eleventh embodiment. In such cases, the driving method may be realized in the manner similar to that of the eleventh embodiment.

### Thirteenth Embodiment

An ultrasonic motor according to a thirteenth embodiment of the invention will be described below.

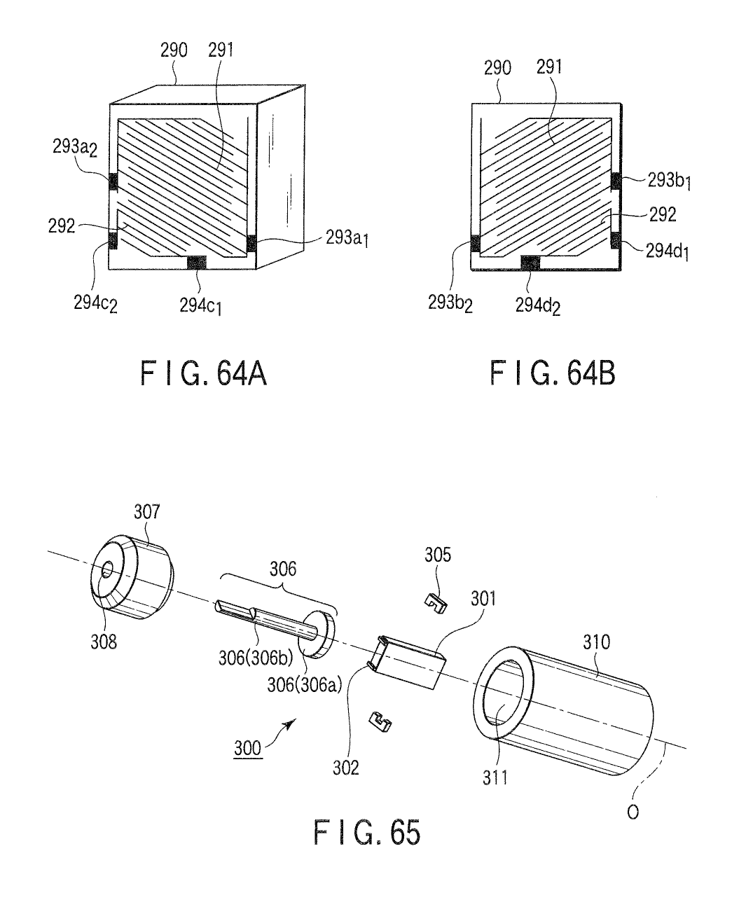

FIGS. 64A and 64B illustrate a configuration of an oscillator of the thirteenth embodiment, wherein FIG. 64A is an appearance perspective view of the oscillator as viewed from a surface side, and FIG. 64B is a plan view of the oscillator as viewed from a backside.

The ultrasonic motor of the thirteenth embodiment differs from the ultrasonic motors of the first and second embodiments only in the configuration of the oscillator. In the thirteenth embodiment, the outer dimensions (e:f:g) of the oscillator are similar to those of the eleventh and twelfth embodiments.

The oscillator of the thirteenth embodiment differs from the oscillator of the eleventh embodiment in that the oscillator of the thirteenth embodiment does not have the laminated structure.

Referring to FIG. 64A, a driving interdigital electrode 291 and an oscillation detecting interdigital electrode 292 are provided in a surface of a piezoelectric element 290 constituting the oscillator while divided. The interdigital electrodes 291 and 292 have the gradient of 45 degrees. The driving interdigital electrode 291 is coupled to the A-phase electric terminals 293a₁ and 293a₂ for the A-positive phase and A-negative phase, and outer lead wires are connected to the electric terminals 293a₁ and 293a₂. The oscillation detecting interdigital electrode 292 is coupled to the C-phase electric terminals 294c₁ and 294c₂ for the C-positive phase and C-negative phase.

As illustrated in FIG. 64B, the driving interdigital electrode 291 and the oscillation detecting interdigital electrode 292 are also provided in the backside of the piezoelectric element 290. In the backside of the piezoelectric element 290, the interdigital electrode has the gradient of 45 degrees, and the direction of the interdigital electrode is identical to that of the interdigital electrode of the surface. The driving interdigital electrode 291 is coupled to the B-phase electric terminals 293b₁ and 293b₂ for the B-positive phase and B-negative phase. The oscillation detecting interdigital electrode 292 is coupled to the D-phase electric terminals 294d₁ and 294d₂ for the D-positive phase and D-negative phase.

Because the configuration of the ultrasonic motor in which the piezoelectric element is used is similar to that of the eleventh and twelfth embodiments, the description is omitted.

The operation of the piezoelectric element having the above configuration will be described.

The oscillator of the thirteenth embodiment has the single-plate structure while the oscillator of the eleventh and twelfth embodiments has the laminated structure, and other configurations are similar to those of the eleventh and twelfth embodiments. Therefore, the description of the operation is omitted. The frequency feedback control in which the signal of the oscillation detecting electrode is used is similar to that of the eleventh and twelfth embodiments, and thus the description is omitted.

Thus, the structure is extremely simplified and suitable to the high-volume production, although the oscillator of the thirteenth embodiment is not driven at a low voltage.

In the thirteenth embodiment, the driving interdigital electrode and the oscillation detecting interdigital electrode are printed in the same surface while divided. The oscillator having the laminated structure of the eleventh embodiment may be formed using the piezoelectric sheets in which the similar patterns are printed.

### Fourteenth Embodiment

The ultrasonic motors of the first to thirteenth embodiments have been described above. An ultrasonic motor apparatus that acts as means for retaining the ultrasonic motors of the first to thirteenth embodiments will be described in the following embodiments.

An ultrasonic motor apparatus of the fourteenth embodiment will be described below.

The ultrasonic motor apparatus of the fourteenth embodiment will be described with reference to FIGS. 65 to 67.

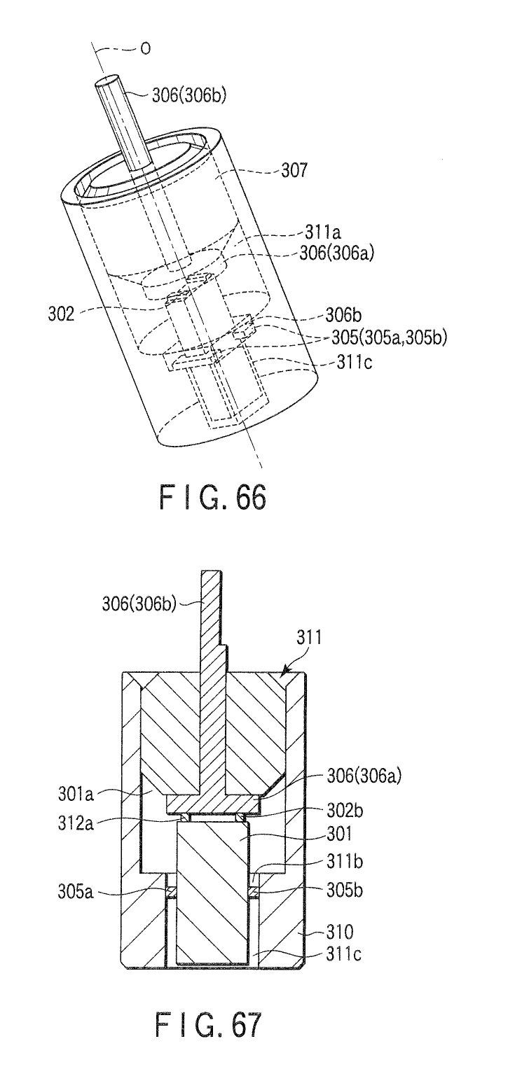

FIG. 65 is an exploded perspective view illustrating a configuration of the ultrasonic motor apparatus of the fourteenth embodiment. FIG. 66 is an assembly drawing illustrating the ultrasonic motor apparatus of the fourteenth embodiment, and FIG. 67 is a sectional view illustrating the ultrasonic motor of the fourteenth embodiment.

An ultrasonic motor apparatus 300 includes a laminated piezoelectric element (oscillator) 301, a friction contact member 302 (302a and 302b), an oscillator holder 305, a shaft-integrated rotor 306, a nut 307, and a case 310.

The laminated piezoelectric element 301 includes a single-structure element whose section perpendicular to a central axis O of the ultrasonic motor apparatus 300 has a length ratio of the rectangular shape. The friction contact member 302 (302a and 302b) is fixed to the elliptic oscillation generating surface, and the elliptic oscillation is generated by combining the first longitudinal resonance oscillation and third twisting resonance oscillation of the laminated piezoelectric element 301. The friction contact member 302 is made of an engineering plastic material (such as PPS). The friction contact member 302 is an arc component having the central axis O of the ultrasonic motor apparatus 300, and is bonded and fixed to the surface orthogonal to the longitudinal direction of the laminated piezoelectric element 301.

The oscillator holder 305 that is an oscillator retaining member is fixed to the portion corresponding to the common node between the first longitudinal resonance oscillation and third twisting resonance oscillation of the laminated piezoelectric element 301. The oscillator holder 305 retains and fixes the laminated piezoelectric element 301 at a U-shape recess of the oscillator holder 305 so as to sandwich the laminated piezoelectric element 301 from the side-surface side. The oscillator holder 305 is made of an aluminum material to which an alumite treatment is performed or a metallic material to which an insulating treatment is performed. The oscillator holder 305 has a shape in which the central axis of the laminated piezoelectric element 301 is matched with the central axis O of the ultrasonic motor apparatus 300 when the laminated piezoelectric element 301 is assembled in the case 310.

The shaft-integrated rotor 306 that is a torque transmitting member includes a rotor portion 306a and a shaft portion 306b, and the rotor portion 306a and the shaft portion 306b are coaxially machined. The rotor portion 306a is rotated while pressed against the friction contact member 302, and is formed in the surface orthogonal to the central axis O. The shaft portion 306b transmits the torque of the rotor portion 306a, and is extended from the rotor portion 306a toward the direction of the central axis O. A leading end of the shaft portion 306b is formed into a shape (for example, a single-side D-cut shape illustrated in FIGS. 65 to 67 and key-groove shape (not illustrated)) to which a transmission component such as a gear, a pulley, and a coupling can be fixed.

A shaft hole 308 is made in the central portion of the nut 307 such that a shaft portion 306b of the shaft-integrated rotor 306 can be journaled in the shaft hole 308 while inserted in the shaft hole 308. The shaft hole 308 has a diameter in which the shaft portion 306b of the shaft-integrated rotor 306 can be fitted. The outer surface of the nut 307 is formed into a fitting shape (circular shape) such that the center of the shaft hole 308 in which the shaft portion 306b of the shaft-integrated rotor 306 is inserted is matched with the central axis O of the ultrasonic motor apparatus 300 when the nut 307 is inserted in and fixed to a fitting hole 311 of the case 310. While the nut 307 journals the shaft portion 306b of the shaft-integrated rotor 306, the nut 307 that is a pressing member comes in contact with the rotor portion 306a to press the rotor portion 306a against the friction contact member 302.

The case 310 that is a retaining member has a cylindrical shape. The laminated piezoelectric element 301 is retained in the fitting hole 311 inside the case 310, and the nut 307 is rigidly bonded while the rotor portion 306a of the shaft-integrated rotor 306 is pressed against the friction contact member 302. A hole 311b is made in the fitting hole 311 made in the case 310, and the oscillator holder 305 fixed to the laminated piezoelectric element 301 is fitted in the hole 311a. A hole 311a in which the nut 307 is fitted is made in the upper portion of the hole 311a. A hole 311c is made in the lower portion of the hole 311b, and the hole 311c is slightly larger than the outer dimensions of the laminated piezoelectric element 301. Therefore, the laminated piezoelectric element 301 is disposed such that portions except for the oscillator holder 305 and friction contact member 302 do not come into contact with the fitting hole 311 in the case 310.

The fitting holes 311 (holes 311a, 311b, and 311c) are coaxially made such that the axial centers of the laminated piezoelectric element 301 and nut 307 are matched with the central axis O of the ultrasonic motor apparatus 300 when the laminated piezoelectric element 301 and the nut 307 are assembled in the case 310.

The shaft-integrated rotor 306, the nut 307, and the case 310 are made of a metallic material such as stainless steel and aluminum.

The laminated piezoelectric element 301 will be described in detail with reference to FIGS. 2A to 2E, 3, 20A and 20B, 21A to 21I, 22, and 23.

The laminated piezoelectric element 301 of the ultrasonic motor apparatus 300 is formed by laminating the plural piezoelectric elements.

In the ultrasonic motor apparatus 300 of the fourteenth embodiment, the configuration of the laminated piezoelectric element 301 is similar to that of the laminated piezoelectric element 81 of the ultrasonic motor of the fourth embodiment illustrated in FIGS. 20 to 23. Therefore, because the laminated piezoelectric element 301 and the friction contact members 302a and 302b can be replaced by the laminated piezoelectric element 81 and the friction contact members 82a and 82b, the description is omitted.

The friction contact members 302a and 302b are bonded to the surface orthogonal to the longitudinal direction of the laminated piezoelectric element 301 to come into contact with the rotor portion 336a of the shaft-integrated rotor 336.

Because the polarization is similar to that of FIG. 23, the internal electrode 86 and piezoelectric sheet 85 of FIG. 23 can be referred to, and the description is omitted.

The operation of the laminated piezoelectric element 301 will be described.

As described above, it is clear that the resonance frequency in the second twisting oscillation mode is matched with the resonance frequency in the first longitudinal oscillation mode when the value a/b is close to 0.6. It is clear that the resonance frequency in the third twisting oscillation mode is matched with the resonance frequency in the first longitudinal oscillation mode when the value a/b is close to 0.3. Accordingly, in the fourteenth embodiment, the dimensions of the laminated piezoelectric element 301 are set such that the value a/b becomes about 0.3.

In the laminated piezoelectric element 301 of the fourteenth embodiment, the dimensions of the sides a×b×c are set to, for example, 3×10×20 mm.

As illustrated in FIGS. 66 and 67, the two oscillators holders 305 (305a and 305b) are bonded and fixed to the portion corresponding to the common node between the first longitudinal resonance oscillation and third twisting resonance oscillation in the surface in the longitudinal direction of the laminated piezoelectric element 301. As described above, the friction contact members 302 (302a and 302b) are bonded and fixed to the surface orthogonal to the longitudinal direction of the laminated piezoelectric element 301.

The laminated piezoelectric element 301 to which the oscillator holders 305 and the friction contact members 302 are bonded and fixed is fitted in the case 310 while the oscillator holder 305 is interposed between the laminated piezoelectric element 301 and the case 310. At this point, the laminated piezoelectric element 301 is positioned in the case 310 such that the central axis of the case 310 is matched with the central axis of the laminated piezoelectric element 301. The nut 307 is inserted in the case 310 while the shaft portion 306b of the shaft-integrated rotor 306 is inserted in the shaft hole 308 of the nut 307.

The shaft-integrated rotor 306 is pressed in the axial direction (elliptic oscillation generating surface side) by the nut 307, and the rotor portion 306a is brought into contact with the elliptic oscillation generating surface of the friction contact member 302 by the rotatable pressing force. The nut 307 is bonded and fixed to the case 310 while pressing the shaft-integrated rotor 306.

Thus, in the fourteenth embodiment, the oscillator can include the single laminated piezoelectric element, and the elliptic oscillation formed by the combination of the first longitudinal resonance oscillation and the third twisting resonance oscillation is generated in a direction in which the rotor portion of the shaft-integrated rotor is rotated in the friction contact member contact surface. When the rotor portion is rotated, the coaxial shaft portion integral with the rotor portion is rotated to transmit the torque in the axial direction. Accordingly, the elliptic oscillation in which the longitudinal and twisting oscillation modes are combined can be formed only by the single oscillator, and the rotor can be rotated by the elliptic oscillation to transmit the torque in the axial direction.

(First Modification of Fourteenth Embodiment)

An ultrasonic motor apparatus according to a first modification of the fourteenth embodiment will be described below.

In the fourteenth embodiment, the outer shape of the nut 307 and the fitting hole 311 in the case 310 are formed into the circular shape. However, the outer shape of the nut 307 and the fitting hole 311 in the case 310 are not limited to the circular shape. When the nut 307 is inserted in and fixed to the case 310, the center of the hole in which the shaft portion 306b of the shaft-integrated rotor 306 is inserted is matched with the central axis of the ultrasonic motor apparatus 300, and the pressing force acts properly on the rotor portion 306a. In such cases, the outer shape of the nut 307 and the fitting hole 311 may be changed to other shapes than the circular shape (for example, polygonal shapes such as a triangle, a tetragon, and pentagon). Further, the shape of the case is not limited to the cylindrical shape.

In the first modification of the fourteenth embodiment, a degree of freedom of the fitting hole is increased in the case in which the laminated piezoelectric element is accommodated.

(Second Modification of Fourteenth Embodiment)

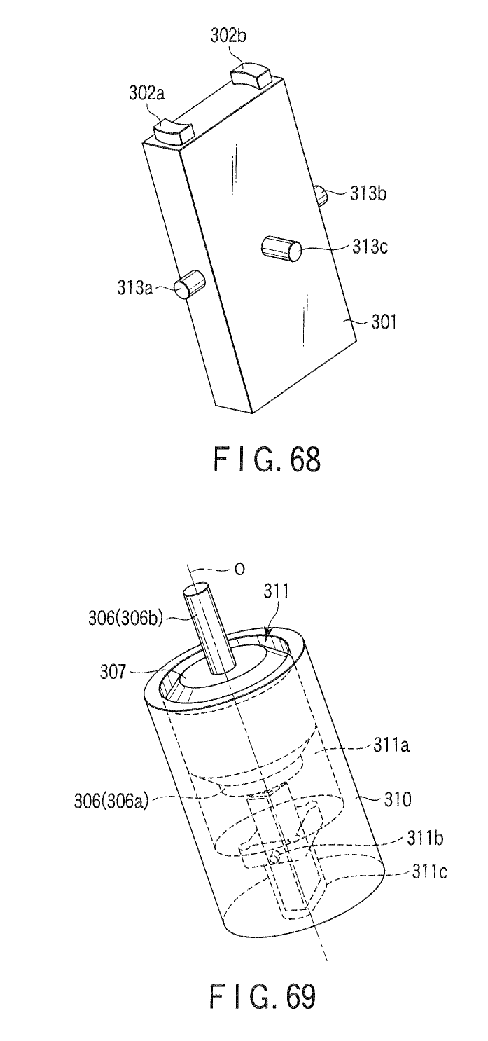

In the fourteenth embodiment, the oscillator holder is formed into the U-shape. On the other hand, as illustrated in FIGS. 68 to 70, pins can be used as long as the pin has the shape in which the laminated piezoelectric element can be positioned in the case.

FIG. 68 is a perspective view illustrating pins 313a to 313d that support a laminated piezoelectric element 301 according to a second modification of the fourteenth embodiment, and FIG. 69 is an assembly drawing illustrating an ultrasonic motor apparatus of the second modification of the fourteenth embodiment.

Holes are made in the portions corresponding to the nodes of the laminated piezoelectric element 301 in the four surfaces after the burning, and pins 313a to 313d (pin 313d is not illustrated) are inserted in the holes. The laminated piezoelectric element 301 is fitted in the case with the pins 313a to 313d projected so as to be in contact with the wall of the fitting hole 311b in the oscillator holder 305 of FIGS. 66 and 67. Therefore, as with the U-shape oscillator holder 305, the laminated piezoelectric element 301 can be positioned in the center of the case 310.

Advantageously the shape of the oscillator holder is simplified to eliminate the trouble of bonding.

In the second modification of the fourteenth embodiment, the pins 313a to 313d are inserted in the holes made in the laminated piezoelectric element 301. Alternatively, the pins 313a to 313d may be fixed by bonding.

The number of pins is not limited to four. At least two pins may be provided in the positions facing each other.

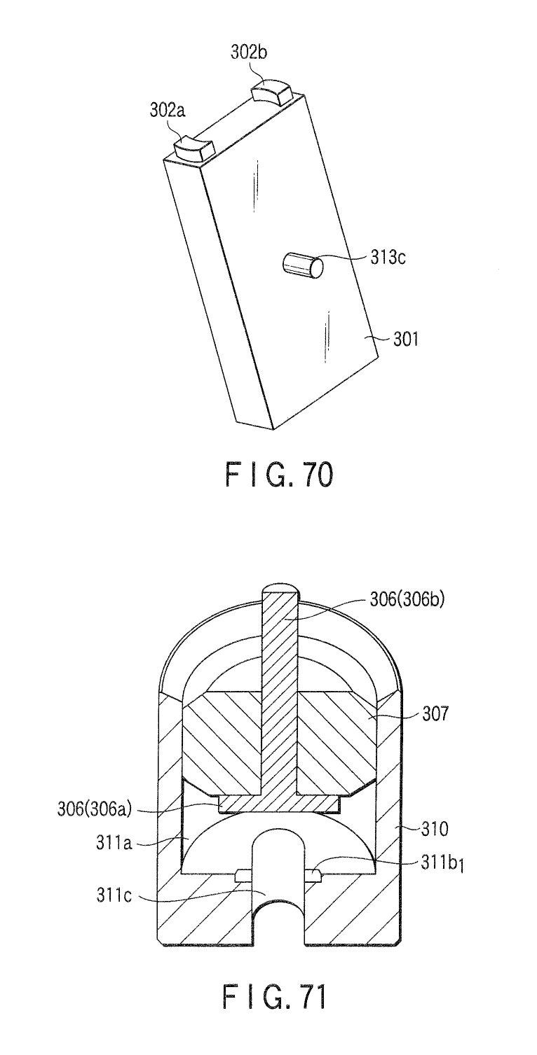

For example, as illustrated in FIG. 70, the two pins 313c and 313d are attached to the surfaces (surface formed by the side b and side c of FIGS. 2A to 2E) on the long-side side of the laminated piezoelectric element 301. As illustrated in FIG. 71, the pins 313c and 313d are fitted in the holes 311b₁ of the case 310. Therefore, as with the four pins, the laminated piezoelectric element 301 can be positioned in the center of the case 310.

The two pins may be attached to the surfaces (surface formed by the side a and side c of FIGS. 2A to 2E) on the short-side side of the laminated piezoelectric element 301. In such cases, the positions of the pin fitting holes of FIG. 71 are also changed onto the short-side side.

### Fifteenth Embodiment

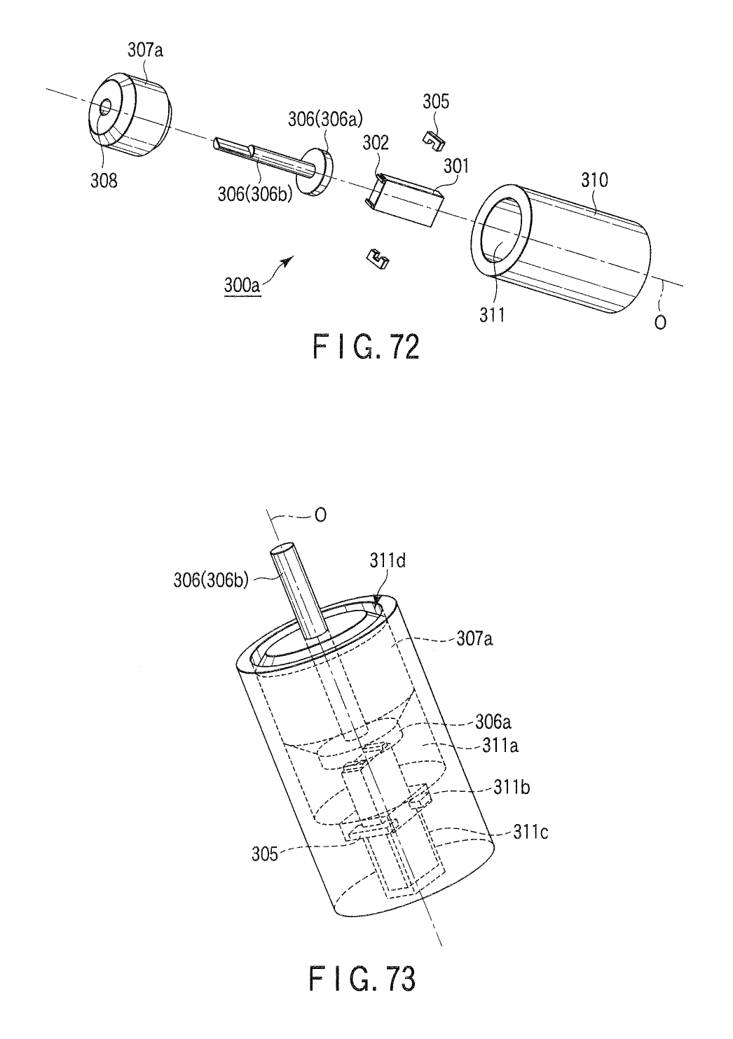

An ultrasonic motor apparatus according to a fifteenth embodiment of the invention will be described below with reference to FIGS. 72 to 74.

In the following embodiments, because the basic configuration of the ultrasonic motor apparatus are similar to that of the fourteenth embodiment, the same component is designated by the same reference numeral in order to avoid the overlapping description, the illustration and detailed description are omitted, and only the different component will be described below.

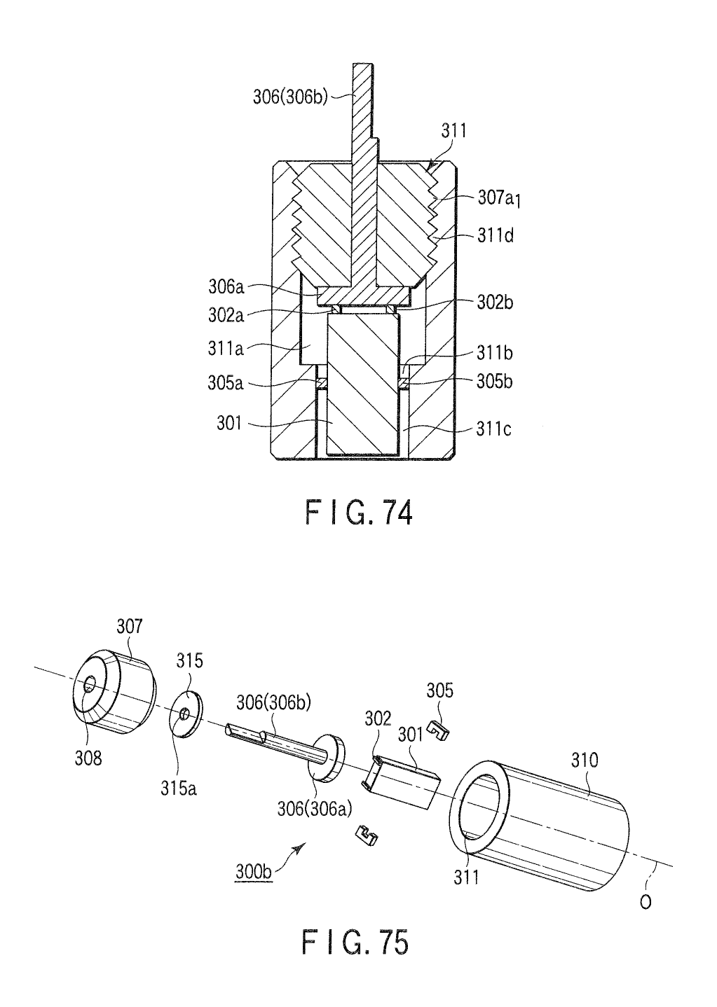

FIG. 72 is an exploded perspective view illustrating a configuration of the ultrasonic motor apparatus of the fifteenth embodiment. FIG. 73 is an assembly drawing illustrating the ultrasonic motor apparatus of the fifteenth embodiment, and FIG. 74 is a sectional view illustrating the ultrasonic motor apparatus of the fifteenth embodiment.

As illustrated in FIGS. 72 to 74, in an ultrasonic motor apparatus 300a of the fifteenth embodiment, screw threads are formed in the outer circumferential surface of a nut 307a and a fitting portion 311a of the case 310 in which the nut 307a is fitted in the fitting hole 311a (a screw portion 307a₁ in the outer circumferential surface of a nut 307a and a screw portion 311d in the fitting portion 311a). Accordingly, the nut 307a is screwed in the fitting portion 311d, thereby fixing the nut 307a to the case 310.

Because other components are similar to those of the fourteenth embodiment, the description is omitted.

Thus, in the fifteenth embodiment, although the operation of the ultrasonic motor apparatus 300a is similar to that of the fourteenth embodiment, because the case 310 and the nut 307 are fixed to each other by the screw, it is not necessary that the case 310 and the nut 307 be bonded to each other while the case 310 is pressed against the nut 307. The rotor portion 306a of the nut 307 is easy to press. Further, the nut 307 can be taken out from the case 310 only by screwing down the nut 307 when the trouble with the internal component such as the laminated piezoelectric element is generated, so that the ultrasonic motor apparatus 300a can easily be taken apart.

### Sixteenth Embodiment

An ultrasonic motor apparatus according to a sixteenth embodiment of the invention will be described below with reference to FIGS. 75 to 77.

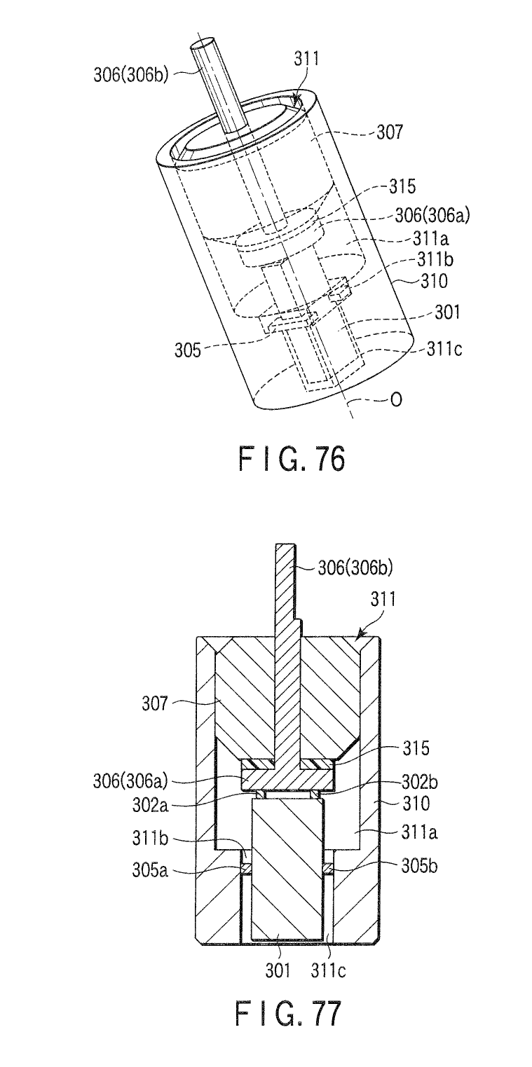

FIG. 75 is an exploded perspective view illustrating a configuration of the ultrasonic motor apparatus of the sixteenth embodiment. FIG. 76 is an assembly drawing illustrating the ultrasonic motor apparatus of the sixteenth embodiment, and FIG. 77 is a sectional view illustrating the ultrasonic motor apparatus of the sixteenth embodiment.

As illustrated in FIGS. 75 to 77, an ultrasonic motor apparatus 300b of the sixteenth embodiment differs from the ultrasonic motor apparatus 300 of the fourteenth embodiment in that a rotational contact member 315 whose surface is formed into a smooth ring shape is interposed between the nut 307 and the rotor portion 306a. That is, the shaft portion 306b of the shaft-integrated rotor 306 is inserted in an opening 315a provided in the center of the rotational contact member 315 and the shaft hole 308 of the nut 307. For example, the rotational contact member 315 includes a fluororesin (Teflon (registered trademark)) washer. A friction coefficient of the rotational contact member 315 is lower than that of the surface facing the rotor portion 306a of the nut 307.

Because other components are similar to those of the fourteenth to fifteenth embodiments, the description is omitted.

Thus, in the sixteenth embodiment, although the operation of the ultrasonic motor apparatus 300b is similar to those of the fourteenth and fifteenth embodiments, because the rotational contact member 315 is interposed between the nut 307 and the rotor portion 306a, the friction coefficient is lowered between the nut 307 and the rotor portion 306a. Accordingly, the rotation accuracy of the rotor portion 306a is improved compared with the configuration of the fourteenth embodiment on which the same pressing force acts.

(First Modification of Sixteenth Embodiment)

As described above, in the sixteenth embodiment, the rotational contact member 315 is interposed between the nut 307 and the rotor portion 306a to lower the friction coefficient of the rotational contact member 315. When the surface of the rotational contact member 315 is machined, the friction coefficient can further be lowered.

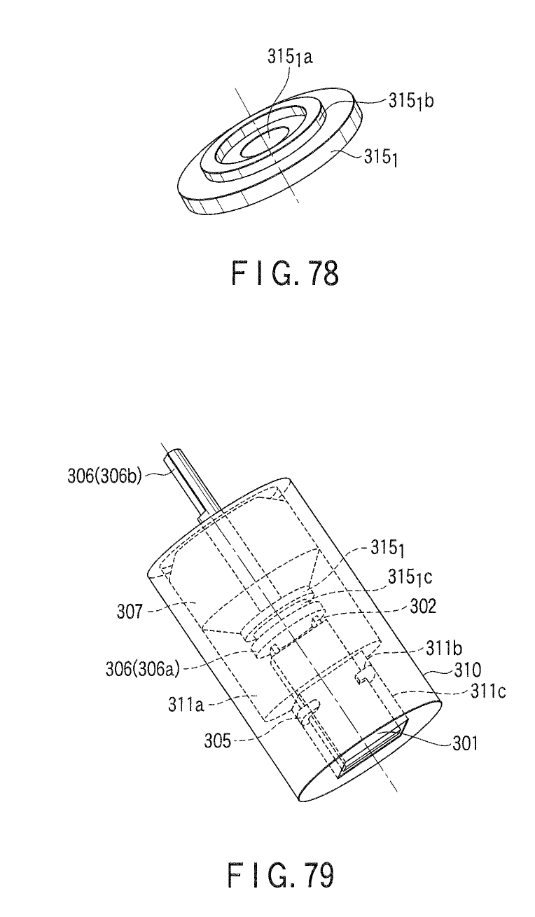

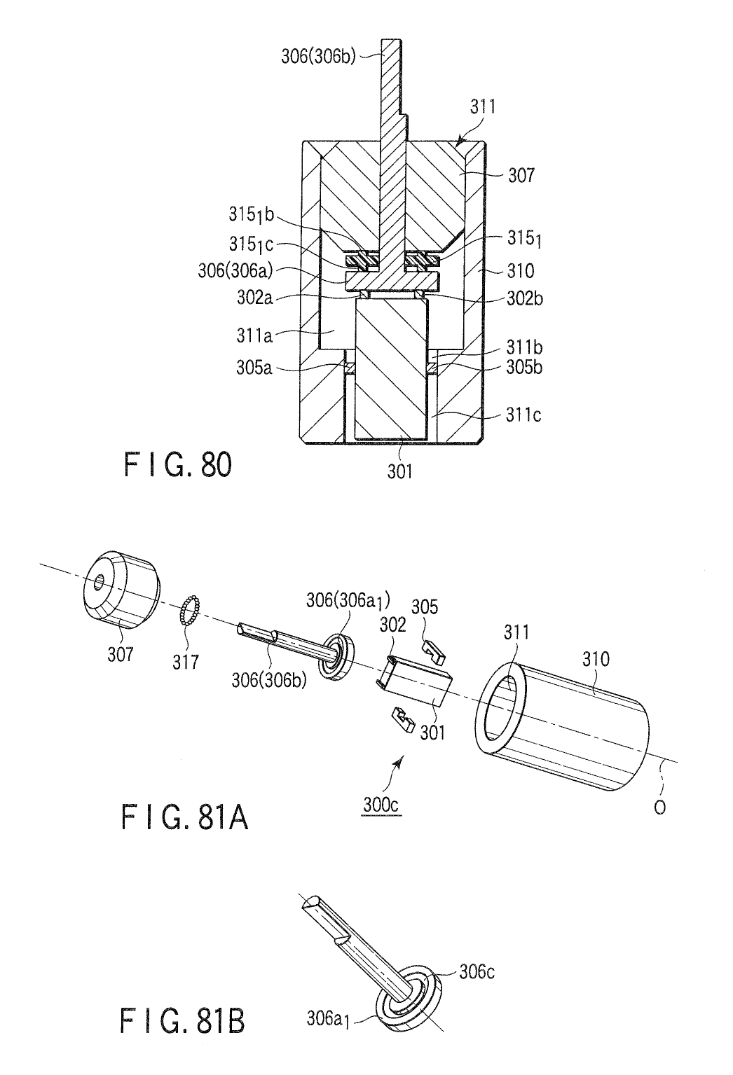

FIG. 78 is an appearance perspective view illustrating a configuration of a rotating contact member of an ultrasonic motor apparatus of the first modification of the sixteenth embodiment. FIG. 79 is an assembly drawing illustrating the ultrasonic motor apparatus of the first modification of the sixteenth embodiment, and FIG. 80 is a sectional view illustrating the ultrasonic motor apparatus of the first modification of the sixteenth embodiment.

As illustrated in FIGS. 78 to 80, in a rotational contact member 315₁ of the first modification of the sixteenth embodiment, projections 315₁b and 315₁c are continuously formed in the positions corresponding to the positions where the rotor portion 306a is in contact with the friction contact members 302a and 302b. The projection 315₁c is formed opposite the projection 315₁b in the rotational contact member 315₁. The shaft portion 306b of the shaft-integrated rotor 306 is inserted in the opening 315₁a.

Therefore, because the portions that do not relate to the rotation are not in contact with the shaft-integrated rotor 306 (the contact area is decreased), the rotation accuracy is further improved.

In the first modification of the sixteenth embodiment, the projections are provided in the rotational contact member. Alternatively, the projections may be provided in the nut 307 or the rotor portion 306a as long as the projections correspond to the positions that are in contact with the friction contact members 302a and 302b. The projections may be coated with Teflon (registered trademark).

(Second Modification of Sixteenth Embodiment)

In the sixteenth embodiment, the fluororesin washer is used as the rotational contact member 315 between the nut 307 and the rotor portion 306a. However, the rotational contact member is not limited to the fluororesin washer. For example, a solid lubricant (not illustrated) such as molybdenum disulfide may be used instead of the rotational contact member when the solid lubricant has an extremely low friction coefficient.

### Seventeenth Embodiment

An ultrasonic motor apparatus according to a seventeenth embodiment of the invention will be described below with reference to FIGS. 81 to 83.

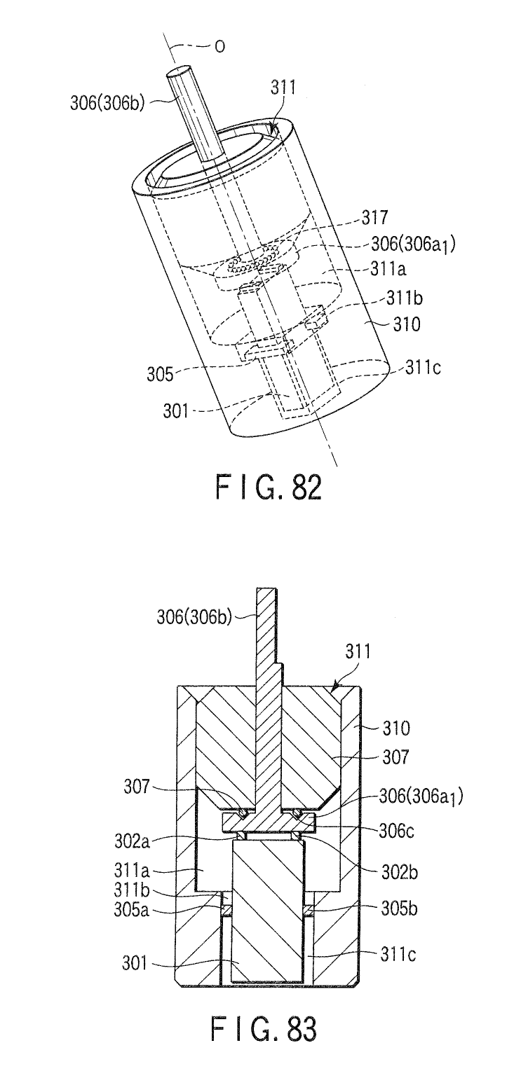

FIGS. 81A and 81B illustrate a configuration of the ultrasonic motor apparatus of the seventeenth embodiment of the invention, wherein FIG. 81A is an exploded perspective view of the ultrasonic motor apparatus, and FIG. 81B is an enlarged perspective view illustrating a shaft-integrated rotor of FIG. 81A. FIG. 82 is an assembly drawing illustrating an ultrasonic motor apparatus of the seventeenth embodiment, and FIG. 83 is a sectional view illustrating the ultrasonic motor apparatus of the seventeenth embodiment.

As illustrated in FIG. 81B, in the rotor portion 306a₁ of the shaft-integrated rotor 306, a continuous groove portion 306c is formed in the surface facing the nut 307 while being coaxial with the central axis O. As illustrated in FIG. 83, the groove portion 306c is formed in the portion corresponding to the position where the rotor portion 306a is in contact with the friction contact members 302a and 302b. Plural balls (rolling member used in the ball bearing) 317 are put in the groove portion 306c.

Because other components are similar to those of the fourteenth to sixteenth embodiments, the description is omitted.

In the seventeenth embodiment, although the operation of the ultrasonic motor apparatus 300c is similar to those of the fourteenth to sixteenth embodiments, the plural balls (rolling member used in the ball bearing) 317 are interposed between the nut 307 and the rotor portion 306a. Therefore, because the nut 307 and the rotor portion 306a are rotated while being in point contact with the balls 317, the contact area is largely decreased during the rotation compared with the configurations of the fourteenth to sixteenth embodiments.

When the rotor portion 306a is rotated, because the balls 317 are rotated while circulated, the rotation accuracy of the rotor portion 306a is dramatically improved compared with the configurations of the fourteenth to sixteenth embodiments.

### Eighteenth Embodiment

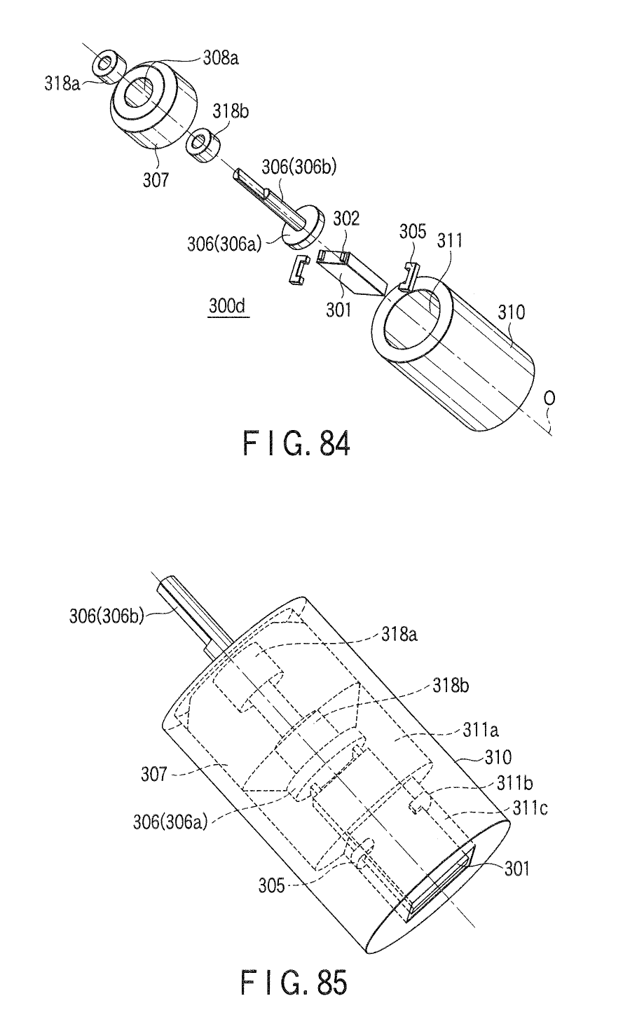

An ultrasonic motor apparatus according to an eighteenth embodiment of the invention will be described below with reference to FIGS. 84 to 86.

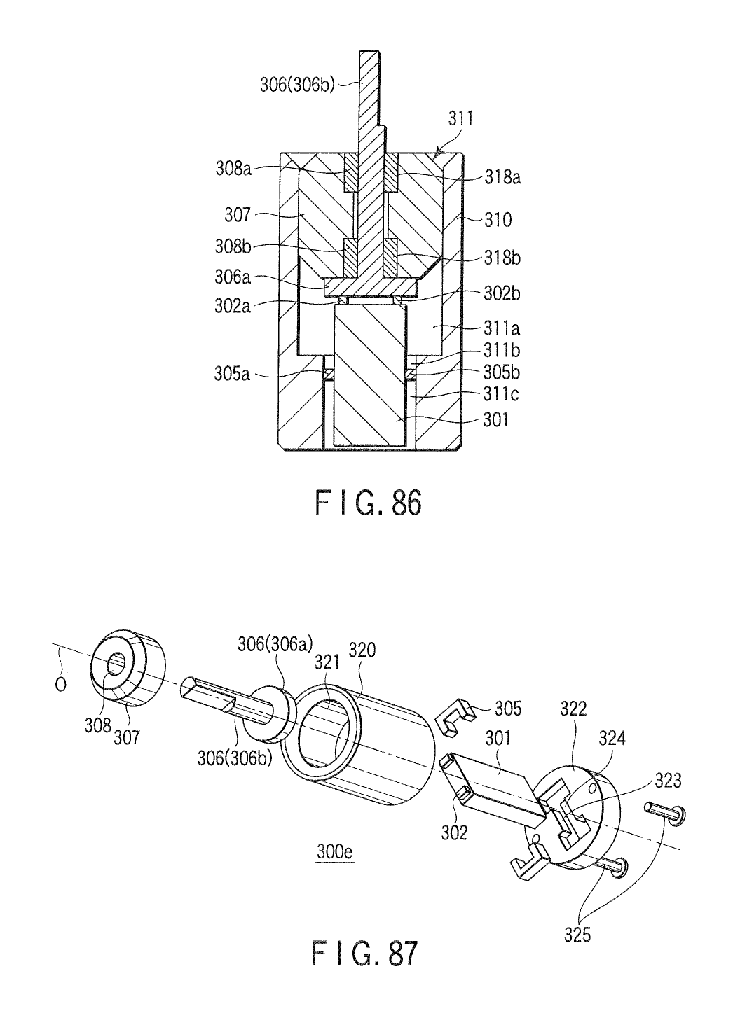

FIG. 84 is an exploded perspective view illustrating a configuration of the ultrasonic motor apparatus of the eighteenth embodiment. FIG. 85 is an assembly drawing illustrating the ultrasonic motor apparatus of the eighteenth embodiment, and FIG. 86 is a sectional view illustrating the ultrasonic motor apparatus of the eighteenth embodiment.

As illustrated in FIGS. 84 to 86, an ultrasonic motor apparatus 300d of the eighteenth embodiment differs from the ultrasonic motor apparatus 300 of the fourteenth embodiment in that rolling bearings 318a and 318b are added between the nut 307 and the shaft portion 306b. Therefore, holes 308a and 308b are made in end portions of the shaft hole 308 in the nut 307 in order to press-fit the rolling bearings 318a and 318b therein.

Because other components are similar to those of the fourteenth to seventeenth embodiments, the description is omitted.

In the eighteenth embodiment, the operation of the ultrasonic motor apparatus 300d is similar to those of the fourteenth to seventeenth embodiments. However, because the rolling bearings 318a and 318b are provided between the nut 307 and the shaft portion 306b, axial runout of the shaft portion 306b is suppressed compared with the configuration of the fourteenth embodiment in which the rotation is performed by the friction contact. Accordingly, the rotation accuracy of the rotor portion 306a is improved.

The two rolling bearings are used in the eighteenth embodiment. Alternatively, one or at least three rolling bearings may be used.

### Nineteenth Embodiment

An ultrasonic motor apparatus according to a nineteenth embodiment of the invention will be described below with reference to FIGS. 87 to 89.

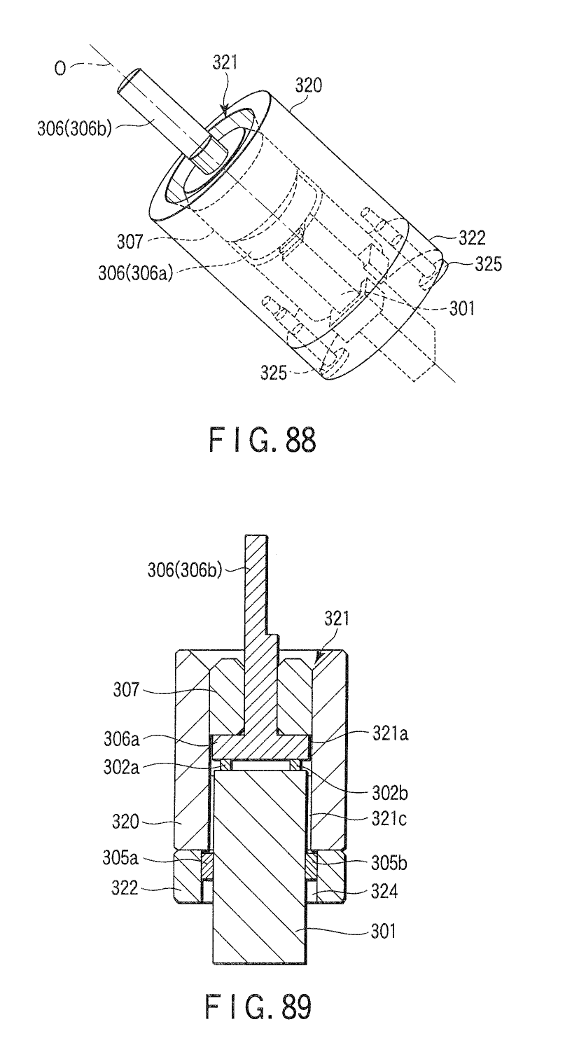

FIG. 87 is an exploded perspective view illustrating the ultrasonic motor apparatus of the nineteenth embodiment. FIG. 88 is an assembly drawing illustrating the ultrasonic motor apparatus of the nineteenth embodiment, and FIG. 89 is a sectional view illustrating the ultrasonic motor apparatus of the nineteenth embodiment.

As illustrated in FIGS. 87 to 89, an ultrasonic motor apparatus 300e of the nineteenth embodiment differs from the ultrasonic motor apparatus 300 of the fourteenth embodiment in that the case is vertically divided into two with the boundary of the fitting hole for the oscillator holder 305.

That is, the case of the nineteenth embodiment includes an upper case 320 and a lower case 322, and the upper case 320 and the lower case 322 are tightened by a case tightening screw 325. As with the case 310, a fitting hole 321 is made in the upper case 320 in order to fix the nut 307. On the other hand, a fitting hole 323 is made in the lower case 322 in order to fit the oscillator holder 305 therein. The fitting hole 323 is basically identical to the fitting hole 311b in the case 310 of the fourteenth embodiment. A hole 324 that is slightly larger than the outer dimensions of the laminated piezoelectric element 301 is made in the fitting hole 323.

The case tightening screw 325 is disposed in the position where the case tightening screw 325 is not in contact with the oscillator holder 305.

Because other components are similar to those of the fourteenth to eighteenth embodiments, the description is omitted.

The operation of the ultrasonic motor apparatus 300e of the nineteenth embodiment is similar to that of the fourteenth to eighteenth embodiments. However, the ultrasonic motor apparatus of the fourteenth to eighteenth embodiments has the integrated case. Therefore, due to the machining problem, it is necessary that the fitting hole for inserting the nut be formed larger than the fitting hole for the oscillator holder.

On the other hand, in the nineteenth embodiment, the case is vertically divided into two with the boundary of the fitting hole for the oscillator holder, so that the fitting hole 321 for inserting the case can be machined slightly larger than the outer dimensions of the laminated piezoelectric element 301 and the diameter of the rotor portion 306a. Therefore, because a margin is generated in the wall thickness of the case, the diameter of the case can be formed smaller than those of the fourteenth to eighteenth embodiments, and the motor can be miniaturized.

### Twentieth Embodiment

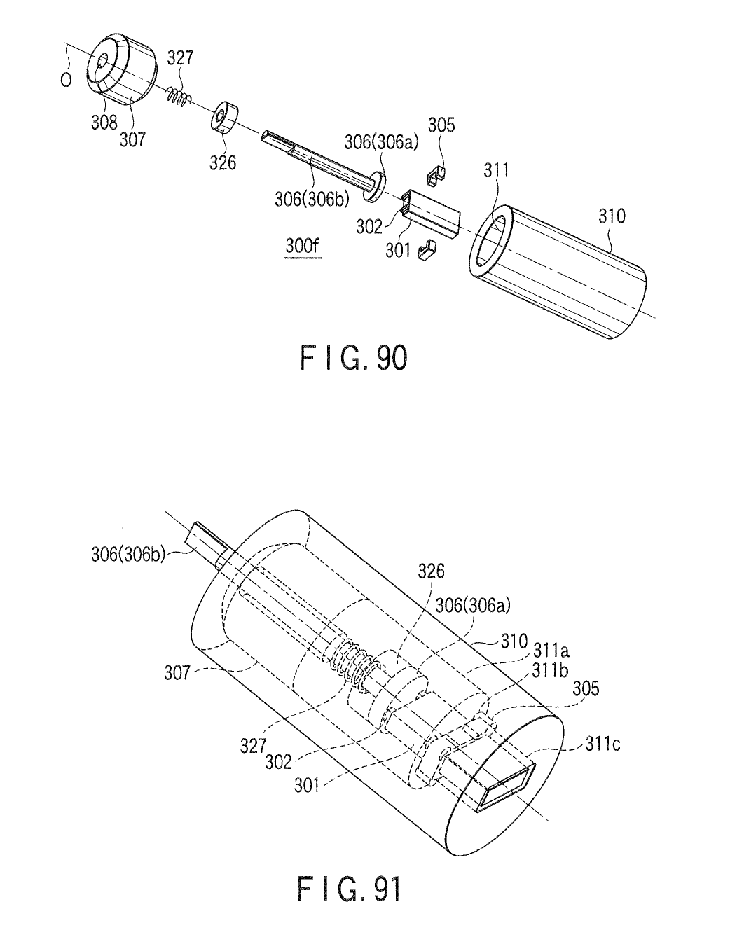

An ultrasonic motor apparatus according to a twentieth embodiment of the invention will be described below with reference to FIGS. 90 to 92.

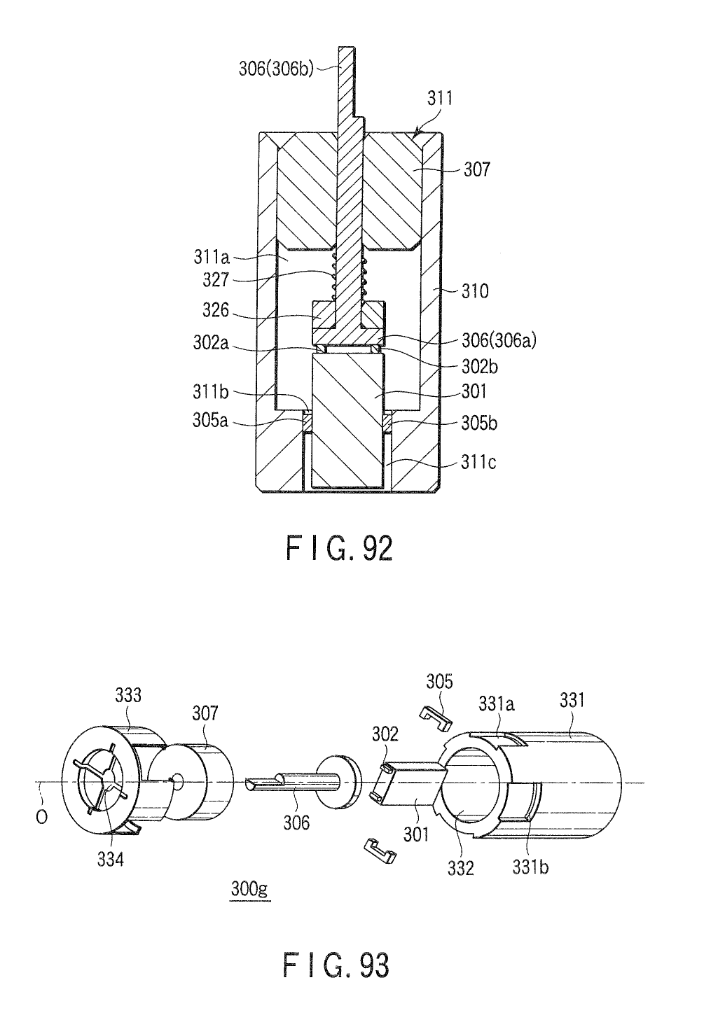

FIG. 90 is an exploded perspective view illustrating an ultrasonic motor apparatus of the twentieth embodiment. FIG. 91 is an assembly drawing illustrating the ultrasonic motor apparatus of the twentieth embodiment, and FIG. 92 is a sectional view illustrating the ultrasonic motor apparatus of the twentieth embodiment.

Referring to FIGS. 90 to 92, an ultrasonic motor apparatus 300f of the twentieth embodiment differs from the ultrasonic motor apparatus of the fourteenth embodiment in that the ring 326 and the spring 327 are interposed between the nut 307 and the rotor portion 306a. That is, the ring 326 and the spring 327 are inserted from the side of the rotor portion 306a in the shaft portion 306b of the shaft-integrated rotor 306, and the nut 307 is inserted in the shaft portion 306b.

Because other components are similar to those of the fourteenth to nineteenth embodiments, the description is omitted.

In the twentieth embodiment, the operation of the ultrasonic motor apparatus 300f is similar to those of the fourteenth to nineteenth embodiments. However, in the configuration of the fourteenth embodiment, because the nut 307 directly presses the rotor portion 306a, the pressing force cannot finely be adjusted. On the other hand, in the twentieth embodiment, the spring 327 and the ring 326 are interposed between the nut 307 and the rotor portion 306a to generate force transmission. That is, the nut 307 is pushed in the case 310, the spring 327 receives the pressing force of the nut 307, the ring 326 receives a restoring force of the spring 327, and finally the ring 326 imparts the restoring force to the rotor portion 306a.

The pressing force is determined by (contracting amount of spring)×(spring constant of spring), so that the pressing force can freely be adjusted only by changing the pushing amount of the nut 307. Accordingly, the pressing force is easy to adjust.

In the twentieth embodiment, the spring 327 and the ring 326 are interposed between the nut 307 and the rotor portion 306a. However, it is not always necessary to provide the ring, but the rotor portion 306a may directly receive the pressing force of the spring 327.

(First Modification of Twentieth Embodiment)

In the twentieth embodiment, the pressing force of the nut is imparted by the spring 327 and ring 326 that are interposed between the nut 307 and the rotor portion 306a. However, the invention is not limited to the twentieth embodiment.

In an ultrasonic motor apparatus according to a first modification of the twentieth embodiment, the case is detachably formed, and the pressing force is imparted by providing a plate spring portion in a cover that is one of the cases.

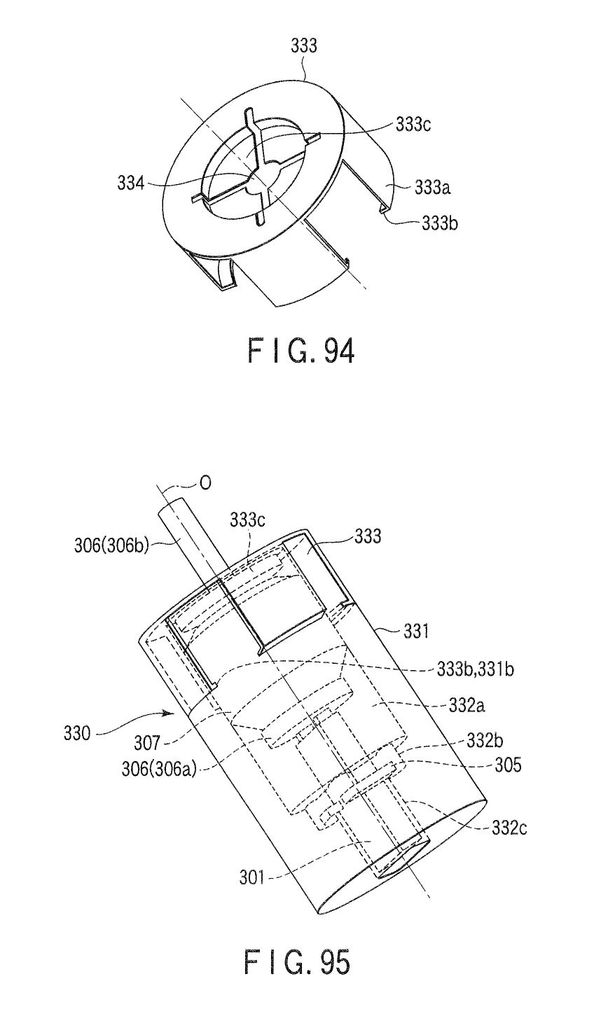

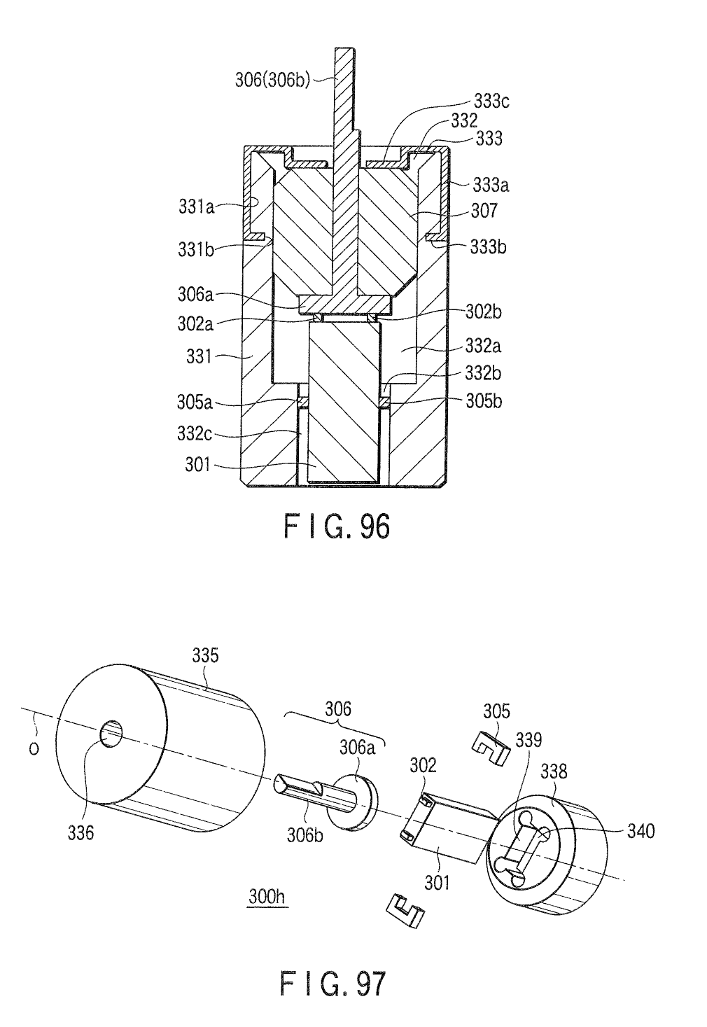

FIG. 93 is an exploded perspective view illustrating an ultrasonic motor apparatus of the first modification of the twentieth embodiment, and FIG. 94 is an appearance perspective view illustrating a configuration of a cover in a case of FIG. 93. FIG. 95 is an assembly drawing illustrating the ultrasonic motor apparatus of the first modification of the twentieth embodiment, and FIG. 96 is a sectional view illustrating the ultrasonic motor of the first modification of the twentieth embodiment.

In the first modification of the twentieth embodiment, a case 330 includes a case base portion 331 and a cover 333. In the outer circumferential surface of the cover 333, plural pawls (four pawls in the first modification of the twentieth embodiment) 333a are provided in the portion that is in contact with the nut 307. A hook portion 333b is formed in the leading end portion of the pawl 333a. The hook portion 333b corresponding to a hook portion 331b formed in the case base portion 331 is used to fix the cover 333, and the hook portion 333b is projected inward from the pawl 333a.

In the upper surface of the cover 333, the inner circumferential portion is recessed from the outer circumferential portion, and an opening 334 is formed in the position that is matched with a central axis O of an ultrasonic motor apparatus 300g. Plural slits (four slits in the first modification of the twentieth embodiment) are formed outward from the opening 334. The recessed portion that is partitioned by the slit is formed as a plate spring portion 333c, and the plate spring portion 333c has elasticity in order to come into contact with the upper surface of the nut 307 to press the nut 307.

On the other hand, plural guide portions (four guide portions in the first modification of the twentieth embodiment) 331a are provided above the outer circumferential surface of the case base portion 331 in order to engage with the pawls 333a of the cover 333. The guide portions 331a are slightly recessed compared with other portions in the outer circumferential surface of the case base portion 331. The hook portion 331b is formed in the end portion of the hook portion 331a, and the hook portion 333b of the cover 333 is fitted in the hook portion 331b to fix the cover 333.

That is, the pawl 333a and hook portion 333b of the cover 333 are positioned along the guide portion 331a of the case base portion 331. Then the hook portion 333b of the cover 333 is engaged with the hook portion 331b of the case base portion 331 to cover the case base portion 331 with the cover 333. At this point, the plate spring portion 333c is deformed to generate the restoring force by coming into contact with the upper surface of the nut 307, so that the pressing force can appropriately be imparted when the nut 307 is attached to the case 330.

Thus, in the first modification of the twentieth embodiment, it is not necessary that the nut be bonded while pressed. The nut is detached from the case by spreading the four pawls hooked in the case when the internal component such as the laminated piezoelectric element has a breakdown, so that the motor can easily be taken apart.

### Twenty-First Embodiment

An ultrasonic motor apparatus according to a twenty-first embodiment of the invention will be described below with reference to FIGS. 97 to 99.

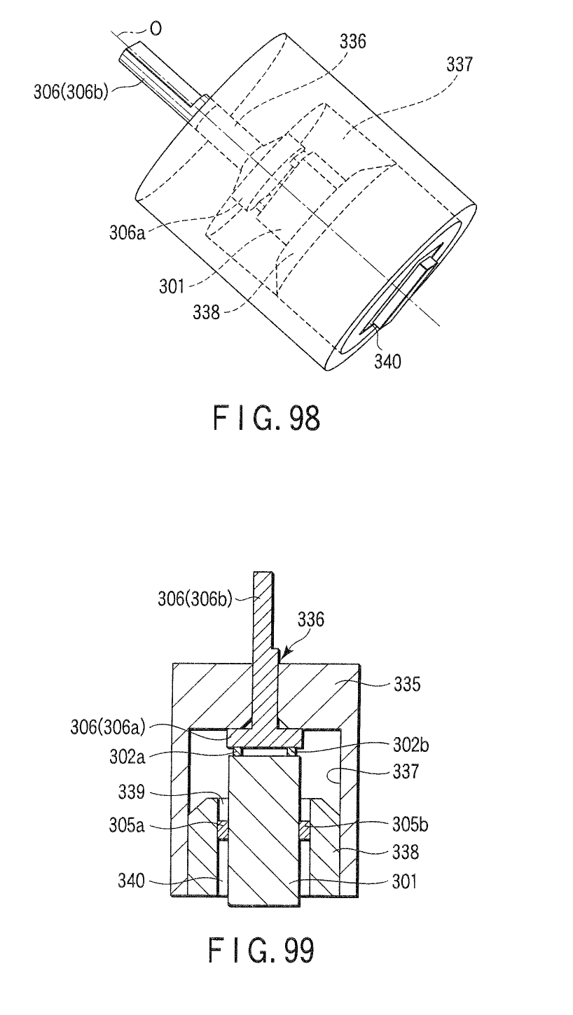

FIG. 97 is an exploded perspective view illustrating a configuration of the ultrasonic motor apparatus of the twenty-first embodiment. FIG. 98 is an assembly drawing illustrating the ultrasonic motor apparatus of the twenty-first embodiment, and FIG. 99 is a sectional view illustrating the ultrasonic motor apparatus of the twenty-first embodiment.

As illustrated in FIGS. 97 to 99, the nut is provided in the lower portion of the motor in an ultrasonic motor apparatus 300h of the twenty-first embodiment while the nut is provided in the upper portion of the motor in the ultrasonic motor apparatus of the fourteenth to twentieth embodiments.

A hole 340 is made in the central portion of a nut 338, and a diameter of the hole is slightly larger than the outer dimensions of the laminated piezoelectric element 301. The hole 340 is not a shaft hole through which the shaft portion 306b of the shaft-integrated rotor 306 is pierced, but a fitting hole 339 and the laminated piezoelectric element 301 are pierced through the hole 340 in order to fix the oscillator holder 305.

On the other hand, a fitting hole for the oscillator holder 305 does not exist in a case 335, but a shaft hole 336 is made in order to insert the shaft portion 306b of the shaft-integrated rotor 306 therein. A fitting hole 337 for fitting the nut is made from the lower portion of the case 335 to the upper surface of the rotor portion 306a. At this point, the nut 338 is bonded and fixed to the case 335.

Because other components are similar to those of the fourteenth to twentieth embodiments, the description is omitted.

In assembling the ultrasonic motor apparatus of the twenty-first embodiment, the laminated piezoelectric element 301 is fitted in and fixed to the fitting hole 339 of the nut 338 with the oscillator holder 305 interposed therebetween, and the integrated nut 338 is fitted in and fixed to the case 335 while pressed in the axial direction (on the side of the rotor portion 306a) such that the pressing force is appropriately obtained to an extent that the shaft portion 306b can be rotated.

In the configuration of the fourteenth embodiment, the pressing is performed in the order of nut→rotor portion→laminated piezoelectric element. On the other hand, in the configuration of the twenty-first embodiment, the pressing is performed in the order of nut (laminated piezoelectric element)→rotor portion.

Thus, in the twenty-first embodiment, the elliptic oscillation in which the longitudinal and twisting oscillation modes are combined can be formed only by the single oscillator, and the rotor can be rotated by the elliptic oscillation to transmit the torque in the axial direction.

In the twenty-first embodiment, the nut is bonded and fixed to the case. Alternatively, as with the fifteenth embodiment, the screw threads are formed in the nut and the fitting portion of the case, and the nut and the case may be fixed by screwing the nut.

In the twenty-first embodiment, the U-shape oscillator holder is used. Alternatively, as described above, the laminated piezoelectric element may be retained by at least two pins.

In the present invention, elliptic oscillation can be generated at any position on an upper and/or bottom surface of the oscillator, and rotors of various sizes can be rotated. In addition, the friction contact members can arranged at any position. Therefore, the invention can provide an improved ultrasonic motor having enhanced stability during rotation against friction loss of the friction contact members arranged between the rotor and the upper and/or bottom surface of the oscillator.

The embodiments of the invention have been described above. However, the invention is not limited to the embodiments, but various modifications can be made without departing from the scope of the invention.

An ultrasonic motor according to the present invention is incomparably small and is desirably used in a situation where adverse effects by a magnetic field must be avoided or in a situation where complete quietness is required. For example, an ultrasonic motor according to the present invention is suitably applied to an actuator which contributes to the robotics of a medical catheter, the driving section of a microscope, the lens driving section of a camera for a mobile phone, the angle-changing driving section for a head rest, the indoor-use air supply motor of an air cleaner, the paper feed motor of a printer or the like, etc.

The ultrasonic motor according to the present invention may be fan-shaped or tapered as long as the rectangle ratio in a section serves to match the resonant frequencies of different oscillation modes as in a section of an ellipse or a rhombus.

The present invention is not limited to the case where the interdigital electrodes described in the specification are used. What is required of the present invention is that a polarization electrode is arranged at a predetermined angle with respect to the rotation axis.

The above-described embodiments include the inventions at various stages, and various inventions can be extracted from proper combinations of the disclosed constituents. For example, even if some constituents are removed from all the constituents illustrated in the embodiments, the configuration in which the some constituents are removed can be extracted as the invention when the problem can be solved by the invention and when the effect of the invention is obtained.

The foregoing embodiments of the present invention provide the following configurations:

(1). An ultrasonic motor comprising:

a substantially-rectangular-solid oscillator whose section perpendicular to a central axis has a rectangular length ratio; and

a driven body that is rotated about the central axis as a rotation axis while being in contact with an elliptic oscillation generating surface of the oscillator, the central axis being orthogonal to the elliptic oscillation generating surface of the oscillator,

wherein the elliptic oscillation is formed to rotate the driven body by combining a first oscillation in which expansion and contraction are performed in a direction of the rotation axial direction of the oscillator and a second oscillation in which the expansion and contraction are performed in a direction orthogonal to the rotation axial direction.

(2). The ultrasonic motor according to the (1), wherein the first oscillation is a first longitudinal resonance oscillation, and the second oscillation is a second twisting resonance oscillation in which the rotation axis is a twisting axis.

(3). The ultrasonic motor according to the (2), wherein the rectangular length ratio of the oscillator is set such that a resonance frequency of the first longitudinal resonance oscillation in which the expansion and contraction are performed in the direction of the rotation axial direction of the oscillator is substantially matched with a resonance frequency of the second twisting resonance oscillation in which the rotation axis is a twisting axis.

(4). The ultrasonic motor according to the (3), wherein a ratio of a rectangular short side to a rectangular long side is set to about 0.6 in the rectangular length ratio of the oscillator.

(5). The ultrasonic motor according to the (4), wherein a section orthogonal to the rotation axial direction of the oscillator has a substantially rectangular shape.

(6). The ultrasonic motor according to the (2), wherein the oscillator includes only a piezoelectric element,

a first driving interdigital electrode is provided in a surface parallel to the rotation axis and near at least one node position of twisting oscillation in the surface parallel to the rotation axis in the piezoelectric element,

an angle θ formed by a longitudinal direction of the first driving interdigital electrode and the rotation axis direction is provided on the following condition:

0<θ<π/2,

a second driving interdigital electrode is provided in a surface facing the surface in which the first driving interdigital electrode is provided, and

an angle τ formed by a longitudinal direction of the second driving interdigital electrode and the rotation axis direction is provided on the following condition:

τ=π−θ.

(7). The ultrasonic motor according to any one of the (2) to (5), wherein the oscillator includes only a piezoelectric element,

a first driving interdigital electrode is provided in a surface parallel to the rotation axis and near at least one node position of twisting oscillation in the surface parallel to the rotation axis in the piezoelectric element,

an angle θ formed by a longitudinal direction of the first driving interdigital electrode and the rotation axis direction is provided on the following condition:

0<θ<π/2,

a second driving interdigital electrode is provided near a twisting node position in an opposite direction to the twisting in the surface in which the first driving interdigital electrode is provided, and

an angle τ formed by a longitudinal direction of the second driving interdigital electrode and the rotation axis direction is provided on the following condition:

τ=θ.

(8). The ultrasonic motor according to the (6) or (7), wherein the oscillator includes only a piezoelectric element,

a first oscillation detecting interdigital electrode is provided in a surface parallel to the rotation axis and near at least one node position of twisting oscillation in the surface parallel to the rotation axis in the piezoelectric element,
an angle φ formed by a longitudinal direction of the first oscillation detecting interdigital electrode and the rotation axis direction is provided on the following condition:

0<φ<π/2,

a second oscillation detecting interdigital electrode is provided in a surface facing the surface in which the first oscillation detecting interdigital electrode is provided, and

an angle ψ formed by a longitudinal direction of the second oscillation detecting interdigital electrode and the rotation axis direction is provided on the following condition:

ψ=π−φ.

(9). The ultrasonic motor according to the (6) or (7), wherein the oscillator includes only a piezoelectric element,

a first oscillation detecting interdigital electrode is provided in a surface parallel to the rotation axis and near at least one node position of twisting oscillation in the surface parallel to the rotation axis in the piezoelectric element,

an angle φ formed by a longitudinal direction of the first oscillation detecting interdigital electrode and the rotation axis direction is provided on the following condition:

0<φ<π/2,

a second oscillation detecting interdigital electrode is provided near a twisting node position in an opposite direction to the twisting in the surface in which the first oscillation detecting interdigital electrode is provided, and

an angle ψ formed by a longitudinal direction of the second oscillation detecting interdigital electrode and the rotation axis direction is provided on the following condition:

ψ=φ.

(10). The ultrasonic motor according to the (6) or (7), wherein the driving interdigital electrodes are provided in a plurality of positions in each surface.

(11). The ultrasonic motor according to the (8) or (9), wherein the oscillation detecting interdigital electrodes are provided in a plurality of positions in each surface.

(12). The ultrasonic motor according to any one of the (2) to (11), further comprising:

a throughhole that is made in a central portion in the twisting axial direction of the oscillator; and

a shaft that is fixed in a substantially central portion of the throughhole,

wherein the driven body is retained while being rotatable about the shaft.

(13). The ultrasonic motor according to the (1), wherein the first oscillation is a first longitudinal resonance oscillation, and the second oscillation is a third twisting resonance oscillation in which the rotation axis is a twisting axis.

(14). The ultrasonic motor according to the (13), wherein the rectangular length ratio of the oscillator is set such that a resonance frequency of the first longitudinal resonance oscillation in which the expansion and contraction are performed in the direction of the rotation axial direction of the oscillator is substantially matched with a resonance frequency of the third twisting resonance oscillation in which the rotation axis is a twisting axis.

(15). The ultrasonic motor according to the (14), wherein a ratio of a rectangular short side to a rectangular long side is set to about 0.3 in the rectangular length ratio of the oscillator.

(16). The ultrasonic motor according to the (15), wherein a section orthogonal to the rotation axial direction of the oscillator has a substantially rectangular shape.

(17). The ultrasonic motor according to the (1), wherein the oscillator includes a single piezoelectric element a polarization direction of the piezoelectric element exists substantially in an inplane direction of a side surface of the oscillator, the inplane direction including the central axis direction, and an angle formed by the polarization direction and the central axis direction is set so as to satisfy the following condition:

0<ε<π/2, and

a first longitudinal resonance oscillation in which expansion and contraction are performed in the rotation axial direction of the oscillator and a third twisting resonance oscillation in which the rotation axis is a twisting axis are combined to form the elliptic oscillation, thereby rotating the driven body.

(18). The ultrasonic motor according to the (17), wherein a ratio of a short side of a substantially rectangular section to a long side is set to about 0.3 such that a resonance frequency of the first longitudinal resonance oscillation in which expansion and contraction are performed in the rotation axial direction of the oscillator is substantially matched with a resonance frequency of the third twisting resonance oscillation in which the rotation axis is a twisting axis, the substantially rectangular section being orthogonal to the rotation axis of the oscillator.

(19). The ultrasonic motor according to the (1), wherein the oscillator includes a single piezoelectric element,

a polarization direction of the piezoelectric element exists substantially in an inplane direction of a side surface of the oscillator, the inplane direction including the central axis direction, and an angle ε formed by the polarization direction and the central axis direction is set so as to satisfy the following condition:

0ε<π/2, and

a first longitudinal resonance oscillation in which expansion and contraction are performed in the rotation axial direction of the oscillator and a second twisting resonance oscillation in which the rotation axis is a twisting axis are combined to form the elliptic oscillation, thereby rotating the driven body.

(20). The ultrasonic motor according to the (19), wherein a ratio of a short side of a substantially rectangular section to a long side is set to about 0.6 such that a resonance frequency of the first longitudinal resonance oscillation in which expansion and contraction are performed in the rotation axial direction of the oscillator is substantially matched with a resonance frequency of the second twisting resonance oscillation in which the rotation axis is a twisting axis, the substantially rectangular section being orthogonal to the rotation axis of the oscillator.

(21). The ultrasonic motor according to the (17) or (18), wherein the polarization is formed in a position including at least one node portion in three node portions of the third twisting resonance oscillation.

(22). The ultrasonic motor according to the (19) or (20), wherein the polarization is formed in a position including at least one node portion in two node portions of the second twisting resonance oscillation.

(23). The ultrasonic motor according to any one of the (17) to (22), comprising:

an internal electrode that is divided into at least two groups with a boundary of a surface including the central axis, the surface being parallel to an outer side surface of the oscillator; and

a plurality of external electrodes that are provided in the outer side surface of the oscillator and connected to the internal electrode,

wherein the polarization is formed between the internal electrodes, and

an alternate voltage is applied to said plurality of external electrodes to excite the elliptic oscillation, thereby rotating the driven body.

(24). The ultrasonic motor according to the (23), wherein the oscillator is formed by laminating a plurality of first piezoelectric sheets and a plurality of second piezoelectric sheets with a boundary of a surface including the central axis, the surface being parallel to an outer side surface of the oscillator, a plurality of first interdigital internal electrode patterns being formed in said plurality of first piezoelectric sheets, a plurality of second interdigital internal electrode patterns being formed in said plurality of second piezoelectric sheets.

(25). The ultrasonic motor according to the (24), wherein at least one of said plurality of first interdigital electrode patterns of the first piezoelectric sheets and at least one of said plurality of second interdigital electrode patterns of the second piezoelectric sheet are a driving interdigital electrode.

(26). The ultrasonic motor according to the (24) or (25), wherein at least one of said plurality of first interdigital electrode patterns of the first piezoelectric sheets and at least one of said plurality of second interdigital electrode patterns of the second piezoelectric sheets are an oscillation detecting interdigital electrode.

(27). The ultrasonic motor according to the (23), further comprising:

a first laminated body in which first piezoelectric sheets and second piezoelectric sheets are alternately laminated, a first right-digit internal electrode pattern being formed in the first piezoelectric sheet, a second left-digit electrode pattern being formed in the second piezoelectric sheet; and

a second laminated body in which third piezoelectric sheets and fourth piezoelectric sheets are alternately laminated, a third right-digit internal electrode pattern being formed in the third piezoelectric sheet, a fourth left-digit electrode pattern being formed in the fourth piezoelectric sheet,

wherein the first laminated body and the second laminated body are integrally formed in the oscillator with the boundary of the surface including the central axis, the surface being parallel to an outer side surface of the oscillator.

(28). The ultrasonic motor according to the (27), wherein at least one in said plurality of interdigital electrode patterns including the internal electrodes of the first piezoelectric sheet and the second piezoelectric sheet and at least one in said plurality of interdigital electrode patterns including the internal electrodes of the third piezoelectric sheet and the fourth piezoelectric sheet are a driving interdigital electrode.

(29). The ultrasonic motor according to the (27) or (28), wherein at least one in said plurality of interdigital electrode patterns including the internal electrodes of the first piezoelectric sheet and the second piezoelectric sheet and at least one in said plurality of interdigital electrode patterns including the internal electrodes of the third piezoelectric sheet and the fourth piezoelectric sheet are an oscillation detecting interdigital electrode.

(30). The ultrasonic motor according to the (1), wherein the oscillator is formed by laminating a plurality of piezoelectric sheets in which interdigital electrode patterns are formed,

a first driving interdigital electrode is provided near a first node position of twisting oscillation in the surface parallel to the rotation axis in the piezoelectric sheet,

an angle θ formed by a digital direction of the interdigital electrode and the rotation axis direction is provided on the following condition:

0<θ<π/2,

a second driving interdigital electrode is provided near a second node position of the twisting oscillation in the surface parallel to the rotation axis, the second driving interdigital electrode being electrically connected in parallel to the driving electrode,

an angle φ formed by a digital direction of the interdigital electrode and the rotation axis direction is provided on the following condition:

π/2<φ<π,

an oscillation detecting interdigital electrode is provided near a third node position of the twisting oscillation in the surface parallel to the rotation axis,

an angle ψ formed by a digital direction of the second driving interdigital electrode and the central axis direction is provided on conditions except for 0, π/2, and π, and

a first longitudinal resonance oscillation in which expansion and contraction are performed in the rotation axial direction of the oscillator and a third twisting resonance oscillation in which the rotation axis is a twisting axis are combined to form the elliptic oscillation.

(31). The ultrasonic motor according to the (1), wherein the oscillator is formed by laminating a plurality of first piezoelectric sheets in which driving interdigital electrode patterns are formed,

a first driving interdigital electrode is provided near a first node position of twisting oscillation in the surface parallel to the rotation axis in the first piezoelectric sheet,

an angle θ formed by a digital direction of the interdigital electrode and the central axis direction is provided on the following condition:

0<θ<π/2,

an oscillation detecting interdigital electrode is provided near a second node position of the twisting oscillation in the surface parallel to the rotation axis,

an angle ψ formed by a digital direction of the oscillation detecting interdigital electrode and the central axis direction is provided on conditions except for 0, π/2, and π, and

a first longitudinal resonance oscillation in which expansion and contraction are performed in the rotation axial direction of the oscillator and a second twisting resonance oscillation in which the rotation axis is a twisting axis are combined to form the elliptic oscillation.

(32). The ultrasonic motor according to the (13), wherein the oscillator is formed by alternately laminating a plurality of first piezoelectric sheets in which driving internal electrode patterns are formed and a plurality of second piezoelectric sheets in which the driving internal electrode patterns are formed,

a left digit side of a driving interdigital electrode is provided near at least one node position of twisting oscillation in the surface parallel to the rotation axis in the first piezoelectric sheet,

an angle θ formed by a longitudinal direction of the left-digit internal electrode and the rotation axis direction is provided on the following condition:

0<θ<π/2,

a right digit side of the driving interdigital electrode is provided near the node position of the twisting oscillation in the surface parallel to the rotation axis in the second piezoelectric sheet,

an angle formed by a longitudinal direction of the right-digit-side internal electrode and the rotation axis direction is provided to be identical to an angle formed by a longitudinal direction of the left-digit-side internal electrode and the rotation axis direction,

the driving internal electrode of the first piezoelectric sheet and the driving internal electrode of the second piezoelectric sheet substantially constitute a pair of interdigital electrodes,

parts of the driving internal electrodes of the first piezoelectric sheet and second piezoelectric sheet are extended to an end portion of each piezoelectric sheet to be electrically connected to an external electrode of each piezoelectric sheet, and

the extended portion of the driving internal electrode of the first piezoelectric sheet and the extended portion of the driving internal electrode of the second piezoelectric sheet are connected to different external electrodes with a boundary of a substantially central portion in the laminated direction.

(33). The ultrasonic motor according to the (2), wherein the oscillator is formed by alternately laminating a plurality of first piezoelectric sheets in which driving internal electrode patterns are formed and a plurality of second piezoelectric sheets in which the driving internal electrode patterns are formed,

a left digit side of a driving interdigital electrode is provided near at least one node position of twisting oscillation in the surface parallel to the rotation axis in the first piezoelectric sheet,

an angle θ formed by a longitudinal direction of the left-digit internal electrode and the rotation axis direction is provided on the following condition:

0<θ<π/2,

a right digit side of the driving interdigital electrode is provided near the node position of the twisting oscillation in the surface parallel to the rotation axis in the second piezoelectric sheet,

an angle formed by a longitudinal direction of the right-digit-side internal electrode and the rotation axis direction is provided to be identical to an angle formed by a longitudinal direction of the left-digit-side internal electrode and the rotation axis direction,

the driving internal electrode of the first piezoelectric sheet and the driving internal electrode of the second piezoelectric sheet substantially constitute a pair of interdigital electrodes,

parts of the internal electrodes of the first piezoelectric sheet and second piezoelectric sheet are extended to an end portion of each piezoelectric sheet to be electrically connected to an external electrode of each piezoelectric sheet, and

the extended portion of the driving internal electrode of the first piezoelectric sheet and the extended portion of the driving internal electrode of the second piezoelectric sheet are connected to different external electrodes with a boundary of a substantially central portion in the laminated direction.

(34) The ultrasonic motor according to the (13), wherein the oscillator is formed by alternately laminating a plurality of first piezoelectric sheets in which oscillation detecting internal electrode patterns are formed and a plurality of second piezoelectric sheets in which the oscillation detecting internal electrode patterns are formed,

a left digit side of an oscillation detecting interdigital electrode is provided near at least one node position of twisting oscillation in the surface parallel to the rotation axis in the first piezoelectric sheet,

an angle θ formed by a longitudinal direction of the left-digit internal electrode and the rotation axis direction is provided on the following condition:

0<θ<π/2,

a right digit side of the oscillation detecting interdigital electrode is provided near the node position of the twisting oscillation in the surface parallel to the rotation axis in the second piezoelectric sheet,

an angle formed by a longitudinal direction of the right-digit-side internal electrode and the rotation axis direction is provided to be identical to an angle formed by a longitudinal direction of the left-digit-side internal electrode and the rotation axis direction,

the oscillation detecting internal electrode of the first piezoelectric sheet and the oscillation detecting internal electrode of the second piezoelectric sheet substantially constitute a pair of interdigital electrodes,

parts of the oscillation detecting internal electrodes of the first piezoelectric sheet and second piezoelectric sheet are extended to an end portion of each piezoelectric sheet to be electrically connected to an external electrode of each piezoelectric sheet, and

the extended portion of the oscillation detecting internal electrode of the first piezoelectric sheet and the extended portion of the oscillation detecting internal electrode of the second piezoelectric sheet are connected to different external electrodes with a boundary of a substantially central portion in the laminated direction.

(35). The ultrasonic motor according to the (2), wherein the oscillator is formed by alternately laminating a plurality of first piezoelectric sheets in which oscillation detecting internal electrode patterns are formed and a plurality of second piezoelectric sheets in which the oscillation detecting internal electrode patterns are formed,

a left digit side of an oscillation detecting interdigital electrode is provided near at least one node position of twisting oscillation in the surface parallel to the rotation axis in the first piezoelectric sheet,

an angle θ formed by a longitudinal direction of the left-digit internal electrode and the rotation axis direction is provided on the following condition:

0<θ<π/2,

a right digit side of the oscillation detecting interdigital electrode is provided near the node position of the twisting oscillation in the surface parallel to the rotation axis in the second piezoelectric sheet,

an angle formed by a longitudinal direction of the right-digit-side internal electrode and the rotation axis direction is provided to be identical to an angle formed by a longitudinal direction of the left-digit-side internal electrode and the rotation axis direction,

the oscillation detecting internal electrode of the first piezoelectric sheet and the oscillation detecting internal electrode of the second piezoelectric sheet substantially constitute a pair of oscillation detecting interdigital electrodes,

parts of the oscillation detecting internal electrodes of the first piezoelectric sheet and second piezoelectric sheet are extended to an end portion of each piezoelectric sheet to be electrically connected to an external electrode of each piezoelectric sheet, and

the extended portion of the oscillation detecting internal electrode of the first piezoelectric sheet and the extended portion of the oscillation detecting internal electrode of the second piezoelectric sheet are connected to different external electrodes with a boundary of a substantially central portion in the laminated direction.

(36). The ultrasonic motor according to any one of the (23) to (35), wherein the external electrode is provided only in one of side surfaces of the oscillator.

(37). The ultrasonic motor according to any one of the (17), (18), (21), (30), (32), and (34), further comprising:

an oscillator holder that is fixed in a substantially central portion of the oscillator;

a shaft that is retained by the oscillator holder; and

a spring that presses the driven body against the oscillator, the driven body being retained while being rotatable with respect to the shaft.

(38). The ultrasonic motor according to any one of the (19), (20), (22), (31), (33), and (35), further comprising:

a throughhole that is made in a portion corresponding to the rotation axis of the oscillator;

a shaft that is fixed in a substantially central portion of the throughhole; and

a spring that presses the driven body against the oscillator, the driven body being retained while being rotatable with respect to the shaft.

(39). The ultrasonic motor according to any one of the (17) to (38), wherein the oscillator is substantially symmetrically disposed in relation to a virtual center line in a section orthogonal to a central axis, the virtual center line passing through the central axis and being parallel to a short side or a long side of a rectangular shape.

(40). The ultrasonic motor according to the (1), wherein the oscillator includes:

a substantially-rectangular-solid elastic body whose section perpendicular to the central axis has a substantially rectangular shape, the elastic body having a first side surface and a second side surface, the first side surface including one side of the substantially rectangular shape, the first side surface and the second side surface making a pair;

a first piezoelectric element that is disposed while facing the first side surface of the elastic body; and

a second piezoelectric element that is disposed while facing the second side surface of the elastic body, and

a first longitudinal resonance oscillation in which expansion and contraction are performed in the rotation axial direction of the oscillator and a second twisting resonance oscillation or a third twisting resonance oscillation, in which the rotation axis is a twisting axis, are combined to form the elliptic oscillation, thereby rotating the rotor.

(41). The ultrasonic motor according to the (40), wherein a polarization direction of the first piezoelectric element exists substantially in an inplane direction of the first side surface of the elastic body, and an angle α formed by the polarization direction and the central axis when the center axial direction is viewed is set so as to satisfy the following condition:

0<α<π/2, and

a polarization direction of the second piezoelectric element exists substantially in an inplane direction of the second side surface of the elastic body, and an angle β formed by the polarization direction and the central axis when the center axial direction is viewed is set so as to satisfy the following condition:

β=−α.

(42). The ultrasonic motor according to the (41), wherein the polarization is formed in a position including at least one of two node portions of the second twisting resonance oscillation.

(43). The ultrasonic motor according to the (41), wherein the polarization is formed in a position including at least one of three node portions of the third twisting resonance oscillation.

(44). The ultrasonic motor according to any one of the (41) to (43), wherein the polarization of the first piezoelectric element and the polarization of the second piezoelectric element are formed by an interdigital electrode in which a plurality of electrode patterns are disposed while intersecting.

(45). The ultrasonic motor according to the (44), wherein the interdigital electrode includes a driving electrode and an oscillation detecting electrode.

(46). The ultrasonic motor according to the (44) or (45), wherein the first piezoelectric element and the second piezoelectric element are a laminated type piezoelectric element having a structure in which a plurality of piezoelectric sheets are laminated, the interdigital electrode being disposed while inclined by a predetermined angle with respect to the central axis in the piezoelectric sheet.

(47). The ultrasonic motor according to any one of the (44) to (46), wherein antiphase alternate voltages are applied to driving interdigital electrodes of the first piezoelectric element and second piezoelectric element to simultaneously excite the first longitudinal resonance oscillation and the second twisting resonance oscillation or third twisting resonance oscillation, and

the elliptic oscillation is generated to rotate the rotor in a predetermined direction.

(48). The ultrasonic motor according to any one of the (45) to (47), wherein a signal supplied from the oscillation detecting electrode of the first piezoelectric element and a signal supplied from the oscillation detecting electrode of the second piezoelectric element are connected in parallel to detect the longitudinal oscillation or twisting oscillation.

(49). The ultrasonic motor according to the (48), wherein the oscillation detecting electrode is formed in the same surface as the driving electrodes of the first piezoelectric element and second piezoelectric element.

(50). The ultrasonic motor according to any one of the (40) to (49), wherein a ratio of a short side of a substantially rectangular section to a long side is set to about 0.6 such that a resonance frequency of the first longitudinal resonance oscillation in which expansion and contraction are performed in the rotation axial direction of the oscillator is substantially matched with a resonance frequency of the second twisting resonance oscillation in which the rotation axis is a twisting axis, the substantially rectangular section being orthogonal to the rotation axis of the oscillator.

(51). The ultrasonic motor according to any one of the (40) to (49), wherein a ratio of a short side of a substantially rectangular section to a long side is set to about 0.3 such that a resonance frequency of the first longitudinal resonance oscillation in which expansion and contraction are performed in the rotation axial direction of the oscillator is substantially matched with a resonance frequency of the third twisting resonance oscillation in which the rotation axis is a twisting axis, the substantially rectangular section being orthogonal to the rotation axis of the oscillator.

(52). The ultrasonic motor according to any one of the (40) to (51), further comprising:

a throughhole that is made in a portion corresponding to the rotation axis of the elastic body;

a shaft that is fixed in a substantially central portion of the throughhole; and

a spring that presses the driven body against the oscillator, the driven body being retained while being rotatable with respect to the shaft.

(53) The ultrasonic motor according to any one of the (40) to (51), further comprising:

a shaft that is integrally provided in a substantially central portion of the elastic body; and

a spring that presses the driven body against the oscillator, the driven body being retained while being rotatable with respect to the shaft.

(54). The ultrasonic motor according to the (40), wherein the first side surface and second side surface of the elastic body are a surface including a long-side direction of the substantially rectangular section of the elastic body.

(55). The ultrasonic motor according to the (1), wherein the oscillator includes:

a substantially-rectangular-solid elastic body whose section perpendicular to the central axis has a substantially rectangular shape, the elastic body having a first side surface and a second side surface, the first side surface including one side of the substantially rectangular shape, the first side surface and the second side surface making a pair; and

a piezoelectric element that is disposed while facing the first side surface of the elastic body, and

a first longitudinal resonance oscillation in which expansion and contraction are performed in the rotation axial direction of the oscillator and a second twisting resonance oscillation or a third twisting resonance oscillation, in which the rotation axis is a twisting axis, are combined to form the elliptic oscillation, thereby rotating the rotor.

(56). The ultrasonic motor according to the (55), wherein a polarization direction of the piezoelectric element exists substantially in an inplane direction of the first side surface of the elastic body, and an angle α formed by the polarization direction and the central axis when the center axial direction is viewed is set so as to satisfy the following condition:

0<α<π/2.

(57). The ultrasonic motor according to the (56), wherein the polarizations are formed at two node portions of the second twisting resonance oscillation.

(58). The ultrasonic motor according to the (56), wherein the polarizations are formed at three node portions of the third twisting resonance oscillation.

(59). The ultrasonic motor according to any one of the (56) to (58), wherein the polarization of the piezoelectric element is formed by the interdigital electrode in which a plurality of electrode patterns are disposed while intersecting.

(60). The ultrasonic motor according to the (59), wherein the interdigital electrode includes a driving electrode and an oscillation detecting electrode.

(61). The ultrasonic motor according to the (59) or (60), wherein the piezoelectric element is a laminated type piezoelectric element having a structure in which a plurality of piezoelectric sheets are laminated, the interdigital electrode being disposed while inclined by a predetermined angle with respect to the central axis in the piezoelectric sheet.

(62). The ultrasonic motor according to any one of the (59) to (61), wherein antiphase alternate voltages are applied between driving interdigital electrodes of the piezoelectric element to simultaneously excite the first longitudinal resonance oscillation and the second twisting resonance oscillation or third twisting resonance oscillation, and

the elliptic oscillation is generated to rotate the rotor in a predetermined direction.

(63). The ultrasonic motor according to any one of the (60) to (62), wherein the longitudinal oscillation or twisting oscillation is detected by the signal supplied from the oscillation detecting electrode of the piezoelectric element.

(64). The ultrasonic motor according to any one of the (55) to (63), wherein a ratio of a short side of a substantially rectangular section to a long side is set to about 0.6 such that a resonance frequency of the first longitudinal resonance oscillation in which expansion and contraction are performed in the rotation axial direction of the oscillator is substantially matched with a resonance frequency of the second twisting resonance oscillation in which the rotation axis is a twisting axis, the substantially rectangular section being orthogonal to the rotation axis of the oscillator.

(65). The ultrasonic motor according to any one of the (55) to (63), wherein a ratio of a short side of a substantially rectangular section to a long side is set to about 0.3 such that a resonance frequency of the first longitudinal resonance oscillation in which expansion and contraction are performed in the rotation axial direction of the oscillator is substantially matched with a resonance frequency of the third twisting resonance oscillation in which the rotation axis is a twisting axis, the substantially rectangular section being orthogonal to the rotation axis of the oscillator.

(66). The ultrasonic motor according to any one of the (55) to (64), further comprising:

a throughhole that is made in a portion corresponding to the rotation axis of the elastic body;

a shaft that is fixed in a substantially central portion of the throughhole; and

a spring that presses the driven body against the oscillator, the driven body being retained while being rotatable with respect to the shaft.

(67). The ultrasonic motor according to any one of the (55) to (65), further comprising:

a shaft that is integrally provided in a substantially central portion of the elastic body; and a spring that presses the driven body against the oscillator, the driven body being retained while being rotatable with respect to the shaft.

(68). The ultrasonic motor according to the (55), wherein the first side surface and second side surface of the elastic body are a surface including a long-side direction of the substantially rectangular section of the elastic body.

(69). The ultrasonic motor according to the (1), wherein the first oscillation is a face shear oscillation that is generated in the same surface of the oscillator, and the second oscillation is a flexural oscillation that is generated in the same surface of the oscillator.

(70). The ultrasonic motor according to the (69), further comprising a retaining member that retains the oscillator in a substantially central portion of a side surface orthogonal to the surface in which the face shear oscillation and the flexural oscillation are generated, the substantially central portion being the substantially node portion of the oscillation.

(71). The ultrasonic motor according to the (70), wherein a ratio of sides in the substantially rectangular sold shape is set to about 1:1:0.45 in the oscillator.

(72). The ultrasonic motor according to the (71), wherein a section orthogonal to the rotation axial direction of the oscillator has a substantially rectangular shape.

(73). The ultrasonic motor according to the (69) or (70), wherein the driven body is a rotating body, and is in contact with the oscillator at least two points in the surface in which the elliptic oscillation is generated.

(74). The ultrasonic motor according to the (72), wherein the oscillator includes a laminated type piezoelectric element in which piezoelectric sheets are laminated in a direction orthogonal to the surface in which the face shear oscillation and the flexural oscillation are generated.

(75). The ultrasonic motor according to the (74), wherein the laminated type piezoelectric element is formed by laminating a plurality of piezoelectric sheets, an interdigital electrode being printed in the piezoelectric sheet while inclined by about 45 degrees.

(76). The ultrasonic motor according to the (75), wherein the piezoelectric sheet in which the interdigital electrode is printed has a function of generating an oscillation.

(77). The ultrasonic motor according to the (76), wherein regions extended to end portions of the piezoelectric sheet of the interdigital electrode on the oscillation generating piezoelectric sheet are different from each other with a boundary of a central surface of the laminated direction.

(78). The ultrasonic motor according to the (75), wherein part of the piezoelectric sheet in which the interdigital electrode is printed has a function of generating an oscillation, and another part of the piezoelectric sheet has a function of detecting the oscillation.

(79). The ultrasonic motor according to the (78), wherein regions extended to end portions of the piezoelectric sheet of the interdigital electrode on the oscillation generating piezoelectric sheet are different from each other with a boundary of a central surface of the laminated direction, and

regions extended to end portions of the piezoelectric sheet of the interdigital electrode on the oscillation detecting piezoelectric sheet are different from each other with the boundary of the central surface of the laminated direction.

(80). The ultrasonic motor according to the (79), wherein the oscillation detecting piezoelectric sheets in which the interdigital electrodes are printed are laminated so as to sandwich the oscillation generating piezoelectric sheet in which the interdigital electrode is printed.

(81). The ultrasonic motor according to the (79), wherein the driving piezoelectric sheets in which the interdigital electrodes are printed are laminated so as to sandwich the oscillation detecting piezoelectric sheet in which the interdigital electrode is printed

(82). The ultrasonic motor according to the (74), wherein a piezoelectric sheet in which the interdigital electrode is printed, the interdigital electrode being disposed while inclined by about 45 degrees in order to excite the face shear oscillation, and a piezoelectric sheet in which the electrode is printed in substantially the entire surface in order to excite the face shear oscillation are laminated in the laminated type piezoelectric element.

(83). The ultrasonic motor according to the (73), wherein the oscillator is a single-plate oscillator, and interdigital electrodes are printed in both surfaces while inclined by about 45 degrees in the same direction, the face shear oscillation and the flexural oscillation being generated in the surfaces.

(84). The ultrasonic motor according to the (83), wherein part of the interdigital electrode acts as the driving interdigital electrode, and another part of the interdigital electrode acts as the oscillation detecting interdigital electrode.

(85). The ultrasonic motor according to the (1), wherein the oscillator includes a single piezoelectric element,

the driven body constitutes a torque transmitting member in which a rotating portion and a rotated portion are integrally formed, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction,

the ultrasonic motor includes:

an oscillator retaining member that is fixed to a portion corresponding to a common node between a first longitudinal resonance oscillation and a third twisting resonance oscillation of the oscillator;

a friction contact member that is fixed to the elliptic oscillation generating surface of the oscillator, the friction contact member coming into friction contact with the torque transmitting member to transmit the torque generated by the elliptic oscillation;

a pressing member in which a support hole is made to support the rotated portion of the torque transmitting member, the pressing member pressing the torque transmitting member against the elliptic oscillation generating surface side of the oscillator while supporting the rotated portion of the torque transmitting member; and

a retaining member in which a first hole, a second hole, and a third hole are made, the oscillator being accommodated in the first hole, the oscillator retaining member being accommodated in the second hole, the pressing member being accommodated in the third hole, the retaining member retaining the oscillator with the oscillator retaining member interposed therebetween, and

the first longitudinal resonance oscillation in which expansion and contraction are performed in the rotation axial direction of the oscillator and the third twisting resonance oscillation in which the rotation axis is a twisting axis are combined to form the elliptic oscillation, thereby rotating the driven body.

(86). The ultrasonic motor according to the (85), wherein an outer shape of the pressing member and a surface of the retaining member are formed into a fitting shape, the surface of the retaining member being coupled to the third hole.

(87). The ultrasonic motor according to the (85), wherein an outer shape of the pressing member and a surface of the retaining member are formed into a thread shape, the surface of the retaining member being coupled to the third hole.

(88). The ultrasonic motor according to the (85), wherein the oscillator retaining member is formed into a U-shape.

(89). The ultrasonic motor according to the (85), wherein the oscillator retaining member is formed by at least two pin-shape members.

(90). The ultrasonic motor according to the (85), further comprising a pressing and fixing member that presses and fixes the pressing member against and to the retaining member.

(91). The ultrasonic motor according to the (85), further comprising a rotational contact member that is disposed between the pressing member and the torque transmitting member.

(92). The ultrasonic motor according to the (91), wherein the rotational contact member is rotated by friction contact.

(93). The ultrasonic motor according to the (91), wherein the rotational contact member is rotated by rolling contact.

(94). The ultrasonic motor according to the (85), further comprising a rotational contact member that is located between the rotated portion of the torque transmitting member and a support hole of the pressing member.

(95). The ultrasonic motor according to the (94), wherein the rotational contact member is rotated by rolling contact.

(96). The ultrasonic motor according to the (85) further comprising an elastic member that is disposed between the pressing member and the torque transmitting member.

(97). The ultrasonic motor according to the (85), wherein the retaining member includes:

a first retaining portion and a second retaining portion, into which the retaining member is divided with a boundary of the same surface as that of a hole, the oscillator retaining member being accommodated in the hole; and

a screw member that tightens the first retaining portion and second retaining portion.

(98). The ultrasonic motor according to the (1) herein the oscillator includes a single piezoelectric element,

the driven body constitutes a torque transmitting member in which a rotating portion and a rotated portion are integrally formed, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction,

the ultrasonic motor includes:

an oscillator retaining member that is fixed to a portion corresponding to a common node between a first longitudinal resonance oscillation and a third twisting resonance oscillation of the oscillator;

a friction contact member that is fixed to the elliptic oscillation generating surface of the oscillator, the friction contact member coming into friction contact with the torque transmitting member to transmit the torque generated by the elliptic oscillation;

a pressing member in which a hole in which the oscillator is accommodated and a hole in which the oscillator retaining member is accommodated are made, the pressing member pressing the rotating portion of the torque transmitting member against the elliptic oscillation generating surface side of the oscillator while the oscillator is retained with the oscillator retaining member interposed therebetween; and

a retaining member in which a first hole and a second hole are made, the rotated portion of the torque transmitting member being supported by the first hole, the pressing member being accommodated in the second hole, the retaining member retaining the pressing member while supporting the rotated portion of the torque transmitting member, and

a first longitudinal resonance oscillation in which expansion and contraction are performed in the rotation axial direction of the oscillator and a third twisting resonance oscillation in which the rotation axis is a twisting axis are combined to form the elliptic oscillation, thereby rotating the torque transmitting member.

(99). The ultrasonic motor according to the (98), wherein an outer shape of the pressing member and a surface of the retaining member are formed into a fitting shape, the surface of the retaining member being coupled to the second hole.

(100). The ultrasonic motor according to the (98), wherein an outer shape of the pressing member and a surface of the retaining member are formed into a thread shape, the surface of the retaining member being coupled to the second hole.

(101). The ultrasonic motor according to the (98), wherein the oscillator retaining member is formed into a U-shape.

(102). The ultrasonic motor according to the (98), wherein the oscillator retaining member is formed by at least two pin-shape members.

(103). The ultrasonic motor according to the (98), further comprising a pressing and fixing member that presses and fixes the pressing member against and to the retaining member.

(104). The ultrasonic motor according to the (98), further comprising a rotational contact member that is disposed between the torque transmitting member and the retaining member.

(105). The ultrasonic motor according to the (104), wherein the rotational contact member is rotated by friction contact.

(106). The ultrasonic motor according to the (104), wherein the rotational contact member is rotated by rolling contact.

(107). The ultrasonic motor according to the (98), further comprising a rotational contact member that is disposed between the rotated portion of the torque transmitting member and the first hole of the retaining member.

(108). The ultrasonic motor according to the (107), wherein the rotational contact member is rotated by rolling contact.

(109). The ultrasonic motor according to the (98), further comprising an elastic member that is disposed between the retaining member and the torque transmitting member.

(110). The ultrasonic motor according to the (1), wherein the oscillator includes a single piezoelectric element,

the driven body constitutes a torque transmitting member that is rotated about a central axis orthogonal to an elliptic oscillation generating surface of the oscillator while being in contact with the elliptic oscillation generating surface of the oscillator, the ultrasonic motor includes:

an oscillator retaining member that is fixed to a portion corresponding to a common node between a first longitudinal resonance oscillation and a third twisting resonance oscillation of the oscillator;

a friction contact member that is fixed to the elliptic oscillation generating surface of the oscillator, the friction contact member coming into friction contact with the torque transmitting member to transmit the torque generated by the elliptic oscillation;

a pressing member that presses the torque transmitting member against the elliptic oscillation generating surface side of the oscillator; and

a retaining member that retains the pressing member, and

the first longitudinal resonance oscillation in which expansion and contraction are performed in the rotation axial direction of the oscillator and the third twisting resonance oscillation in which the rotation axis is a twisting axis are combined to form the elliptic oscillation, thereby rotating the torque transmitting member.

(111). The ultrasonic motor according to the (110), wherein the torque transmitting member is integrally molded while having a rotating portion and a rotated portion, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction.

(112). The ultrasonic motor according to the (111), wherein an outer shape of the pressing member and a surface of the retaining member are formed into a fitting shape, the surface of the retaining member being in contact with the pressing member.

(113). The ultrasonic motor according to the (111), wherein an outer shape of the pressing member and a surface of the retaining member are formed into a thread shape, the surface of the retaining member being in contact with the pressing member.

(114). The ultrasonic motor according to the (111), wherein the oscillator retaining member is formed into a U-shape.

(115). The ultrasonic motor according to the (111), wherein the oscillator retaining member is formed by at least two pin-shape members.

(116). The ultrasonic motor according to the (111), further comprising a pressing and fixing member that presses and fixes the pressing member against and to the retaining member.

(117). The ultrasonic motor according to the (111), wherein a support hole is made to support the rotated portion of the torque transmitting member in the pressing member, and the pressing member presses the torque transmitting member against the elliptic oscillation generating surface side of the oscillator while supporting the rotated portion of the torque transmitting member, and

a first hole, a second hole, and a third hole are made in the retaining member, the oscillator being accommodated in the first hole, the oscillator retaining member being accommodated in the second hole, the pressing member being accommodated in the third hole, and the retaining member retains the oscillator with the oscillator retaining member interposed therebetween.

(118). The ultrasonic motor according to the (113), further comprising a rotational contact member that is disposed between the pressing member and the torque transmitting member.

(119). The ultrasonic motor according to the (117), wherein the rotational contact member is rotated by friction contact.

(120). The ultrasonic motor according to the (117), wherein the rotational contact member is rotated by rolling contact.

(121). The ultrasonic motor according to the (117), further comprising a rotational contact member that is disposed between the rotated portion of the torque transmitting member and the support hole for the pressing member.

(122). The ultrasonic motor according to the (121), wherein the rotational contact member is rotated by rolling contact.

(123). The ultrasonic motor according to the (117), further comprising an elastic member that is disposed between the pressing member and the torque transmitting member.

(124). The ultrasonic motor according to the (117), wherein the retaining member includes:

a first retaining portion and a second retaining portion, into which the retaining member is divided with a boundary of the same surface as that of a hole, the oscillator retaining member being accommodated in the hole; and

a screw member that tightens the first retaining portion and second retaining portion.

(125). The ultrasonic motor according to the (110), wherein the torque transmitting member is integrally molded while having a rotating portion and a rotated portion, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction, and

the retaining member retains the pressing member while supporting the rotated portion of the torque transmitting member.

(126). The ultrasonic motor according to the (125), wherein a hole in which the oscillator is accommodated and a hole in which the oscillator retaining member is accommodated are made in the pressing member, and the pressing member presses the rotating portion of the torque transmitting member against the elliptic oscillation generating surface side of the oscillator while the oscillator is retained with the oscillator retaining member interposed therebetween, and

a first hole and a second hole are made in the retaining member, the rotated portion of the torque transmitting member being supported by the first hole, the pressing member being accommodated in the second hole, and the retaining member retains the pressing member while supporting the rotated portion of the torque transmitting member.

(127). The ultrasonic motor according to the (126), further comprising a rotational contact member that is disposed between the torque transmitting member and the retaining member.

(128). The ultrasonic motor according to the (127), wherein the rotational contact member is rotated by friction contact.

(129). The ultrasonic motor according to the (127), wherein the rotational contact member is rotated by rolling contact.

(130). The ultrasonic motor according to the (126), further comprising a rotational contact member that is located between the rotated portion of the torque transmitting member and the first hole in the retaining member.

(131). The ultrasonic motor according to the (130), wherein the rotational contact member is rotated by rolling contact.

(132). The ultrasonic motor according to the (126), further comprising an elastic member that is disposed between the retaining member and the torque transmitting member.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor comprising:
an oscillator whose section perpendicular to a central axis has a rectangular length ratio;
oscillation applying means for applying a first longitudinal resonance oscillation in which oscillation is performed in a direction of a rotation axial direction of the oscillator and a second twisting resonance oscillation in which the oscillation is performed in a direction orthogonal to the rotation axial direction; and
a driven body that is rotated, with a central axis orthogonal to an elliptic oscillation generating surface of the oscillator as a rotation axis, while being in contact with the elliptic oscillation generating surface,
the rectangular length ratio of the oscillator is set such that a resonance frequency of the first resonance oscillation is substantially matched with a resonance frequency of the second resonance oscillation.

2. The ultrasonic motor according to claim 1, wherein the oscillator includes only a piezoelectric element,
a first driving interdigital electrode is provided in a surface parallel to the rotation axis and near at least one node position of twisting oscillation in the surface parallel to the rotation axis in the piezoelectric element,
an angle θ formed by a longitudinal direction of the first driving interdigital electrode and the rotation axis direction is provided on the following condition:
0<θ<π/2,
a second driving interdigital electrode is provided in a surface facing the surface in which the first driving interdigital electrode is provided, and
an angle τ formed by a longitudinal direction of the second driving interdigital electrode and the rotation axis direction is provided on the following condition:
τ=π−θ

3. The ultrasonic motor according to claim 1, wherein the oscillator includes only a piezoelectric element,
a first driving interdigital electrode is provided in a surface parallel to the rotation axis and near at least one node position of twisting oscillation in the surface parallel to the rotation axis in the piezoelectric element,
an angle θ formed by a longitudinal direction of the first driving interdigital electrode and the rotation axis direction is provided on the following condition:
0<θ<π/2,
a second driving interdigital electrode is provided near a twisting node position in an opposite direction to the twisting in the surface in which the first driving interdigital electrode is provided, and
an angle τ formed by a longitudinal direction of the second driving interdigital electrode and the rotation axis direction is provided on the following condition:
τ=θ.

4. The ultrasonic motor according to claim 1, wherein the oscillator includes a single piezoelectric element,
a polarization direction of the piezoelectric element exists substantially in an inplane direction of a side surface of the oscillator, the inplane direction including the central axis direction, and an angle ε formed by the polarization direction and the central axis direction is set so as to satisfy the following condition:
0<ε<π/2, and
a first longitudinal resonance oscillation in which expansion and contraction are performed in the rotation axial direction of the oscillator and a second twisting resonance oscillation in which the rotation axis is a twisting axis are combined to form the elliptic oscillation, thereby rotating the driven body.

5. The ultrasonic motor according to claim 1, wherein the oscillator is formed by laminating a plurality of first piezoelectric sheets in which driving interdigital electrode patterns are formed,
the first piezoelectric sheets have a first driving polarization formed in a position in the neighborhood of a first node position of twisting oscillation in the surface parallel to the rotation axis, and an angle θ formed by a digital direction of the interdigital electrode and the central axis direction is provided on the following condition:
0<θ<π/2,
an angle ψ formed by the direction of the polarization and the central axis direction in a position neighborhood of a second node position of the twisting oscillation in the surface parallel to the rotation axis, is provided on conditions except for 0, π/2, and π, and
a first longitudinal resonance oscillation in which expansion and contraction are performed in a direction of the rotation axial direction of the oscillator and a second twisting resonance oscillation in which the rotation axis is a twisting axis are combined to generate an elliptic oscillation.

6. The ultrasonic motor according to claim 1, wherein the oscillator is formed by laminating a plurality of first piezoelectric sheets in which driving interdigital electrode patterns are formed,
the first piezoelectric sheets have a first driving polarization formed in a position in the neighborhood of a first node position of twisting oscillation in the surface parallel to the rotation axis, and an angle θ formed by a digital direction of the interdigital electrode and the central axis direction is provided on the following condition:
0<θ<π/2,
an oscillation-detecting polarization is formed in a position in the neighborhood of a second node position of the twisting oscillation in the surface parallel to the rotation axis, and an angle γ formed by the direction of the oscillation-detecting interdigital electrode and the central axis direction is provided on conditions except for 0, π/2, and π, and
a first longitudinal resonance oscillation in which expansion and contraction are performed in a direction of the rotation axial direction of the oscillator and a second twisting resonance oscillation in which the rotation axis is a twisting axis are combined to generate an elliptic oscillation.

7. The ultrasonic motor according to claim 1, wherein the oscillator is formed by alternately laminating a plurality of first piezoelectric sheets in which driving internal electrode patterns are formed and a plurality of second piezoelectric sheets in which the driving internal electrode patterns are formed,
a left digit side of a driving interdigital electrode is provided near at least one node position of twisting oscillation in the surface parallel to the rotation axis in the first piezoelectric sheet,
an angle θ formed by a longitudinal direction of the left-digit internal electrode and the rotation axis direction is provided on the following condition:
0<θ<π/2,
a right digit side of the driving interdigital electrode is provided near the node position of the twisting oscillation in the surface parallel to the rotation axis in the second piezoelectric sheet,
an angle formed by a longitudinal direction of the right-digit-side internal electrode and the rotation axis direction is provided to be identical to an angle formed by a longitudinal direction of the left-digit-side internal electrode and the rotation axis direction,
the driving internal electrode of the first piezoelectric sheet and the driving internal electrode of the second piezoelectric sheet substantially constitute a pair of interdigital electrodes,
parts of the internal electrodes of the first piezoelectric sheet and second piezoelectric sheet are extended to an end portion of each piezoelectric sheet to be electrically connected to an external electrode of each piezoelectric sheet, and
the extended portion of the driving internal electrode of the first piezoelectric sheet and the extended portion of the driving internal electrode of the second piezoelectric sheet are connected to different external electrodes with a boundary of a substantially central portion in the laminated direction.

8. The ultrasonic motor according to claim 1, wherein the oscillator is formed by alternately laminating a plurality of first piezoelectric sheets in which oscillation detecting internal electrode patterns are formed and a plurality of second piezoelectric sheets in which the oscillation detecting internal electrode patterns are formed,
a left digit side of an oscillation detecting interdigital electrode is provided near at least one node position of twisting oscillation in the surface parallel to the rotation axis in the first piezoelectric sheet,
an angle θ formed by a longitudinal direction of the left-digit internal electrode and the rotation axis direction is provided on the following condition:
0<θ<π/2,
a right digit side of the oscillation detecting interdigital electrode is provided near the node position of the twisting oscillation in the surface parallel to the rotation axis in the second piezoelectric sheet,
an angle formed by a longitudinal direction of the right-digit-side internal electrode and the rotation axis direction is provided to be identical to an angle formed by a longitudinal direction of the left-digit-side internal electrode and the rotation axis direction,
the oscillation detecting internal electrode of the first piezoelectric sheet and the oscillation detecting internal electrode of the second piezoelectric sheet substantially constitute a pair of oscillation detecting interdigital electrodes,
parts of the oscillation detecting internal electrodes of the first piezoelectric sheet and second piezoelectric sheet are extended to an end portion of each piezoelectric sheet to be electrically connected to an external electrode of each piezoelectric sheet, and
the extended portion of the oscillation detecting internal electrode of the first piezoelectric sheet and the extended portion of the oscillation detecting internal electrode of the second piezoelectric sheet are connected to different external electrodes with a boundary of a substantially central portion in the laminated direction.

9. The ultrasonic motor according to any one of claims 1 to 8, wherein a ratio of a rectangular short side to a rectangular long side is set to about 0.6 in the rectangular length ratio of the oscillator.

10. An ultrasonic motor comprising:
an oscillator whose section perpendicular to a central axis has a rectangular length ratio;
oscillation applying means for applying a first longitudinal resonance oscillation in which oscillation is performed in a direction of a rotation axial direction of the oscillator and a third twisting resonance oscillation in which the oscillation is performed in a direction orthogonal to the rotation axial direction; and
a driven body that is rotated, with a central axis orthogonal to an elliptic oscillation generating surface of the oscillator as a rotation axis, while being in contact with the elliptic oscillation generating surface,
the rectangular length ratio of the oscillator is set such that a resonance frequency of the first resonance oscillation is substantially matched with a resonance frequency of the second resonance oscillation.

11. The ultrasonic motor according to claim 1, wherein the first oscillation is a first longitudinal resonance oscillation, and the second oscillation is a third twisting resonance oscillation in which the rotation axis is a twisting axis.

12. The ultrasonic motor according to claim 11, wherein the oscillator has a single piezoelectric element,
a polarization direction of the piezoelectric element exists substantially in an inplane direction of a side surface of the oscillator, the inplane direction including the central axis direction, and an angle formed by the polarization direction and the central axis direction is set so as to satisfy the following condition:
0<ε<π/2, and
a second driving interdigital electrode is provided in a surface facing the surface in which a first driving interdigital electrode is provided, and
an angle τ formed by a longitudinal direction of the second driving interdigital electrode and the rotation axis direction is provided on the following condition:
τ=π−ε.

13. The ultrasonic motor according to claim 8, wherein the oscillator is formed by laminating a plurality of piezoelectric sheets in which interdigital electrode patterns are formed,
a first driving interdigital electrode is provided near a first node position of twisting oscillation in the surface parallel to the rotation axis in the piezoelectric sheet,
an angle θ formed by a digital direction of the interdigital electrode and the rotation axis direction is provided on the following condition:
0<θ<π/2,
a second driving interdigital electrode is provided near a second node position of the twisting oscillation in the surface parallel to the rotation axis, the second driving interdigital electrode being electrically connected in parallel to the driving electrode,
an angle φ formed by a digital direction of the interdigital electrode and the rotation axis direction is provided on the following condition:
π/2<φ<π,
an oscillation detecting interdigital electrode is provided near a third node position of the twisting oscillation in the surface parallel to the rotation axis,
an angle γ formed by a digital direction of the second driving interdigital electrode and the central axis direction is provided on conditions except for 0, π/2, and π, and
a first longitudinal resonance oscillation in which expansion and contraction are performed in the rotation axial direction of the oscillator and a third twisting resonance oscillation in which the rotation axis is a twisting axis are combined to form the elliptic oscillation.

14. The ultrasonic motor according to claim 8, wherein the oscillator is formed by alternately laminating a plurality of first piezoelectric sheets in which driving internal electrode patterns are formed and a plurality of second piezoelectric sheets in which the driving internal electrode patterns are formed,
a left digit side of a driving interdigital electrode is provided near at least one node position of twisting oscillation in the surface parallel to the rotation axis in the first piezoelectric sheet,
an angle θ formed by a longitudinal direction of the left-digit internal electrode and the rotation axis direction is provided on the following condition:
0<θ<π/2,
a right digit side of the driving interdigital electrode is provided near the node position of the twisting oscillation in the surface parallel to the rotation axis in the second piezoelectric sheet,
an angle formed by a longitudinal direction of the right-digit-side internal electrode and the rotation axis direction is provided to be identical to an angle formed by a longitudinal direction of the left-digit-side internal electrode and the rotation axis direction,
the driving internal electrode of the first piezoelectric sheet and the driving internal electrode of the second piezoelectric sheet substantially constitute a pair of interdigital electrodes,
parts of the driving internal electrodes of the first piezoelectric sheet and second piezoelectric sheet are extended to an end portion of each piezoelectric sheet to be electrically connected to an external electrode of each piezoelectric sheet, and
the extended portion of the driving internal electrode of the first piezoelectric sheet and the extended portion of the driving internal electrode of the second piezoelectric sheet are connected to different external electrodes with a boundary of a substantially central portion in the laminated direction.

15. The ultrasonic motor according to claim 8, wherein the oscillator is formed by alternately laminating a plurality of first piezoelectric sheets in which oscillation detecting internal electrode patterns are formed and a plurality of second piezoelectric sheets in which the oscillation detecting internal electrode patterns are formed,
a left digit side of an oscillation detecting interdigital electrode is provided near at least one node position of twisting oscillation in the surface parallel to the rotation axis in the first piezoelectric sheet,
an angle θ formed by a longitudinal direction of the left-digit internal electrode and the rotation axis direction is provided on the following condition:
0<θ<π/2,
a right digit side of the oscillation detecting interdigital electrode is provided near the node position of the twisting oscillation in the surface parallel to the rotation axis in the second piezoelectric sheet,
an angle formed by a longitudinal direction of the right-digit-side internal electrode and the rotation axis direction is provided to be identical to an angle formed by a longitudinal direction of the left-digit-side internal electrode and the rotation axis direction,
the oscillation detecting internal electrode of the first piezoelectric sheet and the oscillation detecting internal electrode of the second piezoelectric sheet substantially constitute a pair of interdigital electrodes,
parts of the oscillation detecting internal electrodes of the first piezoelectric sheet and second piezoelectric sheet are extended to an end portion of each piezoelectric sheet to be electrically connected to an external electrode of each piezoelectric sheet, and
the extended portion of the oscillation detecting internal electrode of the first piezoelectric sheet and the extended portion of the oscillation detecting internal electrode of the second piezoelectric sheet are connected to different external electrodes with a boundary of a substantially central portion in the laminated direction.

16. The ultrasonic motor according to any one of claims 11 to 15, wherein a ratio of a rectangular short side to a rectangular long side is set to about 0.3 in the rectangular length ratio of the oscillator.

17. The ultrasonic motor according to claim 1, wherein the oscillator includes:
a substantially-rectangular-solid elastic body whose section perpendicular to the central axis has a substantially rectangular shape, the elastic body having a first side surface and a second side surface, the first side surface including one side of the substantially rectangular shape, the first side surface and the second side surface making a pair;
a first piezoelectric element that is disposed while facing the first side surface of the elastic body; and
a second piezoelectric element that is disposed while facing the second side surface of the elastic body, and
a first longitudinal resonance oscillation in which expansion and contraction are performed in the rotation axial direction of the oscillator and a second twisting resonance oscillation or a third twisting resonance oscillation, in which the rotation axis is a twisting axis, are combined to form the elliptic oscillation, thereby rotating the rotor.

18. The ultrasonic motor according to claim 1, wherein the oscillator includes:
a substantially-rectangular-solid elastic body whose section perpendicular to the central axis has a substantially rectangular shape, the elastic body having a first side surface and a second side surface, the first side surface including one side of the substantially rectangular shape, the first side surface and the second side surface making a pair; and
a piezoelectric element that is disposed while facing the first side surface of the elastic body, and
a first longitudinal resonance oscillation in which expansion and contraction are performed in the rotation axial direction of the oscillator and a second twisting resonance oscillation or a third twisting resonance oscillation, in which the rotation axis is a twisting axis, are combined to form the elliptic oscillation, thereby rotating the rotor.

19. The ultrasonic motor according to claim 1, wherein the first oscillation is a face shear oscillation that is generated in the same surface of the oscillator, and the second oscillation is a flexural oscillation that is generated in the same surface of the oscillator.

20. The ultrasonic motor according to claim 19, further comprising a retaining member that retains the oscillator in a substantially central portion of a side surface orthogonal to the surface in which the face shear oscillation and the flexural oscillation are generated, the substantially central portion being the substantially node portion of the oscillation.

21. The ultrasonic motor according to claim 19, wherein a length ratio in the rectangular solid shape of the oscillator is set such that a short side is substantially 0.45 with respect to long sides.

22. The ultrasonic motor according to claim 21, wherein a length ratio in the direction of the rotation axis of the oscillator is set as (1:1), in which case long sides of the rectangular solid body are (1:1).

23. The ultrasonic motor according to claim 1, wherein
the driven body constitutes a torque transmitting member in which a rotating portion and a rotated portion are integrally formed, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction,
the ultrasonic motor includes:
an oscillator retaining member that is fixed to a portion corresponding to a common node of the oscillator;
a friction contact member that is fixed to the elliptic oscillation generating surface of the oscillator, the friction contact member coming into friction contact with the torque transmitting member to transmit the torque generated by the elliptic oscillation;
a pressing member in which a support hole is made to support the rotated portion of the torque transmitting member, the pressing member pressing the torque transmitting member against the elliptic oscillation generating surface side of the oscillator while supporting the rotated portion of the torque transmitting member; and
a retaining member in which a first hole, a second hole, and a third hole are made, the oscillator being accommodated in the first hole, the oscillator retaining member being accommodated in the second hole, the pressing member being accommodated in the third hole, the retaining member retaining the oscillator with the oscillator retaining member interposed therebetween.

24. The ultrasonic motor according to claim 1, wherein the oscillator includes a single piezoelectric element,
the driven body constitutes a torque transmitting member in which a rotating portion and a rotated portion are integrally formed, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction,
the ultrasonic motor includes:
an oscillator retaining member that is fixed to a portion corresponding to a common node of the oscillator;
a friction contact member that is fixed to the elliptic oscillation generating surface of the oscillator, the friction contact member coming into friction contact with the torque transmitting member to transmit the torque generated by the elliptic oscillation;
a pressing member in which a hole in which the oscillator is accommodated and a hole in which the oscillator retaining member is accommodated are made, the pressing member pressing the rotating portion of the torque transmitting member against the elliptic oscillation generating surface side of the oscillator while the oscillator is retained with the oscillator retaining member interposed therebetween; and
a retaining member in which a first hole and a second hole are made, the rotated portion of the torque transmitting member being supported by the first hole, the pressing member being accommodated in the second hole, the retaining member retaining the pressing member while supporting the rotated portion of the torque transmitting member.

25. The ultrasonic motor according to claim 1, wherein the oscillator includes a single piezoelectric element,
the driven body constitutes a torque transmitting member that is rotated about a central axis orthogonal to an elliptic oscillation generating surface of the oscillator while being in contact with the elliptic oscillation generating surface of the oscillator,
the ultrasonic motor includes:
an oscillator retaining member that is fixed to a portion corresponding to a common node between a first longitudinal resonance oscillation and a third twisting resonance oscillation of the oscillator;
a friction contact member that is fixed to the elliptic oscillation generating surface of the oscillator, the friction contact member coming into friction contact with the torque transmitting member to transmit the torque generated by the elliptic oscillation;
a pressing member that presses the torque transmitting member against the elliptic oscillation generating surface side of the oscillator; and
a retaining member that retains the pressing member, and
the first longitudinal resonance oscillation in which expansion and contraction are performed in the rotation axial direction of the oscillator and the third twisting resonance oscillation in which the rotation axis is a twisting axis are combined to form the elliptic oscillation, thereby rotating the torque transmitting member.

26. The ultrasonic motor according to claim 25, wherein the torque transmitting member is integrally molded while having a rotating portion and a rotated portion, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction.

27. The ultrasonic motor according to claim 25, wherein the torque transmitting member is integrally molded while having a rotating portion and a rotated portion, the rotating portion being rotated about a central axis orthogonal to an elliptic oscillation generating surface of the oscillator while being in contact with the elliptic oscillation generating surface of the oscillator, the rotated portion transmitting a torque of the rotating portion in an axial direction, and
the retaining member retains the pressing member while supporting the rotated portion of the torque transmitting member.

28. The ultrasonic motor according to claim 27, wherein a hole in which the oscillator is accommodated and a hole in which the oscillator retaining member is accommodated are made in the pressing member, and the pressing member presses the rotating portion of the torque transmitting member against the elliptic oscillation generating surface side of the oscillator while the oscillator is retained with the oscillator retaining member interposed therebetween, and
a first hole and a second hole are made in the retaining member, the rotated portion of the torque transmitting member being supported by the first hole, the pressing member being accommodated in the second hole, and the retaining member retains the pressing member while supporting the rotated portion of the torque transmitting member.

29. The ultrasonic motor according to claim 2 or 3, wherein the oscillator includes only a piezoelectric element,
a first oscillation detecting interdigital electrode is provided in a surface parallel to the rotation axis and near at least one node position of twisting oscillation in the surface parallel to the rotation axis in the piezoelectric element,
an angle φ formed by a longitudinal direction of the first oscillation detecting interdigital electrode and the rotation axis direction is provided on the following condition:
0<φ<π/2,
a second oscillation detecting interdigital electrode is provided in a surface facing the surface in which the first oscillation detecting interdigital electrode is provided, and
an angle ψ formed by a longitudinal direction of the second oscillation detecting interdigital electrode and the rotation axis direction is provided on the following condition:
ψ=π−φ.

30. The ultrasonic motor according to claim 2 or 3, wherein the oscillator includes only a piezoelectric element,
a first oscillation detecting interdigital electrode is provided in a surface parallel to the rotation axis and near at least one node position of twisting oscillation in the surface parallel to the rotation axis in the piezoelectric element,
an angle φ formed by a longitudinal direction of the first oscillation detecting interdigital electrode and the rotation axis direction is provided on the following condition:
0<φ<π/2,
a second oscillation detecting interdigital electrode is provided near a twisting node position in an opposite direction to the twisting in the surface in which the first oscillation detecting interdigital electrode is provided, and
an angle ψ formed by a longitudinal direction of the second oscillation detecting interdigital electrode and the rotation axis direction is provided on the following condition:
ψ=φ.

31. The ultrasonic motor according to claim 12, wherein the polarization is formed in a position including at least one node portion in three node portions of the third twisting resonance oscillation.

32. The ultrasonic motor according to claim 4, wherein the polarization is formed in a position including at least one node portion in two node portions of the second twisting resonance oscillation.

33. The ultrasonic motor according to any one of claims 4 or 12, comprising:
an internal electrode that is divided into at least two groups with a boundary of a surface including the central axis, the surface being parallel to an outer side surface of the oscillator; and
a plurality of external electrodes that are provided in the outer side surface of the oscillator and connected to the internal electrode,
wherein the polarization is formed between the internal electrodes, and
an alternate voltage is applied to the plurality of external electrodes to excite the elliptic oscillation, thereby rotating the driven body.

34. The ultrasonic motor according to claim 17, wherein a polarization direction of the first piezoelectric element exists substantially in an inplane direction of the first side surface of the elastic body, and an angle α formed by the polarization direction and the central axis when the center axial direction is viewed is set so as to satisfy the following condition:
0<α<π/2, and
a polarization direction of the second piezoelectric element exists substantially in an inplane direction of the second side surface of the elastic body, and an angle β formed by the polarization direction and the central axis when the center axial direction is viewed is set so as to satisfy the following condition:
β=−α.

35. The ultrasonic motor according to claim 34, wherein the polarization is formed in a position including at least one of two node portions of the second twisting resonance oscillation.

36. The ultrasonic motor according to claim 34, wherein the polarization is formed in a position including at least one of three node portions of the third twisting resonance oscillation.

37. The ultrasonic motor according to claim 34, wherein the polarization of the first piezoelectric element and the polarization of the second piezoelectric element are formed by an interdigital electrode in which a plurality of electrode patterns are disposed while intersecting.

38. The ultrasonic motor according to claim 37, wherein the first piezoelectric element and the second piezoelectric element are a laminated type piezoelectric element having a structure in which a plurality of piezoelectric sheets are laminated, the interdigital electrode being disposed while inclined by a predetermined angle with respect to the central axis in the piezoelectric sheet.

39. The ultrasonic motor according to claim 18, wherein a polarization direction of the piezoelectric element exists substantially in an inplane direction of the first side surface of the elastic body, and an angle α formed by the polarization direction and the central axis when the center axial direction is viewed is set so as to satisfy the following condition:
0<α<π/2.

40. The ultrasonic motor according to claim 39, wherein the polarizations are formed at two node portions of the second twisting resonance oscillation.

41. The ultrasonic motor according to claim 39, wherein the polarizations are formed at three node portions of the third twisting resonance oscillation.

42. The ultrasonic motor according to claim 39 or 40, wherein the piezoelectric element is a laminated type piezoelectric element having a structure in which a plurality of piezoelectric sheets are laminated, the interdigital electrode being disposed while inclined by a predetermined angle with respect to the central axis in the piezoelectric sheet.

43. The ultrasonic motor according to claim 20, wherein the oscillator includes a laminated type piezoelectric element in which piezoelectric sheets are laminated in a direction orthogonal to the surface in which the face shear oscillation and the flexural oscillation are generated.

44. The ultrasonic motor according to claim 43, wherein the laminated type piezoelectric element is formed by laminating a plurality of piezoelectric sheets, an interdigital electrode being printed in the piezoelectric sheet while inclined by about 45 degrees.

45. The ultrasonic motor according to claim 44, wherein the piezoelectric sheet in which the interdigital electrode is printed has a function of generating an oscillation.

46. The ultrasonic motor according to claim 44, wherein part of the piezoelectric sheet in which the interdigital electrode is printed has a function of generating an oscillation, and another part of the piezoelectric sheet has a function of detecting the oscillation.

47. The ultrasonic motor according to claim 43, wherein a piezoelectric sheet in which the interdigital electrode is printed, the interdigital electrode being disposed while inclined by about 45 degrees in order to excite the face shear oscillation, and a piezoelectric sheet in which the electrode is printed in substantially the entire surface in order to excite the face shear oscillation are laminated in the laminated type piezoelectric element.

48. An ultrasonic motor comprising:
an oscillator whose section perpendicular to a central axis has a rectangular length ratio;
oscillation applying means for applying a first resonance oscillation in which oscillation is performed in a direction of a rotation axial direction of the oscillator and a second resonance oscillation in which the oscillation is performed in a direction orthogonal to the rotation axial direction; and
a driven body that is rotated, with a central axis orthogonal to an elliptic oscillation generating surface of the oscillator as a rotation axis, while being in contact with the elliptic oscillation generating surface,
the rectangular length ratio of the oscillator is set such that a resonance frequency of the first resonance oscillation is substantially matched with a resonance frequency of the second resonance oscillation.

49. The ultrasonic motor according to claim 48, wherein the oscillator comprises sections which are an arbitrary combination of sections selected from the group consisting of a substantially rectangular section, an elliptic section and a rhombic section.

50. The ultrasonic motor according to claim 49, wherein the elliptic oscillation generating surface is flat.

51. The ultrasonic motor according to claim 49, wherein the elliptic oscillation generating surface has a depression.

52. The ultrasonic motor according to claim 49, further comprising one or more rotors which are symmetrically arranged with respect to a central axis of the elliptic oscillation generating surface such that the rotors are away from the central axis by predetermined distances.

53. The ultrasonic motor according to claim 49, wherein the driven body is in the form of a disk or a sphere.

54. The ultrasonic motor according to claim 1, wherein the elliptic oscillation generating surface has rotors on end faces thereof, which are along the central axis of the oscillator.
